(19) United States
(12) Patent Application Publication
(10) Pub. No.: US 2016/0328723 A1
(43) Pub. Date: Nov. 10, 2016

(54) METHODS AND SYSTEMS FOR ANALYZING ECONOMIC PHENOMENA

(71) Applicant: Frank Patrick Cunnane, Chardon, OH (US)

(72) Inventor: Frank Patrick Cunnane, Chardon, OH (US)

(21) Appl. No.: 15/212,623

(22) Filed: Jul. 18, 2016

Related U.S. Application Data
(63) Continuation-in-part of application No. 14/672,400, filed on Mar. 30, 2015.
(60) Provisional application No. 61/979,076, filed on Apr. 14, 2014.

(51) Int. Cl. G06Q 30/02

(52) U.S. Cl. CPC G06Q 30/0201

(57) ABSTRACT

Various methods and systems for analyzing economic systems are described. A representative method determines a change in wealth of an economic system by identifying certain transactions in the economic system at different times, assessing a transaction rate, identifying a value of economy of ownership entities, and applying a particular formula to determine the change in wealth of the system.

### CROSS REFERENCES TO RELATED APPLICATIONS

The present application is a continuation-in-part (CIP) application and claims priority upon U.S. nonprovisional patent application Ser. No. 14/672,400 filed Mar. 30, 2015, which claims priority upon U.S. provisional patent application Ser. No. 61/979,076 filed Apr. 14, 2014.

### FIELD

The present subject matter relates to new methods and strategies for analyzing economic phenomena. The present subject matter also relates to computer readable media and systems for performing the noted methods.

### BACKGROUND

Economic analysis concerns the collection, processing, compilation, dissemination, and evaluation of economic data and phenomena. The data may include those of any economy of region, country, or group of countries. Analysis may include topics and problems in microeconomics, macroeconomics, business, finance, forecasting, data quality, and policy evaluation.

Many methods are known to analyse economic phenomena and data. These include, e.g., time-series analysis using multiple regression, Box-Jenkins analysis, and seasonality analysis. Analysis may be univariate (modelling one series) or multivariate (from several series). Econometricians, economic statisticians, and financial analysts formulate models, whether for past relationships or for economic forecasting. These models include both partial equilibrium microeconomics aimed at examining particular parts of an economy or economies, or they may cover a whole economic system, as in general equilibrium theory or and in macroeconomics. Economists use these models to understand past events and to forecast future events, e.g., demand, prices, and employment. Methods have also been developed for analysing or correcting results from use of incomplete data and errors in variables.

Although satisfactory in many respects, a need exists for a new approach for analysing economic phenomena and data.

### SUMMARY

The difficulties and drawbacks associated with previous approaches are addressed in the present subject matter as follows.

In one aspect, the present subject matter provides a method for determining a change in wealth of an economic system. The method comprises identifying and defining an economic system having a plurality of wealth values, each wealth value associated with a particular time. The method also comprises identifying a first number of transactions occurring in the economic system at a first time. The method also comprises identifying a second number of transactions occurring in the economic system at a second time, the second time being after the first time. The method further comprises determining a change in transactions over time by comparing the first and second numbers of transactions in the economic system to thereby obtain a transaction rate, Tr. The method also comprises identifying a value of economy of ownership entities in the economic system, e. The method additionally comprises applying a formula (I) using the transaction rate Tr and the value of economy of ownership entities e to determine the change in wealth ΔW of the economic system, wherein the formula (I) is:

ΔW=½e(Tr)² (I)

In another aspect, the present subject matter provides an article comprising a machine-readable medium embodying instructions that when performed by one or more machines result in operations comprising identifying and defining an economic system having a plurality of wealth values, in which each wealth value is associated with a particular time. The operations also comprise identifying a first number of transactions occurring in the economic system at a first time. The operations also comprise identifying a second number of transactions occurring in the economic system at a second time, the second time being after the first time. The operations further comprise determining a change in transactions over time by comparing the first and second numbers of transactions in the economic system to thereby obtain a transaction rate, Tr. The operations also comprise identifying a value of economy of ownership entities in the economic system, e. The operations additionally comprise applying a formula (I) using the transaction rate Tr and the value of economy of ownership entities e to determine the change in wealth ΔW of the economic system, wherein the formula (I) is:

ΔW=½e(Tr)² (I)

In still another aspect, the present subject matter provides a system comprising a processor and a memory, wherein the processor and the memory are configured to perform operations comprising identifying and defining an economic system having a plurality of wealth values, each wealth value associated with a particular time. The operations also comprise identifying a first number of transactions occurring in the economic system at a first time. The operations also comprise identifying a second number of transactions occurring in the economic system at a second time, the second time being after the first time. The operations further comprise determining a change in transactions over time by comparing the first and second numbers of transactions in the economic system to thereby obtain a transaction rate, Tr. The operations also comprise identifying a value of economy of ownership entities in the economic system, e. The operations also comprise applying a formula (I) using the transaction rate Tr and the value of economy of ownership entities e to determine the change in wealth ΔW of the economic system, wherein the formula (I) is:

ΔW=½e(Tr)² (I)

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a graph illustrating gross domestic product (GDP) for various countries.

FIG. 2 is a graph illustrating electricity consumption for various countries.

FIG. 3 is a graph illustrating oil consumption for various countries.

FIG. 4 is a graph of temperature versus heat applied for a material such as water undergoing a phase change.

FIG. 5 is a graph of a typical response of a system to a perturbation.

FIG. 6 is a schematic diagram illustrating a system receiving input and producing work and heat.

FIG. 7 is a schematic diagram illustrating cause and effect of energy input and occurrence of output(s).

FIG. 8 illustrates a relationship between input(s), output(s), and constant properties of a system.

FIG. 9 illustrates application of a physics to economics model to determine a predicted return of an economy.

FIG. 10 is a schematic illustration of a system in accordance with an embodiment of the present subject matter.

### DETAILED DESCRIPTION OF THE EMBODIMENTS

The present subject matter provides a new strategy for analyzing economic phenomena by identifying one or more economic variables of the phenomena to be analyzed. After identifying the economic variables, one or more physics variables are assigned to each of the respective economic variables. Thus, the economic variables are replaced by physics variables. The physics variables are those that correspond to the economic variable, as described in greater detail herein. After assignment of the physics variables, the resulting collection of physics variables are then evaluated using physical laws, as described in greater detail herein, to thereby analyze the economic phenomena.

Table of Contents

| | |
|---|---|
| | Introduction |
| I. | First principles of Economics |
| II. | Preface |
| III. | The Pilgrim Test of Economic Theory |
| IV. | Introduction to the Principles of Economics |
| V. | The Concept |
| VI. | Three Very Useful Concepts |
| VII. | Measurement |
| VIII. | Energy - The Origin of the Cause |
| IX. | Restating Economics as a First principle |
| | Based on Natural Science |
| X. | Restating Wealth as a First principle |
| | Based on Natural Science |
| XI. | Restating Capital as a First principle |
| | Based on Natural Science |
| XII. | Acceleration - How We Change |
| XIII. | The Counterforces to Economic Growth from |
| | the Natural Science First principle of |
| | Economics View |
| XIV. | Restated Debt in Natural Science |
| XV. | Printing Money Causes the Unites States of |
| | America to be Less Wealthy |
| XVI. | Failure of Modern Finance |
| XVII. | Restating International Trade |
| XVIII. | How to Accelerate the American Economy |
| | with the First principle of Physics |
| XIX. | Physics Applied to Economics as First principles |
| | versus Keynesianism |
| XX. | The Physics Analogy to Economics |
| XXI. | The Physics to Economics Model (PEM) The First |
| | Principle of Economics Process of Input to Output |
| XXII. | Answers to Questions of Economics Based |
| | on the Physics to Economics Model |
| XXIII. | Defining Economics with Principles of the |
| | Physics to Economic Model |

### Chapter I

### The First Principles of Economics

The, “first principle” is the base foundation of understanding to a given question or problem yet to be solved. The first principle precedes the solution because without the, “first principle”, applied as a method the solution to a complex problem is impossible. It must be understood, first the world is a sphere as a, “principle”, before a method to circumvent it can be applied.

Economics is no exception to this well established truth of principle to method. In order to solve problems in economics there must be a set of, “first principles”, which in the physics to economics model are based upon a logical starting point where methods are applied, to reach a predicted ending point.

A “first principles” model in physics begins at the level of the established laws of physics.

The premise of this work is to use the principles of physics as a basis to apply physics methods to understand and solve economic problems. This work both establishes a “first principle” of economics an analogy to physics which has the capacity of applying physics like methods which can be used to solve economic problems and then apply those, “first principles” as the methods to increase the wealth of the Unites States of America by a defined amount in a defined time interval.

Science is the human activity that seeks to predict, control and describe observable behavior. The scientific method is based on the first principle of repeatability of a logical starting point because there is nothing more fundamentally true for practical problem solving ability than the necessary application of the methods derived from first principles.

At present there are not first principles of truth in either economics or finance, making it seemingly impossible to solve problems. The following are a few of the current definitions of economics as follows:

“Economics theory evolves from fundamental postulates about how individual human beings behave, struggle with the problem of scarcity, and respond to change. The reality of life on our planet is that productive resources—resources used to produce goods—are limited. Therefore, goods and services are also limited. In contrast, the desires of human beings are virtually unlimited. These facts confront us with the two basic ingredients of an economic topic—scarcity and choice.” Economics Private and Public Choices, Sixth Edition, The Dryden Press by James D. Gwartney/Richard L. Stroup. 1992

“Economics is the science which studies human behavior as a relationship between ends and scarce means which have alternative uses.” Lionel Robbins, An Essay on Nature and Significances of Economic Science, 1932

Current definitions of economics are not based on hard science principles and therefore cannot be applied to solve problems. They are social science methods, and although social science uses scientific methods those methods are far less deterministic versus natural science. This work advocates using natural science to both understand and solve economic problems.

Economics is dominated by hard science problems such as moving mass over distance which takes time. Social science is not the science of mass, distance and time. Social science is the study of human behavior. Attempting to solve the essence of the physical world of economics with non-physical thinking has precipitated an on-going decline of American wealth. The following are examples of the lack of or decline of economic prosperity.

1. The United States government debt has increased from 60% of the GDP in 2005 to 108% in 2015. The debt to GDP in 1980 was only 30%.

2. The Federal Reserve, separately from the government, has added to the debt burden of the people by increasing America's Federal Reserve debt from 8% of the economy in 2007 to 30% of the total economy, or 4 trillion dollars, by 2015. The Federal Reserve's debt is then added to the total debt which equals 138% of the total GDP. The Federal Reserve's money creation decreases the purchasing power of America's domestic currency causing prices of goods and services to increase without a corresponding increase in wages or income.

3. The debt (bond) interest rate market is frozen, shut down, allowing an artificially low interest rate on borrowing to exist which in time reduces the value of savings and owned assets. This means in five to six years the value of a person's savings will be cut in half.

4. In 2007 housing starts were at 2,350,000 per year but in 2014 they are at 1,000,000, or 57% lower than in 2007. Debt was increased in an attempt to solve economic problems, 8 trillion by the Federal Government and 4 trillion added by the Federal Reserve, from 2008 to 2015 and there is little or no improvement, but the spending power of the middle class has decreased.

5. Productivity in 2007 was 2.6% growth per year. In 2014 productivity it is 0.7% growth per year which is a 73% drop. In economics, productivity growth or a strong productivity presence is necessary for economic growth or well-being.

6. The labor participation rate, (the percentage of the total available labor force that is employed), in 2007 was 65% of the people of the total labor force with a job. In 2014 the participation rate was 55%, which is a 15% drop.

7. There were 20 million food stamp recipients in 2007. In 2014 it has risen to 50 million recipients. A 150% increase in welfare recipients.

8. Global shipping, or charges to ship dry goods, was 15,000 as an index measure in 2007. Now (2015) the measure is 1,000 which is a 93% decline without any improvement.

9. Average wages have increased 1.5% per year from 2007 to 2014 while auto prices have increased at 8% per year over the same period. That means the average worker is getting poorer.

10. Of the total GDP calculation, 18% of the stated gain is derived from government borrowing. 18% of the GDP is debt. This has not been the case during most of the post war era, (1945 to 2006), when annual deficits were only 4-5% of the total economy. Approximately 18% of the GDP is government spending which the government is borrowing from the people meaning 18% of the GDP is not from economic growth. This means the economy is not growing at 3%, it is actually declining at a negative −15%. The Department of Commerce is using America's debt to prop up the total GDP number as if debt were from earnings. When a person borrows money the debt is not an addition to net worth. Debt must be paid back with real labor, real work, real hours on the job, paid back in principal and with interest. This means American citizens work many months each year just to pay principal and interest on government debt.

11. The young are disproportionately suffering from lack of career opportunities. This means things are moving in a negative direction because the efforts of the nations youth are wasted as their labor is used to pay principal and interest on government debt. What will America be like when the “lack of opportunity” group takes over?

12. What do Americans make well and what do we make that is best in class? What products in our stores are Americans made? The answer is, almost none.

Is economics a natural science or social science? Is it concerned with the behavior of relationships of people (with free will) or with the movement of material objects (deterministic)? What is economics?

To improve the economy is to move from an initial position to another position (position final). To increase wealth is a change in position where acceleration occurred. To understand how to become wealthier is in practicality a natural science problem, assuming people have a high degree of freedom.

### Chapter II

### Preface

The premise of this work is that there is an analogy between the basic laws of physics and the basic laws of economics. These basic laws guide understanding and enable us to find solutions by reasoning. A first principle of physics is the foundation of how the world works and is the guiding law of behavior. Laws of physics are precise, and are expressed by mathematical formulas. The laws of physics are well established and most importantly do not have exceptions as they cannot be violated. The premise of this work is to interpret economics as an analogy to physics, and to use that as the guide to understanding and using the laws of physics as the reasoning discipline to find solutions.

This analogy is reasonable because much of economics is actual physics. Real mass is moved a distance in an interval of time in both physics and economics. Economic behavior should closely follow the principles of the field of study of natural science, such as the branch of physics. Consider a block of steel.

How can a block of steel sitting on a flat surface move? Why is it sitting still? Why doesn't it move on its own? These are questions of physics and of natural science of the behavior of mass (the block of steel), its movement in distance and time, and what causes it to move. Understanding why a ‘cause occurs’ is necessary if a change is to be effected by intent. Where does the cause come from or what is the origin of the cause. The answers, methods, mathematical formulas, and governing principles are the domain of natural science. Natural science concerns the natural world where the methods are constrained by the laws of behavior of the natural universe. If magic, mysticism, wishful thinking, or beliefs have an opposite, it is the natural science view of how things work.

How much does it cost to move a block of steel? Who will move the steel? How long will it take? How far is it going to be moved? Where did the steel come from? Who made the steel and how much did it cost? Who put the block of steel on the flat surface and how much was the delivery cost? Who owns the steel? Have the taxes been paid? Was there debt involved? How much steel is available? These are all questions of economics and they are also questions of physics. Economics as a field of study should be able to explain the events which happened to make the steel and then deliver the block of steel to whoever purchased it. The events which happened to enable the steel to be delivered is iron ore was dug up against the force of gravity using the force from energy to meet the human benefits that the steel produces meet by supplying steel. The physical movement of steel is of the domain of physics. The movement of steel involves the principles of both physics and economics.

In natural science (objects) move because they are caused to move. To know physics is to know the cause and to know physics is to know the resulting effect which is a result from the cause. The cause moves the object and the movement is the effect of the cause. The cause of movement is from an origin where energy is generated and applied as force, and the application of force is the process which is then counter acted upon by counterforces that must be overcome if the net force, the applied force minus the counterforce, is enough to move the block of steel, than there is an effect via the net force and the steel moves or is accelerated either from at rest or from its current speed. The steel can never change its speed unless it is caused to change. The steel can't change its speed on its own and claim it caused itself to move faster. Only the cause of applied force derived from energy can cause the steel to accelerate by transferring energy into the steel. Acceleration, the increase in movement of any and everything, (the object of study), other than the objects natural state, can only occur via energy applied as force externally to the object. That is, the cause is external energy and the effect is the change in speed (acceleration) of the object. Economics must follow the same principles of the acceleration of objects as physics does. Modern economics has often failed to understand the concept of cause and effect as an observable principle of truth. As such, modern economics cannot answer or provide solutions on how to improve the economy. What is worse, the policies of modern economics are actually making America less wealthy. In physics, adding a counterforce always lessens velocity; additionally reducing energy, given the object remains the same size, will also lessen the velocity/speed (for ease of use the word speed is used as well as velocity although velocity is used in any formula). The same is true for economics. To accelerate an economy also requires a change in the change of velocity. Something must go faster to become wealthier than presently exists. Assuming the economy has some growth, to change the current growth is a change in the change of growth which is acceleration. Acceleration is the change in a growth rate divided by the time and this also must apply to a change in the wealth of the United States.

Answers to economic problems can be found in the science of the natural world where cause and effect based on mathematics and the concepts of physics which can succeed in problem solving. However, modern economics is not using, “natural science,” resulting in policies that lead to the wrong answer. Natural science can never be violated in the sense that in physics an effect will always have a determined cause.

In the language of physics how is an object (steel block as an example) accelerated from either at rest to movement or from an initial speed to a faster speed. The process of movement involves the transfer of energy from an outside entity to the steel block through an applied force. There may be counterforces which act against the applied force where the force push minus the counterforces equal a net force which is a positive net or greater than zero. The net force referred to as the sum of the force push minus the counterforces is the, “summation of force”, (the symbol for summation is Σ) and written as a symbol of the summation of force of “Σf”. When the summation of force is greater than zero the object or block of steel moves. The movement is an acceleration of the object. The acceleration is a two-step process where first there is an instantaneous acceleration then secondly a change in velocity occurs in some time interval resulting in the object having kinetic energy (energy due to motion). The summation of force (Σf) when positive is the cause of the acceleration of the object. The object can never accelerate unless by a cause where the cause is the net force as a positive. The cause always happens first, the effect as acceleration in the order of occurrence always happens secondly. The force must interact directly upon the object to cause a change in speed. When a steel block is moved, its movement is the effect due to the summation of force as the cause and the effect always comes second in the time order of events in the laws of physics. The acceleration can begin in zero time, but to move distance requires a time interval. Energy is not transferred to the block until it moves. In economics it is assumed goods moved distance occur in a time interval.

Adding more detail to motion are the definitions of each part of the movement:
Energy→enables the applied force to exist and act upon another object
Applied force→is the force which pushes the object forward
Counterforce→the forces which act in the opposite direction of to the force push
Force Push→is the force which counter acted upon by counterforces
The push force−counterforce=the net force or the summation of force written as (Σf)
If the summation of force is non-zero then the steel block moves in the direction of the net force
The block of steel has mass. Mass is a measure of an objects resistance to acceleration. Kilograms (kg) is a common unit of mass.
Gravity on the surface of earth pulls downward toward the center of the earth
The net force must overcome all other forces to accelerate the object
The unit of the object is mass; measured in kilograms (2.2 pounds)
The block of steel exists at a location in space. When it moves, the distance travelled is the change in location measured often in meters as a unit (1 meter=about 3 feet)
Travelling a distance (moving from one place to another) takes time. A time interval may be measure in seconds as a unit.
The summation of force equals mass multiplied by acceleration (Σf=ma) as Newton's second law.

Newton's second law of motion which may be written as Σf=ma, that is the base principal of acceleration. To describe the second law in international units of measure is called a unit of force or a Newton. A Newton is equal to one kilogram multiplied by a meter divided by a second squared. The definition of a Newton is: N=Kg (m/s²). It means one Newton is required to move or force a 2.2 pound object to move about 3 feet per second and faster the next second and so on. It is a way to measure and explain the order of events in which a cause results in an effect.

How does present day economics describe the block of steel? Modern economics which is presently defined in terms of a social science view does not use natural science and describes the block of steel as follows: “The steel is a good, it is to be distributed, and the steel blocks are scarce”. The problem with this definition is that cause and effect cannot be quantified and therefore it does not offer a solution for a change of position. This description in present day economics is derived from the social science view, is not a natural science method of reasoning and therefore cannot calculate an answer. Social science describes human behavior and free will. Behavior is non-deterministic and is not in a useable mathematic form. If the desire is to move a hundred blocks of steel per day and do it faster and cheaper than anyone else in the world, (to compete), then the social science view of a scarce product that needs distribution is of little practical use.

This work is specifically seeking an answer of exactly how to move more steel, faster and cheaper than anyone else in the world, from a US prospective for the express purpose of making the Unites States of America wealthier. In physics, a steel block in motion was caused to move by the application of a net force accelerating the mass, a distance, in a time interval. Energy, mass, distance, time. So much energy, counter acted upon by so much counterforce, can move so much mass quantified in units of kilograms so much distance in units of meters in so much time in units of seconds. This is the physics view.

A car uses energy to move a distance (a distance can be revolutions) in time and so does a tractor, train, plane, lathe, saw, bull dozer, fork lift, ship, drill, auger, trencher, pump, turbine, windmill, battery, washing machine, and so on as the machines of the modern world operate by the laws of physics. Even electricity moving through wires follows the same concept in physics as objects do. It is all motion, whose origin is energy, using applied force−counterforce to move mass a distance in a time interval. It seems to me economics is energy, mass, distance, and time; at least to a significant degree. Yet there is very little physics in current economic thinking. This seems odd because before Newton (1640's) there were not any machines with engines. It was Newton's Laws of motion which allowed the engine age to become the industrial revolution. Then the automobile, tractor, air plane, etc. all work via Newton's Laws of motion. Newton's Laws of motion are natural science, not social science and currently there is very little natural science in economics.

Behavioral science does not have the principles and methods to direct the macroeconomic policies crucial for a nation state to prosper. Ideas like economic stimulus sound empathetically human by supporting the common good but without hard reasoning based on the principles of natural science these ideas are resulting in failure.

American's economy is over 100% in debt. That is hard to believe, but it is true, even government reports admit it. The consequence of 100% debt is it is a counterforce to growth, which is almost impossible to overcome. There is not any way to pay the debt off because it requires using assets normally set aside for economic growth. Money used to pay principal and interest manifests in higher taxes, which further reduce growth. Debt will inevitably cause prices of goods and services to increase, cheating all the workers and moms out of the value of their labor, and out of their stored wealth (savings accounts). The value of personal assets decline and wages are reduced in the amount equal to the debt, plus interest due. Manufacturing cannot function and compete in a rising domestic price environment so as a consequence very little global manufacturing can occur in the Unites States of America. In the 1970's 16% of the businesses were rate AAA, now less than 6/10 of one percent are AAA. American products have become fewer and fewer, where almost no American made products are in our stores. We care because our lives, our well-being, our wealth, freedom, health, and future for our families are completely dependent upon the value of products made by Unites States of America owned businesses.

I have been studying economics since 1977 and find it lacking in its capabilities to plot a future course to increase the wealth of the nation. A new course must be determined and its basics must be in agreement with the principles, truths, laws and mathematics of the natural sciences.

This work offers a natural science based solution to increasing wealth, and natural science solutions often begins with what is referred to as the position initial.

### Chapter III

### The Pilgrim Test of Economic Theory

The pilgrims landed in Plymouth in approximately 1620. It was completely undeveloped, but there were abundant materials, a dense forest, plenty of water, wild animals, and a nomadic people who had skills utilizing raw natural resources. They were next to an ocean full of fish as another potential source of food.

Upon arrival in North America the economic conditions of the pilgrim, “economy”, was 100% unemployment, zero production of any kind, zero housing, and there was not any stored wealth to borrow from. Their only capacity to do work was derived from their natural caloric energy (physical labor). Their physical labor is fueled by the stored energy in their bodies and replenished through the food they ate. Their economic velocity was zero (v₀) and their stored wealth was also zero. They all gathered on the beach and someone yelled “Go”, which was the verbal declaration of the starting point (the position initial) of the New England economy. What did they do to begin the economic activity to improve their lives? They swung tools. In physics, to swing a tool is to have as origin of a cause which is the chemical energy in the human body which interacts with the tool as an applied force and is then counteracted upon by gravity. William Bradford, the governor of the colony designed the social order which was to mandate that all assets be communal property. Everyone shared equally in the economic system. Eventually this did not work as Bradford wrote there was an “unwillingness to work”. How Private Property Saved the Pilgrims (The Hoover Digest), June 1999 Tom Bothell. They rejected the social science hypothesis of communal sharing and applied what they observed in Europe to be true, which was private ownership was more productive.

The first thing they did was to maximize their energy output by swinging their tools downward putting as much energy into their economic system as possible.

The purpose of the pilgrim economic system was to increase their wealth, but there was confusion and disagreement as to what the most efficient process should be. They first used social science to design their economy. It was a process without any experimentation or applied mathematics, they ignored their religion, they simply decided without referencing history to just work, then at some point in the future, “harvest time”, equally split up the results of their efforts, (social provisioning).

The commune method failed. Since there were only 150 members of the pilgrim economy, their failure was apparent as they were starving to death. Starving to death makes for an easy debate, not too many long winded eloquent speeches, just results oriented proposals. They concluded everyone would work for themselves, which resulted in an acceleration of wealth where acceleration is to increase from the starting point (becoming more rich than previously existed); resulting in enough wealth to enable a surplus. The surplus wealth was used for additional businesses to start up aside from agriculture and housing, such as ship building and manufacturing repair parts for passing ships. They became so wealthy that they broke from England and became an entirely new country. They initially applied social science to their economic system which failed and later converted to natural science to succeed. The natural science method has the least amount of interference between the energy input and the resultant output. In natural science, the output would increase as the interference to the input is lessened. The less interference, the greater the output.

In a natural science theory, there is a process with experimentation, and observation which must conform to the laws of physics or it is unlikely to be true. The pilgrim economic system is an historic laboratory to test economic theory, even today's economic theory because it had such a clearly established initial position of zero. Their society had velocity zero (v₀) as its starting point and additionally had zero stored wealth. In economics, their society can be used as, “the pilgrim test”. A test is to support, not prove, any hypothesis as to what the output might result from a given input. Testing works by apply the input, then test and observe the output. Assume an economic policy is introduced as the input into the pilgrim society, Next, test the policy and use the results of the test, to pass judgment on the merits of the policy.

The conditions of the initial Pilgrim systems were:
No stored wealth
No stored energy
Velocity of zero
Acceleration is necessary to progress

What type of policy would enable the Pilgrim system to increase wealth? Should an economic policy be based on natural science or social science?

The following is a comparison of the difference between natural science and social science.

TABLE 1
Comparison of Natural Science to Social Science

| Natural Science | Social Science |
|---|---|
| Can be measured | Cannot be measure easily |
| outcome is deterministic | Outcome is a guess or non-deterministic |
| Difficult to misstate | Easy to misstate |
| Repeatable experiments | Not subject to repeat experiments |
| Has principles | Also has principles |
| Has principles of the truth | Not as certain as a natural science |
| | principle of truth would be |
| Object of study is inanimate | Object of study is human free will |
| Measureable deterministic | Not measurable |
| equations | |

A policy can be tested to see how it might affect the Pilgrim test.

When two pilgrims departed the Mayflower and upon landing at Plymouth Rock one had a gun for hunting and the other had a hoe for farming. The pilgrims traded. What was the result of the transaction? The answer is, there was not any aggregate increase in wealth because the transaction was internal to the pilgrim system where no external energy was applied. If all they did was swap goods among themselves they all would have starved or died of exposure. What if they attempted to borrow money to buy a house? They could not borrow because there was no stored wealth to borrow from. Can an economic theory pass the, “pilgrim test”? The following are examples of how the pilgrim test might be used as a method of reasoning to determine the validity of an economic theory:

1. At the initial arrival, of the first 12 months could the pilgrims simply declare themselves employed teachers (school) with good pay and a pension?

2. Could the pilgrims have printed money and used the printed money to buy a house, food, or clothing?

3. Could the pilgrims have borrowed money to buy a house, food, or clothing?

4. Could the pilgrims have started the government and have the government pay the pilgrim so they could buy their necessities?

5. Could the pilgrim establish a minimum wage?

6. Could they have started a hedge fund?

7. Could they have implemented quantitative easing, QE 1, 2, or 3? Quantitative easing is an economic policy where the government generates unearned money. The extra money is put into the economy in hopes of improving it. Although no one knows what improving the economy actually means.

8. Why didn't the pilgrim just issue food stamps to feed the poor pilgrims?

9. When an economic system is in an initial position, at rest (velocity zero), or with zero stored wealth than how does the initial position change to a future position where acceleration occurred (position final)?

10. What eventually enables the pilgrim economic system to begin moving or gaining wealth?

11. Can spending unearned money which is simply printed by the government build a pilgrim house or feed a pilgrim family?

The Pilgrim test is a method to answer economic questions. The test would be applied to existing policy to see what the outcome might be. If a policy could not help the Pilgrims become wealthier it might not be capable of helping the United States today. The answers to these questions are in this work.

### Chapter IV

### The Introduction—to the Principles of Economics

The purpose of this work is to advocate applying the methods of natural science, a physics based design method of solutions as a first principle, to reverse America's economic decline. A decline is measured by a reduction in gross domestic global market share from the 1950's at a 30% plus wealth share to the present (2015) at a 16% global market share. The average income of the American worker is declining because wages have not increased at the rate of inflation in the past ten years, (2006-2015), but prices of automobiles and food has doubled making the net economic well-being (well-being means how wealthy someone is) move in a negative direction. Steel production is below 1940 levels, and peace time government debt has increased from the 50% range (in early 2000) to over 130% of the GDP (as of 2015), (more is owed than what is produced) per the U.S. Department of Commerce.

American political and military strength is insufficient to suppress Russian and Chinese moves toward expansion. The Chinese navy is becoming larger than the United States navy. There are more U.S. Citizens on welfare than ever before, there are fewer working than ever before and those working have less buying power than ever before. There is confusion as to what to do regarding America's available natural resources versus what wealth is being generated. Based on resources, the Unites States of America should have the relative highest global market share of wealth and it should be maintained for hundreds of years.

For the past seven years the only solution offered to the American people by its representative government is to print money and reduce freedom. This work questions their methods and proposes new methods based on the principles of truth as methods of natural science where laws interpreted by the process of physics are used to increase domestic wealth.

This work is a complete re-think of what economics is, how it works and what are the best methods available to create greater wealth for America which should be at least equal to or better than its available natural resources. If the economic objective is to become wealthier then the solutions are found in natural science. To increase wealth mass must move from one place to another, and it must move faster than a competitor could do it. The people are told there are scarcities preventing prosperity, or we are not living up to our exceptional potential. Neither of these concepts of scarcity nor exceptionalism exist in natural science. Natural science, “physics,” is saying based upon the abundant natural resources within the Unites States of America it should dominate global trade given those natural resources and in addition there already exists cultural capabilities to help generate a volume of wealth which should add up to a 30-40% plus global market share. To fall below that number is mismanagement. The benefit of an increase in wealth to every American citizen is betterment, a better wage, a longer life, and a richer and longer retirement within the safety of a strong nation state that protects our freedom, and perpetuates an increase in personal freedom for our future generations. More wealth means a better life as observed throughout history.

The object of this work is to solve the current economic problems by applying a first principle of physics reasoning process to economics which follow the laws of physics. This is a different method compared to the social science methods used currently. This changes the social science definition of economics to a physics based definition. Physics uses the fundamental scientific reasoning process of cause and effect and is based upon the first principle that every effect has a cause. Physics uses a process to understand the cause and resultant effect with a forward looking capacity to predict and control.

To understand economics in a physics view that avails itself to a natural scientific methodology of an applied cause and effect seems to be the practical method needed in order to implement changes to move America forward. Physics says a cause applied determines an effect. Then the effect of a cause designed to increase wealth has an outcome of increased wealth. By applying a scientific cause, a specific effect occurs. Natural science and physics in particular offers great clarity as to the relationship of the cause and effect based on well-established principles and truths, repeatable experimentation, and observable laws.

The first principle by which economics may be interpreted in the natural science laws of physics are based upon the fact that both humanity and goods made are physical, occur against the force of gravity, and must follow the constraints of the tangible universe. A human has weight, plus internal energy which is produced from chemical reactions, and as a result of the internal energy is able to move distance in time. Humans must conform to physics. An economy has mass but cannot accelerate itself. Goods made are in kilograms and then move distance, in time. Physics is a study of and is written in mass (mass measured in kilograms), space (measured in distance using meters), and time (measured in seconds). Gravity (the force of gravity), force, energy, mass, space, time and the relationship of energy to the motion of mass are governed by the constraints, principles, and laws of physics, and they are highly proportional to the answer to economic conditions. Effecting improvement in an economy which are than based upon these first principles and are subject to natural science based solutions is the process for improvement.

Economics is likened to an object of study in motion, as a change in the economic system is an economy in motion. To become wealthier is to do something. The question is what is the action, or the something to be done as a cause which results in a determined effect as an outcome where the outcome is an increase to the aggregate national wealth? First in the order of events based upon the methods of physics is the cause. The cause of motion to acceleration begins with energy. The energy is used to cause a force which pushes. The force push is counter accelerated upon and if the push is greater than the counterforce than the force is positive as a net force. The net force is the cause of the existence of wealth, as without net force, (also written as the summation of force), there cannot be wealth. The net force then moves the object of the economy resulting in a change in speed or velocity (for the purpose of this work speed and velocity are used interchangeably for ease of handling). By making the object of the economy accelerate as the velocity increases. Given time, the change in the velocity increases the kinetic energy of the object of the economy and the kinetic energy (KE) is than proportional to the change in wealth.

Within the process of generating wealth, natural resources must be altered from their natural state. Force derived from energy is used to alter resources which resist force. The alteration of resources from their natural state to a commercial good is only possible by energy applied as force. The force must come first in the order of events. The altered resources put into a changed state, such as iron ore to automobile, must be done in such a way where the finished good has greater value than the natural resources which the goods consist.

In the physics view economics is applied force originating from energy utilizing resources, changing the velocity of the economy, than in time changing its kinetic energy. The change in kinetic energy is then proportional to the change in wealth. A nation can be as wealthy as its resources allow including imported resources, given the net force is efficient. Net force is in two pieces. First is applied force as applied force can exist without counterforces. Next are counterforces which exist on their own such as gravity and counterforces which can only exist if there is a force push first. The applied force minus the counterforce must equal at net force. Resources are generally fixed, which is the current situation on earth at present, than to increase the economy is to change the net force. The net force can be increased by either increasing the force push or by decreasing the counterforces opposing the force push or a combination of both. This is the basis of the physics to economics model (PEM).

The economy is physical and is likened to an object of study in motion moving distance in time. To change the economy is a similar process to changing the speed of mass in motion traversing distance, in time. This is a cause and effect solution. The cause accelerates the object and its acceleration is the effect.

The dominant economic theory at present, (2015), is defining economics from a social science base methodology. Social science as a methodology is still based on principles and does use scientific reasoning methods. However, social science is non-deterministic allowing for latitude in interpretation. Conversely, the laws of physics (natural science) has a starting point, a change due to a cause and an ending point as an effect which occurred from the cause and is measured in distance and time and has consistent answers. In complete contrast, Social Science does not have a starting point or an ending point. There is not a cause which determinalisticly results in an effect. Social science is not a determinalistic concept. The problem is, because there is a lack of precise measurement it results in bad social science and good social science being difficult to determine. Social science can say, “being a surf is good”, “being a subjugate non-asset owner worker is good”, or a, “free individual is equally good”. There are not any exact truths or laws allowing a repeatable observation in social science to determine a correct answer as there are in physics. Social Science cannot discern a truth. Social science is a study of the self where the behavior of free will is estimated. Social science is useful in economics; however, social science alone is insufficient to solve economic problems. It is easy for corrupt political powers to misuse social science for the sake of power against the people's interests.

The current definitions of economics are in the reasoning process of social science, absent of natural laws. Social science is absent of the cause and effect concept where the opposite is true in natural science. The social science view has brought America, an abundantly resource rich country, to become debt ridden, void of growth, and offering little opportunity for the young to build careers. It has also failed to match the availability of resources to the generation of wealth equal to those resources: American is poorer than it should be and is in danger of failing.

The content of this work rewrites the present day view of economics dominated by a social science view to an alternative vision based on a first principle of economics as an analogy of the reasoning process of physics. The objective is, introduce the application of physics to economics and to enable to a superior more practical physical process in order to determine how to change the current economic position to an improved future by more clearly defining what cause manifests to a specific result, that is, what is the cause of wealth where wealth is an effect.

In physics the desired effect can be determined by the characteristics of the cause. By applying the analogy of physics methods to economic then some cause applied will result in some type of increase of wealth? This work is the process of going from the current economic thinking in social science to a natural science and physics view of economics. In physics the origin of economics is energy and the effect is a result enabling wealth to occur.

### Chapter V

### The Concept

From approximately 2006 to 2014, the global markets share as measured by the “gross domestic product” or “GDP” of the Unites States of America has declined from a 25% share to a 16% share. What's more, in the 1950's the global market share of the Unites States of America was 30-40% depending upon how it was measured. In the 1950's the Unites States of America produced 90% of all automobiles in the world; now it only produces 5%. America's ship production is gone, and the steel production is at 1940's levels. Almost no clothing is domestically produced, electronics are mostly foreign and to launch a US satellite we have to have the Russian's do it for us because apparently we can't. Spacex, a private company can launch a small satellite, but their earnings after tax could not buy one B1 bomber. NASA has been greatly reduced and its research is without a viable budget. There has been a long decline since 1971 (the end of the gold standard) and in the first decade of the twenty-first century a more rapid fall off occurred which started in 2007. A 16% global GDP market share is not a super power. The evidence and observation indicate the Unites States of America is incapable of applying enough pressure to suppress volatile regions into stability, or to be a manufacturing leader: America is a non-super power because it is no longer the dominant influence of international relations. How many goods in our own stores are made is the Unites States of America? The answer is almost none.

In complete contrast to what is observably the loss of American's relative global economic strength is the physical superiority of American domestic natural resources. Based upon the combination of natural resources such as arable land, water, rivers capable of power generation, precipitation, forests, access to the ocean, internal natural navigable rivers, a mild climate and oil, coal, gas plus other energies, the Unites States of America is far wealthier than the GDP measurement implies. Additionally, given these resource advantages, the Unites States of America is in a position to convert resources to production resulting in a plurality position, a 30-40% plus global market share simply due to its combined resource dominance. It is not just a single resource; it is the mixture of agriculture, metals, energy, climate, combined that gives the Unites States of America an absolute advantage. Our products should be the best and cheapest. The ingredients to the generation of wealth are energy and natural resources assuming domestic policies are efficient.

For the Unites States of America to be out produced is fully the fault of domestic policy. The value of America is being mismanaged.

One of the many purposes of this work is to explain how to increase the wealth of the Unites States of America by 100% measured by the GDP without government spending in eight years. A 100% growth rate is equal to the best year of the 1950's multiplied by eight, which means it is possible. A 100% change in wealth in eight years is approximately a 9% annualized growth rate. The long-term historical growth of the Unites States of America has been in the 6-7% range. China, for example, grew at 12.8% per year from 2000 to 2005. Other countries have had growth rates similar to 14%. Of course it is easier for smaller countries to have a higher growth rate because it has less mass, but even a large country like China succeeded in rapid growth. True, the circumstances of China's growth are different, but the first question is, is it possible for the Unites States of America to grow as fast or faster than a relatively large country? China, for example, only has a small fraction of America's resources plus America has one third the population. This should make it more difficult for China to out produce America not the other way around. The Unites States of America has superior resources plus fewer people giving it a clear edge to have the strongest economy. A 9% American growth rate in eight years is the objective and it is possible under the principles of natural law.

The obstacle to wealth generation is less from the natural order of the physical world and more from a limitation of the currently established social science methods, the field of economics, (social science), as of body of study that is based on methods that are not deterministic principles of truth. Presently economics is defined in the domain of the social sciences, and it is under weighted in the natural science. It is the hypothesis of this work that using a natural science solution to solve economic growth based on the first principles of physics applied to economics is a better process than using social science which is void of deterministic first principles.

Social science as a field of study developed out of the age of industrialization as nation states began to take a more political approach to quantifying their observations of society. Natural science unlike, social science, was the predominant process of using deterministic methods to solve problems of Western civilization until the 1970's, although the communist Soviet Union began a formalization of social science in 1917. Social science uses statistical averages and draws conclusions. This method does not use principles of truth or observable facts, it simply collects data points. Social Science should be consistent because it is a science. However, because it is not deterministic theories in social science can easily draw opposite conclusions from the same data. Social Science in the Middle East encompasses a heavy application of religious authority to facilitate what is best. Communism uses social science to prove oppression is best for the people's well-being. The business oriented West has allowed free markets, concluding that method is best to maximize wealth. Without first principles of truth, social science can become adrift as a methodology of problem solving because it can be misapplied. Bad science is more easily hidden in social science. Political agendas can subvert good science resulting in policies which are not in the peoples best interest.

The age of enlightenment began with the renaissance period of the fourteenth century as the Dark Age ended. Natural science was the dominant method of science from the Renaissance until the 1970's. However, the definition of economics as a social science began to become more popular in the 1920's.

The institutional presence of social science increased during the post-World War II period. In 1996 the United States established “Behavioral Social Science Research”, (BSSR), instituted by order of congress. The English have a social science institution, and the old USSR published theories based on social sciences from the USSR's Academy of Science beginning in 1918.

China established the, “Chinese Academy of Social Science”, (CASS) in 1977. Vietnam established the, “Vietnam Academy of Social Science”, (VASS) in 1953, the Catholic Church established the, Pontifical Academy of Social Science”, (PASS) in 1994. There is the, “Indian Academy of Social Science”, (ISSA) established in 1974. Lenin established the Russian Social Science organization in the first year of the Russian Revolution in 1918. These academies are using social science methods of reasoning, which is not a deterministic principle based on observation, not based on deterministic truths, and do not have a beginning or an ending point. Social Science theories or proposals are in contradiction to observation, yet persist in spite of facts to the contrary. This is not the fault of science. It is the fault of those who use bad science and arrive at the wrong answer. Natural science, (physics), specifically conforms to the natural science methods which are, observed behavior and established principles of truth. A natural science answer must be followed. A common present day definition of economics in the social science method of reasoning is based on a hypothesis where the distribution of goods and resources are scarce. This is solidly a non-natural science method of reasoning because the definition is clearly absent of natural law concepts, or at least it is under weighted by natural science. As late as 1970 only the natural sciences were regarded as a true science according to the American Dictionary (1969). The general definition of science has been broadened to include fields of study in both social sciences and natural science with similar sounding titles but with differing methodologies.

The definition of natural science is a branch of knowledge or study dealing with a body of facts or truths systematically arranged and showing the operation of general laws, a deterministic science. Physics is a systematic knowledge of the physical world gained through observation and experimentation. Knowledge of facts or principles is gained by the systematic study of any branch of natural science or physical science.

Many economic occurrences are not simply social science or human behavior, but are actual physical events, such as iron ore being mined against the force of gravity, shipped a distance, in time, and melted with temperature from energy. It seems a greater grasp of economics as a field of study can be improved by adding physical science to the field of economics and applying definitions in economics constrained by the theories and mathematics of physics. Physical laws have a high degree of problem solving capability because its specific methodology is to solve problems. If it were applied to economics, it could be used to more clearly establish the cause and effect of generating greater wealth for the betterment of humanity, (the betterment means to be wealthier than previously).

Than one of the objectives of this work is to increase the wealth of America by 100% in eight years based upon a First Principle and using mechanical physics with established concepts, rather than the current social science view. The process is to first redefine economics along with the subsequent categories of economics such as wealth, trade, debt, cost of capital, capital, unearned currency in circulation (printing money in excess of the underlying value of production), the expected return on assets as a national aggregate (GDP) and concepts that are the factors for economic change, then turn them into an analogy using the principles of physics.

These principles of science differ between various scientific methods; different fields of study use different methods. Social science uses stochastic methods analyzing statistics, using historic data, which are non-forward looking, and extrapolate a guess from the data points. Social Science uses averages; squares, un-squares, and devisers, which are multiplied, where averages upon averages, are manipulated. Social sciences will know the average income of society, but social science cannot scientifically understand how to increase the average income. Natural science also uses statistical methods, but physics is also capable of establishing a fact to purposefully look forward to an expected effect from a defined cause because the underlying object of study is deterministic not random or subject to free will. Natural Science can look forward by the design of its methods. Looking forward is useful when seeking an economic solution.

Physics is a science that deals with the structure of matter and the interactions between the fundamental constituents of the observable universe. According to the American Heritage, “physics is field of study of matter, force, energy, space (distance), and time understood in physical theory”.

Mechanical physics is the science of energy, force, mass moving, distance, and time. There are other fields of physics, such as thermal dynamics, nuclear, and electrical, however this work is concentrating on the mechanical analogy of physics and how economics can be interpreted in the principal concepts and mathematical constraints of energy, force, distance, and time. These methods have a purposeful use in physical science to obtain answers and they are the construct of the mechanical age associated with the industrial revolution.

Modern finance is both a method to count and a method to manage assets and is heavily reliant upon social science methods. Finance uses statistics, but not physics, and the field of finance does not have a First Principle vision of why things occur. It is difficult for the methodologies of finance to answer questions of cause and effect just as it is difficult for social science to determine cause and effect. Finance typically extrapolates the past events as a reason to expect that similar results will occur into the future. That is not unreasonable, but these methods of statistics, the squaring and un-squaring of average upon average cannot obtain an origin cause and resultant effect as physical science might. If the cause cannot be determined than the effect, the desired outcome, cannot be achieved. Finance occupies more of a social form of reasoning and is not based on a natural physical principle based on the cause-and-effect process.

Natural science, physics, and mechanics, are forms of mathematics, methods, and principles derived from observation and experiments repeated over and over in order to understand the physical world. Physics is a language in mathematics; it has First Principles, is in concepts, and is a reasoning methodology based upon the natural universe. Not every concept is a formula, but the basis of a determination must conform to observation. Exact observations are not always possible, and so similar circumstances are used in experiments and measured. Natural science measures specific types of measurements to derive conclusions. Reasoning is constrained into accuracy by principles of truth bound by consistent measurement methods that must reflect observation. Something counter to an observation, no matter how badly the desire for it to be so, is not true. Social science is not constrained in this manner from observations when the USSR, China, England, and the Unites States of America all believe equally (from the opinion of the institution producing the finding) that their own respective societies are all equally wonderful. It is not the social science itself which is a problem, but it is how it is practiced which leads to a broad range of answers. From observation all of these societies are not equally desirable to live in. Conversely, natural science in the USSR (such as their damn producing x kilowatts) is exactly the same as in America based upon the force that enables the generation of electricity which is exactly equal in both countries. The mass flow rate in a hydroelectric dam is physical law and is the same everywhere on earth because gravity is the same globally. It is the globe that generates the force of gravity and natural science measures the force in a quantity with units of distance, time, and seconds with a direction and is the same everywhere.

Interpreting the field of study of economics in the form of natural science is narrowed more toward using a mechanical physics methodology with principles as the process which then can be used to determine the generation of wealth to solve problems, particularly economic problems. This work is a rethink of economics diverting away from a social science view and moving toward a, First Principle, physics view to a physical science analogy as a methodology of reasoning.

Economics as a concept can be applied in the methods of physics, redefining economics, wealth, debt, cost of capital, energy, force, trade, money printing, the expected national aggregate rate of return, and related economic concepts to a redefinition, as an analogy of physics to economics.

In physics for the economy to change means (as an analogy to the reasoning process) a change in the velocity of mass or a change in the velocity of the economic system (the object of study) must occur from its starting position, accelerating over distance, in time and then resulting in a change in value where there is an assumption of direction. To change the speed of mass, (the object of study), requires the ability of energy to operate as a force, occurring between two entities, the energy and the object, where the force is applied to the mass, to put the mass into motion, where the mass moves faster than it was going moving a distance, taking some amount of time during movement, and eventually going someplace. Energy, force, distance, and time; to be understood in the reasoning methodology of physics, is what happens in daily economic events.

Iron ore is moved out of the ground against the force of gravity, moved a distance in time, and shipped against the force of gravity, (overcoming friction), for a length of distance, taking time to do so. Inevitably the mass is accelerated where the object being accelerated has an increase in velocity and also has an increase in kinetic energy. Velocity is distance divided by time (d/t) and is the same as speed. Increasing velocity is to go faster or accelerate. To accelerate is to change velocity in a change in time. In economics, to become richer means to go faster; to go faster means to accelerate or change velocity in a change in time. Time is the measure of rate. Fifty miles per hour is 50 miles divided by time in hours; such as 50 mi./time in hours, or mi/time, which is distance/time, (d/t). To make the Unites States of America wealthier means, “more”, is a change in velocity, which has a direction (assume positive) and is a rate in time. To increase the GDP is to change the velocity of the GDP to make it go faster and farther. To change it in eight years is to change it in a time interval. What will enable the GDP to change? Assuming the change has a positive direction then only with energy using force as a conduit to interact with the economy can the economy be caused to accelerate. More wealth is an effect of acceleration. Specifically more aggregate wealth cannot occur unless there is acceleration. To make the USA 100% wealthier in eight years will make acceleration necessary in a practical sense. Acceleration occurs when there is a net force where force push is greater than the counterforces opposing force push. To become wealthier as a nation the net force or the summation of force must increase.

Energy, force, mass, distance, time, and acceleration are measured as quantities and have units. Mass is a quantity and kilograms (kg) is a unit of mass. Natural science applies units to solve the quantity, something which is not always applied in finance. Two plus two is four. The units are two what plus two what? Two apples plus two apples are four apples, but two apples plus two cars is not four of anything. The typically used units for a quantity of mass in physics are kilograms (kg), mass is the quantity and kilogram is the unit, length is in units of meters (m), and time is in units of seconds (s). kg, m, s (kilogram, meters, seconds) are standard units of measurement. The iron ore used to make an automobile is measured as a kg of ore, moving meters in a distance in and interval of seconds of time against the force of gravity in meters divided by seconds squared. The force of gravity is 9.8 meters per second squared. To move anything on earth this force must be overcome. As the units are consistent then solutions can be determined. When units are not consistent solutions can still be determined using a proportionality.

How much energy is necessary to move so many kilograms of iron ore over so much distance and, in so much time is answerable in physical science. “What does it take to move ore further and faster?” is answerable in natural laws, but not determinable in the concept of social science or finance. This is the weakness of social science. Social science cannot determine how much additional energy is needed to make automobiles.

It is not always possible to have the same units on both sides of the equation so proportionalities (α) can be used when units on the left side do not match the right side. This is not the essence of proportionalities, but is a method to use for physics as an analogy to economics. This means economic problems can be solved using the reasoning process of physics.

In summary, the natural science field of study, narrowed to mechanical physics using principles, concepts, reasoning based mathematics as an analogy can be used to interpret the body of knowledge of economics as a field of study. The answers to economic questions will differ depending upon which method, either social science or natural science is applied.

The following questions are examples of where social science and the physics to economics analogy will have different answers. The physics to economics analogy answers and the social science interpretation can be completely opposite.
Does printing money cause the Unites States of America to become more or less wealthy?
Does printing money cause the individual average wage earner to become more or less wealthy?
Does printing food stamps make the Unites States of America more, less, or the same degree of wealthy?
Does the government printing money and using the printed money to buy good from the people increase, decrease or keep the same level of wealth in the Unites States of America?
Does inflation make the Unites States of America more, less, or the same degree of wealthy?
Does government debt in the form of treasury bonds make the Unites States of America more, less, or the same degree of wealthy?
Does taxation make the Unites States of America more, less, or the same degree of wealthy?
Does the money spent on unemployment make the Unites States of America more, less, or the same degree of wealthy?
If everyone were employed and as a result there was zero cost to unemployment would the Unites States of America be more, less, or the same degree of wealthy?
Does leverage (government borrowing) make the Unites States of America more, less, or the same degree of wealthy?
Does moving assets to change ownership from “A” to “B” make the Unites States of America wealthier even if the movement is for a good cause? Is the greater good, served by moving assets from one class to another?
Does the International Monetary Fund make the Unites States of America more, less, or the same degree of wealthy?
What exactly is a job?
What is the cause of jobs?
What causes commodity prices to move up and down to the degree that occurs at present?
What causes the stock market prices to change 50% from highs to lows?
Can any subsidy, in any form, for any reason make the Unites States of America more or less wealthy?
Does recalibrating an inch alter actual distance?
Does increasing minimum wage increase the wealth of the individual being paid the minimum wage or the aggregate wealth of the nation?
Can the economy be stimulated by artificially low interest rates or be artificially stimulated by any financial method?
What exactly does an increase in the economy mean?
Can government spending change wealth?
What is the cost of government?

The reader should also be able to differentiate between the physics view of economics versus the present vision of economics as interpreted by the social science method of reasoning as a result of reading this work.

### Chapter VI

### Three Useful Concepts

Here are three useful examples of concepts explaining how the physical world is related to economics. First, energy generation is a function of the GDP of the 20 richest countries; second how water changes temperature when the amount of energy in the form of heat is added, and third is a perturbation, the nonlinear response of a system to a cause where there is seemingly no change at first then eventually an overwhelming response or this can work conversely. These concepts can be observed. In order to understand an observation the interpretation must be put into a useable form of knowledge or a methodology as a first principle. Often, economic theories persist, even when observations are to the contrary. A valid theory can be applied to multiple circumstances and still remain valid. Observations should be repeatable showing either the same or similar effect due to a specific input where the output should be predictable or the theory cannot be correct. Knowledge obtained via repeatable observations is the input which creates laws of what the physical behavior actually means. They are not legal laws, but rather laws of natural science constructed into a standardized mathematical form or concept as a base principle, which can be used and understood to solve problems.

The first concept is an observation of the importance of energy by plotting the GDP of the twenty richest countries in the world, along with the amount of electricity generated plus oil consumed.

This data is the foundation for the belief that the generation of wealth is directly proportional to the generation of energy. The hypothesis of this work is energy is an input of applied force and the output is an acceleration which leads to a change in velocity of the economy, and an increase in kinetic energy follows as the output. The object accelerated is the economy and the change in kinetic energy is proportional to the change in wealth. Given this, the theory would expect to see the GDP of a country increase as its energy use increases and vice versa. This is a cause and effect process in the laws of physics. The event of energy interacts with the entity of the economy that accelerates it resulting in an output in the form of an increase of wealth.

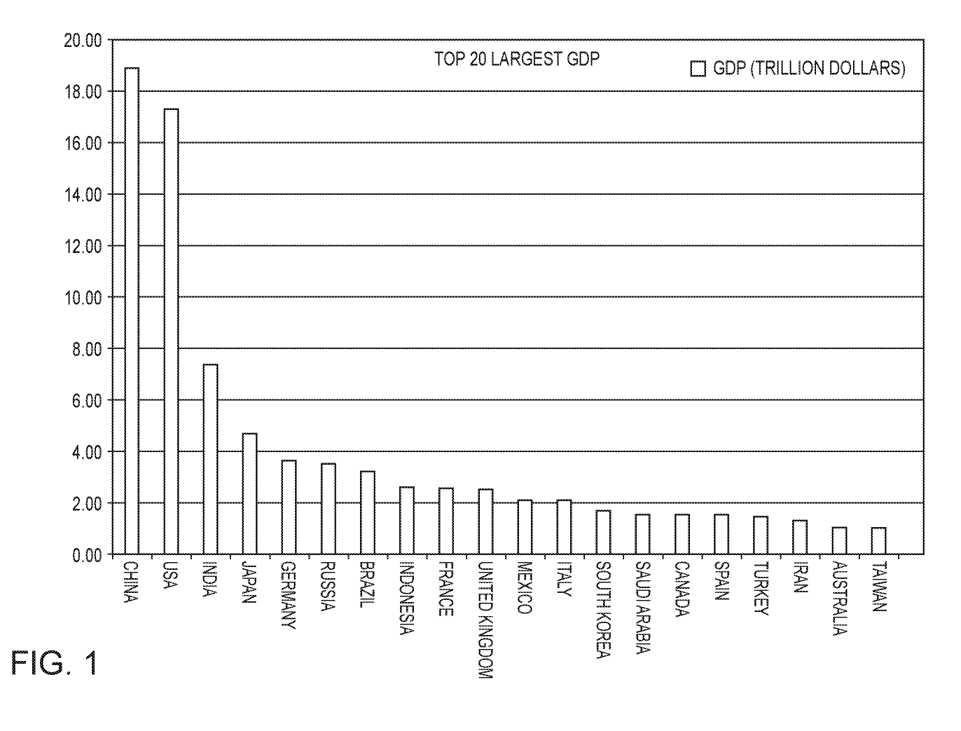

FIG. 1 is illustrating the GDP (a measure of wealth) has something to do with electrical generation.

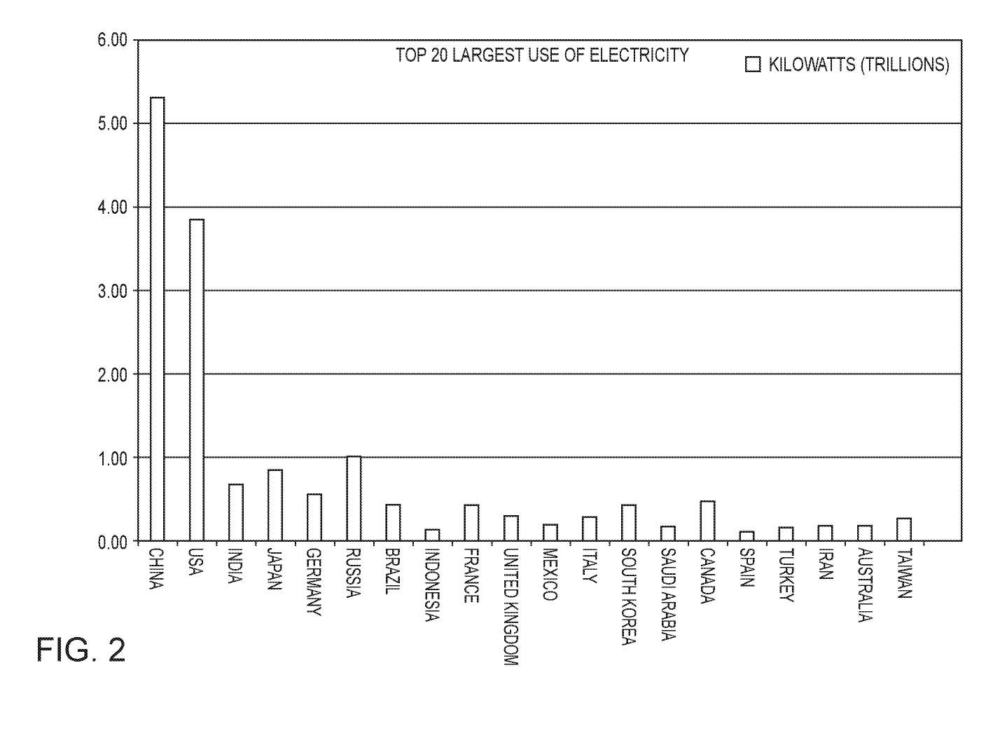

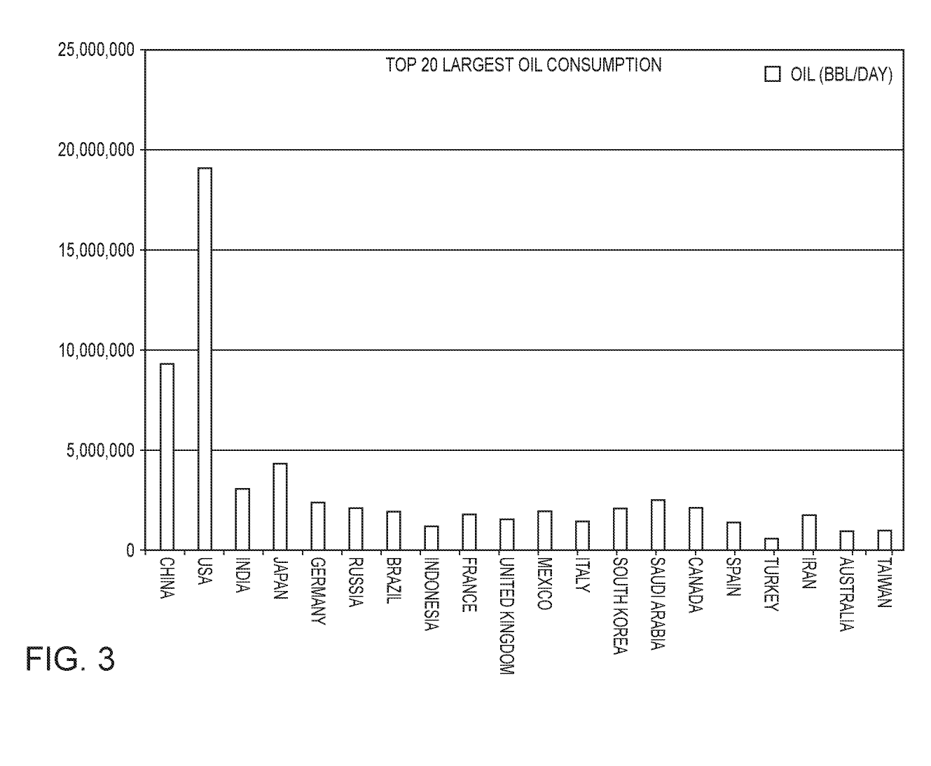

FIGS. 2 and 3 are graphs are comparing the top 20 richest countries to their electrical generation and consumption of oil. It takes an enormous amount of energy to process raw materials to a finished product; wealth is generated when resources are processed where the finished good has greater value than the original raw material plus other costs.

The energy is the input cause and energy has a place in the understanding of natural science as the origin of the cause. In the order of occurrence of the cause and effect the cause comes first and the effect second. The kilowatts generated are an input to an economy, and: the oil consumed is also an input. The observation is gross domestic product increases as kilowatts generated and fuel burned increase (graph #3). Again, in natural science energy comes first and the effect is a result of the cause. As GDP increases than fuel burned also increases where the observation is fuel burned is causing greater economic activity. What would happen to a factory if its energy input stopped? Production would stop.

Energy consumption is not in an exact order of size, however it is very close. This can occur for a variety of reasons. Some countries are increasing their energy generation capacity before manufacturing capacity occurs. Additionally, economic growth which is an acceleration, a change in the change in velocity, does correlate with the change in energy generation. China's 10% per year GDP growth is matched by its 10% growth in energy generation capacity. However, countries like the United States have been printing large amounts of unearned money (i.e. per year of the GDP) which makes their GDP appear to be increasing when actual economic growth is stagnant.

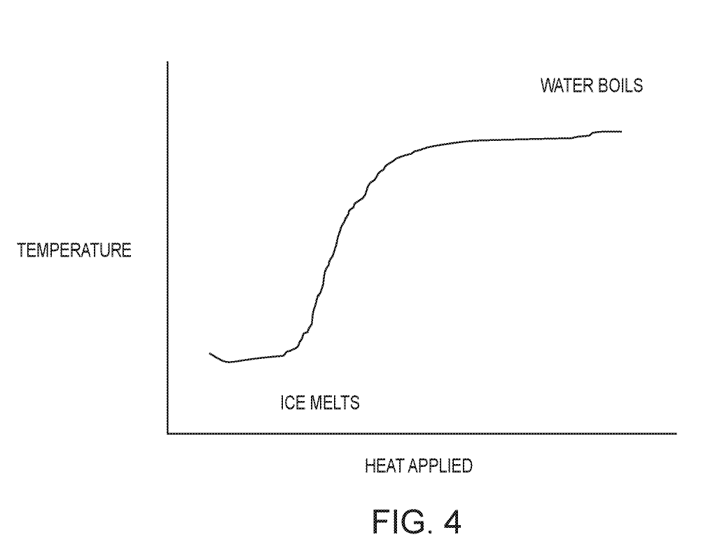

FIG. 4 depicts how a change in temperature occurs due to a change in energy when the material undergoes a phase change.

As heat is added to the ice the temperature does not change at first. Energy as heat is going into the ice, but the temperature is slow to change even though heat is being added. There must be some other use for the energy to explain the lack of change in temperature of the ice. The reason for the lack of temperature change is the energy is being used to change the form of water from a solid to a liquid. The temperature will only change after all the ice has been turned into liquid. Eventually the H₂0 is no longer a solid and additional energy changes the temperature of the liquid because the molecules increase movement, and increased molecular movement is observed as an increase in temperature. As the water heats to the point of becoming a gas the change of state from liquid to gas occurs and this change of state also consumes energy where the energy is used to alter the state rather than increase the temperature. There is less change of temperature as water changes to a gaseous state because there is less energy available to alter temperature because energy is required to alter the state of the liquid to another state.

For something to be worked on, for anything to be done, no matter what it is, requires the use of energy. Every cause originates as the application of energy.

There is no way to hide from the fact that in order to effect a change there must be an application of energy. Once this is understood, it becomes clearer how inefficient policy, which does something other than produce wealth, results in energy wasted and therefore a waste of wealth. All policy, regardless of how big or small, must consume energy to be effective. Poorly constructed policies waste resources and cause a lessening of national wealth. Energy input spent upon something other than wealth generation is energy wasted.

One of the objectives of this work is to increase the wealth of the USA. In natural science how wealth is increased will be related to the concept of energy.

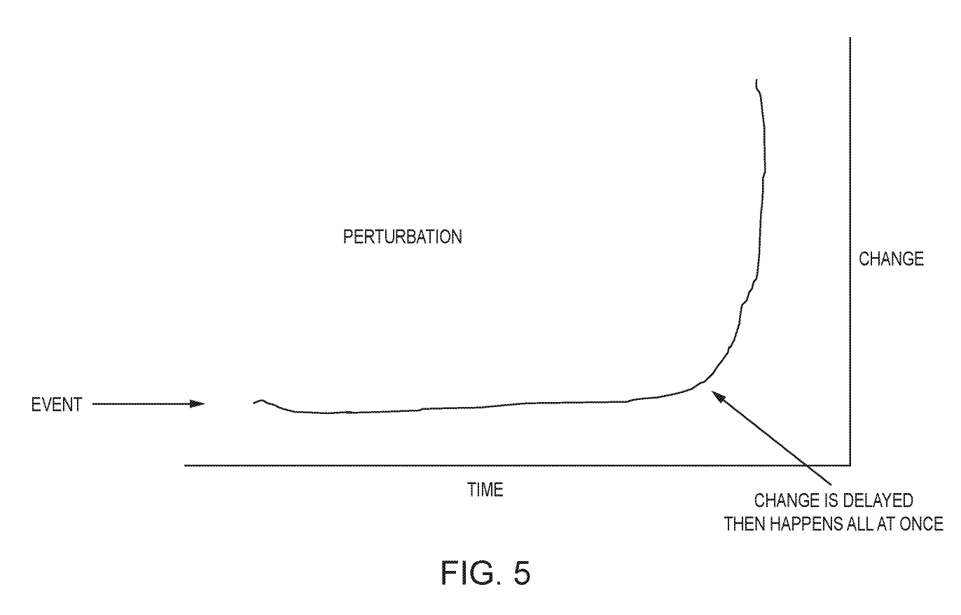

FIG. 5 is of the possible response of a system to a perturbation. A perturbation is a small change introduced into a system.

A material can smolder in a suppressed state without an outward demonstration and in time eventually ignites by some outside disturbance.

It appears there is not an event occurring where some input is not causing an effect. However, eventually, in time sometimes, but not always the effect happens all at once. The time interval observed may fool the observer because a non-changing environment appears not to be effected but in time does change. The time interval of observation may be too short and the observer is fooled. As time increases, the effect occurs. It may take some time for cause and effect to occur, but eventually there is some effect. Sometimes little change or effect occurs. However, determining the source of a cause is necessary to succeed in having the desired effect occur. A cause resulting in acceleration of an object can only be derived from energy. Without the input in the order of occurrence in physics as energy first there cannot be an expected effect such as a change in the velocity of an object.

These graphs are observations of energy causing an effect. This is the natural science cause and effect derived from the principle and laws of truth. Economics must therefore follow these principles as observed by the kilowatt and fuel burned to the GDP illustration. Nothing can physically move unless it was forced to move by net force unless its movement as a natural state. Iron ore will not jump out of the ground and transform itself, melt itself, and paint itself and just be a car. Energy caused the car which is physics. The analogy of physics to economics is how energy affects an economy. To present an economic theory where the objective is to increase wealth then the theory should meet scientific standards.

### Chapter VII

### Measurement

The various current definitions of economics, of wealth, capital, the cost of capital are linguistically descriptive, non-mathematical, non-scientific. They are typically non-quantitative, and are not necessarily concepts, and are not in units which enable a process to determine answers as to why events occur. The current basic definitions of economics are not measurement definitions. An objective to increase the wealth of the Unites States of America by 100% in eight years cannot be addressed by descriptive statements. Attempting solutions by some method of manipulating descriptive phrases is impractical. Adding to the problem is the fact that the current linguistic phraseology is particularly antithetical to the reasoning process of physics. There are no measurement capabilities in the current economic definitions. Social science, the current method of thinking does not possess a clear interpretation of cause and effect nor does it apply a process of measurement.

To increase the GDP of the Unites States of America 100% in eight years is to do something measurable. All that exists can be measured in some form as a magnitude, quantity, with direction, as a basic unit, or a measure with multiple units, (a set of other measures together to form a unit). Measures can be a single number or multiple concepts. Physics is a reasoning process which is a mathematically based method using various measures that are well defined.

Currently there are many descriptive phrases linguistically labeling economic concepts with words that do not relate to either measurements or units or do not follow any scientific reasoning. The current descriptive phrases are not in mathematical form or in the scientific method of physics. Mechanical physics, a field of study within the broader scope of physics describes the natural world in mass, distance, and time, sometimes in single measures, in magnitude (how much), both with and without direction as speed or a vector. Measurement can have both magnitude and direction in quantities, units, and with multiple units. Time is a quantity and seconds is a unit. Distance (length) is a quantity and a meter is a unit of distance. The phrase, “a person went a distance”, is not very useful. Saying distance in time as speed, (d/t), as in fifty miles per hour, is better, but there is not any direction. The fifty miles is the magnitude, but without direction it is a scalar. Going 50 miles per hour south at 180 degrees has a velocity, and it is a vector. It tells magnitude and direction which makes it a vector. To become wealthier is a direction, where more means an increase in something. To become wealthier is a change in velocity (Δv) divided by a change in time (Δt) which is acceleration. For ease of use both speed and velocity are used interchangeably. To change the velocity requires a change in the net force. Net force is the net energy as an input less counterforces.

The first principle of economics must be written in a form where there is both magnitude and direction, making the assumption free people are spontaneously moving toward betterment because evolution is an observation. Improvement in the human condition through history has been an observation. Economic development is a vector, with magnitude, with direction, and in units, that describe quantities. Some definitions are in multiple units made of multiple concepts. Mass is a quantity with a SI unit of kilograms with a symbol of kg. Time and distance have units of seconds (s) and meters (m) where the SI units of mechanical physics are Kilograms, seconds and meters or (Kg, m, and s). Than economics should be understood in SI units of kilograms, meters, and seconds (Kg, m, s), as the units of quantity of mass, distance and time. A complex economic concept can certainly (and likely should) be written as an analogy to a unit in physics. A unit can be other measures such as feet, yards, or inches, however the SI units of kilograms, meters and seconds are easier to work with and are prevalent in scientific communication. Along with SI units there are multiple units making up a Newton, joule, or watt, which are made up of kilograms, meters, and seconds and are vectors. In order for economics, to be interpreted in mechanical physics it should also be restated in an analogy to Newtons, joules, and watts where a joules and watts are related to a Newton.

If the progression of humanity, (where progression is a vector of betterment), were plotted on a growth curve, the point of inflection, (where the growth begins to increase more so than previous periods in history) would be the point of Isaac Newton's life. Newton changed the world, and his laws of motion enabled the machine age of the industrial revolution.

Physics, which is Greek for the, “natural order”, is a human activity of mathematical based reasoning of principles and laws, with specific types of measurement to answer questions of how the universe operates. Two thousand years prior to Newton, the Greeks saw motion as a single event. The arrow flew and then slowed because they believed the force pushing the arrow dissipated over distance and time. In the 1560's Galileo made progress in understanding motion, concluding that motion is from multiple forces as a summation of force. It was Newton who was able to further define the behavior of motion in his three laws of motion where the second law is the formula for force accelerating mass from multiple forces as a summation of force. Newton said the arrow flying will continue to fly unless acted upon by opposite (counter) forces. This means applying the force which moves mass to acceleration is actually a summation of multiple forces where the net of the multiple forces is a summation that is the cause for something that accelerates mass or the object of study. Newton's second law of motion is the summation of force equals mass multiplied by acceleration, written as: Σf=ma, which has direction. The summation of force is (Σf), a net force derived from force push being subtracted by counterforce. It is the Σf which causes the acceleration of mass (the object of study or the properties of a system) to move it faster than it was moving. There is a cause and effect and they are not reversible in practicality. Therefore a, “Newton”, is a unit of force push−force drag=mass multiplied by acceleration. Where one newton equals one kilogram multiplied by a meter divided by a second squared (Σf=ma where 1 N=1 Kg m/s²). Mass is just a scalar of a quantity viewed alone, but mass being accelerated is a vector because the force net is accelerating the mass in a direction.

Acceleration is the object of study going faster than it was going. Acceleration is the change in the change of position during a change in time. A change is noted by a delta, “Δ”, and a change in a change is Δ². It means acceleration is a change in an objects velocity. Whatever the old speed was the new speed is different. It can mean going faster or slower, both are a change in velocity. Force is necessary to cause acceleration. Velocity is a change in distance divided by a change in time. To change velocity is a change in the change of distance over the change in time. It is easier to say acceleration is the change in velocity in the change in time (Δv/Δt). Speed is a scalar (a quantity with magnitude without direction) and is distance divided by time, (d/t). The units of distance and time are meters and seconds. Speed in units is meters/seconds or m/s. Velocity, (which is a concept) and how to calculate it are in the same quantity and units as speed, but with direction (and can be written with an arrow). Velocity is meters divided by seconds (m/s) with direction. To accelerate is to change the velocity, where acceleration is the final velocity minus the initial velocity divided by the final time minus the initial time, which is the change in velocity/divided by the change in time (Δv/Δt). It is the Σf, which changes the mass's velocity by making the mass go faster, measured by its change in speed.

Velocity final minus velocity initial divided by the change in time is Δv/Δt. However, to understand how the Unites States of America's economy can be increased by intent makes understanding acceleration necessary.

Acceleration is essential to understand because to pursue the objective to make the Unites States of America wealthier is to accelerate the aggregate domestic economy of the country where the production and resultant gains are owned by a free people. It means the velocity of the country is going to be changed in a way that Newton said it would change; in proportion to the net applied force.

Newton's seconds law is written as Σf=ma, which means applied force minus reactive and other forces is equal to mass multiplied by acceleration and it is a process which should also apply to economics.

This equation does not go backward. Kilograms sit in a natural position or the current position, the current object could already be in motion, which is likely the circumstance of the economy. The kilogram will not be accelerated or have its motion changed until force is applied. It is better to say net force is applied when the net force is force push−counterforces, which is the net force or summation of force (Σf). The amount of mass that is a number of kilograms does not change when acceleration occurs, but the behavior of the mass is altered by being forced to go faster. The cannon ball does not change size when shot, but the ball goes faster from being fired.

Than a Newton is unit of force which is a vector because it has direction. The only reason direction is mentioned is the assumption of a forward movement in increasing wealth, for ease of handling assume direction is forward. The premise of this work as an analogy of physics to economics where the change in the velocity of mass or the properties of the economic system as the object of study as the economy (or the economic system of ownership entities) becomes accelerated from its natural or current speed to a new speed over distance in time as Newton's second law explains. Therefore, the mass or the economic system is not going to change velocity (change wealth) unless made to do so by a applying net force. To cause the Unites States of America to become wealthier by intent means the summation of force must be applied as the summation of force (ΔΣ). Thinking in the physics view means using the reasoning of physics to understand economics using various measurements in quantities, and units where force push, counterforce, force drag, kilogram, meters, and seconds are the concepts to apply in order to derive solutions.

James Joule is honored by having the compound unit for energy named after him. A joule is a newton multiplied by distance or a newton meter.

In terms of a base unit, the joule can be expressed as kilograms multiplied by meters divided by seconds squared times meters or J=kg m²/s². For example, how many joules of energy are required to push a 10 kg object a distance of 1000 meters? Since there is direction the unit of a Joule is a vector and moving the object can be measured.

A watt, named after James Watt, is a joule as a rate per second. A watt=joule/second. A watt is the time rate change of energy as a measurement. Kinetic energy is the energy in the object in motion as an average and it is in a unit of a joule. It is ½ mv². This is the observation as velocity changes kinetic energy changes. In the economic analogy than increase in kinetic energy leads to the increase in wealth in some proportion.

A Newton, Joule, and Watt are compound units of force, energy and rate of energy usage, and are written in units.

The mass, distance and time are quantities and we measure the quantities of mass in kilograms (kg), distance in meters(m) and time in seconds(s). Than a Newton written units of kilogram meters and seconds.
Newton=kg(m/s²)=Force to accelerate a kilogram one meter per second
Joule=kg(m²/s²))=Measure of energy to move an object by applying a force over a distance in one meter
Watt=kg(m²/s³) A joule per second

Economics should be written in this same method because economics is the proportional change of velocity in an economy in a distance and taking time to do so. The assumption is that free people will take a direction toward betterment. Economics in the analogy of the reasoning process of physics enables a cause and effect process to analyze in order to obtain a desired outcome.

The question of increasing wealth in economics can be answered by the application of methods which are scientific methods to determine a solution within the constraints of how the natural world operates. Theories that cannot meet the test of conforming to the constraints of the natural world are likely incorrect.

A tractor is made of iron ore measured in units of kilograms. It is possible to understand in physics how much iron to mine against the force gravity, how much energy it takes to ship the iron distance in units of meters, how fast in units of seconds it takes, and all are measured in energy, in units of joules.

To make a tractor better and faster than the global competition can produce is a question of force push−counterforces−force drag moving kilograms of material so many meters in so many seconds. To make the United State of America wealthier is a problem of force push−force drag moving kilograms to acceleration a distance in meters in so many seconds. By taking the methods of physics and applying them, as an analogy, to economics, it allows answers to questions on how to increase wealth to the full potential of a nation state.

There are a variety of linguistic definitions of economics based on social (not natural) science, formed using non-deterministic methods which incorrectly limit economics, to the study of people and the randomness of behaviors. One such common definition is based on the non-mathematical method where social science defining economics as: a social science multiplied by goods distributed divided by scarce resources.

Social science is not a study of mass moving distance in time interacting with energy. Without understanding how much energy is involved it is impossible to understand distributing goods. Social Science is not a measure of things physical. Social Science is the study of human behavior and is absent of a deterministic cause and effect. The behavior of gravity or friction is physical science and is measureable. How much of economics is human behavior? To have economic events, mass must be moved against the force of gravity and against the force needed to overcome friction as well as other counterforces. Iron ore for metal products, stone, sand, and food, are all mass moved, moved a distance in time. It takes energy to move and process the mass into useable forms. A worker working, sleeps, eats, works, rests, and is obligated to spend a little time in socializing, there is not much time remaining between work and rest. Most behavior is preset by the circumstances of the economic activity of free people as people will act in a direction of betterment naturally and most time is spent working for betterment. Free people obtain betterment by generating energy, and applying it as a force, when the force overcomes the counterforces, then the net force moves the mass distance in time and wealth results. A significant proportion of economics is net force moving mass distance in time. It is reasonable to conclude a significant portion of economic theory should relate to physical movement.

Scarcity is the most unique part of the social science descriptive definition because there is not scarcity in the natural world. There is not scarcity of the sun light, at least in reference to the sun. The sun is finite but referring to it as scarce seems useless. Scarcity is more likely in the definition to create an emotional response to serve a political end for a control seeker, control not likely used to further the interest of a free people. There is not scarcity of iron ore, there is just a finite amount of iron ore on earth. Scarcity is an emotional judgment. Of course resources are finite, but finite in so far as there is energy available to make good available. Availability is energy dependent. Energy is central to economics and behavior is secondary.

The objective of this work is to make the Unites States of America wealthier; assuming the natural spontaneous desire for betterment of humanity exists. The explanation of economics should not be written to create an emotional response to fool or manipulate, but to rather be based in natural science (physics), and be subject to observation, criticism, and experimentation as natural science should be.

Economics based upon the premise of this work is the movement of mass, the object of study which is an economic system of ownership entities, multiplied by a change in velocity divided by a change in time. To change the economy assuming with direction (vector) for betterment, is to move the economy by accelerating it from its present velocity to a changed velocity in a change of time. The velocity is changed by the origin which is energy to apply force. This means the summation of force, or force net must be sufficient to accelerate the economy of free people who own production as ownership entities. It is the free people who own which is being accelerated, which means to change the transaction rate of the free people to a new transaction rate as an output leading to more wealth. This can only be accomplished when force net, the summation of force written as (Σf) exists, which can be accomplished by increasing the applied force (force push) and reducing the counterforces or both.

What then increases the wealth in America?

### Chapter VIII

### Energy—the Origin of the Cause

The hypothesis of this work is economics in concept and practice is more usefully interpreted as a natural science based upon the principles of the reasoning process of physics as opposed to a social science. A social science is more of a descriptive linguistic in statistical mathematical form without the capacity to process a cause and effect.

Using the analogy of the methods of physics applied to economics, which establishes boundaries and constraints that are consistent with observations, it elevates the practicality of a process of expected causation resulting in a related effect. The physics to economics theory is economics occurs due to the change in the velocity of the object of study (the economy), over a distance, in time where the energy as the applied force cause the economy to change and acceleration occurs. A zero growth economy is moving at a constant speed without a change in velocity. Given the properties of the economy are the object than it is only possible to accelerate the economy by causing to change speed. A change in the change of velocity results in time a change in kinetic energy as an increase resulting in a proportional increase of wealth. This places kinetic energy, (energy in motion), central to economics. Physics is a concept which uses mathematics. Measurements are always in units, and there is a beginning point and an ending point where the cause resulted as a change in the behavior of the object of study by resulting in the objects change in velocity in a change in time (acceleration); with an output of kinetic energy.

In physics, mass, or the object, or the object under study, is moved by energy by the operation of force. The necessary truth of the natural world is when there is something to be done or when there is the ability to do work, in mechanical physics, it is a result of the application of energy as an applied force which interacts with something that resists change. The analogy of mechanical physics applied to economics is the ability for an economy to do work, and it is a result of the availability of external energy as an input. This is observable where energy generated is observably as a proportion to national wealth as measured in GDP, (it is recognized GDP is a problematic measure).

Physics is a set of principles and laws in a scientific process which is a description of how the natural world operates. It is deterministic, because the input will always result in an output. The methods of physics can also be analogous to the concept of economics. This means economics is significantly a result of the input of energy as an applied force which causes an output of wealth. Energy applied to economics is using the physics concept of energy as opposed to the everyday descriptive term for energy.

There needs to be some additional clarity about the concept of energy; because scientific definitions of energy are generally uncommon in everyday usage. Energy is typically thought of as oil or gas. The concept of energy in physics is different than the everyday usage of the term. In physics, energy is a concept. Energy defined in physics as the ability to do work by applying force on its surroundings, it is the capacity of a system to change position, to change speed, to change its state (gaseousness to liquid, to solid, to heat), to change form, to change from its surroundings and move to a new position in new surroundings and change relative to time. Energy is the property of a system which has magnitude. A big mass, takes more energy to accelerate compared to a smaller mass. This is important because the Unites States of America is a big economy and therefore it takes big energy to accelerate it. The Unites States of America is not Sweden. Sweden, although lovely, is small relative to the Unites States of America and it consumes about the energy equivalent to New York City. Energy can be in multiple forms, and it is necessary to accelerate mass because mass is something which resists being accelerated. The purpose of this chapter is to clarify how energy is generally understood in the view of natural science via physics and how the analogy of energy in physics is applicable to the cause and effect of economics. In order to improve the economy of the Unites States of America understanding the role of energy is essential.

Energy is not stuff, but stuff can have energy in it. Energy can neither be created nor destroyed. The universe has energy and the energy cannot be used up. It then follows that energy is conserved. Not the common use of “conserved”, in the everyday use of the term where conserved means using less. Conserved in physics means energy cannot be destroyed and therefore when used, it changes from one form to another but does not end or disappear. Often the changed form is not practically useful. Regardless, the energy used does not go to nothing, simply it changes form. The energy of a moving car is converted to heat in the brakes as the car reduces speed. There is potential energy (stored energy), kinetic energy (energy in motion), chemical, electrical, nuclear, height, solar, and more. The sum of all energies in the universe is unchangeable. “The work out equals the energy in”, is a principle in physics and is also a real physical occurrence in economics. The principle of the change in work equals the change in energy, is also a practical analogy to economics. Kinetic energy (KE) is calculated by one half multiplied by mass multiplied by the velocity squared (½ mv²) The ½ comes from the averaging changing speed during a time interval assuming a liner change in speed (constant acceleration). The net work done is KE_{final}−KEᵢₙₜᵢₐₗ. Kinetic energy used is work done. An increase in work cannot occur without the change in energy being applied. The change in energy equals the change in work, this is a law of physics; and is an essential concept to understand. It means that which is a possession has been derived from a form of energy, and the value of a job is derived from energy. Your car, house, and possessions, were once a form of energy; the energy changed form and enabled a transformation from one form of existence to another.

Employment cannot be understood without first learning the role of energy. The employed are employed in the first place as a result of the input of energy. Physical labor is a form of energy because energy allows the transformation from caloric energy in the human body to force to motion. Production is an effect of energy. Anything in motion is derived via energy. Therefore driving, mining, farming, melting, and shipping, occur essentially due to the source of energy. Without energy there is not any motion, other than what is naturally occurring. Energy consumed is energy changing form from one type of energy to another, where kinetic energy+potential energy+stored energy=total energy which is conserved. The analogy in economics is the energy of electricity generated as an operator (energy is not created because energy cannot be created as it is always there; energy is generated) also changes form to kinetic energy again changing form to stored energy, and again changing to stored wealth. Wealth is a form of energy as energy transformed to wealth. Then the economic process is the conservation of energy, where resources are transformed from a natural state to, eventually wealth. Energy is the capacity to do work, and wealth is the capacity to consume. What alters the ability to change the capacity to do work? Energy is applied by the operator of force push and force push is obstructed by counterforces plus force drag, which then results in force net as the summation of force (Σf). The summation of force enables production and production is a transformation of the resource to and from energy. The input of energy accelerates the transaction of the owner's and in time wealth is increased. Wealth is from the change in kinetic energy and wealth is the ability to consume. Wealth is derived from the accumulation of energy caused by the input of energy into the economic system. Energy out can only exist from the cause of energy in: as energy in=energy out plus energy lost due to friction. This is assuming the system is not shrinking. If energy from the system is used to do work without any input from outside the system than the energy within the system will decline.

The objective to make the Unites States of America wealthier is a change in energy, “in” from outside the system, (energy as an input). A change in the input allows for a change in the output, as well as a lessening of the counterforces which will result as an increase in energy out. It is quite impossible to have zero energy as an input yet expect energy out unless the system declines. For ease of use assume the shared objective is to maintain the system or increase it. It is equally impossible to have zero change in energy as an input and expect a change in work as an output unless the counterforces are reduced. Mass is accelerated by force by the summation of force where Σf=ma (Newton's second law). This does not operate backward; acceleration cannot make, cause, or generate force because acceleration cannot occur without force. This means in order to affect the economy the answer lies within the summation of force. An artificial input in physics is the same as zero energy in. An artificial input is actually a negative because something articfial still causes drag. Mass cannot be accelerated or be maintained in motion via an artificial input because an artificial input in natural science is not an applied force. In science, no applied force as an input will equal nothing as an output. Therefore zero input of applied force actually leads to a loss of energy in natural science and this occurs in economics, just as it does the laws of physics. An economy will contract if too little energy input occurs, because there is always friction to be overcome.

How does energy generate wealth in the analogy of physics to economics?
1. Begin with energy being input into the system as the form of the applied force.
2. The applied force is force push which is counteracted upon by counterforces.
3. A net force results when the applied force overcomes the counterforces.
4. The net force, or the summation of force, instantly accelerates the object in zero time. However, kinetic energy is not observable yet because distance must occur.
5. A newton is a unit of force and is calculated as 1 Kg m/s² in units and the formula is Σf=ma
6. Energy is measured as a newton meter and is named a joule. A joule is a unit of force multiplied by distance. Distance is paramount to understanding kinetic energy. A joule is force multiplied by distance and in units is calculated as 1 Joule=1 Kg m/s²× m=1 Kg m²/s². Kinetic energy is measured in joules. For energy from the input to be transferred to the object distance must occur. Without distance occurring in an interval of time the energy is not being transferred to the object.
7. As the summation of force accelerates the mass and as a result the velocity changes in a change in time. Acceleration=Δv/Δt=a definition. The change in velocity involves distance. This is why energy equals force multiplied by distance. The velocity is the evidence of motion. The mass in motion is the kinetic energy and the change in kinetic energy is from the increase in speed. To increase KE there must be acceleration. To have acceleration there must be an increase in the summation of force. To have force push there must be an input of energy.
8. Kinetic energy is the ability to do work and is a definition regarding motion.
9. In the analogy of physics to economics the wealth is the ability to consume and the change in kinetic energy is proportional to the change in wealth as it takes energy to consume where (w) equals wealth in this example of the change in kinetic energy which is proportional to the change in wealth (ΔKE α Δw).
10. The first step is mass multiplied by acceleration. The second step is acceleration is not the end, but is what is needed to change kinetic energy. Acceleration plus the change in time equals the change in velocity which has duration. The velocity is a demonstration of kinetic energy (KE) and vice versa. The kinetic energy is the output from the energy from the input. Wealth, the ability to consume cannot change (increase) unless there is an input of energy as a cause. The cause is first in the order of occurrence. To increase wealth is to increase kinetic energy.

In the analogy of physics to change the economy requires a cause, where the cause originates from energy. Zero net force cannot accelerate the economy. The applied force must overcome the counterforces to result in a positive net force. The greater the net force, the greater the acceleration, the greater the velocity, the greater the kinetic energy, and in the analogy of physics to economics the greater the generation of wealth. To improve unemployment for example, is an effect from a cause, where the cause is a change in the summation of force. There cannot possibly be an improvement in employment (economic event) unless first there is a positive summation of force (force net). The remaining chapters begin by stating economics as a first principle based upon an analogy to the reasoning process of physics which I refer to as the Physics to Economics Model (PEM).

### Chapter IX

### Restating Economics as a First Principle Based on Natural Science

This chapter begins with the first principle of economics as an analogy to the principles of physics from the natural science process of reasoning in order to determine how an economy operates. Called the Physics Economics Model (PEM), its purpose is to establish an operational process to understand the relationship between the input into an advanced economy and what the resultant expected output might be. The Physics to Economics Model's (PEM) methods are based on the mechanical physics process of reasoning, mathematics and principles of truth as a First principle in understanding economics.

PEM is independent of current definitions of economics which are typically not based on natural science, but are dominated by a social science view. The social science definition of economics in use today lacks the ability to determine how economics operates.

The most current definitions of economics are based on a field of study from the social sciences. The social scientific methods are observations of situations and are compiled, creating data points which are averaged. Assumptions are made, and then the averages are manipulated to guess toward a conclusion as a curve fitting approach to explain data. Social science is the study of people and their relationships with each other, motives, and values, they are studied with scientific methods, but there are not any laws which determine an outcome. There is room in the social science methodology for broad interpretations which could be in conflict with the reasoning of the natural science field of study. Social science can be subverted for non-scientific reasons because its methods are designed to deal with random behavior. Social science is of the self and is random as opposed to natural science which is independent of people and deterministic.

Currently, economics is defined by the methods of social science as “a social science for the distribution of goods divided by scarce resources”. If this definition (a social science multiplied by distributed goods divided by scarce resources) were put into a formula, it could not be calculated. What are goods divided by scare resource multiplied by 5 equal to? A number multiplied by scarcity is not a number. There is not any useful meaning derived which can be applied to solve economic problems.

The social science methodology is a set of observations in a variety of averages, standard deviations, and grouping of averages written in statistics: it is a set of data points which could have multiple meanings: there is little cause and effect methodology. Specifically, what is a good (merchandise) and how it came into existence is not made clear. What caused the good, and what effects are there upon the good? What if there were not any goods, what about newly invented goods? What if no goods were invented? How much does a good weigh? Were the goods imported or made domestically? There are not any established, base principles in social science which allow clear definitions.

More confusing is the term, “scarcity”. Scarcity is a very non-natural science thought although the concept if finite is more useable. The term scarcity is an emotional judgment. The north and south poles do not have a scarcity of sunlight. The suns energy cannot be scarce; it is a finite amount of energy. By saying there is not any scarcity in physics, it means there is not any method to calculate scarcity nor is there a concept of scarcity. It does not seem practical to have the concept of scarcity as a key determination in economics. It is impossible to change the outcome with a process of vague concepts. Economics cannot be defined in social science because there are not calculations enabling practical solutions. The solutions to improving the economic conditions are most plausibly found in the principles, laws and concepts of physics.

Historically, 2000 years ago, the Greeks incorrectly interpreted natural law in motion as a dissipation of force. This was a good attempt to establish a first principle, but it could not be calculated. This view when observed, looks plausible; but is not Newton's view, which is a first principle and can be calculated. It is Newton's views of motion where the object must be acted upon by a force to be sped up or slowed down, where the object is acted upon by multiple forces of, force push−(counterforces). The machine age of the industrial revolution is an observation which resulted from the application of physics. Motion must be understood in a formula first. There must be a, “first principle”, first, before the machine could be built. First comes the principle of understanding and then comes the action. The object in motion is the result of multiple forces not a dissipation of force. A method used to derive a solution must be in a useable form to allow clarity of cause and effect. It is easy to find the answer of two multiplied by a kilogram which is equal to two kilograms, two multiplied by a meter equals two meters.

The essence of natural science is the behavior of the object of study. Physics as a branch of the natural science field of the study of energy, force, time, space (distance) and motion. Physics concepts are in mathematical formulas. Quantities are measured in standardized units. Physics is a reasoning process, using mathematics based upon principles derived from observation and experimentation to understand how the natural universe behaves and operates. Physics should apply universally regardless of the political system. A peasant under the king, a comrade under a dictator, those subject to religious or atheist rule, and free capitalists should all use the exact same principles of physics to shoot a rocket, build a farm tractor, or mine for minerals. However, social life would be extremely different in a dictatorship versus a constitutionally free individual. Social science without determinism is incapable of consistently clearly differentiating between the desirability of being free or being heavily subjugated because its methods can be misapplied. Conversely, a physics base reasoning when applied as an analogy to economics can only operate when people are free to respond to input.

It seems rational to view economics with methods based on natural science and particularly within the field of physics. Iron as a quantity is measured in units of kilograms that can only be mined, shipped, and melted by energy moving the iron over a distance in time. To make more cars or make them cheaper and faster is a kilogram, distance, and time problem. To meet the demand, iron ore must have been mined first. It takes energy to mine, then ship, and melt iron ore.

The process of physics (mechanical) reasoning is founded in Newton's second law where an object moving in a direction can only be accelerated by net force. There are always counterforces due to gravity to push forces (force push). If the force of force push is greater than the counterforce the summation of force, which is force push minus counterforce equals net force as the summation of force. Force is the means by which energy is transferred from one object to another. To sketch this, energy has the ability to manifest a process of force to interact with an object and make it accelerate in time. Energy→force push←counterforce=Σf→object→to accelerate. Where Newton's 2^{nd} law is the summation of force=mass multiplied by acceleration (Σf=ma). This work is saying force and what it does is a first principle of economics.

This is how the natural world, the natural universe operates. Everything which moves follows this law as a principle of truth. Than the summation of force equals mass multiplied by acceleration is a concept. As economics is of the natural world it should follow the same reasoning process as Newton's laws. Much of what is economics is in fact an object being caused to accelerate some distance in some time. It then follows the “first principles” of economics should have within it the process of Newton's formula of Σf=ma. Additional concepts in economics should also follow the first principles of physics.

By stating economics in a usable form such as a first principle, it is possible to understand what alteration of causes are needed to alter the desired effect with the effect being a change in the economy. Most important, this method enables the differentiation between that which is a cause and that which is an effect, as well as why there is an occurrence. Cause and effect are in an order of occurrence, where cause comes first and the resultant effect arrives secondly: not the other way around. The order of occurrence is not, in a practical sense, reversible. This analogy enables an understanding of what to do to alter the outcome. To endeavor to increase wealth is possible because the change in wealth occurred due to a change in the net input. Without the input of force derived from energy wealth cannot increase in the aggregate.

Economics is an occurrence of activity caused from the origin of energy as applied force, (the ability to do something), which is counter acted upon by both human policy and by the counterforces of the natural force drag as a natural counterforce, establishing a net applied force as a summation of force (Σf economic). The net force (Fₚᵤₛₕ−the counterforces) accelerates the object of study. Energy is than the prime mover as the cause that effects the change upon the system (economy) of free people who make up the ownership entities as, “the system to be altered”. What is altered is the behavior of the system. The system stays the same (in this analogy) and is accelerated by the evidence of a change in the change of velocity. The velocity is the transaction rate or a transaction divided by the change in time. To observe the wealth increasing is to observe the change in transactions in time increase. What is accelerated is the economy and the evidence of acceleration is the change in the transaction rate (velocity=change in the transaction rate in the analogy of physics to economics).

In the analogy of physics to economics the following economic terms are substituted for physics terms.
X=position of owner
Mass=economy
Transact=distance
Transaction rate=distance/time=velocity
Acceleration=change in velocity/the change in time=change in transaction rate/change in time

This is a quick review of economic acceleration. To become wealthier is to accelerate and acceleration is an effect from the cause of net force. To accelerate an object of study is to change its behavior by accelerating it as follows:
mass=the size of the object of study, not in space, but as a measure of how easy it is to accelerate.
To change the position of x=x_{f}−xᵢ
x_{final}−Xᵢₙᵢₜᵢₐₗ
Time occurred during the change of position of x as (time_{final}−timeᵢₙᵢₜᵢₐₗ) or (t_{f}−tᵢ)
The rate of change in position of x is the velocity of, “x”, which is (x_{f}−xᵢ)/(t_{f}−tᵢ)=Δx/Δt with direction
Velocity=v=Δx/Δt=distance/time=d/t with direction
To accelerate is a change in velocity divided by a change in time=Δv/Δt
a=acceleration
a=Δv/Δt
a=Δ(x_{f}−xᵢ/t_{f}−tᵢ)/Δt=[(x_{f}−xᵢ)/(t_{f}−tᵢ)₂−(x_{f}−xᵢ)/(t_{f}−tᵢ)₁]/(t₂−t₁)/Δt
a=Δ²(x)/(Δt)²
Substitute ownership for x for the analogy of physics to economics
ow=ownership entities of a free people
Velocity=v=the change in ownership/the change in time=Δownership/Δtime=(ownership_{f}−ownership)/(t_{f}−tᵢ)=Δow/Δt
The acceleration is the change of the change in ownership Δ² (ownership) in the change in the change in time, (Δt)²
a=Δ² (ownership)/(Δt)²

A transaction is a change in ownership and a transaction rate is a velocity as a transaction rate is a Δ ownership in a change in time. Than a change in the transaction rate in a change in time is Δ(transaction rate)/Δt=acceleration.

To change wealth there must be acceleration. Acceleration can be either positive or negative, but acceleration must be positive when the objective is to increase social wealth. Acceleration is in the direction of the net force.

What then is being accelerated? The economy is being accelerated and the change in the transaction rate is the evidence of the acceleration. Assume free people transact at a profit than an increase in the transaction rate (a change in velocity) will result in a change in the profit as an increase. It is the ownership as an entity which is the object being accelerated which changes velocity. The acceleration is a change in ownership, than to change velocity is a change in the change of ownership ((Δ²)(ownership)) as (Δ²) is a change in the change. To change wealth necessitates a change in velocity (transaction rate) in a change in time. A transaction rate is a velocity and is a change in position of the ownership in a change in time. The acceleration of the transaction rate is a change in the transaction rate divided by a change in time. This definition follows the physics concept of the laws of motion, the summation of force (Σf) equals mass multiplied by acceleration which is the change in velocity divided by the change in in time Σf=ma or Σf=m(Δv/Δt) or Σf=m(Δ² (x)/(Δt)². This concept can be expressed as Σf=entity Δ² (ownership)/(Δt)² as the analogy of physics to economics.

Energy uses force to accelerate the mass or the system. However it is the force net that accelerates, and force is made up of multiple forces of force push, minus counterforces and force drag, multiple counterforces can be as factors, or as an impediment to force push, which alters the process to slow force push. Friction and gravity are also reductions to force push. Where force push is multiplied by (1−f₁−f₂−f₃) there are factors (f) reduce the force push. Also gravity (g) (acceleration due to gravity) and the coefficient of friction (p pronounced mue) where p is a coefficient of force drag and mass (m) are natural counterforces to force push calculated as μmg. Therefore Fₚ (1−f₁−f₂−f₃ . . . )−μmg=the net force. Force push multiplied by the quantity of one minus the factors 1, 2, and 3, reduce force, and natural counterforces also reduce force push: [Fₚ (1−f₁−f₂−f₃)−μmg] is the summation of forces (Σf). It is the if that accelerates mass (m) or mass multiplied by acceleration.

This is the physics view of Newton's second law of motion. An analogy of Newton's law to economics follows the same form of reasoning.

Force push in economics is electricity generated plus fuel burned (other than fuel used to generate electrical power). This then makes the economy go, (operate), because energy is the origin of movement and force is the operative which interacts with the object of study (the economy). An interaction can be a field of gravity which actually does not touch an object, yet the force of gravity is a real force.

What is the foundation of economics? Force push makes the economy accelerate forward assuming the direction of economic activity is a spontaneous behavior for the betterment of humanity (a positive vector). To do anything economically for the general betterment of humanity requires energy. Energy as an applied force, which overpowers the counterforces to become a net force. The net force is the input and the output is a result from the input which causes the change in wealth. The counterforce to force push are factors of inefficiencies from the governmental policies such as factors of taxation, government debt (failure to balance the budget), and the cost of unemployment. It is possible the counterforces could be stronger than the force push, which would make the economy go backward (contract), or negatively accelerate. Before going any further, my solution will advocate full employment. I advocate eliminating the cost of unemployment by enabling full employment. Force push is confronted by taxation where taxes can be between zero or 100% of force push, (0>1). Where the factor of the counterforce of taxation is fₜₐₓ where 0<factorₜₐₓₐₜᵢₒₙ<1. Than 1−fₜₐₓ is for example, if hypothetically taxes are at 40% of annual income than [(1)(−0.4)]=0.4 multiplied by force push making Fₚ0.4, cutting the accelerating ability of force push by 40% due to taxation. Therefore, taxation is a counterforce to economic growth.

The accumulation of the factors of counterforce can exceed force push when there is no gain to economy even if additional force push is introduced.

The PEM theory of economics as a “first principle”, an analogy to physics as a formula is as follows:

Force push (1−fₜₐₓₐₜᵢₒₙ−f_{government debt}−f_{cost of unemployment})−μmg (the coefficient of friction, the force of gravity on mass), as a natural force which resists gains, which is proportional to the properties of the economy multiplied by acceleration as the change in velocity of the economy in a change in time.

Therefore, Fₚ (1−fₜ−f_{d}−fₑ)−μmg=ma, where the fₜ is a factor due to taxation and the subscript, “t”, is for taxation, the subscript, “d”, is for the factor due to government debt, and the subscript, “e”, is a factor due to the cost of unemployment.

The analogy to economics relates to mass as the object of study is likened to the system of ownership entities of a free people. Acceleration is the change in the transaction rate divided by the change in time. The alteration of the economy occurs as the behavior of the ownership entities of a free people which is the system to be accelerated changes velocity in a change in time. The acceleration is the change in transaction rate divided by the change in time.

Acceleration in physics is the change in velocity/the change in time. The economic analogy is net force accelerates the object of study. In time, the velocity increases and results in an increase of kinetic energy and proportionally wealth increases. Wealth is a consequence of energy accumulated in the economy as caused by the input and the change in wealth is the output. Before there can be an increase in energy there must first be energy in. Energy generation (electricity+fuel burned) allows force push, which is counteracted upon by inefficient policy as the counterforce reducing the positive effect of energy as the force push. Additionally there are the counterforces of friction (μ) and gravity (g) against the system of the economy (m), and μmg must also be overcome by force push (electricity+fuel burned). Then μmg are natural counterforces to force push. To dig up iron ore is to dig up against the force of gravity, where energy must overcome gravity. Then additionally production is taxed at the same moment, meaning the natural counter-force reduces production, and the counter-force of taxation additionally reduces production. Production, enabled by the use of energy, is counter-acted upon by the taxation and counter-acted upon by the resistance of nature. Additionally, there are more counterforces, which are mainly government debt and the cost of unemployment.

The units on one side of the equation are not the same on the other side and so proportionality is used (α) as opposed to an equal sign. Than, Fpush (1−fₜₐₓ−f_{debt}−f_{unemployment})−μmg α (production owned by ownership entities of a free people (the object to be studied) multiplied by (Δ(transaction rate/Δt) is the physics to economics model of economics. Energy as an input causes energy as an output as wealth results as energy out, wealth is proportional to energy as an input, which results in energy as an output and enables wealth to occur as an output. The Δ(transaction rate)/Δt can also be written as Δ²(ownership)/(Δt)²). The resultant wealth can only occur form the input of the summation of force (Σf) as the operator from energy, and it must be clear counterforces reduce wealth.

In physics, Newton's formula is Σf=ma and this is expanded upon by Fₚ (1−factors)−μmg=object of study multiplied by acceleration→energy out. Than this formula now applies to economics . . . .

Electricity plus fuel burned (1−fₜ−f_{d}−fₑ)−μmg α the system of ownership entities Δ(transaction rate/Δtime) can be used to increase wealth.

The process is to determine the input of applied force as electricity generated plus fuel burned less the counters of government policy plus the friction due to natural forces equaling a net force, when the net force will cause a proportional output of wealth as an effect from the cause of energy in. The process enables the management of the net inputs to increase the aggregate wealth of the Unites States of America as an expected output. It is assumed in the analogy that the transactions between free people occur at a profit and as transactions increase profits also increase.

The following Table 2 summarizes how the analogy of physics to economics operates:

TABLE 2
Summary of Analogy of Physics to Economics
The Physical World
Human activity of mathematics and reasoning of physics
Mathematical/reasoning of the scientific view of the natural world supported by observation

| | | |
|---|---|---|
| The Cause | The Object | The Effect |

Newton's second law of motion is a principle of truth of reasoning with mathematics
are used to understand the observation of motion in the natural world
Newton's Second Law of Motion is Σf = ma

| | | | |
|---|---|---|---|
| Σf | = | m | a |
| Summation of Force | = | mass | acceleration |
| Applied Force − Force Drag | = | mass | Δvelocity/Δtime |
| Force Push (1 − Factors) − Friction | = | mass | acceleration |
| Mass Gravity | | | |
| A Newton | = | mass | acceleration |
| (Force Push) (1 − factor₁ − factor₂) − | = | mass | acceleration |
| μmg | | (m) | (a) |
| The summation of force | equals | mass | acceleration |
| (Σf) | = | m | a |

It means net force causes an object to accelerate,
that is to move faster than it was previously going before the force was applied
The First principle of Economics as an Analogy to Economics

| | | | |
|---|---|---|---|
| Σf | = | m | a |
| Applied force − counterforces − force | = | m | a |
| drag | | | |
| Electrical generation + fuel burned | (α) | Owned by ownership | Δ²(ownership)/(Δtime)² |
| push − counterforces − force drag | Proportional | entities of free people | |
| | To | | |
| Electricity + Fuel_{burned} | α | Ownership entities of | Δ (transaction rate)/ |
| (1 − Fₜₐₓ − F_{Gov debt} − F_{cost} | | a free people | Δtime |
| _{unemployment}) − μmg | | | |
| Force Push is electricity + Fuel | α | As a system of the | Transacted in a rate in |
| burned other than fuel used to | | number of economic | time between free |
| generate electricity | | entities of ownership | people with the |
| Less counterforces | | is being accelerated | assumption of a profit is |
| Counterforces are the counterforce | | | the change of velocity |
| to production (that which prevents | | | |
| the input to production and lessen | | | |
| the transaction rate) Also there are | | | |
| natural counterforces on earth which | | | |
| are the force of gravity and force | | | |
| necessary to overcome friction as | | | |
| (umg) | | | |
| Counterforces are factors of | | | |
| taxation, government debt, and the | | | |
| cost of unemployment which reduce | | | |
| production because they consume | | | |
| energy, therefore counterforces | | | |
| cannot be force push and secondly | | | |
| counter focrces reduce the Fₚ and | | | |
| reduce Σf. There is an assumption | | | |
| iron ore is not put back into the | | | |
| ground without any reason, than the | | | |
| use of energy is assumed for the | | | |
| purpose to make a gain. | | | |
| Factors of counterforces are 0 > 1 | | | |
| and are cumulative | | | |
| The factors of taxation + the cost of | | | |
| government debt + the cost of | | | |
| paying people not to work all add up | | | |
| to counter act upon the generation of | | | |
| wealth. | | | |

| Physics | Physics to Economics Model |
|---|---|
| Energy as an external input causes a change | Energy as an external input causes a change |
| in the output | in the output as a change in wealth |
| Energy taken internally from the system can | Energy taken internally from the economy can |
| cause a change in the output but the energy | cause a change in the output but the |
| within the system is depleted. | aggregate wealth of the nation is decreased. |
| x = the position | x = the net worth of ownership |
| The change in the position of x is distance | The change in ownership assumed at a profit |
| | is distance |
| Distance = the change in position | Distance is the average velocity multiplied by |
| distance = d | the change in time |
| change = Δ | distance = transaction |
| position = x | Transaction = T |
| d = Δx | d = T |
| Δx = position final minus position initial | change = Δ |
| Δx = x_{f} − xᵢ | position = ownership |
| To move distance there must be a change in | ownership = ow |
| time (Δt) | d = T |
| Distance is a response to the input of energy. | The change in ownership = |
| Distance equals the average velocity | ownership_{f} − ownershipᵢ = transaction |
| multiplied by the change in time | Δow = ow_{f} − owᵢ = T |
| d = \tilde{v}Δt | To change ownership requires a change in |
| | time. A change in ownership is a response to |
| | the input of energy. If the input of energy is |
| | external than the aggregate wealth increases. |
| | If the input is internal than aggregate wealth |
| | decreases. |
| | distance = transaction/Δt · Δt |
| | Distance = T |
| | (see below) |
| Speed is velocity with direction | Speed is velocity with direction |
| Velocity is the time rate of change of position | Velocity is the time rate of the change in |
| Velocity = distance/time | ownership or velocity is the time rate of |
| v = change in position/change in time = | change of a transaction |
| position_{f} − positionᵢ/time_{f} − timeᵢ = | Velocity = |
| x_{f} − xᵢ/t_{f} − tᵢ = Δx/Δt = d/t | the change in ownership/the change in time = |
| | ownership_{f} − ownershipᵢ/(time_{f} − timeᵢ) = |
| | Δownership/Δtime = |
| | transaction/change in time = T/Δt = |
| | Transaction rate = Tr |
| | Velocity = Tr = d/t |
| | Rate is a quantity in time |
| Acceleration is the change in velocity in a | Acceleration is the change in the transaction |
| change in time (Δv/Δt) and happens | rate in a change in time (ΔTr/Δt) and happens |
| instantaneously | instantaneously |
| Acceleration is the change in the time rate of | Acceleration is the change of the time rate of |
| the change in position in the change in time | the change in ownership in the change in time |
| (Δv/Δt) | Δ²(ow)/Δt = (Δv/Δt) |
| Acceleration = a | Acceleration = a |
| a = (position_{f} − positionᵢ)₂ − (position_{f} − positionᵢ)₁/ | a = (ownership_{f} − ownershipᵢ)₂ − (ownership_{f} − |
| t₂ − t₁/t_{f} − tᵢ | ownershipᵢ)₁/t₂ − t₁/t_{f} − tᵢ |
| a = Δ(Δx)/Δt² = Δ²(x)/Δt² = Δv/Δt | a = Δ(Δow)/Δt² = Δ²(ow)/Δt² = Δv/Δt |
| | Change in ownership = transaction = T = d |
| | a = change in transaction rate/change in time |
| | a = Δ(Tr)/Δt = Δv/Δt |
| Acceleration is instantaneous and energy is | Acceleration is instantaneous and energy is |
| not transferred until distance occurs and there | not transferred into the economy until distance |
| must be a change in time. | (transaction) occurs and there must be a |
| | change in time. |
| The summation of force (Σf) is not showing a | The summation of force (Σf) of electricity plus |
| change in energy until there is distance in | fuel burned minus counterforces is not |
| time. | showing a change in wealth until there are |
| | transactions in time. |
| Energy = force · distance | Energy = force · distance |
| E = f · d | E = f · d |
| Σf = netforce = force | Σf = netforce = force |
| ΔE = Σf · d | ΔE = Σf · d |
| d = \tilde{v}Δt | d = \tilde{v}Δt |
| ΔE = Σf \tilde{v}Δt | ΔE = Σf \tilde{v}Δt |
| In time the change in velocity demonstrates | In time the change in velocity demonstrates |
| the change in kinetic energy (ΔKE). | the change in kinetic energy (ΔKE). |
| | The change in wealth is demonstrated by the |
| | change in the transaction rate in time which |
| | demonstrates the change in kinetic energy and |
| | the change in wealth is proportional to the |
| | change in kinetic energy. |
| Newton's second law: | Newton's second law in the analogy of physics |
| Summation of force equals mass multiplied by | to economics: |
| acceleration (Σf = ma) = | Summation of force equals the economy |
| Force push − counterforce = object | multiplied by acceleration (Σf = ea) |
| multiplied by acceleration | e = economy |
| | Σf = electricity + fuel burned − counterforces = |
| | the ownership entity of a free people |
| | multiplied by acceleration |
| Σf = ma | Σf = ea |
| ↓ | ↓ |
| Acceleration and a time interval (change in | a and a time interval (change in time) |
| time) leads to the change in velocity where the | equals the change in the transaction rate |
| changed in kinetic energy is the output ↓ | where the change in kinetic energy is |
| a and a time interval (change in time) | demonstrated as an effect and is proportional |
| equals the change in velocity where the | to the change in wealth as an effect. |
| change in kinetic energy is the effect. | |
| Σf = ma | Σf = ea |
| ↓ | ↓ |
| a and a time interval => | Acceleration and a time interval = |
| Δv → ΔKE | Δv → ΔKEαΔw |
| | w = wealth |
| | Δv = aΔt |
| | v_{f} − vᵢ = aΔt |
| | v_{f} = vᵢ + aΔt |
| | Kinetic energy = demonstration of the property |
| | of the system of owners ability to consume. |
| | Wealth is the ability to consume and is like |
| | motion. |
| | KE is the visible demonstration of the change |
| | in wealth (Δw) proportionally |
| | ΔKE α Δw |
| | energy = one half economy (transaction rate)² |
| | E = ½eTr² = |
| | how much energy is needed to change |
| | wealth |
| Object | Object in Economics |
| The object of study is accelerated by the | The economy as the number of ownership |
| summation of forces | Entities of a free people |
| Fp minus counterforces is the net applied | The summation of force is electricity plus fuel |
| force | burned multiplied by |
| | (1 − factor of taxation − factor of government debt − |
| | factor of cost of unemployment) minus the |
| | friction of the natural world which is (μmg). |
| | The net applied force to an economy the Σf, |
| | which accelerates the economy. |

Table 3 lists various items in the analogy of physics to economics.

TABLE 3
Listing of Terms in Analogy of Physics to Economics

| Physics | Economics |
|---|---|
| Fa = force applied | Applied force from some resource |
| Fp = force push | Electrical generation + fuel burned |
| 0 < Factor₁ < 1 | f₁ is a factor of counterforce from taxation |
| a counterforce | |
| 0 < Factor₂ < 1 | f₂ is a factor of counterforce from the cost of government |
| a counterforce | debt plus interest paid |
| 0 < Factor₃ < 1 | f₃ is a factor of counterforce from the cost of |
| a counterforce | unemployment fₑ |
| d = distance | distance = transaction |
| v = velocity = d/t → | v = transaction rate |
| a = acceleration = Δv/Δt | Acceleration is the Δ in the transaction rate/in Δt where |
| | the economy is a system of ownership entities where the |
| | change in speed is the (velocity) |
| E = energy = concept | In the analogy Kinetic Energy α wealth |
| | Where wealth is concept |
| m = mass | The object to be accelerated as the number of ownership |
| | entities of a free people |
| μmg = friction coefficient mass | Force drag = natural counterforce of friction and gravity, |
| multiplied by gravity is force drag | the same as physics, where economic activity must |
| | overcome gravity multiplied by friction, maintaining |
| | against the wear and tear due to the environment |
| Energy In | Energy In |
| ↓ | ↓ |
| Physics | Economics |
| Energy as a concept | Wealth as a concept |
| The ability to do work | Wealth is the ability to consume |
| Energy in = | Wealth out proportional to energy as an input less the |
| Energy out less friction | counterforces of nature additionally less the counterforces |
| | of government policy |
| E = ½ mv² | E = ½eTr² |

To accelerate, velocity must change.

To increase wealth the economy must be accelerated by a net force where the evidence of acceleration is the change in velocity illustrated by the change in the transaction rate.

Then wealth is generated from the input of the change in energy first where the change in energy is the cause for the acceleration of the economy plus time as observed by the change in transaction rate.

Transactions are already going on in the economy. To increase wealth the transaction rate must increase (assuming the dollar values remain the same.)

Transactions are assumed to be at a profit and then transactions must increase for growth to increase. However it is incorrect to attack the problem of too little growth by attempting to alter transactions and thinking it is possible to stimulate transactions by inputting artificial unearned money avoiding altering the summation of force first. Attempting to increase transactions by printing fake money cannot cause a change in velocity of the economy. Only the summation of force can cause an increase in wealth. When artificial money is put into the economy it cannot be a stimulus because it is not an external force. Using unearned artificial money is taking from the systems internal energy. A system cannot accelerate itself by using its own energy. Artificial money goes to some and not others resulting in no net gain. Placing artificial money into the system is also subject to all the counterforces which exist in an economy and this means artificial stimulus of any kind will cause a net loss of wealth. There is more information on this in later chapters.

Transactions are an effect from the cause of applied force less counterforces.

Transactions come second in the order of logic based upon physical law. To increase transactions, to increase wealth, and to make the Unites States of America wealthier, is to increase the net force. The cause in economics is the summation of force, which originates from energy, applying force, via the summation of force to alter the behavior (behavior is altered by causing the velocity to increase) of the ownership entities by increasing the velocity where the output is a change in wealth as an effect from the input of a net force derived from energy.

The objective of this work is to increase (accelerate by applying the rules of physics as a first principle) the gross domestic product (production in mass owned by entities) causing an increase in wealth as a change in the energy as an output relative to the current energy as an input by 100% in eight years, an approximate annualized increase of 9% per year. The economy is already growing at 2% than to accelerate it to a total growth to 9% is to add an additional 7% increase to the GDP. The objective is to become wealthier. The social science method of reasoning is not capable of accomplishing a 9% growth rate by intent because it can't clearly understand the cause resulting in an effect. The physics method is particularly cause and effect oriented. The physics method more accurately reflects how an economy increases, or decreases and how much wealth is generated as a result of given input. Physics is designed to understand and calculate the change in velocity of the object accelerated, in an interval of time. To become wealthier is to accelerate the economy to a new velocity. The formula Σf=ma does not work backwards, meaning acceleration cannot cause force. The cannon ball hits and releases energy, but the energy released is not useable. The cannon ball cannot un-hit, or a cannon ball after being shot cannot go back and re-shoot itself. Therefore what causes a change in wealth? The answer is clearly more rational from the physics form of reasoning, where the cause and effect are clearer. The cause comes first in the order of occurrence in physical laws and the effect comes second. To increase wealth requires the summation of forces to increase where either force push increases or the counterforces decrease or a combination of both.

### Chapter X

### Restating Wealth in Natural Science as a First Principle

Economics should be understood as a set of principles based on natural science applied as a tool used to determine practical theory. The physics to economics model uses natural science based principles to enable the Unites States of America to become wealthier by a definable quantity and quickly enough to be of a benefit to the average person as measured in a time interval. The objective is to accelerate the economy resulting in a change in value relative to a starting point, and cause the GDP to increase by approximately 9% for eight consecutive years, which is an increase from the current (2015) $18 trillion to (2×18=36 trillion). Economics is currently defined in a social science human relation construct and so it is not possible to clearly envision how to change wealth over some period of time or to even understand what wealth is. The linguistics used to define social science concepts cannot be used in order to solve cause and effect problems.

A present day common definition of wealth is to own a lot of a material entity. This definition quickly runs in trouble because the ability to value stuff is inconsistent, and changes over time. Ownership has relative interpretation from country to country and is complicated by taxations systems (government policy). Some countries outlaw the ownership of material goods making ownership of a lot of stuff impossible. Wealth in physics would still exist under the constraint of no ownership, but to a far less degree and wealth in nation states that forbid ownership result in wealth being concentrated in the hands of a few unelected rulers. The dictator and the high level government associates have wealth but it was stolen from the people. It takes more energy to improve the living condition within a society with less personal freedom. Physical energy is transferred into a society minus the counterforces of governmental policy. Restrictive policy is a counterforce to the input.

It is difficult to determine wealth or the change in wealth based on the study of human relationships or from the, “amount of stuff”, definition. Simply using an amount of stuff as a definition, although physical, is too simplistic a concept when challenged with the attempt to increase the wealth of a society. A society could have more stuff but not become wealthier.

Applying the methods of physics, a natural science, which is outside of the self and is a process of interaction of force, energy, space (distance) and time is a better methodology, as exhibited when attempting to accelerate an entity (change speed), including changing wealth from a present value (position) to a future value (at a faster speed). By using physics as an analogy to economics and defining wealth as a form of energy as a first principle based on physics, this methodology is more likely to enable clarity which enables the ability to determine an outcome. The understanding between the cause (the attempt to increase wealth) and the effect, where wealth did increase, is an obtainment of the effect. The obtainment as an effect is a measurable increase, in some measurable way, and it is determinable in the physics method of reasoning.

To cause a change in wealth in physics is to cause a change in the summation of force (the net input), which enables the change to occur as the output, where wealth is a form of output (effect from the cause), and where the cause is the input. The output cannot change unless the input changes first. Natural science is not a trick or mysticism, there are principles and concepts and laws of cause and effect based on mathematics, and reasoning; experimentation should have consistent and observable outcomes.

Defining wealth in an analogy to the process used in physics and then applying it to economics is a process which defines wealth in a relation of mass, distance, and time. A Newton is a shorthand notation of a collection of units of a Kg multiplied by a meter divided by a second squared (Kg m/s²) and is a unit of force. A Joule is force multiplied by distance or a Newton meter (f×d) or Kg m/s² m=Kg m²/s². A Joule is a measure of a unit of energy. The definition of energy is the ability to do work. Than energy is calculated by force multiplied by distance when the force causes the object of study to accelerate, eventually in time and some distance occurs: mass, distance and time, calculated in kilograms, meters, and seconds is the measure of what the cause did and the cause must originate from energy. To increase wealth will involve a change in energy which can be measured by a Joule. A change in wealth will involve a change in energy. Energy is the input where the effect of the output is proportional to wealth as the output.

A change in energy is the transference of energy from the potential energy of a natural resource to wealth. Energy enters an object through a force net force which was counter acted upon by counterforces and force drag, where force push−counterforces−force drag=a force net as the summation of force (Σf). When the summation of force interacts with the mass (the object of study), the result is the behavior of the mass changes by its velocity changing in a change in time, which is called accelerated. Wealth is an output from an input of energy, which makes it an effect, where wealth is the effect from force multiplied by distance which is derived from energy which may be measured in joules.

Than it is possible to calculate how much energy to apply to move so much stuff (measured in units of mass as kilograms) so much distance (in units of meters) in so much time (in unites of seconds). This means, in economics, energy in is highly proportional to the result of wealth as wealth is an output from the input of energy.

The energy in, (applied), caused work to be done, (work is defined in science to say a position was changes to a new position as a result of an effect), because the kilogram moved a distance in time. If the kilogram of stuff does not move than no work was done and no energy was transferred. The kilograms were accelerated by the net force of the applied energy, moving a distance in time. Work is then an occurrence originating from applied energy where the outcome is kilograms moved a distance in time. To move more kilograms at the same speed, or to move the same kilograms faster requires either more energy or less counterforce or a combination of both. This is very pertinent to how stock markets operate which is discussed in later chapters.

Wealth is a concept just as energy is a concept. To measure wealth is the same as energy in motion or kinetic energy or a stored energy or stored wealth. Energy is the ability to do work and can be measured in units of Joules. Kinetic energy is a form of energy due to motion. The change of the kinetic energy is a result of the object being accelerated. The cause of the acceleration is the energy in, or the input. As acceleration occurs velocity increases, then kinetic energy increases. The analogy of physics to economics model is energy is the ability to do work and wealth is the ability to consume. To increase kinetic energy is to increase the ability to do more work. Wealth is the ability to consume. Kinetic energy in economics is an output of energy which is proportional to the output as wealth. The output has the ability to consume. Wealth is also an output from energy as an input. To increase wealth is to increase the summation of force in an economy. The economic summation of force is the force push of electricity plus fuel burned minus the counter forces. Wealth can be increased by the increasing force push, decreasing the counterforces or by doing both.

Wealth is the ability to consume as work is done in consumption. Wealth is the ability to do work upon the environment for the benefit of the owner.

The event of wealth generation occurs when natural resources are altered from their natural state to an altered state. The change in resources to manufactured goods, such as iron ore to automobiles, leads to the change in wealth. The goods are sold for more than the isolated value of the natural resources and that gain is an increase in wealth. The ownership entities of property are the system being accelerated by externally applied energy causing an output change outside the system as a result. The system is a constant as an assumption so the change in wealth occurs as work is done outside the system. The change as an output crossing the border of the system will result in the change in wealth as long as the force push is external to the system. The origin of the change is from the cause of applied energy and the effect is the generation of wealth. Force push as a net force enters the system, and results in a change of kinetic energy within the system; the KE crosses the boundary of the system as an output and the output results in change which is proportional to the change in wealth in the analogy as the ability to spend.

In economics there are multiple properties of the system. An economy has resources and human skill. An educated economy is different than a less educated country. Regardless, the skilled labor can only occur or come into existence because resources were altered initially by energy. Wealth comes second as an effect from energy which was input first. The position of this work is the steel mill came first, and service businesses are a subset of manufacturing. It was the iron ore being mined against the force of gravity, which moved distance, in time, opposed by friction, than was melted, pounded into shape by the applied force derived from energy, sold at a profit, which enabled stored wealth to occur. In turn the stored wealth is used to service and educate. Stored wealth first was derived from energy which is secondly applied to pay for services and education. The stored wealth was derived from the manufacturing process which came first. The cause must come first, and the effect second. The manufacturing process came first, resulting in stored wealth and education is second because a student is a consumer of stored wealth (student loan). Skilled human capability is an effect from energy, where the energy was first input into the economy and the output is transferred energy from the input. The resources which were altered by energy came first, and then education was paid secondly from the effect of the occurrence of the input of energy.

Within this analogy, it is important to note energy is conserved. Conserved does not mean to use less energy. Electricity as a form of energy is transferred to wealth with a loss due to counterforces. Wealth and energy are both forms of energy as an analogy where the input is transformed to the output. In the order of time in the laws of physics, the energy applied is first, and then as a result of the applied energy the summation of force is the cause of the result which is the output that occurs secondly. Wealth is the output in some proportion of the input of energy. Energy can neither be created nor destroyed, but energy changes form, and often this change in form is not reversible. The conservation of energy in physics is the change in the form of energy from one type of energy to another. The everyday lesson in the conservation of energy is a rollercoaster where energy changed form from kinetic energy (motion) to stored energy (height). Conservation is a zero sum game. What one form of energy loses another gains with no energy is lost or created. Energy is not destroyed when it changes form; energy cannot be destroyed. Energy has multiple forms and therefore wealth also has multiple forms. The total energy of the universe is a constant and cannot change. What changes is the form by which the energy exists. This means coal in the ground is potential wealth as coal is stored energy which can be converted to wealth.

The characteristics of wealth in the reasoning of physics are it changes form, it is generated, and not created, it is often not reversible once applied, and it is stored. Stored wealth changes form to motion which can do work.

Stored wealth, changes form to kinetic energy and can be used to cut grass. The cut grass is the effect, and the cut grass cannot easily be converted back to energy. The energy used to cut the grass is lost to reuse, but is not destroyed and the useable energy goes back into the universe. However it is possible to make fuel from cut grass to cut more grass.

The definition of wealth, in concept, is kinetic energy (½ mv²) and it can be measured in joules and it can change form to stored energy. Kinetic energy can be acquired from stored energy and applied to move mass a distance in time. To cause a change in wealth is to cause a change in the input of energy where energy as an input is equal to energy as an output. To become wealthier is to fundamentally increase the energy as an input. The Chinese know this, because their energy in kilowatt generation capacity has been increasing at 10% per year for the past 20 years, versus the Unites States of America's annual change in kilowatt generating capacity growing at only 1-2% per year. On Jul. 10, 2014, the Wall Street Journal noted natural gas use in China from 2000 to present growing at 13.6% per year, versus the United States growth at 6.3%. This is how the Chinese have gained a global market share over countries that had the advantage over them just a few years ago. The change in wealth is proportional to the change in energy and this is observable.

The first principle of economics in the physics reasoning process as an analogy is: (Energy)→force push (1−fₜₐₓ−f_{gov. debt}−f_{cost of unemployment})−μmg α the number of ownership entities multiplied by the change in transaction rate/time, where force push is the generation of electricity plus fuel burned lessened by the counterforce factors from taxation, government debt, and the cost of unemployment, less the counterforce of the coefficient of friction and the force of gravity (the resistance of nature) which then causes the number of ownership entities multiplied by the change in transaction rate divided by the change in time to accelerate or change the behavior of ownership. To change behavior means to change the quantity of ownership change as acceleration.

Electricity+Fuel Burned (1−Fₜₐₓ−F_{government debt}−F_{unemployment cost})−μmg=ownership entities owned by a number of free people multiplied by the change in the transaction rate divided by the change in time (Δ(transaction rate/Δt)). This follows the concept Newton's second law as Σf=ma.

Wealth is like the force multiplied by distance, where W=wealth, W is proportional to ½ mv², or wealth in a form is likened to kinetic energy, (½ mv²).

Work done in physics is when energy uses force to interact with mass and move it. If force is applied and the mass does not move then no work occurred. If no work occurred it means the force was insufficient or is net zero. High paying jobs are proportional to strong increases in energy generation or a reduction of counterforces, resulting in a strong increase in force net.

Wealth is the ability to consume, and the ability to consume is essentially synonymous with the ability to cause work (move mass faster), where the change in energy equals the change in work. Some energy is lost to heat.

Wealth is the analogy of energy as an output which occurred from energy as an input. Energy out is the effect from the cause of the energy in as applying force to interact with the object of study due to the summation of force (Σf).

To make the Unites States of America grow more rapidly is to either increase force push or decrease the counterforces against force push or both, increase force push and simultaneously decrease the counterforces. The best method to increase wealth is to do both, increase force push and at the same time decrease the counterforces of taxation, government debt, and the cost of unemployment. Natural counterforces from gravity and friction cannot easily be reduced, however taxes can be lessened to 10% and the income taxation method of collection should be eliminated entirely and replaced by a bank reduction method, which takes zero time from production. Government debt can quickly be zeroed out permanently and unemployment can nearly be eliminated by guaranteeing jobs on a voluntary basis. If everyone has a reasonable paying job, retiring at 60 with 100% of pay with paid vacations (which can be achieved by workers becoming a stock holder in the domestic businesses) the economic growth will increase. This is explained in later chapters.

The observation of European zero growth is from causation. No net force is zero growth. In economics as an analogy to physics, the summation of force (Σf) is interacting with the number of ownership entities and results in a change in velocity by changing the transaction rate in a time interval at an assumed profit but only if the summation of force is greater than zero. The physics view is the European force net; the summation of force (Σf) is zero and therefore no acceleration can occur. The French growth in GDP has been essentially zero for many years, and the reason is the if is also zero. The physics answer to zero growth is to alter the summation of force by increasing it. Europe fails to grow because there is not any force net which is to little generation of electricity plus fuel burned, or too much counterforce due to government policies or some combination of those events both resulting in the French summation of forces (Σf)=net zero. This means the policies of the European authority are 100% responsible for the zero growth because in physics the zero growth is an effect from a cause. Presently (2015) the same anti-growth policies are becoming prevalent in the Unites States of America.

The cannon-ball's force in motion is from the cannon not the ball when the ball was at rest. The ball will have energy only because it was put into motion by the force push of the cannon. To make the ball go faster requires a change from the cannon assuming the ball is the same size. The ball cannot be stimulated in flight. The ball in flight is the effect. The cannon is the cause. A cannon ball cannot be reshot. Attempting to stimulate an increase in wealth cannot be from an attempt to alter the effect, which would be the same as an attempt to stimulate transactions or stimulate demand which is a useless linguistic phrase. The only way to alter effect is to first change the cause. Transactions, the buying and selling for a profit, is an effect not a cause. Wealth occurs as an output from the Σf. Wealth is a net output from force push because force push equals energy. To change demand can only occur by a change in the summation of force first. To increase is to change. Wealth is proportional to the KE which is observed by the increase in velocity. Velocity cannot be changed on its own. It is the net force which causes the object to go farther. Demand cannot be changed on its own because it is an effect from energy as an input. Demand occurs secondly in the order of time. Using stored wealth or debt to stimulate demand causes an aggregate net loss to the nation. Stimulating demand must be derived from energy outside the system. To transact, there must be ownership because a transaction is a change in ownership. To increase wealth, then is from the cause of applied force. That which is accelerated is the object and acceleration is observed by a change in velocity. To change the transaction rate is to go from transaction rate final minus transaction rate initial. The transaction rate is velocity in the analogy of physics to economics. The velocity final equals velocity initial plus something which explains velocity final. Velocity final equals velocity initial plus acceleration multiplied by the change in time (V_{f}=Vᵢ−aΔt). There is acceleration with the change of time which results in velocity final. In the physics to economics analogy the economy is the system to be accelerated. To accelerate the object of study or accelerate the entity of the system is to alter the behavior of the system, but not necessarily change its size. There is a change in speed with direction making it a change in velocity in an occurrence of time. The change in the velocity is the effect from net force. The change in velocity is the economy accelerating. No net force will result in no effect, or no acceleration. The gain in wealth is the acceleration of the system where an increase in transactions, result in a change in ownership by a free people which occurs at a profit (excluding government transaction). For zero growth to occur means something must cause the existence of zero change. Zero growth is the result of zero net force. In order to successfully accelerate wealth, there must be ownership, as it is the ownership which is being altered in behavior to go faster. To have ownership there must be the highest possible allowance of personal freedom. A police state is not freedom and will not allow ubiquitous wealth because transactions related to the input of force cannot occur. From the history of observation, has any police state become wealthy? The answer is no. To require everyone to be the same in wealth prevents transaction, prevents ownership, prevents wealth, and uses energy to control rather than to produce; this is why socialism fails to produce wealth and this is observed to be true. To cause acceleration means to increase force net, to be more efficient, to produce more, and to transact faster. Efficiency only works in a short duration of time then the effect ends. Once a competitor obtains the same or similar techniques of efficiency then the competitive advantage reverts back to the origin, which is the cost of energy. To beat the competitor is to maximize the low cost of generation of energy and to minimize the counterforces of taxation, government debt, and the cost of unemployment.

For prolonged acceleration the summation of force must be sufficient to accelerate over time. The summation of force is the cause. Energy is the applied force less the counterforces. If the counterforce from policy and natural force drag equals or exceeds force push then net force can be zero and no acceleration (economic growth) can occur, which is today's America. This means an economy which has zero growth, similar to what the Unites States of America is experiencing presently (2015) is caused and the cause is force net is zero. To fix the American economy is to fix the summation of force. Stimulating the transaction by artificial means cannot in the laws of physics allow prolonged economic prosperity; when prosperity means actual acceleration over many years. The current policy of the Unites States of America and many other nations is to print large amounts of unearned money and input it into the economy. Printed money is not energy or a force push and therefore cannot cause an effect which is positive. An output cannot be stimulated as it is an after the fact event from the preceding cause. A transaction is not demand. The transaction is a result of demand. Supply and demand leads to a transaction. Stimulating demand by increasing debt cannot succeed because debt is a counterforce and lessens force net. Lessening force net lessens transactions. To correctly use the phrase economic stimulant would mean to increase the generation of electricity plus fuel burned and or decrease the counterforces of taxation, government debt and cost of unemployment. A true stimulant would eliminate 100% of government debt for example. In the analogy of physics to economics real force push causing a positive force net enables an increase in net wealth.

Wealth is generated from the cause of energy using force to interact with the object of study and move the object faster relative to its current speed. To accelerate the economic system from a standstill, such as what the pilgrims did, or accelerate it when motion already exists can only be accomplished by a net force. From 2000 to 2014 the Chinese have increased their application (use) of natural gas by 13.6% per year. Compare that to the Unites States of America which has only increased its use of natural gas by less than 1% per year (Mitsui OKS Lines BP Statistical Review; the US Department of Energy). Acceleration requires a change in velocity. A change can only occur due to a change from the input of the summation of force. According to the IMF, the Chinese have over taken the Unites States of America as the world's largest economy.

Wealth is proportional to the total energy, which can take the form of kinetic energy (½ mv²) and also stored energy and wealth can change its form as energy changes form. Wealth is a zero sum game because wealth is not destroyed when used. More wealth requires more energy. Energy used changes form, and wealth used changes form. Yes, wealth is finite, but finite relative to the available energy of the universe. Wealth is a form of energy and has the ability to consume. Once used it typically changes form and cannot be reused. However, there is nothing stopping the generation of new wealth. The impediment to the generation of wealth is the counterforce of poorly constructed policy by the government. There is simply nothing else preventing the Unites States of America, from growing at 9% per year for 8 years, given the enormity of natural resources within its domestic borders. Other nations with far fewer resources have grown at 9% per year. China has far less resources compared to the United States.

Wealth, like kinetic energy is caused by the input of a net force. Energy is first, then the effect from energy is second and wealth is an effect from the input of energy. Wealth is the net effect of energy input as energy in, and then it interacts with the object of study or the economic system, in this analogy. The applied force as force push, from the energy, must come from somewhere. In economics it is electricity generated plus fuel burned lessened by counter-forces. Importantly, not just energy will succeed in generating wealth. In order to beat the competition the energy must cost less than the global competitors energy costs them. Wealth being a form of energy like kinetic energy, can only be obtained from another form of energy. The most wealthy country will have the greatest applied force with the lower ratio of counterforces. Whatever nation has the best joules to economic system ratio and is large enough to have an economy capable of large scale manufacturing is the global winner. The nation with the lease cost of energy has the advantage. Economics is than a competition over the cost to generate effective energy.

Wealth is directly proportional to force multiplied by distance in motion.

To become wealthier requires that the economy:
Generates more force push or generates more electricity and burn more fuel
Reduce counter-forces from governmental policy because counter-forces waste energy unnecessarily (the true green solution is to be efficient)
Increase personal freedom (the green solution because efficiency does not cost energy) The cost of a rule is free, but the cost of enforcement can kill an economy by causing lack of competitiveness.
It costs energy wasted to use the peoples time by personally taxing individual income. It is better to take the government's portion of the people's wealth from the banking system by an independent institution because it is significantly more efficient. The income tax system costs or wastes energy equal to the GDP of Russia. One business hour in America costs approximately 8.6 billion dollars. How many hours are wasted on income taxes? How much oil is used to generate 8.6 billion dollars?
Embrace differences in wealth because differentiation is a natural state and it uses the least amount of energy. It takes more energy to cause sameness or to redistribute (it is not green to waste energy on sameness). The energy used to attempt sameness of wealth is like driving a million cars every year for no reason, a waste of energy.

A block of steel at rest at room temperature has some molecules moving fast and some moving slowly. To make all the molecules move at the same speed would require significant energy; energy completely wasted. The second the energy is no longer applied the molecules will immediately differentiate. Attempting to even out financial income is anti-physics, wastes energy, and causes eventual social failure as observed through historical observation.

Wealth generation from the physics, the natural science view has clarity of cause and effect. Of course there are necessary compromises with social science, (the cost of compromise) however the compromise should not be at the expense of the betterment of humanity or at the expense to the greatness of the Unites States of America, or at the expense of personal freedom.

### Chapter XI

### Restating Capital as a First Principle in Natural Science

The natural science view of capital is that it is a physical object and has resistance to acceleration. It is subject to the physical laws of the universe. Capital in a practical sense in economics is mass, and as such, it interacts with force, energy, gravity, distance, and time. Therefore in concept, the behavior of mass is a hard principle and is expressed in economics as an analogy to the laws of physics. Acquiring capital in economics is to increase mass or an object of study and the movement of mass is primarily understood from the field of knowledge of physics. In order to have an economic event requires something must change. The change is to alter resources from their natural state to a processed state. Moving or accelerating mass is not an analogy to physics; moving mass is physics. However, the analogy to economics is how energy input to an economy changes it by using natural resources. The change in position is position final minus position initial, and can occur at a constant speed without a change in input. When velocity is constant then there is not any change and no additional energy is needed. Some energy is needed to counter the force of friction. An object can move with zero net force if it has constant speed excluding the force necessary to overcome friction. Zero net force is when the applied force equals the counterforce. Changing the economy will require a change in force, moving something a distance over time. Changing the economy means changing the net force.

Unscientific thinking accepts the belief the cost of capital can be manipulated by altering the measurement system in financial accounting. This type of incorrect science is saying in order to make a house bigger, the standard measurement of one foot should be made smaller (changing a foot to a half foot). This will increase the square footage of the house based upon the new, altered measure in question, but the size in physics remains the same. Cheating on measurements cannot change the natural science magnitude. This is an extremely misdirected view if the objective is to increase the total aggregate wealth of the nation by altering the measurement system. To change the cost of capital would require a change in gravity, a change in the atomic weights of atoms, and the alteration of chemical bonding of friction. To engage in an attempt to alter the cost of capital is a falsehood because the cost of capital cannot be altered as it constrained by the laws of nature. Accounting methods can be altered; however accounting methods cannot alter mass, gravity, weight, distance, and time. To pretend something is not so does not make it not so. To pretend cannot cause an effect.

An economy in the natural science method has principles, starting points, mathematics, laws, observations, and repeatable experiments. Natural science is outside the self, and is used to observe the behavior of mass, energy, time, and distance which is understood within the conformity of those principles, laws, and mathematics. One can't wish it so and therefore make it so, not in natural science. To wish the cost of capital to change does not make it happen. In the pursuance of changing the cost of capital, gravity would have to change, the unit of energy necessary to overcome resistance would need to change, and the properties of the mass moved would also have to change.

A first principle in economics, the natural science view of economics in this work is electrical generation+fuel burned (1−Fₜₐₓ−F_{government debt}−F_{cost of unemployment})−μmg α ma where m=the number of ownership entities multiplied by “a”, where “a” equals the change in the transaction rate divided by the change in time. It means energy must be applied to do something and the something done must follow the rules of how the universe operates.

There is capital and the cost of capital. Capital is mass in a physical form and resists being accelerated. The object of study being accelerated in the analogy of physics to economics is the properties of the economic system which are the ownership entities to be accelerated where something physical still occurs. The acceleration of mass is not entirely an analogy in economics because mass is a measure of resistance to acceleration and inversely proportional to acceleration. Moving mass from rest or accelerating it follows the laws of physics. The mining, shipping, and processing of the iron ore is physics. The iron ore is the capital, and in natural science the capital is mass, which resists acceleration. It takes real energy to move that which resists acceleration. The common present definition of capital is, “wealth in money and material owned” which is different from interpreting capital as mass or an object as a system. Mass is a quantity, and in economics money could be the unit of measure. This work realizes the value of money is inconsistent. The dollar amount of iron ore is a quantity with a unit measure. In natural science iron ore is typically measured in kilograms. Kilograms are consistent. Still, even when valued in money, the meaning of the natural resource which is accelerated is an input of energy problem.

Capital as mass or an object of study means it has a cost in energy (to use the energy) in order to be delivered for production. Physical resources must be accelerated to be transported. Even human capital has an energy cost. An energy cost means energy is necessary to cause its availability. The cost of capital is subject to gravity and friction, and it costs energy to move it a distance in an interval of time. Assume natural resources are at rest. What does it cost, not for the mass itself, but to deliver the mass? To move an object from rest requires force. Mass offers resistance to its change in acceleration. To be moved from rest is acceleration. A net force is needed to accelerate mass. The more mass moved the greater the net force requirement. Force could be applied in an attempt to accelerate, but if the mass does not move, then the net force would be net zero. A positive net force is necessary to cause the object to move. Work cannot occur unless the mass moves a distance in time. An accounting scheme, no matter how clever, is not energy. Accounting schemes cannot alter the required input of applied force to move resources (mass) to production. Only energy as force push interacting with mass can cause acceleration. Only energy can enable the iron ore to be delivered to the back door of the factory. Energy is the ability to do work. Natural resources cannot be produced without energy. Any movement of natural resources requires the application of energy. Delivering capital is accomplished by the use of energy and energy has a cost. This means there cannot be a zero cost of capital. Energy cannot be generated by accounting schemes.

Capitalism requires ownership of resources accelerated by energy to enable wealth. When free people transact a raw material with a processed good assumed at a profit then wealth occurs. Capital is the mass delivered and is owned by a free people. Mass delivered is a universal necessity for production to occur. The idea of capital being viewed as either favorable or unfavorable is to say iron ore is good or bad. To have an economy, elements are moved from their natural state or position to a change. Capital is the physical entity which has value. Saying capitalism is bad is like saying elements moved from their natural state, a distance over time is bad. Phraseology condemning capitalism and private ownership is a word game used to gain control of free people. Without capital there cannot be a value generated.

The unit cost of capital on earth is the friction coefficient (μ) multiplied by gravity (g) and friction and gravity are force drag. Work divided by distance=μmg (the friction coefficient multiplied by mass multiplied by gravity) and work divided by mass multiplied by distance equals μg. The unit cost of capital is μg (the friction coefficient multiplied by gravity), because the concept of the cost is a usage of energy which is resisted by counterforce to force push. Capital contributes to the force drag of the economy. This means applied force is reduced by μg because energy is required to accelerate and energy is not free of cost to generate. Neither can the expense of energy generation be manipulated by accounting tricks. To accelerate the mass is to cause work to occur, and one must generate a net force derived from energy to do so. Every country and every position on earth must apply net force to overcome μmg. The Russians pay μmg, the Chinese pay μmg, and Americans pay μmg to deliver the natural resources. The total cost of capital would include the capital itself (mass), making the total cost of capital μmg. The μmg is a natural counter-force (force drag) to force push. For an economy to grow there must be acceleration of the economy which is the ownership entity of a free people. The resources used to produce and how the resources came to be available is the subject of capital. Capital is acquired by the application of force derived from energy and there is very little room to manipulate its value.

Additionally, the cost (energy used to cause a change in acceleration) of capital is a negative in that it is an expense which is added to by the additional negatives of governmental policy which determines taxation, the cost of government debt and the cost of paying for unemployment. The total cost of capital is (1) the capital itself, plus (2) then energy needed to alter resources from a natural state to a usable form of capital and (3) additional energy is needed to overcome the expense of governmental policy. Governmental policies include taxation, the cost of government debt, and the cost of paying the population not to work. A society can only be as wealthy as its force push less the counterforces−force drag relative to its size (resources and population), assuming maximum personal freedom and the assumption of spontaneous behavior acting for the betterment. It also costs energy to put iron ore back into the ground, but there is an assumption people will not act against their own self-interest. However, historically, societies have destroyed themselves by their own policies.

The cost of capital is a counterforce to force push which lessens applied force, along with the counterforce of governmental policy. It is the acceleration of the economy which is the cause of change, it is caused by the input of the summation of force. To say the cost of capital is free is to say iron ore can be mined, shipped, and melted without energy and the iron ore itself is worthless. Artificial, (not market determined) unnaturally low interest rates cannot be a correct solution to increase wealth because the real cost of energy is omitted. Repricing the cost of capital by the authority of the government does not absolve society from coming up with the necessary energy to accelerate the economy. Artificial cost of capital policies simply cause prices to increase via the depletion of stored wealth because the currency going into the economy is cheapened. Energy in=energy out and to change the economic output first requires a change to the economic input. Unless the input increases the output cannot increase. To become wealthier is to increase the summation of the force as the input, because the cause in the occurrence order of physics comes first. Repricing energy does not affect energy; the price of gold does not affect its kilograms. Repricing is an alteration of a measurement such as changing an inch to something smaller, such as a half inch, but the physical distance remains regardless of the measurement technique.

Capitalism in natural science is a free people who have the right to own property and transact for a profit contingent upon the summation of force being sufficient to generate wealth.

The cause of a real change in wealth is the change in net force; not cheating on artificial financial measures. To make the house bigger in physics requires more building material, not altering the meaning of an inch. The total cost of capital is (μmg) friction multiplied by gravity multiplied by mass making the cost real and not subject to being altered without causing a equal reaction somewhere else, which means a price increase somewhere else. Therefore (μmg)(friction mass gravity) is the reactionary counterforce, and is not man made. A counterforce reduces applied force. The expense (counterforce) cannot be avoided or manipulated in any way. On earth (μmg) is a counterforce, no discounts are allowed. Look at food prices before the government stimulus in 2007, and look at food prices in 2014. What is observed? Artificially changing measurements in one place simply causes an increase in pricing in some other place. The physics view used to truly, become wealthier as a nation and also as an individual can only occur by an increase in the summation of force, by either generating more energy as an increase in applied force, or reduce the counterforces of government policy, or by doing both. Individuals can become wealthier by altering the measures for distance and time relative to their particular transaction, but this occurs at a loss to others. Nations become wealthier by maximizing force net and not altering measurements, which is how to make everyone wealthier.

### Chapter XII

### Acceleration—How We Change

The purpose of this work is to explain how to increase the aggregate wealth of the Unites States of America, as inclusively as possible, where the average employed person becomes one and a half to two times richer—more than his or her current position. The target expected increase of the total economy is to grow, (accelerate), at approximately a 9% annualized growth rate for eight consecutive years using the current gross domestic product as a starting point while correcting how the GDP is calculated. As an example, the current design of the GDP calculation should be adjusted to exclude government spending, because government spending is a negative event. At present the total GDP includes government spending, which is incorrect because government spending is a subtraction from production and individual wealth. An individual would not borrow money and say the borrowed money makes her wealthy. The government cannot borrow money and say America is wealthy by the amount of the borrowed money, which it does now (2016). Debt is a negative event regardless if the debt is paid back, because stored wealth is depleted by debt in multiple ways. The method used to generate the increase in growth (acceleration) is applying the concepts of natural science, narrowed to the formula and disciplines of physics as defined in physical laws and principles. The methods of physics are used in an analogy to understand economics and to calculate initial and future positions.

To become wealthier in less time than the historical norm, and faster than the global competition can accomplish, means a change in speed with direction from the current economy to a faster moving change. To become wealthier is to change the speed of the economy relative to whatever the current speed is and that means acceleration must occur. Moving faster is accelerating and becoming wealthier as a nation means accelerating. Both the cause and effect need to be understood in economics in order to enable a change to occur by intent.

Speed is distance divided by time, distance/time, or d/t. How far did the object go and how long did it take. In physics plus and minus are used to indicate forward or backwards on a line. Velocity is motion with a direction. Both speed and velocity are distance divided by time but velocity has with direction. Acceleration also has direction and to define acceleration velocity is used. To become wealthier also has direction, which is a positive because the assumption is not to purposefully become poorer.

Velocity (→d/t) must change from however fast something, (the object of study), was going at the starting point to going faster and if the acceleration continues over time than the acceleration is to go faster and faster and further, and further. Acceleration is the change in velocity divided by the change in time (Δv/Δt) because the idea of acceleration is to change how fast the object was going either if the object was initially at rest or was already in motion. Becoming wealthier requires a change in velocity divided by a change in time.

Newton's second law of motion is the summation of force (force net) acts upon the object of study and accelerates it. The (force push−counterforce)−force drag is the net force, the summation of force and this force interacts with the mass or object of study, causing an effect upon the mass (a change in behavior) which is a change of the velocity (the mass goes faster), where the mass will transverse distance in some amount of time. The formula for Newton's second law is Σf=ma, the summation of force equals mass multiplied by acceleration. Force is necessary to cause the mass to change its velocity, Σf=m(Δv/Δt). The economics analogy is using physics to apply the same reasoning to cause a change in wealth (assuming an increase in wealth is desirable) which is to increase velocity resulting in an increase in kinetic energy which is how wealth increases.

To gain, to improve, to increase, to make more, for humanity to progress toward the general betterment, and for the Unites States of America to become wealthier, and stronger, to enable opportunity for the young to have careers and well-paying jobs, means from a physics point of view to accelerate. To gain means to change from the present velocity (velocity initial), to a new velocity (velocity final), where the new velocity increased. The new velocity occurred because it was caused to change by a net force.

For the change to occur, something must accelerate the object. The “something” is energy applied as a force makes the object go faster. The force net than accelerates the object of study's speed and in economics the net force accelerates the economy's speed.

To increase speed is to accelerate. To make the Unites States of America wealthier by intent, by design, is to accelerate the generation of wealth by making the economy as the object of study go faster. To go faster is to change the speed or to change velocity; a change in velocity is written as Δv. Also, to change velocity takes time to do so, and the change in velocity occurs in a change in time. A change in time is written as, Δt.

The answer in physics to make the Unites States of America wealthier in time means to accelerate the economy, which is a change in velocity divided by a change in time as (Δv/Δt)=acceleration.

How does acceleration work? There must be a grasp of the process of acceleration to understand how to make the Unites States of America richer (accelerate) over time.

### Acceleration

There is the object of study.

The object of study is the something to be made to go faster.

In physics the object has mass (that which resists force).

In economics the object of study is the economy which can be quantified by the number or wealth of the ownership entities of a free people.

People must be free to transact in their own best interest as a necessary condition of the economy.

The economy has an initial position as its starting point which likely already has velocity.

The physics method of reasoning is to measure the change in speed of the object of study as an effect from being acted upon by force.

In economics ownership entities of free people is the economy which is to be accelerated, where the object of study as the properties of the economic system.

The speed of the object is going to change and in economics the ownership changes as a transaction.

The position is designated as “x”.

A change in the position is the change in x=Δx.

Speed=distance/time=d/t.

Velocity=distance/time=d/t→speed with direction.

Velocity=the change in x divided by the change in time.

Velocity means x moved from the initial position of x to a final position of x and did so from an initial time to a final time.

Velocity=v=x_{final}−xᵢₙᵢₜᵢₐₗ/x_{final}−timeᵢₙᵢₜᵢₐₗ=d/t.

Acceleration is the change in the velocity of the object of study in the change in time (Δv/Δt).

The definition of acceleration=Δv/Δt.

a=Δ(x_{f}−xᵢ)/Δt/Δt.

a=ΔΔx/Δt/Δt=Δ² (x)/(Δt)².

a=Δv/Δt.

a=Δ²(x)/(Δt)²=the change in the change (Δ²) of x.

Than to make the Unites States of America wealthier involves, in economics, a change in the velocity of ownership entities divided by the change in time due to the cause of a forward (+) force net.

Forceₙₑₜ→interacts with the object of study multiplied by acceleration which is Newton's second law as.

Newton's second law is Σf=ma.

Then to make the Unites States of America wealthier involves a change in the summation of force first (ΔΣf).

The only way to increase the summation of force is to increase the generation of electricity plus fuel burned as a force push, or reduce counterforces to the force push or both increase the force push and simultaneously reduce the counterforces.

The economy must be accelerated to increase wealth. To accelerate the economy is to change the transaction rate in a change in time.

In economics, what is being accelerated? The economy is being accelerated by the evidence of the change in velocity which is the change in the transaction rate in a change in time.
ow=ownership.
Δow=Δownership=a change in ownership.
Δt=a change in time.
v=velocity=Δow/Δt=Δownership/Δtime.
a=Δv/Δt.
Acceleration (a)=a change in the change of ownership/a change in time/a change in time=Δ(Δownership)/Δt/Δt=Δ² (ownership)/(Δt)².
The change in ownership is a transaction.
Velocity equals the transaction rate.
acceleration is =Δv/Δt=Δ(transaction rate)/Δt=Δ(transaction/Δt)/Δt
Therefore the summation of force=the object of study economy multiplied by a Δ(transaction rate)/Δt as the analogy to (Σf=ma).

A change in the summation of force can only occur from a transfer of energy (ΔE), or a reduction in the counterforces which increase the force net, or both increasing energy as an input and simultaneously decreasing the counterforces to force push.

In physics the summation of force equals ma (Σf=ma). In the economics analogy to physics the summation of force is proportional to (α) the economy multiplied by the change in the transaction rate divided by the change in time.

Going back to the physics analogy of economics where electricty+fuel burned (1−fₜₐₓ−f_{government debt}−f_{cost of unemployment})−μmg α the number of ownership entities multiplied by the change in the transaction rate divided by the change in time which means there must be an input of a summation of force to cause change. This formula is saying that an increase in production and consumption of energy in an economy leads to an increase in wealth unless stopped by counterforces. However, since the cause and effect are in different units (α) replaces the equal sign (=) to indicate that more energy production and consumption is directly proportional to more wealth. Than Fₚ (1−fₜ−f_{gd}−fᵤₑ)−μmg α the number of ownership entities Δ(transaction rate)/Δt. For ease of explanation the equal sign can also be used.

The acceleration in economics is the change in ownership rate (transaction assumed for a profit) divided by the change in time, Δ(transaction rate/Δt). The Δ(transaction rate/Δt) occurs by the number of ownership entities being accelerated and moving faster. The mass multiplied by acceleration side of the equation of Newton's second Law Σf=ma is the effect side. The Σf is the cause side. Mass in motion has kinetic energy. The change in energy causes the change in kinetic energy by accelerating the mass. The motion could not happen in the first place unless caused by the summation of force. The cause and effect of the economic analogy is the summation of force is a to the economic system multiplied by acceleration and in a time interval demonstrates an increase in kinetic energy as evidenced by the change in velocity. The physics to economics model is stating the increase in kinetic energy is proportional to the output as the change in wealth.

In economics the wealth in general of a society is closely matched to kilowatts generated plus fuel burned, where the force push is essentially electricity generated plus fuel burned. Always keep in mind; the cost of the energy generated must be equal to or less than the cost of energy globally. It is fundamental to understand that acceleration is derived from the cause of force net. This does not work backward. More transactions cannot generate electricity and fuel burned. The force occurs first from energy, which is applied and causes the effect of acceleration, secondly. The equal sign in the equation does not mean there is a time occurrence; it is simply for calculation purposes. The same is for the proportional sign (α). The force interacts with the mass and accelerates it instantaneously and it takes time for the velocity to increase. When the velocity increases over a time interval distance occurs and it demonstrates the change in kinetic energy. Without the force net the acceleration cannot occur, even if one wishes otherwise.

Becoming wealthier as a nation while also including the free people of the nation to participate means increasing the summation of force. The summation of force is (force push−counterforces)−(force drag) and so either decreasing the counterforces or increasing force push, or both is the physics process which is necessary to increase wealth as wealth as defined by the ability to consume. Wealth is (w) where wealth is proportional to kinetic energy (wα ½ mv²). The summation of force accelerates by moving mass and only energy can accelerate mass outside of its natural state. Although a kilowatt cannot be exactly translated to a dollar, through observation more kilowatts cause more wealth and wealth is measured in units of dollars.

An artificial attempt to become wealthier cannot succeed according to the discipline of physics, because physics follows laws and principles and a process of cause and effect. An artificial effort is a counterforce, or it is not force because force push comes from energy being applied as force push. Artificial money is not energy. It is actually a negative because it opposes the generational wealth. To oppose force push is a counterforce. Any counterforce or force drag reduces force push, which lessens the summation of force (Σf). Lessening the summation of force must lessen the action upon the mass or object of study that is to be accelerated. If the force push is insufficient to accelerate the object of study, than nothing happens or no gains occur. Force net will always accelerate the object because force net means the force push must be greater than the counterforces to be a net force.

Printing money in any form cannot accelerate the economy. Stimulus of any kind cannot stimulate the economy. To alter the value of a dollar cannot accelerate the economy. Only net force derived from energy can stimulate a change. Acceleration is the physical manifestation of increasing wealth because the cause cannot be separated from the effect. The acceleration in economics occurs from free people who are free to own and engage in transacting faster at an assumed profit, which results in the increase of wealth. The cause enabling a change in the transaction rate in a change in time is from energy, not from money.

The service businesses cannot increase wealth. Service is a dependent subset of production. A service sector transaction transacts existing wealth (i.e., is a swap of existing goods), but does not generate new wealth. Energy input into the economy is mostly being transferred to the generation of goods. A transaction involving a good is the transference of electricity plus fuel burned to wealth. Service transactions swap existing goods or service and this transacts existing stored energy. Stored energy is internal to the system. The pilgrims could not increase their wealth swapping goods, which they brought with them. Generating new wealth can only be derived from force net, or the summation of force. The pilgrims could not sell insurance to gain wealth at their initial arrival. There must be an external change in the net force as a cause to effect an increase of wealth. Service businesses are not a net force, therefore they cannot increase wealth. Trading internally within a system does not allow an increase in output unless the system decreases where the decrease would equal the output and further decrease due to energy lost due to friction.

The desire to improve the economy in the physics to economics analogy (PEM) is to increase the effect by increasing the cause first. Only energy can cause a change. Mistakenly, current economic thinking seeks the desired effect without consideration of what is necessary to cause the effect; to stimulate demand is impossible because demand can only be met by the application of force derived from energy. This is a social science blunder. The occurrence order in physics of cause and effect is the cause comes first and the effect comes second, and this is not reversible in a practical sense. An attempt to alter the effect without first applying force derived from energy is quite impossible. Therefore, an attempt to stimulate demand is equally impossible because demand is consummated by a transaction. Transactions are velocity and the change in velocity is an effect caused by the summation of force. Velocity cannot be stimulated unless from the cause of the summation of force. To become wealthier is to increase the input first, which is an increase of electricity generated+fuel burned and/or lessening taxation, government debt, and the cost of unemployment. Inefficient policy wastes far more energy than any other single event. Efficient capitalism feeds the people with the least energy used. High taxation, government debt, and high unemployment wastes energy.

Increasing employment, both in number and in compensation, is an energy effect. A job is an indirect effect from energy occurring secondly in the order of occurrence. Then to endeavor to increase the number of jobs and increase pay is a cause and effect problem. To change employment requires a change in the summation of force first. The summation of force is the cause which allows the energy from the input to be transferred to work being done. The economy can only be accelerated by increasing the summation of force or lessening the counterforces or by both increasing the force net and decreasing inefficient government policy. To become wealthier is a result of an input of the summation of force when the change in wealth is resultant output.

### Chapter XIII

### The Counterforces to Economic Growth from the Natural Science First Principle of Economics View

Increasing wealth results in the betterment of humanity based on the assumption humanity spontaneously moves toward greater invention and individual freedom. As history has observed, the increase in wealth enables an increase in what is good, better health, longer life span, time available for leisure, personal freedom, capacity for invention, and general prosperity. In the natural science reasoning methodology, this means energy using force to act upon the object of study, accelerating the object distance in time, and assuming with direction (vector) is an effect from the cause derived from energy. Newton's second law of motion is Σf=ma. The summation of force (Σf) is [force push−counterforces]. When it is positive, it is sufficient to accelerate mass, or the object of study, in a forward direction which means there is a change in the velocity (Δv) divided by a change in time (Δv/Δt). The net force or summation of force is both a push force and a force drag which is force push minus the counter forces that equals the net force used to accelerate the object. The net force is the cause, and the acceleration of the object is the effect measured by the change in velocity. In order to become wealthier the force net must increase as the change which causes the change in wealth.

Keep in mind the objective is to increase the wealth of the Unites States of America in aggregate, making the nation wealthier relative to the starting point. It is possible, in fact it is being implemented at present, where there is a shrinkage of the total economy (lessen aggregate wealth) coupled with increase stock prices. This is accomplished by closing competing bond markets and printing large amounts of unearned currency in the range of 15 to 20% of the total economy per year. A shrinking America is masked by an increasing stock market. That is observed by the present global market share of the Unites States of America declining to only 16%, which is lower than previous years. Fewer and fewer goods are made here and this loss of production capacity has allowed China to become the largest economy as of late 2014. Yet the American stock market still goes up. The stock market is not the economy. More on this subject in later chapters.

To cause America to become wealthier in total, relative to the global market share measure requires the summation of force to increase.

Becoming wealthier can be from either an increase in force push or a decrease in the counterforces, or both which results in an increase in net force. This chapter focuses on the reduction of the counterforces, which impede the increase of motion or speed which in turn will impede the increase in wealth. The natural force drag due to gravity and or friction cannot be easily altered, and so it is more effective to focus on reducing the counterforces to economic growth which are derived from governmental policy. The force of friction is proportional to acceleration due to gravity and this problem is fixed by gravity.

A counterforce causes the same reaction as drag force and opposes the direction of motion. Counterforces to motion are not within the body of knowledge of social science, making social science a poor methodology as a choice of process to use as a construct to increase wealth.

A counterforce is that which acts in a direction opposite to the force push and as a consequence reduces the effect of force push. Net force is force push minus counterforces. The less counterforces there are, the greater the effect the force push will be. The economics analogy to physics is force push equals electricity generated plus fuel burned. The concept of multiple forces acting on a single body is the fundamental principal of Newton's view regarding how the physical world operates. Prior to Newton (1640) the ancient Greek view of motion was that applied forces naturally dissipate over time. The Greeks observed an arrow shot, will first fly, then slow, then fall, then stop. They concluded the force push of the bow upon the arrow dissipated, becoming less and less force overtime and causing the arrow to slow over time and finally stop. Seven hundred years later, Galileo postulated the shot arrow was subject to multiple forces. This was the correct answer, but Galileo did not have an equation. Newton said the arrow shot would fly and move indefinitely until acted upon by counterforces. That means the energy in the flexed bow acted upon the arrow via the force of the bow string. The force push of the bow was immediately counteracted upon by counterforces and the net force accelerated the arrow. The arrow in motion is acted upon by counterforces which cause it to slow and stop. Newton's concept of nature as force and counterforce has allowed the machine age of the modern era to exist (1640-present (2016)).

The force push is opposed by counterforce. The summation of force concept is where force push minus counterforces totaling a force net as a summation of force is the revelation of the modern world. Counterforces are the significant reasons which are preventing the Unites States of America from obtaining an increase in wealth over time.

Force push is lessened by counterforces and the result is a net force. Force push comes from energy, and counterforces oppose the force push. Force push minus the counterforces is a force net which acts upon the object of study or the economy. When the net force is positive the object of study will accelerate which is the effect from the cause. In the analogy of physics to economics, the counterforces are the expense incurred by the owners due to government policy which causes fewer and fewer transactions, from loss of production, resulting in less wealth. The energy generated by electrical power plants plus the energy generated from fuel burned is energy available for production and the generation of wealth. Dollars spent not on production are counter to force push.

The cause part of the (PEM) equation is force push (Fp), where Fp is multiplied by (1−factor of government expense of greater than zero to less than 1 (0<1)) or 0<factor<1.

If force push generates $10 of production capability with a 40% tax rate for example (10(1−0.6)=10×0.6=$6, the net output is $6. The original input of $10 is reduced 40% to $6.

The 40% corporate tax or income tax per year (rate is time) reduces the $10 in energy generation available for production to a lower amount, of $6 due to taxation. Taxation is a factor (f) in the reduction of force push. As a reduction to the change in acceleration as the factor of taxation is (fₜ) and results in less. Taxation only exists because there is force push first. Taxation opposes force push by lessening it to a net force. Taxation is counter to (acts opposed to force push) the ability of force push to accelerate the object of study, which is the economic system. Taxation lessens net force as (force push minus taxation as of factor equals less force push). Wealth is an effect from net force. The less, or fewer, the counterforces the greater the net effect will be upon wealth generation. Accelerating the ownership entities means increasing their transaction rate which enables wealth to increase. Anything that lessens the transaction rate lessens wealth. Counterforces specifically lessen transactions in time. The primary thesis is force push equals electricity generated plus fuel burned increases the transaction rate and in time there is an increase in wealth which is proportional to the net force.

To move a stagnant (no growth) economy to a growing economy means something must change. What changes is speed. A change in speed is acceleration and acceleration can only change when there is first a change in the input as a change in net force. Acceleration results from the increaser of the summation of force (ΔΣf) from the initial force which pushed the zero growth or constant speed economy. The economic summation of the force is the net result of force push less the factors of government policy and less the natural forces of nature.

Taxation is a reactionary counterforce which is proportional to net force and reduces the generation of wealth. Force push from the generation of electricity plus fuel burned is the primary cause of wealth being generated. Taxation works in the opposite direction of force push. Wealth is the ability to do. It is the ability to consume. To have the ability to do something can only be derived from energy which is true in physics as well as in economics. The thesis is not proved by applying the analogy of physics to economics. It is observed that economic growth increases when the cost of government decreases. The truth of how economics operates is from observation. The summation of force is the net force after taxes are deducted. As energy consumption and production increase so do taxes, which makes taxation like a counter reactionary force proportional to force push. Taxation alone cannot cause force push. Taxation can only occur if force push is present first. Therefore taxation cannot increase wealth.

Taxation is a counterforce to wealth that is proportional to force push. Generating electricity and fuel burned is not an analogy to physics because it is an actual force push. The analogy of physics to economics is what happens to the force push when it acts upon the economy. Taxation is not physics, however taxation as a counterforce to force push is an analogy based on the reasoning of physics. In physics certain types of counterforces are proportional to force push. The reactionary counterforce can only exist when there is an applied force present first. Take away the applied forces, and the reaction cannot exist. However, take away the reactionary counterforce, and the applied force remains. A system could be taxed without applied force which would deplete it assuming there is stored wealth. The pilgrims could not be taxed upon their initial landing because they did not have stored wealth. If the energy input remained constant and taxes increases the result would be a declining economy. When the system of the economy is accelerated it is observed by a change in the transaction rate and is due to the change in the applied force external to the system. Force net is outside the system, and in order to change the system, the force net must come from outside as a change in net force to change the output of the economy to an increase. This also means taxation is outside the system, or taxation is not part of the system. Energy→applied force→force push (counterforces of taxation, which are a reaction and a factor of proportionality opposed to force push can only exist because of the force push from the applied force occurred). The force push is minus taxation which equals economic net force. The net force is less than the force push because of taxation. If there were not any economic activity then there could not be any taxation making taxation a proportional counterforce. As an example of an economy with a velocity of zero, (v0), the pilgrims could not be taxed without making them poorer.

The equation is electricity generated plus fuel burned (1 minus the factor of taxation minus the factor of government debt minus the factor of the cost of unemployment) minus the coefficient of friction multiplied by mass multiplied by gravity equals force net or the summation of force (fp(1−fₜ−f_{gd}−fₑ)−μmg=fₙ or Σf) where the factors reduce force push because they are counterforces. The reduction of the effect of energy generated is the net force, or the Σf=Fp (1−0<factor of taxation>1). The summation of force to generate wealth in an economy is energy which applies force, less the counterforces equals the summation of force (economic) as the summation of force in the economic analogy.

Various types of counterforces and force drag can react to force push differently. Counterforces can be a direct response or some proportionality to force push or the counterforce can be independent. Additionally, an economic counterforce can have its own force counter acting upon force push. Taxation is a proportional counterforce, as the force push increases, or decreases, the ability to tax increases or decreases relative to the force push in a practical sense.

Government debt is another counterforce to the generation of wealth. Government debt repayment expense of both principal and interest increases in value in time, due to interest, which compounds the counterforce in excess of the original amount borrowed. Government debt is a multiple counterforce of principal plus interest payments. For ease of handling government debt will be illustrated as a proportional factor to force push. Note what interest is; interest is taken from the gain from production, where production is derived from the force net or the summation of force. To pay interest is to pay from the ownership entity what was gained from production. Interest payments on government debt are a counterforce to wealth. This means government debt (government bonds) are a double counterforce, but the formula treats it as a single event. This point is confused by modern finance which is discussed in chapter sixteen. Paying back the principle and interest of government debt decreases force push and therefore decreases production. Counterforces act to decrease wealth.

The cost of unemployment is also a proportional counterforce opposing force push and is outside the system. All government expenses are counterforces. Some governmental policy expenses are necessary, but most are not. Taxation is necessary, but neither in the magnitude or method it is collected. Unemployment costs can be entirely eliminated by being more efficient, enabling 100% employment, and Government debt is also completely unnecessary, and is imply mismanagement. Each of these factors, taxation, government debt, and the cost of unemployment individually can cancel or reduce the ability of force push to generate more wealth. This is the problem of modern day Europe. The counterforces of taxation, government debt, and the cost of unemployment exceed the force push, making force push net zero so that no gain is possible.

Newton's second law is Σf=ma. One unit of force is one Newton. The unit is equivalent to 1 kg m/s². A Newton of force is required to give a mass of one kilogram (1 kg) an acceleration of one meter per second squared (m/s²). One Newton is 1 kg m/s².

The summation of force is force push less the counterforces.

In the economics analogy the summation of force of electricity plus fuel burned is lessened by factors of taxation, government debt, and the cost of unemployment. In addition the force push is lessened by the natural counterforce of friction due to gravity. This means the net force from the input of energy from electricity plus fuel burned is reduced by both natural and governmental policy counterforces. The summation of force (economics) is equal or is proportional to the ownership entities (the object) multiplied by the change in the transaction rate divided by the change in time. Of course there are many other lesser counterforces which should also be eliminated to increase net force which in turn increases the output of the increase of aggregate wealth.

The counterforces are the factors (f) noted by factors of taxation (fₜ), factors of the cost of government debt (f_{gd}), and factors of the cost of unemployment (fₑ) where the value of the factor is greater than zero and less than one, (0<factor>1).

The formula in the analogy of physics to economics is electricity+fuel burned (1−fₜ−f_{gd}−fₑ)−umg α number of ownership entities multiplied by the change in the ownership rate divided by the change in time. The μmg is the counterforce due to the natural environment as friction due to the force of gravity, which is proportional to the magnitude of the mass. It takes more energy to move a big economy relative to a small economy.

The counterforces of government policies are the factors of taxation, government debt, and the expenses to pay for unemployment, (fₜ−f_{gd}−fₑ).

Policy has the capacity to negate any amount of force push regardless of how large the force push is. A policy is a counterforce and any counterforce reduces force push along with the force drag from natural forces. In physics, anything which causes a reduction in force push must decrease the outcome as an effect, and the outcome in economics is wealth. Reducing force push by counterforce reduces wealth. A bullet shot into water will only travel one meter at high velocity versus the same bullet shot through the air will travel miles. It is the difference of the counterforce of water versus the air which reduces the force push.

The formula for the analogy of physics to economics is as follows:

### Long Version

Electricity+Fuel Burned (1−factor_{tax (0>1)}−factor_{gov. debt (0>1)}−factor_{cost of unemployment (0>1)})−friction (μ) mass (m) gravity (g) a number of ownership entities Δ(transaction rate/Δtime)

### Short Version

Fpush(1−Fₜ−F_{gd}−Fₑ)=μmg=number of ownership entities (Δ(ownerhip rate/Δt)

Which is the same reasoning as Newton's second law of motion:

(Σf=ma).

To become wealthier as a nation and as an individual requires a cause and effect that conforms to the principles of natural law. As ore which can be measured in kilograms is shipped a distance in time, there is energy applied to enable acceleration of the ore. Energy is calculated in a unit of a Joule in kilograms multiplied by distance in meters divided by time in seconds squared multiplied by distance written as Joule in units as J=Kg (m²/s²) or a unit of force multiplied by distance. Then a change in wealth in physics is a result and proportional to a change in energy as an input applied as a force push lessened by counterforces to a net force. As long as there is net force the object will accelerate. It is a law of physics where, mechanical energy in, equals mechanical energy out. What impedes energy (counterforce) will equally impede energy out and the energy out is directly proportional to wealth out because wealth is the effect from the cause of the summation of forces as the input. Wealth is an effect that occurs from a cause. The summation of force causes the effect of wealth in some proportion; ΔΣf α Δwealth.

The disagreements in the endless, fruitless, circle of debate, resulting in a lack of performance of the American economy, is currently due to defining economics in social science terms as opposed to applying natural science. The failure is based on the failure of methods. The methods of social science are not cause-and-effect methods under the principles and disciplines of physical law derived from truths. Social science cannot explain how an economy increases wealth, because social science lacks a deterministic process to increase wealth. How can it be increased if no one knows what it is?

Mathematical physics and other fields of study in natural law are methods precisely formulated to understand a change in position (position final minus position initial) and how and why a change can result in acceleration. To become wealthier is to increase the summation of force which accelerates the ownership entities observed by a change in the transaction rate divided by the change in time. The change in velocity is the change in kinetic energy which is proportional to the change in wealth. Energy is a form of wealth in the analogy of physics to economics. Energy as an input is transferred to wealth as an output.

Consider the physics view of government debt. The Unites States of America is 138% in debt (2016), caused by government policy (this is exclusive of individual and state debt). Being 138% in debt means the total debt owed is more than equal to the total GDP. The debt owed is similar to the value of eight Russia's. For America's economy to progress it must first, by domestic producers manufacture stuff equal to eight times the value of Russia's GDP without compensation to workers to pay off the debt. All the energy used to do this is completely wasted. America's true value is equal to America minus eight Russia's minus friction. How much energy, distance, and time must occur to dig up, ship, melt, then design it into a product and sell products made of 80 billion tons of iron ore as a tangible event relative to eight Russia's, just to pay back a debt where no gain occurred? While working without compensation. Whatever the answer is, it means it will have to be done for zero compensation because paying off debt is done without compensation to workers. To pay people to move mass in order to pay back government debt reduces the assets available for production. The Unites States of America's debt is 80 billion tons of ore in debt, which must be processed into product for free in order to pay the debt. This does not include interest. A $100,000 house purchased with a mortgage of $100,000 for 30 years at 3.7% interest costs the borrower two times the original debt or 2×$100,000=$200,000. The repayment of the government debt over the next 30 years will be 2 multiplied by 80 billion tons of iron ore 160 billion tons) (or 16 Russia's) to be processed for free on the backs of those who must toil to pay it off. Who thinks this is a good idea?

The reasoning process of physics immediately concludes the best policy regarding government debt is zero government debt, on a permanent basis. Physics reasoning jumps to zero as the best policy because government debt in the laws of natural science, views debt as a counterforce.

Employment is not a counterforce; however, unemployment is a counterforce because it involves an expense if there is a payment to the unemployed. Employment could be viewed as a force push because a person has chemical energy. Human chemical energy built the pyramids, and people working is a force push. The physics conclusion is zero unemployment or 100% employment best enables the increase in wealth.

Taxation in any amount is a counterforce. It is impossible to have zero taxation, but the time spent on taxation can be zero and the amount of taxes can be locked down to 10% of the GDP (calculated correctly) and collected via another method where it is not collected from individuals nor corporations. The objective is to pay the expense of social orderliness in a method to minimize the counterforce to wealth. Wasted time is an economic counterforce when twenty five wasted days is 10% of total production in a year. American society certainly wastes twenty five days of time on the subject matter of taxation and this is a complete misuse of energy. From the green view, 10% of pollution is from the time wasted collecting taxes. The government can receive 10% of the GDP by taking from the banking flows with zero time spent collecting it; a win, win, that is a big gain to wealth.

Using natural science to interpret economics along with social science would create a significant gain to the wealth of the Unites States of America, easily causing a 9% like growth rate over eight years, enough to push the country's strength to a position of unchallenged superiority, a position commensurate to its resources.

What is being accelerated? In the analogy of physics to economics the economic system is the ownership entity of a free people is the object being accelerated. Acceleration equals the change in the transaction rate divided by the change in time. As more transactions occur more profit occurs. It is assumed free people would only engage in a profitable transaction. Acceleration is evidenced by a change in velocity which causes a change in kinetic energy. It is the change in kinetic energy which is proportional to the change in wealth. The only possible way to increase national wealth, which in turn enables individual wealth to increase, is a change in force net, or the change in summation of force (ΔΣf).

### Chapter XIV

### Government Debt Restated in the Natural Science View of Economics

The objective of this work is to explain how to increase the total wealth of the United States of America from its current position to an accelerated future position which generates more wealth than at the initial position based upon principles of natural science. In the analogy of physics to economics the cause is the summation of force accelerating the system which is the number of ownership entities multiplied by (acceleration) which is (the change in the transaction rate divided by the change in time).

A person cannot walk up to a steam engine when it is at rest and say, “move”. The engine will remain at rest and not obey a verbal command. Why does the steam engine refuse to obey a human's voice? The reason a person's voice is not strong enough to accelerate a two hundred ton steam engine is because the net force of the input (the voice) is zero.

What does have enough energy to move the locomotives? A ton of coal set on fire, consumed within the fire box heating the water in the water tank will accelerate the engine. The reason the burning coal moves the engine is because there is a net force. The applied force is a net force because the applied force is greater than the opposing forces. This means force push minus the counterforce equals a net force where the net force is greater than zero.

The applied force of force push (electricity+fuel burned), which is the force push allowing the generation of wealth is counteracted upon by taxes (there must be some, but not collected as an income tax), the cost of unemployment (can be completely eliminated by employment) and government-established debt (which can be zeroed out permanently). By lessening the counterforces to the generation of wealth the effect is an increase in wealth. This chapter focuses on government debt because it is particularly destructive to societal well-being and the general betterment of American society. Too much debt destroys nations (by observation).

Egypt spent its wealth building pyramids, which produced nothing. If they put the same amount of energy building an irrigation canal system to support its agriculture then they would not have been weakened as an empire. Rome's dominance followed Egypt, and it also failed due to internal financial mismanagement (too much debt). Germany's Weimar Republic failed due to debt and money printing. Germany's money printing lead to social chaos, which allowed Hitler to gain control of the political system. Present-day Japan began rapidly increasing its debt in the 1980's, and now they are 250% in debt and their stock market has not increased from 30 years ago. The observations are when any society becomes over burdened with debt which it cannot repay, the outcome results, in a mixture of various undesirable failures causing a manifestation of zero growth, shutting out the opportunities of the young, ruining the retirement plans of the old, and resulting in the inability to compete, inflation (the loss of stored wealth), the decline of general well-being of the quality of life, the loss of freedom, and the failure of a nation in all or in part due the counterforce of debt.

Debt in the natural science quantitative view, is a counterforce in the reasoning process of physics, which is a very different vision of government borrowing in the current view of social science. Social science practiced by some believes debt is a gain to society. Debt cannot be a gain because it obtains its ability to consume by taking from stored energy or stored wealth. Debt is not energy. Debt is using internal energy from the system therefore it depletes the system. It depletes the system by the debt itself, plus further depletion occurs from the interest owed and more energy is lost due to friction. Keep in mind, energy can be neither created nor destroyed. Matter can neither be created nor destroyed. This means for either debt or printed money to exist they must take their value from somewhere. Government debt takes away wealth (the ability to consume) from the people. Printed money must take away something from somewhere to exist. It is the people who are taken from. A dollar of government debt plus interest is not paid back by the government, it is paid back by the people. The debt plus interest is paid back by the people's labor. Which people? All people. The counterforces reduce everyone's wealth except for a few government overseers. Debt takes from the life savings of anyone who has saved. Debt steals wealth from the life savings of anyone who has worked. Free college tuition is not free because the tuition has to come from somewhere. It comes from the depletion of currency which depletes everyone's wealth. It damages the aggregate economy which damages the career opportunities who stole from the retirement savings of the average citizen. The rich will not be over taxed. They will simply avoid tax. They will corrupt the government to create a loophole, or fire workers to maintain the balance sheet, or move the assets into tax free muni bonds or go off shore. Unearned printed money decreases the stored wealth of the people, requiring additional labor to maintain their wealth. In the physics view, debt established by the government cannot serve any economic purpose because government debt can only decrease wealth and under no condition can government debt increase wealth. Debt is a counterforce to force push therefore lessening the generation of wealth. A negative can never cause a positive. There have been historical periods where economic growth was large enough and government debt small enough as to mask the negative effects of the debt. Government is excluded from any growth causing effect because it is derived from internally obtained stored wealth. Government debt lessened the capital available for production and therefore shrinks total wealth. A practical exception justifying government debt would be an unexpected military conflict or natural disaster which would exceed normal budgeting. Borrowing to finance a war or meteor strike (large) will still decrease aggregate wealth even though it was for a good cause. World War II is often cited as an example where debt succeeded in improving the American economy. However, our historical global competitors were in ruin as a consequence of the war enabling the United States of America an advantage for a while and the debt was paid back. This advantage was later squandered by bad post-war policy.

The principal of economics truth is debt is it is not a force push. It is a counterforce opposing force push plus there is an additional negative force due to interest payments making government debt a double decrease to the national wealth at a loss of the amount of the debt plus interest. Interest owed is a negative and it is compounded as a negative upon a negative. The energy consumed to pay off debt must equal the amount of the value of the debt, the value of the interest, plus the loss of energy due to friction. The primary function of government, such as the firemen, post office, and the military, etc. remain an expense and debt is an additional expense. In natural science the value of something cannot exist from nothing. Debt is nothing. Debt does not exist yet it can still be used to consume. Therefore debt derives its value from the stored wealth of the people. Debt is not energy generated as a force push yet debt has the capacity to act as a force push, but it is derived internally from the system. The energy to allow debt to act as a force push must come from somewhere. The existence of government debt comes from the people's stored wealth. Wealth cannot just be. For wealth to occur natural resources must be transformed from their natural state to an altered state by applied force. The physics to economics view is wealth is from electricity plus fuel burned and this force push is used to pay the principal and interest of the debt resulting in the fact that all the energy used to pay off the debt and interest was wasted because debt is unnecessary. Debt is energy owed. How much energy is necessary to pay off the debt, including interest plus friction due to activity? However much energy it takes is entirely wasted because the debt was never needed in the first place. Debt can be paid from internal energy, which means more debt is created to pay the existing debt: this is the current situation of the United States. This means the debt continues to increase causing the value of the assets owned by the people to continue to decrease.

There cannot be a perpetual machine in natural science because to move a molecule is to cause heat from friction, and heat is energy lost to a typically irreversible form. This means there are additional losses from borrowed debt for no other reason than friction due to gravity. In addition to the natural counterforces of gravity, and heat due to friction, there are also policy counterforces that must be overcome to pay off the debt. The same policies which result in counterforces to the general economy are also counterforces against the activity of whatever the debt was used for. A force net is always less than the initial applied force because counterforces reduce the applied force. Counterforces will always lessen force push. Energy enabling work to be done has counterforces plus experiences loss due to heat (friction). Energy input equals work out plus heat. This means the work out is only a fraction to the energy in. The change of work done will experience a conversion of energy from one form to another, and the conservation of energy is heat lost to an unusable form. The change of form of energy has a necessary loss. Only 40% of the energy of gasoline moves the car, the other 60% from the combustion is lost to heat. The same occurs when wealth consumes as a spending activity (wealth is applied as spending) the consumption will have experienced a conservation of energy when some energy changes form to a new form which is not useable such as heat. It takes an enormous amount of energy (electricity plus fuel burned) to pay off debt when the debt should not exist in the first place. Debt is political mismanagement. Much of the energy applied to pay off the debt is lost to heat and this results in an enormous amount of energy necessary to pay off debt, which is entirely wasted.

The irony is our own inefficient policies make it more difficult to pay off the debt. Debt being paid off is hampered by the existing debt, plus taxation, and plus the cost of unemployment. Think of all the energy eight Russia's would use (Russia's GDP is approximately one eighth of the United States GDP www.worldwork.org (Russia's GDP in billions of dollars) plus energy lost due to heat, plus energy used to counter act government policy. All of that energy dumped in a field and burned for no reason plus interest, is the true cost of our debt. The value of eight Russias is the cost of America's debt, assuming no interest, no new debt, and immediate repayment. The modern accounting system and modern finance fails completely to account for government debt.

To pay off the debt more energy is needed than what is equal to the value of the debt, plus more energy still to pay interest plus the counterforces of policy, which makes a gain from debt impossible, just as a perpetual machine is impossible. When energy in=energy out, there cannot be energy in=something greater to energy in. In addition to paying the value of the debt there is also the cost of the interest which compounds negatively. The $18 trillion of government debt (2016) at 3.7% interest will increase to $34 trillion in thirty years assuming no new debt is incurred, which is a weak assumption based upon historical behavior. Debt payments are a little different than mortgage payment, but not much different.

In natural science, in order to eliminate debt, energy must be obtained by generating enough electricity plus fuel burned to consume wealth equal to $34 trillion, and this use of energy provides zero betterment to humanity. How much oil will be burned to pay off $34 trillion and is this a good use, or best-practice use of global resources? The opposite of green is government debt. If global warming is true, than to be true demands conformity to the principles of physics. It takes energy to pay off debt, and the existence of debt is 100% unnecessary as a principle of the physics reasoning process. Those against global warning should equally be against government inefficiencies, particularly the inefficiencies of government debt. By eliminating government debt global warming is cut in half because the western world economies are over 100% debt at present. Wealth is the ability to consume. The government cannot take wealth from the people and turn around and apply the taken wealth and produce a net gain. Much of the wealth taken is lost in the process of taking it and more wealth is lost in reapplying it. This also implies the government would possess far superior skill at production than those professional producers would have. Global warming is due to the input of fuel burned energy (theory). Climate change is due to fuel burned than half of fuel burned is wasted on government debt. The current usage of generated energy by burning fuel must increase five times in the western world over the next few decades to do nothing more than pay off the national debt. If anyone truly believes the fuel burned to generate energy is a pollutant and will cause adverse effects on the earthly environment those people should seriously fight (non-violently) against the policies of government debt and money printing. Only a balanced budget is a green budget.

Wealth exists as the effect from energy and only the ability of wealth consumed enables the wealth to be used to pay both the principal and interest of government debt, which is the expenditure of wealth where the cause of the expenditure is the government debt. It takes energy to generate the wealth, and therefore to pay is to use energy. Government debt takes wealth from the people. The people's wealth is lessened by both the principal and interest payments on government debt plus friction.

Business debt (individual) is different because as a free person, there is a possibility to make a gain that exceeds the counter properties of debt. Business debt is part of the risk of the attempt to make a profit. However, government is not in business and cannot likely make a gain. An asset only exists because resources were transformed from a raw material to something processed. How can the government obtain an asset? The government must take the asset from the owner because the owner generated the asset first. There is a cost in taking an asset from an owner. When the asset is transferred from the owner to the government it is depleted in a variety of ways. The owner loses the opportunity to apply the asset to production. The average gain from production is 11% annually. A moved asset must be re-accounted for, re-banked, and placed under new management. A known concept in the investment world is the cost to apply private assets to a private investment partnership are 30%. Add the cost of borrowing, which is to pay banks both principle and interest, which is a compounding expense and the borrowed asset is almost entirely depleted to a few cents per dollar. Businesses have the skill to borrow and make a gain, but it is a very thin margin deal. Government has no such skill. This is why the government cannot take assets from private producers and attempt to reinvest it. No government debt would allow sufficient compensation or gain to cover the costs of taking assets from producers who have superior skills and giving the asset to those without skills. The government taking assets cannot increase aggregate national wealth. The government can only be an expense. Only a free market of free people can establish the information necessary to determine an accurate price (cost of energy needed to accelerate the object of study a distance in time). The government cannot possess the information of private ownership because it is not a private owner and cannot price a transaction. When a government cannot pay its bills, it counterfeits money, which takes the value out of people's banks savings or their stored labor. When Fannie Mae and Freddie failed the government printed money to fix the failure. Private individuals cannot counterfeit money to pay bills therefore they must have the transaction correctly priced as an efficient use of energy. Mispricing is accounted for as a waste of energy. The private market process determines the value of energy used for every activity existing on earth which changes by the second. It must because goods must be priced exactly to lower the input costs of energy necessary to produce ship and distribute to the best possible efficiency. This information only exists for those who live or die on its accuracy. Private business cannot print money when the price does not cover the cost.

Only force push being greater than the counterforce can generate wealth. A counterforce cannot generate more of anything; it can only reduce net force. At a given point, a reduction of the counterforces will result in an increase of the summation of force, which will result in greater wealth. The only way to increase wealth is to increase the summation of force.

Debt is a counterforce to force push. Debt is not part of the origin of energy, but it is a negative force because so much wealth is taken from production to pay the principal and interest of debt. The principal and interest are a loss of energy because the use of stored energy to enable debt to exist depletes wealth. For the United States of America to become wealthier and stay wealthy government debt must be permanently banned and 100% paid off immediately. There is a method to eliminate domestic American debt immediately (without a default) by transferring it into something else. The transformation of debt is not discussed in this work.

Government debt depletes the wealth of the people. It does not take from the rich; the reduction in wealth is mostly felt by everyone who earns a wage or receives welfare. Owners are least affected and wage earners are hurt the most. The reason wage earners are damaged is because they cannot control their individual transaction rate and they cannot pass on higher costs because their wage are generally fixed. Money printers hurt the wage earners because like debt printing money also depletes stored wealth. Printing unearned money lessens the wealth of the working class (better stated as the wage class), which is almost everyone. By the way, the rich hate money printing because it increases the price of domestically manufactured goods and services. The rich want America and everyone in it to become richer because it makes themselves richer.

There is not any future time concept in physics. In the formulas, mathematics and principles of physics, there is not any future energy place or any type of future place. Energy, the origin as the prime mover is in the present. It may sound unusual at first; however debt is sold to the public as something of the future. In the reasoning of physics is energy is of the present. There is no future in the physical world. Future sun rays cannot be used in the present. This means, in the truth of physics, debt is taking something from the present. Debt must come from somewhere, but it can't come from the future. Debt is to take from stored wealth in the present. There must be stored wealth such as women's bank accounts in order to enable borrowing to occur. This is why poor countries, societies, poor people, and the pilgrims, cannot borrow. To borrow is take stored wealth in the present. The International Monetary Fund is funded by American workers whose assets are taken from their stored wealth, and the money is borrowed by poor countries who will never (or are highly unlikely to) ever pay the loan back. Poor countries can't borrow because they do not have stored wealth. The wealth is taken from American and given to the borrowers and likely it is lost forever. This means the IMF depletes the wealth of the United States of America. The IMF depletes the value of American women's bank accounts.

Debt must be something. For debt to purchase a car means stored wealth was used. Nothing cannot move mass. Only energy using force to interact with the mass can move mass. For debt to be able to purchase something means the debt is something. Then something did purchase the car. Debt is a form of stored wealth. To apply debt for a purchase is to apply stored wealth. Stored wealth is depleted by the amount of debt plus there is an additional loss due to the cost of formulating the debt into useable form. If all cars were purchased by debt than the aggregate wealth of America would decline regardless of how many cars were sold. Non-energy is non-force and non-force cannot affect the velocity of mass outside of the natural state of the mass. The pilgrims could not use debt to solve their problems and neither can a poor country acquire debt, because debt is stored energy. Debt is the use of present stored wealth that is paid back with interest in the future. When loss of use of stored wealth occurs, the stored wealth must be replaced and there is a fee via interest paid to use the stored wealth, which depletes additional stored wealth.

Debt is not time, distance, mass, energy, motion, height, or force, and therefore it cannot be force push. Only externally generated energy can increase wealth. A society which decreases counterforces, keeping force push as a constant, means it would increase wealth because the summation of force will increase. Lessening counterforces enables net force to be greater if force push remains the same. A force push could be lessened if simultaneously the counterforces were relatively more lessened and the net forces could still increase. Environmentalism should pursue the physics to economics reasoning because it accomplishes the greatest wealth with the least fuel burned. It is easier to accelerate a 1,000 kilogram stone when the stone is on ice versus pavement. Pavement is a stronger counterforce than ice. Than a country decreasing debt will become wealthier as a reduction in government debt as it is reduction in counterforces. The biggest advantage of no debt goes to the average wage earner.

In American society which possess stored wealth, in practice, debt can move mass, but it is neither energy nor force push therefore it must be stored energy. Using stored energy makes a nation poorer, as observed by the general production capacity decline of the United States of America which is in a much weaker position as opposed to when the gold standard ended in 1971. Production was at its greatest until 1971. It is difficult to borrow with a gold standard. To borrow is to increase a counterforce, which decreases the summation of force. Wealth originates from energy applied by the summation of force because wealth is the ability to do and doing requires the application of energy. The cause of wealth is the input of energy, and debt reduces the input, therefore it also must reduce the output, which is proportional to wealth. To make the United States of America significantly wealthier along with everyone in it, and to double the wealth of the checkout person in the supermarket, can be achieved by terminating and banning forever all present and future government debt.

### Chapter XV

### Printing Money Causes the United States of America to be Less Wealthy

If any great nation has an economic Achilles heel, it is its domestic currency. Currency (money) is the government's measure of work done and wealth stored. Currency is the quantity of measure in finance; it is what is counted, it is understood as a determination of value, and is a tool used to allocate resources to solve problems. The unit of currency in the United States of America is the dollar. Work is financially measured in units of dollars just as distance is measured in physics by various units such as feet or meters and time as a quantity is measured in units of seconds. The value of the stored wealth is defined in units of dollars as a measure of stored wealth, where in units of dollars or currency is used to purchase something in the future for example. Every economic activity is measured in units of dollars, like every distance is measured in units of inches or meters and so on.

The determination of the precise measure of a fixed unit (dollar) is necessary to fix the value in a present value relative to the future value. What is an hour of work worth today and if the same hour of work is stored for twenty years to be used to consume in the future, what will the future value be? Can a truck driver store a dollar in the present (if the present is 1960) to buy twenty candy bars for five cents each during retirement some day in the future? The answer is determined by the result of what happened to the measure of the value of the dollar over time. A worker driving a truck, or anyone receiving a wage as compensation, works and then stores earned labor thinking the value of the stored wealth will be relative to the stored life efforts, (work done), to be used in the future to consume. An hour saved in the present can be used to consume in the future an amount of consumption equal to the value of the original hour. It is to say, a working life is worth so many dollars saved where the stored dollars saved will be used to pay for the retirement years. The assumption is when a slice of life's energy is stored in the form of dollars, it can be later retrieved, and when it is used to consume, as money has the ability to consume, it will be equal or similar to the value of the original slice of life's energy spent to acquire the dollar. A truck driver works one hour for five dollars in 1960. Five dollars in 1960 could buy one hundred candy bars. Therefore the value of an hour of stored wealth in physics is one hundred candy bars. How many candy bars can five dollars buy in 2015? The five cents stored in 1960 to consume a candy bar in the future is insufficient by a multiple of twenty because the money lost 95% of its value over time. Five dollars in 2015 can only buy five candy bars, not one hundred. The hour of work stored, and measured by one dollar is only worth five cents in the future. It means the workers sixty minutes of work lost fifty-seven minutes of its value. The worker's efforts are depleted by a factor of twenty. This means twenty hours worked is only worth one hour in the future. It means workers lost nineteen hours of pay out of twenty hours worked. Therefore 95% of the worker's stored wealth was taken because of bad governmental policy which caused the value of the unit of measure to change. In physics when something is added to one place it must be taken from some other place, because mass and energy are conserved. In natural science the value of the stored wealth will be depleted equal to the amount of unearned (fake) money printing: there is no cheating in physics. The workers stored wealth was reduced by a loss of 95%. Someone took it. That someone is not the worker's friend. Those responsible are real people who allowed and benefitted from the printing of unearned money.

Modern social science in the view of the current policy makers believe creating unearned money is the solution to employment. Social science, like any science applies scientific methods. Social science means science applied to people. The weakness of this method is it is not deterministic. The lack of determinism allows for misuse. Bad social science is used for someone's political agenda. It is poorly thought out social science which causes the hard working truck driver to lose 95% of the value of her stored wealth (bank savings). The fault is in the application of methods, not in the methods themselves. Social science is valid, but believing something can be created from nothing is a false application of methods. Conversely, the methods of natural science are particularly designed to determine, by measurement, the cause and effect based upon the principles and laws observed in the natural world, which enable the understanding of a measured cause resulting in measured effects. The difference between the two science methods are social science cannot determine the cause to achieve a desired effect and therefore it cannot achieve a desired result by intent, as opposed to natural science which quite purposefully is designed to specifically determine a resultant effect. This fact places the two sciences at odds in interpreting economic events. This also is puts them at odds in terms of creating solutions to increase wealth and therefore enabling the betterment of humanity (making everyone wealthier) through the increase of wealth. The reason 95% of the worker's stored wealth was lost due to a reduction in the value of the money. Those who believe in the social science method of stimulating the economy with unearned (printed) money cause the dollar to lose its value. The methods of current social science thinking have failed to understand the consequences of the polices, which caused the loss in purchasing value of the currency. Stored wealth is measured in dollars. Policies which cheapen the purchasing power of the currency equally lessen a worker's life savings.

The natural science view requires a change in wealth that can only occur from either an increase in energy (force push), or a decrease in counterforce to force push, or both increasing energy as force push and simultaneously decreasing counterforce. The natural science view to make society wealthier is to increase force net, the summation of force. Efficiencies also increase wealth through inventions, however inventions are proportional to profit, meaning as profit increases so than does inventiveness increase. Profit is an effect from the cause of force net. Egypt invents new ways of doing things. Ancient Rome is wealthier than Egypt because they invented more. Renaissance Italy invented more still. During the greatness of France (1650-1850) the French invented more and they became wealthier than Renaissance Italy (1400-1600's). The English colonial period was the height of European wealth and it was also the height of Europe's inventiveness. As Germany industrialized it too overflowed with inventions. The United States flooded the world with new ideas and inventions (1800-2000) and now the growth in patents are losing global market share. The USSR, a profitless society, invented practically nothing, not a car, radio, plane, engine, light bulb, computer, clock, camera, or anything useful. Profit is the resource which allows time away from toil to increase knowledge. A University exists on the back of profit. This means as the summation of force increases an increase in inventions are proportional. To lock in the present value of the currency earned from production by the worker it is necessary to match the currency's present value measure to something that cannot be altered such as a set of elements or some type of difficult-to-obtain set of compounds or organic items. This way the money earned in the present maintains its value into the future. So far every government in history has printed unearned money which resulted in the people suffering a loss of wealth. Tying money to real items and adding multiple layers of control can reduce institutional money printing.

Currency is a measure, a quantity in units of dollars, and it is the financial value measure of wealth, however actual wealth is a form of energy, not units of currency. Currency or money is the measure of work in the financial counting methods; and it is used to measure stored wealth and the ability to consume from the use of stored wealth. Money is supposed to be fixed in its value to honor the contract of compensation for work done, just as an inch is fixed in its value of distance. Money as a median of exchange allows unlike events and items to be calibrated in value, enabling so many sheep in units of dollars to be transacted for many computers in units of dollars, which enables information to be obtained that is necessary information making it possible for production calibrate the transactions of millions of events. The information is used to determine whether or not a transaction is capable of allowing a gain between the maker and user (or buyer and seller) which is the determinant of how to acquire resources to match production to demand.

When the unit of currency is altered the value measure of all things valued in the currency are equally altered. If a meter is altered then all things measured in meters are equally altered. The dollar is the unit of measure and so changing the meaning of the unit therefore must also change the outcome. Currency should equal the value of the actual event, where so much iron ore is calibrated to a unit in dollars, dollars per ton of ore, dollars per bushel of corn, and so on for all goods. Natural science will not allow the alteration of a value of a unit of measure without defining all measures, the same. To change the value of a unit affects all items valued by that unit. Social science currently applied to American economics misses this point. To print unearned money, not corresponding to an actual event, is to lessen the value of everything in existence valued by money particularly, one's bank account regardless of your sex or race.

In 2007 iron (an element) cost approximately $6 per ton. By 2014 the price per ton increased to $150 per ton. Iron is an element and an element can't change. It was the value of money which changed. The value of money decreased in value where it takes twenty-five times more money to buy the same thing. The value of the money was cheapened by the policy which believes printing unearned currency is useful.

Building a house in units of feet where one hundred feet equals distance and then changing the value of feet to something smaller would certainly alter the size of the house in the unit of measure. The quantity (one hundred) and the unit (feet) mean quantity in units are calculated to determine a physical measure in distance. Changing the unit valuation must change the distance measure, but not the actual distance. To change the meaning of a foot to six inches would then change the written definition of the square footage of a house. This would cause the 2000 square foot house to change to a 4000 square foot measure, but the actual size in physics remains the same.

Conversely, to print unearned money lessens the dollar, but it still takes the same amount of the summation of force to produce a product like an automobile. The price of a car is the energy to make it plus the resource. The energy to make it cannot practically change. Therefore the present cost of a dollar per automobile changed because the money changed value; the money became worth many times less. The average cost of a car in 1960 was $2,600 and in 2015 it is $35,000. The cost is now twenty times more than the 1960 price. All prices are affected by printing unearned money. The money changed, not the car. Cars can't change; it is the same car which previously cost x, and now it costs in dollars twenty times more. What changed is the money, which became worth twenty times less due to unearned money printing by the government. From the 1960's to 2006 was a period of mild money printing of approximately 4% false money per year. Beginning in 2007 money printing has tripled to approximately 20% per year, if the Federal Reserve is added in.

In natural science the value of a dollar is actually a unit of energy. To accelerate mass faster than it was already going or to accelerate it from rest necessarily requires energy. Energy cannot be faked because energy is force push which has the capability to alter the environment. Energy in economics it is the generation of electricity plus fuel burned. To print unearned money will not alter the resources necessary to generate energy. The energy necessary to apply a force of 2,000 Newton's to an object as it travels a distance of one meter in time is a constant. Changing the definition linguistically of the meaning of the unit of measure will not alter the energy needed to accelerate the 2,000 kilogram mass one meter in time. Nothing can change the energy needed to accelerate mass on earth. This means unearned money printed can only increase the quantity of money, but not increase the quantity of wealth. The five-cent candy bar now costs twenty times more because twenty times more money was printed than should have been. Only by increasing the summation of force can the standard of living increase when the summation of force is force push less the counterforces. Printing money cannot possibly, under any circumstance, alter the state of wealth because wealth is a proportional result of energy and a result from the cause of the input of summation of force.

By increasing the money supply unrelated to activity, the dollar value of energy changes, but the physical energy cannot be changed by an artificial financial measure or anything else. To become wealthier requires the actual physical energy to increase, where either force push increases or counterforces decrease. The unit value of the dollar has nothing to do with the physical laws of the natural world. In physical law a change of energy is necessary for the change in work done to occur. A trillion unearned dollars has zero effect upon the physical law, but the cheapening of money depletes stored wealth if the stored wealth is denominated in the same currency. It is possible to purchase a good with unearned printed money. However, the value of the unearned money had to come from somewhere. Neither matter nor energy can be created from nothing. If valueless money is given value by the authority of the government then the value was generated by taking value from stored wealth. Printed unearned money takes from stored wealth. As a result, it takes more money from a savings account to buy the same good, which in the past cost less. The stored wealth was depleted because the fake money was printed. This is why people buy gold coins, because gold is an element and cannot be artificially changed. However, the Federal Reserve sets the lending per year (lending rates) for gold at twenty to a hundred times the principal, causing wild gyrations in gold prices, to thwart the public's ability to substitute commodities for currency. Commodities are aggressively leveraged causing them not to be dependable for storing wealth. The government prefers people to use treasury bonds as a method of storing wealth. However, Treasury bonds are depleted in value by the printing of unearned money because the bonds are a money unit.

There are many types or methods of creating additional money in society. Criminal counterfeiters print it and the civil authority prints it, both cause a devaluation of the currency. Is the civil authority acting in the best interest of the United States where devaluing the currency? Social science practiced by the American government says yes, but it causes the peoples wealth to be depleted in value. Several types of government money devaluation techniques are food stamps, rent control, minimum wage, unemployment payments, government bonds, artificially low interest rates, subsidies of any kind, providing credit where repayment will not occur, stimulus of any kind, government purchasing of the peoples assets, simply printing it, and the banking system with leverage, among others. Food stamps, for example, are not earned. When the food stamp was exchanged for corn the food stamp has to cover the expense to grow the corn. The food stamp does not have any value therefore it cannot pay for the energy used to produce the corn. Something other than the food stamp has to pay for the corn production. The food stamp obtains its purchasing power by taking from stored wealth from the people's savings accounts. What paid for the food was the value taken from the stored wealth of the free people. Food stamps deplete stored wealth

Social science applied by some concludes the cheapening of the dollar as a unit of valuation is good for society. This is the base premise of Keynesianism which reflects current United States policy. Is it? Does too much money in the system increase wealth? Does the devaluation of all the savings accounts increase wealth?

When applied to economics, the principles physics reasoning conclude printing unearned money makes the aggregate nation (and eventually everyone in it) less wealthy. It has been observed since 1971. Money is not energy, is not a force push, and shrinks stored wealth when printed in excess to what is justified from production. Never forget friction. An artificial dollar is a cheapening of stored wealth by a dollar plus an additional cheapening by the friction to be overcome by the act of printing and distributing it. Energy is necessary to overcome the force of gravity of all activity including activity which is inefficient. Force push, in economic is electricity plus fuel burned, which enables production to occur and then causes the acceleration of the economy evidenced by an increase in the transaction rate due to a change in ownership. The same force push is needed to implement the wrong answer. When energy is used for the wrong answer the energy is wasted.

In natural science, the object of study, or the entities of ownership is the system and it cannot change velocity unless acted upon by a force net. This means in order to increase wealth, the external input of net force is increased specifically as a change in energy input. The change in wealth is people becoming wealthier as an effect from the input of energy. The concept of wealth is the ability to consume and is proportional to kinetic energy (½ mv²). To increase wealth means the velocity of the economy must be accelerated by a change in the net force. Wealth is not simply owning kilograms. For wealth to exist, somewhere at some time, some kilograms had to have moved a distance in time. To consume, the kilograms must move distance in time. That means in order to accelerate kilograms force is necessary. The system in economics cannot be accelerated unless there is a change in net force. Printed unearned money is not energy because energy cannot be created. However unearned money can be force push where the force push is derived from stored wealth. Using stored wealth depletes aggregate national wealth if more stored wealth is being used then new wealth is being generated from business activity. Even if the amount of stored wealth used equaled wealth generated there would still be a net loss. The decrease must occur because there is always friction.

Altering the behavior of the object of study (the system) or the ownership entities means changing the speed or accelerating with direction, which is to move a distance in time. To alter the velocity of the economy requires it to be forced to accelerate. There must be force first, as a cause, and then the effect occurs although acceleration occurs instantaneously. Energy is the input, and the effect is the output. Energy in, equals energy out. It is better to say energy in equals energy out plus energy lost due to friction. There is always a loss due to friction. Artificial money uses energy from the historic applied force due to energy which has been stored. Artificial money is something only because it takes from stored energy which is the stored wealth of the people. Yes, the government can give someone unearned money to buy a car, but the money used is from stored wealth. The stored wealth is depleted by the price of the car plus there is an additional depletion due to friction. Buying a car with unearned printed money results in a net loss to the aggregate economy. The current thinking of the policy maker's is claiming they have the power to create energy from nothing; which is impossible. This violates Newton's first law of Σf=0 where there is not any force the object stays at the same speed. Newton is saying if there is not any force in then the object of study will not move or have no changes in velocity. Zero force cannot shoot a cannonball. In physics nothing in will always result as an effect of, nothing out, where (0 in=0 out). Printed money is zero energy, and is zero force, and therefore the cause is zero and the effect must also be zero. Zero movement of a bow string causes no effect upon the arrow and the arrow remains at rest.

How does printed money actually cause mass to move or cause economic events? Mass cannot move unless forced to do so by the summation of force, so how does artificial money succeed at stimulating the economy at least temporarily and more accurately only to a localized segment? Printing money is always a counterforce to growth because stored wealth is depleted by the amount of artificial money plus energy lost due to friction. Stimulating the economy is only possible if the summation of force is increased by generating energy external to the system.

The natural science answer is the energy from a government stimulus had to come from somewhere; and the somewhere is from stored energy (the people's bank accounts). Therefore stored energy is used to generate a force push via the use of stored energy. This means economic stimulus is using the people's stored wealth. People's bank accounts lose purchasing capacity because the stimulus takes its energy from stored energy. This is what happened to the stored wealth of the truck driver who thought his dollar would buy twenty candy bars in the future. The stored wealth from the truck driver was taken by the occurrence of printing unearned money.

Immediately after the United States of America stopped backing the currency via the gold standard and began printing unearned money in large amounts in 1971, production declined, and manufacturing suffered, the “rust belt” resulted, and the national aggregate capacity to produce rapidly declined. America's ability to produce declined and continues to decline in 2016. America's trade deficit is seriously understated because foreign businesses manufacturing within the United States are counted as domestic. These businesses are not domestic because their profits go outside America.

Price is the amount of money divided by stuff ($/stuff). The amount of money is printed, but the stuff remains the same, and the result is the price of the stuff increases. When the American currency stopped being backed by a standard of gold: (the standard could be any set of elements or commodities) the price of American-made steel increased by the percentage amount of printed money in dollars. This caused the dollar value price of American manufactured steel to go up to the point where it became more efficient for domestic consumers of steel to import steel rather than buy it domestically. The primary reason the United States of America imports steel from inferior resource countries is not due to cheap foreign labor. It is because the United States of America's government is printing unearned currency and putting it into the domestic economy, increasing the cost of American goods. Labor is only a small fraction of the price of steel, around 7% per ton. The most significant cost of steel is the iron ore and the energy necessary to melt it and ship it. Two years of printing 4% of unearned currency wipes out the argument that the cause of lower foreign prices was due to labor. The United States of America has both the ore and the coal, oil, and gas necessary to melt the steel, yet it is importing steel from countries that have neither ore or energy and who are additionally disadvantaged by shipping distance and shipping time. America's steel production increased year by year from 1776 to 1971 and since 1972 declined every year since. The gold standard ended in 1971 and the money printing began in 1972.

In 1980 the average American family's income was $8,000 per year, which could buy a three bedroom house and a car. By 2012 the average pay increased to approximately $50,000 per year, but the $50,000 could only buy the same lifestyle, the same three bedroom house and a car. The cause of the change in the value of dollars was due to the amount of printed money year after year; approximately 6% unearned money was printed per year for thirty-two years. The result is a relative increase in prices of US goods by 6% per year relative to America's competitors, resulting in an inability to compete.

An annual increase of 6% fake money per year is the same as a 6% price increase of US made goods per year and a 6% decrease in the value of the stored wealth of all Americans for 32 years. The continuous US price increases caused by domestic money printing has resulted in American goods being stressed as to their competitive advantage. In natural science the value of the fake money, or the ability of the fake money to force a change, is derived mostly from taking energy from stored wealth. Society declines because its stored wealth is diminished by printing currency. Fake money does not correspond to actual production, which results in the cost of American goods becoming too high priced. This means inflation subtracts from stored wealth, making anyone in American who owns stored wealth (which is aggregate stored wealth owned by the people) experience a decrease. American manufacturing is in shambles, and the cause is the policy of printing unearned money. The competition took advantage of American's inefficient polices, and that is why the resource rich country of the Unites States of America is in debt to other resource-poor countries. As a result our retail stores are almost completely void of American made products.

The current social science practice is to give printed money to essentially anyone who needs it. Printing money unrelated to production is supposed to shift wealth from one group to another. Attempting to shift energy causes an entirely new set of counterforces. For each dollar shifted the other group is depleted by more than just the money transferred. Worse the inability to compete due to higher prices caused by the additional currency begins to destroy domestic production. The decline of production hastens the negative effect of shifting wealth resulting in a greater negative then simply the loss due to printing valueless currency. The effect is, the printed money causes the depletion of stored wealth and also causes domestic price increases which has caused an American global competitive failure, plus there is always an additional loss due to friction. Every year since the gold standard ended the United States of America has had a trade deficit, a lessening of national wealth due to trade.

A government stimulus is a term applied to printing valueless money. It is a term used to by John Keynes, and early twenties century economist. Consider the variety of government-decreed stimulus such as QE 1, 2, 3; minimum wage, artificially reduced cost of capital, government bonds (government debt), trade deficits, any form of subsidy, unearned pension, creating a false demand, and a reduction in personal freedom. Reducing personal freedom is very much an economic issue because freedom directly relates to the transaction rate. Anything which lessens the transactions also lessens wealth generated. As freedom decreases transactions also decrease. As transactions decrease wealth decreases. Money printers were supposed to make people better off, but they failed. The results (effect) of the social sciences method, which advocated printing money, caused a decline in American wealth resulting in a military decline as well, which is clearly visible in 2016.

Taxes from real gains earned are necessary to some degree. Real gains occur when natural resources are transformed into a product at a value add, or at a profit. Most Americans are not robbed by a band of outlaws because there is police protection (paid by taxes). When fire occurs the firemen come to our rescue (paid by taxes). Disputes are settled in court, (paid by taxes). The police, the fireman, the court system, and the teachers are designed by the social science vision of civil orderliness, which is necessary for society to function, but not necessarily to progress. Money cannot be created from nothing to pay for the civil servants or anything else; the money for civil orderliness must be earned from production. To become wealthier is a physical change in the acceleration of mass or the object of study, which is the system of ownership entities of a free people in the analogy of physics to economics. This change begins at the initial velocity and results in a change in velocity. The change in velocity is better explained by the physical, natural sciences as caused by the summation of force. Both social science and physical science are necessary for economics to improve. However, natural science must be conformed to as the lead method to increase wealth and secondly, social science, applied accurately is necessary for general orderliness. To improve means to change. To change is a change in velocity from the initial velocity to a final velocity where velocity_{final}−velocityᵢₙᵢₜᵢₐₗ equals the change in velocity. The percentage change in growth is the change in the final velocity minus the initial velocity divided by the initial change, where the cause of the change must come from the summation of force. In economics the positive summation force must overcome both poorly constructed government policy plus the natural counterforces of gravity and friction.

If social science becomes overly dominant, than the causation of individual wealth may slow, stop, decline, and possibly fail completely terminating the existence of the nation state. The old Soviet Union successfully generated wealth, but the social science of communism beat down the wealth of the individual to a horrid peasantry because the Russian summation of force was net negative because the counterforce of policy exceeded the force push. It was the social science branch of communism which drove the USSR out of existence. Many communist policies are over bearing counterforces meaning the counterforce of policy exceeds force push. What good were the kilowatts from a Soviet hydroelectric dam if the people gained nothing from it? The cost associated with the social science view of distribution of wealth is a counterforce to the generation of wealth. The counterforce must be less than the force push or else failure occurs. A counterforce has the capacity to destroy wealth and consequently destroy a nation. The costs associated with social counterforces to wealth generation (force push) must be considered when the objective is to increase the wealth of a nation. Forced kindness (taking from the rich and giving to the poor) may be considered by many to be a reasonable value and preferred to increasing the aggregate wealth. However there is a loss in the transfer. Taking from one group and giving to another group will reduce aggregate wealth of nation 100% of the time because to take is a counterforce and not a force push. Also, there is friction due to motion, and to move wealth from group A to group B will experience friction, which is an expense, that is a counterforce. It costs less to distribute goods via a free market versus a government controlled market. Freedoms increase wealth because freedom decreases economic counterforce.

To become wealthier requires a change in net force. An efficiency improvement (because it increases force net) can cause an increase because it lowers the counterforce opposing force push. A prolonged ongoing increase in growth in time (rate is in time) will require an increase in net force, not just from efficiency improvements, but other changes as well. Competitors quickly negate efficiency improvements. Force net is not a social science concept; a change in force net is necessary to increase wealth, and therefore the physics analogy to economics should be applied. This means more constraint must be applied to social science policies which impede the generation of wealth.

In the concept of becoming wealthier, there is an assumption people desire a betterment (being richer) and do not put mined ore back into the ground meaning a change in summation of force is necessary to experience betterment. Than an increase involves the system of ownership entities of a free people being accelerated in a vector (direction) from its initial velocity to a changed in velocity. The change in net force must happen quickly enough to cause betterment within a human life span.

Printed money, that is unearned, and does not correspond to production is not force push derived from energy. It is not electricity, nor fuel burned, or solar, wind, hydro, or thermal energy either. Artificial money is not energy therefore its ability to consume is from stored wealth. The false currency does carry police authority, so it must be accepted. Its use then, is a transformation form of energy from kinetic energy to stored energy. Stored energy is the stored wealth of the individual and stored wealth of the nation, where the printed money depletes bank accounts, pension funds, coal mines of their resources and depletes opportunity. Printing money depletes everything valued in money. If there was not any stored wealth in a society to use, then the effect upon the transactions would not occur because printed money without stored wealth cannot apply a force upon the system. Printing money in a very poor country has no effect upon wealth generation because the poor country does not have any stored wealth from which to borrow or take from. If the Pilgrims had printed money upon arriving in North America, it would not have any effect upon the wealth of pilgrim society because the Pilgrims did not have any stored wealth from which to subtract. The Pilgrims had to use kinetic energy to till the soil, and hew (kinetic energy) wood products from raw wood to sell to passing ships in order to obtain the global currency of their time, and acquire precious metal coins to increase and store their wealth. If the Pilgrims printed money, they could not have used it to because printed money obtains its value from taking stored wealth, and the pilgrims did not have any stored wealth. The initial position of the pilgrims was velocity zero. An economic theory to be applied to increasing wealth would have to also work in a zero velocity system as well as a system that has a present, steady velocity of motion.

Present day quantitative easing stimulus as a form of printing unearned money also mandate the use of unearned money (by the authority of the state) to purchase assets of the people. It then drives up the price of the people's assets, which in turn forces the people to buy back their assets from the government in the future for a higher price than it should be. That action further depletes the assets of the people. Stimulus money printed is not force push regardless of the type of stimulus used. To be force push is to come from energy. Energy cannot either be created or destroyed, but it can be generated. False money that is unearned cannot generate energy. False money is not an output energy and therefore it cannot be force push. However, stimulus money does in fact move mass because the authority of the police decrees its use and the mass is moved in the natural science view because the false money changes form to stored energy. A dollar saved thirty years ago to buy twenty candy bars can only buy one candy bar in the present because the dollar stored was depleted by 95% from its original value due to the year after year deficit spending (money printing). Taking from the saver of the dollar 95% of the saver's wealth (wealth as the ability to consume) is a policy that makes the United States of America less wealthy and causes ethics problems as well. Should the people be reimbursed? The money printed used the value of the saver's wealth to consume, and the resulting consumption occurred by taking from the stored wealth or stored energy. In physics there is no cheating on the natural world. The unearned money, required to be accepted by the authority of the police, must deplete something else because it actually did have the value of stored energy and there must eventually be a conservation of energy. It was not the people's fault the value of their savings was depleted; they do not make the printed money. It is the money printer's fault.

Why is the middle class (average wealth of the people) shrinking relative to Americas historical past? It is certainly not automation. Did the industrial revolution cause unemployment? No, it did the opposite. Automation will always increase employment unless the summation of force is counteracted upon to the degree where the gain from automation is pushed backward by counterforces. There must be zero net force or net negative force to allow unemployment.

The money printing during the post war period to 2007 (1945-2007) was approximately 4-6% unearned money printed per year. In 2007 the fake money increased to 20% per year. It is the increase in fake money that causes the price increases which reduces profit. The reduction of profit results in a reduction of the middle class.

Minimum wage is a similar concept. It uses the stored wealth of the people and results in mis-valuing (cheapening) money. The value of work is from energy using force to interact with the object (system) and accelerate it. To transact a sale allowing the consumption of a burger and fries is to move mass in time (when time is a rate) and a distance. The change in ownership of food in time can only occur in the natural science view as an effect of the application of the summation of force. The wage paid is a proportion of the cost of energy to accelerate the object a distance in time. The value of the unit of currency must remain relative to all other economic events as mass moved a distance in time. The value of the accelerated hamburger is the change in distance in a change in time, plus energy used, plus the value of the object moved plus the value of the labor. If the wage is not in relation to the task performed then it is a misevaluation of currency and misvalues the energy used. To misvalue the currency results in all other events valued in currency to also be misvalued. For the wage to correctly increase then either more product is moved in the same amount of time, or the same product is moved in less time, or less product is accelerated in a lot less time. If the dollar remains at a constant value then there is no other way to increase wages, unless invention allows fewer workers to move the same product in less time. It is impossible to simply decree the hamburger worker be paid more dollars for the same mass in time acceleration unless the value of the unit of measure (the value of a dollar) is altered to a smaller amount (the dollar shrinks in value causing more dollars to buy the same thing). Altering the value of the unit of measure (cheapening the value of the dollar) causes all things in existence to be recalibrated to a higher price negating the gain the wage earner was supposed to receive. Wealth cannot be increased by recalibrating the value of a unit of measure. A house is not bigger because the inch is made smaller. The dimensions of the house are fixed in natural law and cannot change because some authority changed an inch. Space, time, and mass cannot be altered. In defense of the workers demanding higher minimum wage, it is not their fault the money has been cheapened by the money printers, and as a consequence they have lost stored wealth. It is the money printer's fault. The money printers hurt all of us.

An artificial low cost of capital is the similar problem to minimum wage in concept, which also deletes stored wealth. Minimum wage is an artificial higher price for labor, and likewise, an artificial low cost of capital misprices the cost of everything valued by the unit of measure (the dollar). Artificially low priced interest rates cause commodity prices to increase. Capital is mass delivered in the analogy of physics to economics. Iron ore delivered to Ford is not free. It took energy to mine, ship, load, and unload the ore, and then it takes energy to melt it. To not pay for the actual use of the force net to accelerate, the mass of iron a distance in time means someone else had to pay. The cost of capital is the energy it takes to overcome the force of friction and the force of gravity to accelerate the mass, which are natural counterforces to force push, and the energy used to mine, ship, and melt ore and one still has to pay for the other counterforces of government policy. Capital is subject to the summation of force. Capital delivered is not free because it takes real energy consumed from the actual use of resources to generate the energy, which enable the capital to be available.

Government debt, like artificially low interest rates, causes unearned currency to be put into the economy in the form of government borrowing. The unearned currency is not electricity generated or fuel burned, and therefore, it is not force push. It can't be energy from outside the system. Unearned currency is derived from inside the system and when used the system has less energy. The government borrowed currency used to move mass operates by taking the people's stored wealth which has the effect of shrinking aggregate national wealth. The people become poorer by the cost of debt occurring and the people become poorer by the shrinkage of stored wealth. The dollar stored to buy twenty candy bars can only buy one candy bar, or 95% less, because the value of the dollar was recalibrated to become 95% less relative to its original value.

The domestic recalibration of the unit of value (the dollar) causes the domestic price of goods to increase. This forces domestic manufacturing to move operations out of the country and also simultaneously causes the domestic consumers to import rather than buy their internally produced goods. Unearned money increases the price of American products to the point of an inability to compete.

In natural law, any form of recalibration of the unit value of the dollar must take away value from somewhere. This is why the money printing advocates reject natural laws because in natural laws there must be a conservation of energy and mass. Energy and mass cannot be created or destroyed; therefore unearned currency cannot have an effect unless it obtains energy from somewhere else. A base tenant of some of those who practice social science is to claim the economy is never in balance. This is the basis for the reasoning that an authority can reject free markets. However in natural science a summation of force is an imbalance. To accelerate is an imbalance. Based on physics, the maximum output occurs due to the efficiency of the system, and the least counterforces. This is the observation of the natural world. The machine age is a process the summation of force equals mass multiplied by acceleration. Anything moved from rest or increased in speed was caused by net force. For the economy to grow mandates a change. Growth means a change from the old to the new. If people are without, the solution is to generate more, or to become wealthier. Taking from one group and giving to another reduces aggregate wealth. If too much money is printed it can cause a total economic failure. This makes money printing a counterforce.

Women retirees on a fixed income lose purchasing power, or lose the ability to consume when the value of the currency decreases due to printed money. It takes more currency to buy the same things, which is caused by government bonds and other forms of creating valueless currency. Forms of printing money such as government bonds that is government debt, government established artificially low interest rates, minimum wage, stimulus, subsidies, and rent control are all a revaluation of the dollar to a smaller unit value and therefore lessens the ability of stored wealth to consume resulting in making the United States of America and everyone in it poorer.

Based on natural science, the physics view of economics is to accelerate the ownership entities of a free people in a change in distance over a change in time which requires energy as an input to change the velocity of the economy. Money printers claim to create demand. Actual demand is the desire to consume and the ability to consume is from energy. Therefore to meet the increase in demand, energy must be generated. Energy cannot be generated by printing anything, either money, or rent control, government debt that will never be paid off, stimulus, artificially low interest rates, cash for clunkers, food stamps, or by printing anything else. To increase demand, the wealth of the people must increase as a result of a positive change in the summation of force. Demand results in a transaction that is an effect, not a cause. An effect cannot be altered to create a cause. An untransacted event must have energy to transact; there must be an assumption of profit from the transaction and there must be the freedom to own. A transaction is the velocity of the system. A change in velocity results in a change in kinetic energy. Velocity cannot be stimulated unless by an increase from net force first. To change demand means to change velocity. Printed money takes stored wealth from within the system to change velocity, but the system ends up with less ability to consume. Printed money reduces stored wealth and is energy taken from the system. Thus printed money cannot stimulate demand. To become wealthier the summation of forces (net force) must increase, assuming the spontaneous nature of humanity is for the betterment. Cause and effect have an order in time or occurrence, where the cause comes first and the effect from the cause comes second. This does not necessarily mean time has elapsed, but in a practical matter of the economy, elapsed time would be necessary. It does take a change in time for a change in the velocity to occur. Then demand can only exist given the input of energy first. Demand comes second after energy is input, and demand is an effect from energy, not the other way around. This is the natural science view of economics, and in order to pursue greater wealth for the country it will be necessary to apply the methods of natural law as opposed social science. Social science as currently practiced is deep into the belief printing unearned currency will increase wealth. This hypothesis is rejected in observation and is rejected by the principles of natural science. Of course there are some whose lives benefit from printed money. However, anyone who earns a wage or has a typical narrow salary range will suffer as prices increase more quickly than wages increase. Perhaps the people using money printing to rob us use social science phraseology as a decoy to mask their true intentions.

Many American politicians believe it is a good idea to give money to the poorest even though it lessens the total wealth of the nation. Their power to rule is a conflict of interest between the interest of the nation and their own personal interest to keep their position of power and wealth. The physics to economics solution is to increase the aggregate wealth and use that ability to, with a 98% confidence level, guarantee everyone a job. A job is a result of net force. Increasing jobs without first increasing net force simply takes existing work from some and gives it to others, resulting in the nation becoming poorer.

Printed money, false currency, and currency printed not in correspondence with actual production depletes stored wealth in the natural science view. Value is created by the transformation of natural resources to an altered state (change of state) of the natural resource eventually having energy converted or transferred to wealth as a transaction. Energy is applied as an applied force or force push. Printed unearned currency is a counterforce to force push, which reduces the summation of force (Σf), and therefore reduces the wealth of the nation. It is true some individuals benefit from the printed currency, but the aggregate wealth of the nation declines.

### Chapter XVI

### The Failure of Modern Finance

Modern finance's definition of the measurement and valuation of money relative to the economic system is somewhat ambiguous and is not based on principles used in natural science. Governmental policy is intentionally devaluing the currency to cause inflation. Inflation is mechanically accomplished by first and most importantly having the government declare a dollar as legal tender, but the unit of a dollar is not based on anything physical such as any element or the commonly used gold or silver. Secondly, and simultaneously the government first prevents a free market process to determine the interest rate on debt and then it prints large amounts of unearned money. Since interest rates cannot increase to punish the money printers and the money is not backed by anything physical, the money can be printed with impunity without any market available to oppose it. As a result, the value of capital determined by interest rates is made artificial and the unearned money is artificial, which allows for the mispricing of capital plus everything valued in dollars as the unit of measure is also misvalued. The people suffer because the value of their life savings is taken from them by the devaluation of purchasing power, but they don't complain because it is too difficult to understand. Even college students who are supposed to be smart don't understand if they were to receive free college the payment would occur by taking from the life savings of the average people who spent their lives earning it. Plus, inflation depletes domestic manufacturing, which suppresses the economy in which college students think they are going to get a job in. The measure of money relative to economic events is out of calibration and inconsistent with the physical universe. Finance uses many types of quantitative mathematics and statistical methods, but it does not apply the principles which are fundamental to the process of natural science. Modern business finance counts things, however what is being counted is not always clearly defined in measurable units as opposed to natural science where units are more consistent. Units of valuation in finance are inconsistent and sometimes missing entirely. There is a concrete side to finance when it functions for the purpose of counting, but the clarity falls into disorder when the statistical analytic methods attempt to project and extrapolate historical observations into the future, where it expects the future to be similar or relative to the past even though the world (underlying facts) may be changing. Finance is based on a cause and effect hypothesis that states history is the cause and the effect occurs because the effect is likely to be similar to the history. Those who practice finance do not consider the methods of physics, the interaction of energy, force, space (distance), temperature, and time as variables to its conclusions. Although financial conclusions are often expressed in some quantity divided by time, the how and why things occur is missing. A rate of return is a change in value over time. Absent are the questions of where the return comes from, what is the origin of the cause, what make things change, and why there would be an expectation of an occurrence, where all of these are absent in finance as a field of study. Natural science considers the origin of the cause which leads to the effect and outcome. Cause and effect are addressed by physics as a field of study with mathematical methods, principles, and truths with laws, which pursue observations to determine the reasons for occurrences. The methods of finance do not use the principles of physics. Financial concepts are intertwined with social science theorems, which are often counter to natural law. Social science uses nondeterministic methods to seek the understanding of an outcome. It is missing the natural science methods necessary to determine cause and effect. Without understanding the cause and effect, finding consistent solutions are impossible. The principles of physics are specifically seeking the resultant cause and effect relationships and therefore are ideal methods to solve problems, such as how to increase wealth.

The United States of America is over 130% in debt, which cannot ever be paid back. This debt will be subtracted from everyone's savings accounts by price increases and losses of opportunity particularly for the young. Under the current concept of either modern finance or social science methods of reasoning, the finance industry seems unconcerned about the magnitude of debt. Most of Europe is in the same condition and Japan is worse (Japan is 250% in debt to its domestic GDP, a hopeless situation). Growth in America, Europe and Japan are essentially zero, meaning the betterment of humanity, and the capacity to increase jobs, and wealth or offer opportunities for the young is boxed in by a counterforce which is approximately equal to force push making net force zero. Net force at zero is a no growth scenario. Giving college students free tuition decreases net force. The effort to seek betterment (become richer) is facing an equal counterforce to stop betterment, and in fact the progress of an improving middle class has stopped its forward motion where there has not been any progress for many years. There cannot be forward gains to the middle class when the counterforces equal the force push. At this time (2016) the middle class is shrinking relative to the total population.

The social science method to pay off debt is to lessen the value of the citizens' assets and wages in an environment of very little forward movement (potential for a gain). Modern finance is part of the problem and currently lacks the capacity, to provide answers affecting a solution. Methodologies for determining useful solutions are very weak in modern finance.

To improve the economy of the United States requires physics methods, where the principle of accelerating the object of study occurs over some distance and in some period of time, and where the effect is a change measured as energy out. Energy out comes from energy in. This is a law, a principle of truth, and it certainly applies to economics.

The basis of how an economy changes from an initial position of wealth to a future (final) position of wealth are not addressed by modern finance. Financial methods do not ask how the economy increases, or what the causes were, or what the effects from the causes might be. Financial methods borrow concepts from those who practice social science and believe government debt is a positive, and incorrectly interpret debt as a force push where the payment of interest is somehow a gain. An interest liability can never be a gain and capital available for production is lessened by interest paid on government debt. Modern finance is stating government debt plus the interest payment on the debt is the same as a riskless gain. Its position is debt plus interest results in an effect that somehow conjures a risk free wealth occurrence. Debt can never be wealth. Debt plus interest is not energy, and therefore it cannot be force push. This premise of debt plus interest being a positive cause is impossible because debt plus interest is a counterforce to force push. Debt is the taking of stored wealth. Stored wealth is depleted equal to the amount borrowed plus interest plus friction. A counterforce means the opposite of a positive motion. Also, the term “risk free” is a linguistic phrase outside the basic concepts of natural science. Risk free is a term referring to the interest paid on government debt. Government debt should not exist in the first place. It means money borrowed from the people where the people pay the interest and the debt is not likely to be paid back. The people's wealth is depleted by the debt. Paying back the principal of debt takes capital from production. Paying the interest on debt also takes away from production and there is friction from the activity of debt issuance and pay back, the cost of which is paid by production. Government debt is a negative to the wealth of the nation. A return implies an acceleration and debt, interest, and friction are counterforces to acceleration. The very existence of debt plus interest lessens capital available for production. Also, as an industry generates wealth, the wealth is used to pay off debt rather than making the United States of America, (industry), richer. Government debt takes capital away from production lessening the generation of wealth. Therefore, debt and its additive interest payments must lessen wealth. Ford makes cars out of iron. Ford must purchase less iron because part of Ford's wealth must be used to pay down debt. Therefore there are less assets available to purchase iron resulting in fewer cars made, and fewer jobs are needed as a result.

The entire concept of energy, not barrels of oil, but energy as the capacity to effect a change in natural law as the driver of a cause of change is omitted in finance. The methods of finance seemingly have no idea why things physically change.

Modern finance believes an expected rate of return (ERR) is based on the interest of government debt and how much the general domestic stock market changes value. The formula is written as the ERR=Rf+b(mᵣ−R_{f}).
ERR=expected rate of return
R_{f}=Risk free return from the government debt is the interest payment
b=beta (relative measure of change)
mᵣ=the return of the stock market (typically the S&P 500)

The risk free (R_{f}) return in the Cap M formula is for the return of government debt. This view accepts the concept where the government debt, borrowed money, is a gain. This is not accepted in general accounting. A gain cannot occur from borrowing when the borrowing is done by the government because the capital used for production is lessened. Interest paid on government debt is a loss of capital to the economic system. The risk free concept of the formula is a financial tool to determine relative risk and to understand the expected rate of return of investments of financial instruments such as stocks and bonds. These investments are made related to government debt. However, the formula does not question the magnitude of debt or how debt is an expense. This financial theory errors in ignoring the size of government debt and it errors again in thinking interest on government debt is a return. Interest on government debt is not a gain; it is a physical loss of wealth by society because assets are taken from production to pay the debt, plus interest plus friction. The United States of America can be disastrously indebted, and the financial formula of Cap M ignores the environment by accepting the concept debt is a gain. Debt is not a gain, it is a loss. It is not scientific to expect the same output when the input changes. When the facts change the result should change. Also, modern finance does not ask why an economy increases or decreases. It is not a principle of mathematics to say stock prices always gain or always recover, yet finance assumes a constant recovery, entirely neglecting the underlying events of the cause. A gain or a loss must occur for a reason. The origin of the cause that results in an effect is important because to make America wealthier or to increase employment (to have more high paying jobs) is to understand what the cause for a change is.

The modern finance expected rate of return which assumes a unit of time is annual is the expected rate of return=government bonds+relative historical risk (beta) [the return of the US stock market−government bonds]. This method does not look forward, it does not have a cause and effect, it has no starting point or ending point, and it is significantly flawed by incorrectly defining government debt (bonds) as positive. Government debt in the form of bonds is using the stored wealth of the people and depleting the stored wealth of the people by both the amount of debt plus the interest payment as well, plus there are losses due to friction; this then shrinks assets available for production. The financial expected rate of return (ERR) formula is a descriptive method only. There is not any buying power explanation, it does not look forward, it only sees backward. There is not any concept on how to increase the expected rate of return. The formula falls apart when government debt becomes too large (as in 2016) because it cannot recognize the volume of debt. There is not any cause and effect concept because the quantities of the variables do not relate. Neither government debt nor the stock market are the cause of the other.

Asking how to increase the economy via the cap-M method of thinking is not possible because it is not a cause and effect method, and has misunderstood what effects government debt has on wealth.

In complete contrast, the physics analogy method of economics is in practice a cause-and-effect process of thinking, and it is also forward looking. The physics analogy to economics is based on natural science, and is specifically designed to answer what input is necessary to generate more wealth to make the country richer. Increasing wealth is derived from the input, which is necessary to cause the object of study (economy) to accelerate. Change originates from applied force in a direction as a net force (the summation of force), which is from energy. The net force is the operational cause derived from energy less counterforces caused by policy, less force drag from natural counterforces, which totals as the summation of force. It is the net of force as a cause which enables the effect to occur and wealth is an effect from the cause. The question of growth as an economic gain is dependent upon the net force. If there is a negative net force the economy declines, a zero net force and there is not any change in growth and only a net force results in an increase in the output. Each country has different attributes of the conditions of their economy. The applied force is not an exact relationship to the result because other factors alter the one-to-one relationship. The ratio of outputs to inputs are dependent upon the attributes of the system.

The change in the input is proportional to the output on the economy. The future expected rate of return is the output of the economic system resulting in wealth as demonstrated by the change in velocity of transactions resulting in a change in kinetic energy which is proportional to the change in wealth as energy out. The economic system is defined in the physics to economics analogy as the people who are free to be owners. The input is electricity plus fuel burned. Then there is an input represented as net force which accelerates the economic system (ownership entities of free people) where the system has an output. In physics, for something to have happened, meaning for a change to occur, there must be an input of a positive summation of force. An automobile engine at zero torque upon the wheels does not have an input and results in no output which means no change; the car is at rest. In order to move the car, there must be input from the net force of the engine. The output of acceleration from the system is defined in physics as work being done. A car being accelerated is work being done. Work is done because an output occurred. The existence of the output is solely dependent upon the input when the input is the summation of force which is derived from energy. If the input is positive, then the system will accelerate resulting in a gain. There is a cause (input) and acceleration of the economy (change in speed/change in time) and an output (work being done) in distance, over time, which results in the occurrence of an effect as a change in wealth. The cause upon the economic system results in an output as a change in wealth, which is the change in the ability to consume.

Societies differ. The differences can be based on natural resource or cultural differences. Both the availability of natural resources and the cultural attributes of a society determine the properties of their economic system, and so different inputs will affect different systems in different ways. The United States of America has the ability to utilize a trillion kilowatt increase in electricity as an input easily; but a less developed country may take a hundred years to develop the capacity to utilize the large input of energy in a useful way.

Different systems have different attributes. This work is specifically referring to the economic system of the United States of America at the time of this writing (2016).

The physics analogy to economics proposes there must be an input from net force acting upon the system to enable an increase in wealth. This is completely different than what modern financial theories conclude. Modern financial theory does not offer any explanation as to why there is an expected return, other than the reference to historical data. Physics, as a natural science, insists a cause is necessary for an effect to occur, because this is observed.

In the physics analogy to economics, first there is energy derived from the universe, (the sun, stored energy, and motion of the universe). The energy is put into a useable form of electricity plus fuel burned, which interacts with the system via the operation of applied force. The system is unique to the society and its policies and resources. Newton's second law of motion is the summation of force is equal to the object (mass), which has resistance to force, being pushed, causing it to move faster (a change in velocity) in a change in time or Σf=ma. In the economics analogy (Σf) is the electricity plus fuel burned, m (mass) is the system of ownership entities of a free people, and a (acceleration) is the change in behavior of the system resulting in a change in the transaction rate in a change in time. The size of the system is the constant. A cannonball shot does not alter the cannonball's mass. What is altered is the behavior of the cannonball. The alteration is the behavioral change in velocity in the change in time (Δv/Δt). The system is the constant, the summation of force is the input, and the effect as the result is the output which is the occurrence of acceleration. Then in time, distance occurs, enabling the change in wealth to occur. The change in energy is a change in force multiplied by distance and is a change in kinetic energy. In the analogy the change in kinetic energy is proportional to the change in wealth.

To apply the analogy of physics to economics is to apply natural science to solve problems. In the analogy of physics to economics what is the expected rate of return? Why did the economy have a return which was greater than the initial economy? Why did the behavior of the economy change from what it was doing in the past? What causes a behavioral change? The expected rate of return in finance translates to physics as change in kinetic energy. Physics is deterministic so there is not an expected event due to a cause, the effect in physics is a certainty. The finance expected rate of return is a return in the change in time, (the return is the change and the rate is in time). If an economy does not have any growth than the net force is zero and the velocity is constant. To accelerate from a constant velocity requires a change from zero net force to an increase in the net force.

In the physics to economics analogy the expected rate of return is the effect from the cause of the net force. The net force accelerates the object of study and the velocity changes in time, which is the evidence of the kinetic energy increase. The increase in kinetic energy is proportional to the increase in wealth. To have a return is to have a change in wealth. The expected growth in economics is a percentage gain expressed as the expected rate of return.

In natural science, a gain is a change that occurred in time as an effect which can only occur by the application of force derived from energy. The expected rate of return has a direct relationship to energy. The analogy of the physics to economics method is the applied force to the economy is electricity generated plus fuel burned as force push counter acted upon by the opposing forces of taxation, government debt, and the cost of unemployment, and also counter acted upon by the natural counterforce of friction. The formula is [(Fp(1−fₜₐₓ−f_{government debt}−f_{unemployment})−μmg] equals the summation of force. The expected rate of return is an effect caused by the summation of force. The expected rate of return is expressed as a percentage change, however the summation of force is expressed in different units (typically kilograms, meters, and seconds). When one side of the equation has different units than the other side the proportional sign (α) is used as opposed to an equal sign. To write the expected rate of return is proportional to the kinetic energy is, ERR α KE. Note, the ERR is equal to the change in energy (ΔE) which is force multiplied by distance (Σf(d)). This means the effect is proportional to the cause. If the objective is to increase the expected rate of return then the summation of force must increase first.

To explain how the expected rate of return is proportional to the summation of force the problem can be expressed as a direct proportion using a constant of proportionality written as y=kx where y is the output, k is the constant, and x is the input. K is the rate of the output which is a property of the object.

Breaking this equation down in the view of the physics analogy to economics is as follows:

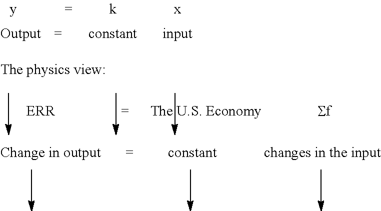

Notice the output is on the left side of the proportionality equation, but this does not alter the fact of the order of occurrence where the input comes first. An expected rate of return is a change and is due to what has been accelerated (the object of the study as the economy) where the property of the economy remains constant. To cause a change results in an effect by accelerating the object of study. The object does not change; its behavior changes by being accelerated. To accelerate the economy of the United States of America is not to change its size because it remains relatively intact. However, to accelerate the economy is a change in the behavior of the economy due to the cause of the external application of energy as force net acting upon the economy. Acceleration occurs instantaneously and in time the change in velocity occurs indicating an increase in kinetic energy. The change in kinetic energy is the output and it is proportional to the change in wealth. The output of energy is calculated as force multiplied by distance and then the ERR is proportional to force multiplied by distance; (ERR α Σf(d)).

The economy is the system as the object of study and the system has properties. The output is proportional to the input, which means wealth is proportional to net force. The energy out is in the analogy where wealth is an output. To change wealth (to increase it) is to change the summation of force which is to increase it. The relative expected rate of return is a change in value divided by the initial value (Δvalue/value initial or Δv/vᵢ=growth). However, since this is in the natural science view the expected return (ER) is from a change in energy divided by energy initial (ΔE/Eᵢ) and so (E_{f}−Eᵢ/Eᵢ)=growth in a percentage. Energy is also force multiplied by distance (f·d) and so ER=(f·d/Eᵢ). The expected rate of return includes the change in time as a rate (the time interval is typically one year). Therefore ERR=(ΔE/Δt)/Eᵢ. In order to break out distance as a property of the economic system as the velocity of a transaction, distance also equals speed multiplied by time (d=s t). The average speed is used to calculate acceleration (\tilde{v}) in a change in time (Δt), which is distance. Then the summation of force multiplied by the average velocity multiplied by the change in time is the change in energy. When it is divided by the initial energy as kinetic energy (½ mv²) then

ERR=the growth rate as a percentage change which is:

(ΔE/Δt)/Eᵢ=(f d/Δt)/(KEᵢ)=(Σf\tilde{v}Δt/Δt)/(½mv²)ᵢ

E=energy
Eᵢ=initial Energy
ΔE=change in energy
KE=kinetic energy
KEᵢ=initial Kinetic Energy
f=force
d=distance
fd=force multiplied by distance
t=time
Δt=change in time
v=velocity
\tilde{v}=average velocity

### KE=½ mv²

m=mass

The system as an analogy is (\tilde{v}Δt/KEᵢ) and the summation of force (Σf) accelerates the change, and change is relative to the initial energy. Growth is occurring because the transaction rates (assumed to occur at a profit) are increasing due to the summation of force. Kinetic energy is used to describe the initial state as the economy is presently in motion at a constant velocity. A zero growth economy in time (growth rate) is still in motion, but there is not any acceleration. To accelerate, external applied force must occur as a positive summation of force resulting in an output, where the generation of wealth is the output which is observed as the consequence of the expected rate of return (a gain in an interval of time) which was caused by force, (ΔE/Δt)/Eᵢ.

The cause (Σf) effects a change, which is the output as work done. The summation of force (Σf) interacts with the system (\tilde{v}Δt/Δt/KEᵢ) and acceleration occurs.

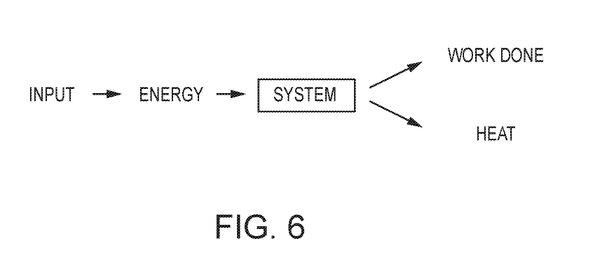

In FIG. 6, the input into the system has an output of work done and the change in temperature. Temperature is only mentioned to note some energy is always lost due to heat.

It is important to note there is also heat occurring due to friction as part of the output. Whenever motion occurs, there must be energy lost (not useable) because heat is due to friction. This is why a perpetual machine is impossible. It always takes more input to obtain a lesser output. This subject will be later addressed in the discussion of Keynesianism.

The expected rate (in time) of return (gain) in the physics to economic analogy is the expected rate of return (ERR) is proportional to the summation of force (Σf), where the expected rate of return is proportional to force multiplied by distance (ERR α fd). This process is as follows:

Δ in value/Δ in time/value initial=gain in general as a rate (in time)

y=output
x=input
ERR α Σf(d)
x=Σf−input
y=ERR−output
K=(\tilde{v}Δt/KEᵢ) as an economic constant describing the current behavior of a particular system (economy)
ERR=Σf(V)Δt/Δt/KEᵢ)=(fd)/Δt)/KEᵢ=(ΔE/Δt/Eᵢ)=gain in wealth

The change in work or work done is energy out minus energy in which results in work done. To have the effect of work done there must be a cause derived from the summation of force. Energy out less energy in equals work done, where work done is the amount of energy that crosses the boundary of the system and is the output. Work done cannot cross the boundary of the system unless there is an input of energy externally to the system or the energy within the system is lessened by the use of stored energy. This concept is also important to understand because in economics, unearned, printed money is not an external input, and therefore printed money cannot cause work done unless the system is depleted. The system becomes depleted by using the stored wealth of the people. In economics, to deplete the system is to deplete the wealth of the United States of America and to deplete the wealth of particularly the wage earner.

In economics as an analogy to physics there are three things that can happen to the energy in the system.

Demonstration: To transact at a profit or transaction rate

Waste: money not used for production

Storage: Money stored or saved; saved money is depleted by the government printing money

Growth in the economy occurs because there must be a cause for growth (acceleration of the object of study as the ownership entities of free people) as growth is an effect.

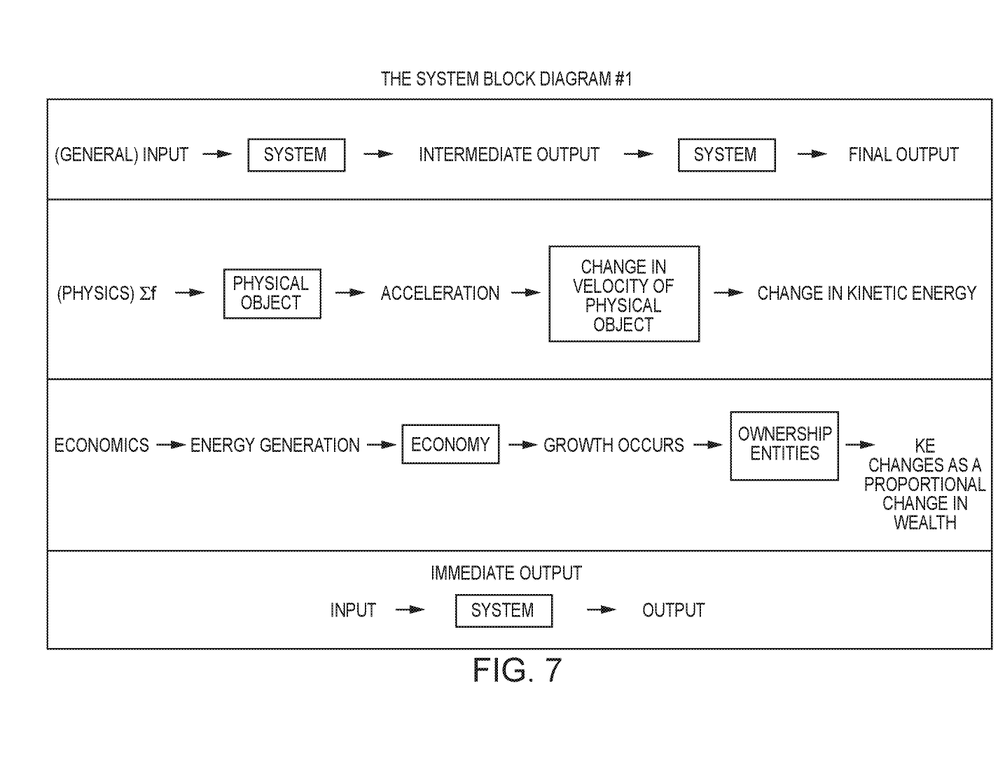

The following FIG. 7 explains the cause and effect of energy in and the occurrence of the output.

The premise of the physics view of the predicted national rate of return, the true gain in national wealth in time (rate), is force net as the summation of force accelerates the system, resulting in a change in wealth. The physics view predicts the rate of return which is different than an expected rate of return.

Newton's second law clearly shows cause and effect of applied force and reads left to right as cause and then effect. The cause is the summation of force (Σf) which leads to the effect which is the system being altered by a change in velocity in a change in time, or (Σf=ma).

The proportionality constrained equation is written with the output (effect) on the left side equaling the constant (k), which in this analogy represents the properties the system multiplied by x which is the input on the right side. The cause precedes the effect even if time is zero.

The formula is y=kx

y=output, k=constant and x=the input
Output=constant of the proportionality multiplied by the output
Output=k input
Effect=k cause

y=kx

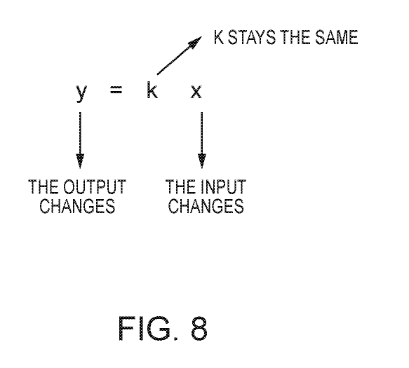

The mass, or system in physics is not changing, but its behavior changes making it a constant (k) where k represents the constant properties of the system. The output and the input change as illustrated in FIG. 8.

The physics to economics analogy proposes the effect of wealth can only be derived from the input of energy as a force net or summation of force.

The output equals the constant multiplied by the input.

Σf=input

y=k(Σf)

K is the economy which is a constant

Wealth α ½ mv² is the output as y

Wealth=(the properties of the system) multiplied by (Σf)

The system is altered by being accelerated, but it does not change or is not changed in a practicality short period of time.

Distance does not have a clear economic analogy, so it is more in spirit to use velocity and time for distance.

The distance travelled by an object is the product of its speed and time travelled. This can be expressed as:

Distance=velocity multiplied by time

d=vt

where

d=distance travelled

v=speed of the object

t=time during which the object travelled

The output of wealth is derived by the change in energy. Energy is a unit of force multiplied by distance. The force is the summation of force if. Distance is the average velocity multiplied by the change in time (\tilde{v}Δt). Then force multiplied by distance is Σf(\tilde{v}Δt), which is the change in energy. The predicted or expected return is the relative change in energy. Then the ER=ΔE/Δi.

ERR=expected rate of return

ΔE=change of energy

Δt=rate

Ei=initial energy or kinetic energy

Then the ERR=a change/reference=(growth/time)/initial=(ΔE/Δt)/KEᵢ

Than the direct proportionality is y α kx

TABLE 4
Example of Analogy of Physics to Economics

k = \tilde{v}Δt/KEᵢ
x = Σf
y = wealth
α = proportionality
Mass ~system of ownership entities
distance = d → change in ownership or a transaction
v → transaction rate
a → Δ(transaction rate)/Δ time
Δt = the change in time
distance = d = (speed)(time)
(f · d/t)/Eᵢ = Σf(\tilde{v})Δt/Δt/KEᵢ
Wealth α to KE
The change in KE is proportional to the change in wealth
y = k x
ERR = (ΔE/Δt)/Eᵢ = (f · d/Δt)/KEᵢ = (Σf(\tilde{v}Δt)/Δt)/½ mv²ᵢ = Σf\tilde{v}/½ mv²ᵢ
The premise is the wealth generated is directly proportional to the
net force applied

The expected return (ER) is proportional to the energy added to the system where the change in energy is equal to the summation of force multiplied by distance divided by the relative initial kinetic energy ER=ΔE=Σf·d/KEᵢ. The purpose of dividing the KEᵢ is to make the return relative, that is, a fraction that can be expressed as a percentage rather than a return in energy.

Wealth is proportional to the system because the summation of force is multiplied by the attributes of the system (\tilde{v}Δt/KEᵢ).

As the change in energy is divided by the initial kinetic energy (ΔE/Eᵢ) or the change/initial=a percentage change as growth.

The initial energy is kinetic energy as it is the property of the system which is in motion and is what the change is relative to as an initial condition.

Then the change in energy (ΔE) is equal to the average force multiplied by distance.

The gasoline consumed and the distance an automobile travels are proportional although the units are different.

As long as the car/mi/gal ratio of the car remains constant, the distance travelled changes in proportion to the input, which is the gas consumed.

There is still a cause-and-effect relationship even though distance is in meters and gasoline is in gallon, which are different units. As long as the properties of the system, in this case a car, are constant.

The efficiency of the cause and effect is the output to input ratio: y/x=output/input, is the efficiency ratio. The output is proportional to the input just as the expected rate of return is proportional to net force.

The output is equal to the constant multiplied by the input (y=kx) and the expected rate of return of an economy is equal to the input of force times distance relative to the initial condition.

The expected return is change to the expected, “rate”, of return by dividing the expected return by time. The expected rate of return is the expected return divided by the change in time.

ERR=ER/Δt/relative KEᵢ

ERR=Σf(\tilde{v})(Δt)/Δt/KEᵢ→dimensionless number as a function

The constant of the proportionality (y=kx) is the expected rate of return as the output equating the size of the system multiplied by the output. The summation of force multiplied by the average velocity multiplied by the change in time divided by the change in time divided by the initial kinetic energy Σf(\tilde{v})(Δt/Δt/KEᵢ is a percentage gain.

Miles per gallon is the efficiency ratio of fuel usage. Efficiency is to go more miles for less gas. The efficiency ratio of the economy is wealth divided by energy. The desire is more wealth for less energy, but this depends upon to the properties of the system. If the system is constant then only more energy applied as the net force can increase wealth and continue to do so over time.

As in the automobile example there are only three ways to obtain more distance:

1. Use more gas if miles per gallon are the same to get more distance

2. Change the properties of the automobile by lessening the counterforces to its resistance to force net

3. Do both

It is the same for the economy. There are three ways to increase wealth:

1. Generate more electricity plus fuel burned

2. Change the properties of the system to lessen the counterforce caused by governmental policy

3. Do both

For an economy to be globally competitive wealth divided by the summation of force must be superior to all others. The advantage goes to any country that possesses natural resources. The United States of America is the most resource abundant country. However, the possession of resources is not enough. Resources squandered by inefficiency leads to the loss of wealth. No matter how much the natural resources, if counterforces exceed force push the result is a net negative summation of force, which is a contracting economy. We have only those who mismanage governmental policies to blame for a poorly performing economy. The generation of wealth is from the conversion of resources to a product processed efficiently enough to enable a profit. If all the countries had the same policies than whomever has the most natural resources would be the winner.

In physics three things must happen when energy is the output:

1. Energy out is demonstrated→kinetic energy

2. Waste→heat is energy lost

3. Store→elevation, gravitational, etc. occurs as stored energy

In economics the change in energy (ΔE) out results in three things occurring:

1. To demonstrate is to transact at a profit

2. Waste are inefficiencies

3. To store is to save resulting in stored wealth.

The premise in the physics view is wealth is directly proportional to how the properties of the system of ownership, which are accelerated due to energy generated lessened by taxation, government debt, and the cost of unemployment and natural counterforces change velocity resulting in a change in wealth.

The formula:

Forceₚᵤₛₕ(1−fₜₐₓₐₜᵢₒₙ−f_{government debt}−f_{cost of unemployment})−μmg (the force of nature to be overcome)=number of ownership entities (the change in transaction rate/the change in time) as an analogy to Newton's second law.

A change in the input and output in the physics to economics model is as follows in Table 5:

TABLE 5
Example of Analogy of Physics to Economics

| | Physics | Economics |
|---|---|---|
| 1 | ΔE = a change | (R) |
| | | R = return |
| | | ΔE = a return |
| 2 | ΔE/Δt = rate | (RR) |
| | of change | RR = rate of return |
| | | ΔE/Δt = rate of return as an expected return |
| 3 | ΔE/KEᵢ = | ΔE/KEᵢ = relative return |
| | relative change | |
| 4 | (ΔE/Δt)/KEᵢ = | (ERR) |
| | relative rate of | ERR = expected rate of return |
| | change | (ΔE/Δt)/KEᵢ = relative expected rate of return |
| | | as force times distance divided by the change |
| | | in time divided by the initial kinetic energy |
| | | ΔΣf(\tilde{v})(Δt)/Δt/KEᵢ = |
| | | relative predicted rate of return |
| | | Energy = force multiplied by distance |
| | | E = f · d |
| | | f = Σf |
| | | d = \tilde{v}Δt |
| | | f · d/Δt/KEi = relative predicted rate of |
| | | return (ERR) |
| | | ERR = expected rate of return |
| | | In the physics to economics model it is a |
| | | predicted rate of return because physics |
| | | predicts a future event and finance expects |
| | | something to be similar to the past. |

Δ = change
t = time
E = energy
R = return
RR = rate of return
ERR = expected rate of return
Ei = energy initial
KE kinetic energy
KEi = initial kinetic energy

### Economics

Change of energy equals the return (ΔE=Return)

The rate of return is the change of energy divided by the change in time (ΔE/Δt)

The relative return is the change in energy divided by the initial energy of the system (ΔE/KEi)

The relative rate of return is the change in energy divided by the change in time divided by initial kinetic energy (ΔE/Δt/KEi)

To increase the expected rate of return of the USA means there must be an increase in the summation of force. The expected return means predicted in the physics analogy to economics. Expected is an after the fact measure and predicted is before the fact. Physics in deterministic and predictive, therefore before the fact.

Let's look at stocks, bonds, cash, and physics. Why is the stock market increasing, but the economy is contracting with negative GDP? GDP minus government spending is a negative GDP from 2007-2015. This work is not about investing; however the public's interpretation of economics is heavily influenced by the price of debt and equity (bonds and stocks). When the stock market increases, the leap is made in the public's mind that the economy is also increasing. From 1776 to 1971, during the gold standard period, this was essentially true. After the gold standard (ending in 1971) significant money printing occurred, causing stock prices to detach from the economy. During the post-world war two period (1945 to 2007) the average annual unearned money printed was approximately 4-6% per year. Correspondingly stock prices increased, or the value of the currency shrunk at approximately an amount equal to the unearned money printed. Since 2007 money printing has increased to 20% per year of the GDP, a significant 400% increase from pre 2007 period.

Beginning in 2007 the economy contracted and has continued to remain contacted even though numbers measured in finance appear improved. Finance does not account for the increase in national debt. Stocks are up 100%, but so is the cost of an automobile. The real gain is zero. From 2008 to 2015 according the Bloomberg, gasoline consumption has remained flat, but the stock market doubled. The doubling of the stock market was approximately the change in money printed which is approximately ten trillion dollars. The stock market gains are equal to the change in printed unearned money. Historically gasoline consumption increased with the stock market because fuel consumption is related to business activity. The 2008 to 2015 increase of ten trillion dollars in printed money was from government debt increasing five trillion and the Federal Reserve printing five trillion over the same period. The stock market was printed up. The gains were not gains from businesses.

(1) The percentage of employed has declined and not recovered

(2) Housing has not recovered from 2007 to 2015

(3) Money printing spiked to 15-20% per year which includes Federal Reserve currency creation through their quantitative easing programs.

(4) The Baltic Dry Index has not recovered

(5) The GDP growth would be negative if government supports were eliminated

(6) Energy use is not increasing or is increasing very little

(7) Iron Ore was $6 per ton in 2006 now it is $150 per ton. This means it takes twenty five times more stored wealth to buy the same good, which is a depletion of stored wealth.

The reason the price increased is the force push of the economy has been added to by using the stored wealth of the people. However, an economy cannot increase wealth by using stored wealth as an input. A perpetual machine is impossible because energy is lost due to friction, a machine cannot use its own energy to run itself.

### Physics Economics Model

The physics to economics model is as follows:

Electricity+fuel burned (1−factors of government policies are counterforces to force push)−natural counterforces of friction and gravity equals the number of ownership entities of a free people (Δ(transaction rate)/(Δtime))

By freezing the mechanism which allows the cost of capital to reflect its true market value (the bond market) and simultaneously inputting an increase to the national debt from 60% of GDP to 130% of GDP the increase in unearned money had nowhere else to go, but into stock prices. The economy is flat but the stock market increases roughly equal to the increase in debt. The stock market is driven by debt and not economic growth. The summation of force is slower due to the counterforces of debt which causes less acceleration. The system has less energy due to the counterforce of unearned money being put into the economy. The number of owners decrease as stored wealth decreases making the system smaller or the system has less energy or less value.

The value of the system shrinks because printed money is energy taken from inside the system. It take more savings to buy a car, meaning the energy of savings decreases, meaning the value or energy of the system decreases, but the system stays the same size.

The unearned money regardless of how it occurs takes away from the force push. Stock prices go up because stocks receive stored wealth from other sources. The artificial cost of capital actually transfers bond wealth to stock wealth causing the appearance of a strong economy when actually it is contracting.

The relationship of applied force to accelerating the object is force push less counterforces equals mass multiplied by acceleration. Unearned money is a counterforce opposed to force push. Any counterforce will lessen the acceleration of the ownership entities.

There cannot be a perpetual machine. The instant a molecule accelerates it heats up. The heat is lost energy. No matter what the input is there is always energy lost. To cause an aggregate change energy must come from outside the system. Energy from outside the system is able to cause a net force which results in an aggregated gain. However, energy taken as stored energy from within the system lessens the aggregate energy of the system and there is no acceleration. In economic terms, this means stimulus (printing unearned money) is derived from stored energy inside the system cannot improve the economy. The net result of economic stimulus (any form of unearned currency printed) is an aggregate decline of energy (wealth) and the system is lessened by the internal wealth taken plus the loss due to friction. Stimulus of any kind, printing currency, food stamps, minimum wage, artificially reduced cost of capital (lower than market interest rates) cause a net loss to American society.

The average American is not participating in the accelerated transactions caused by the use of stored wealth and they are becoming poorer as a result. Stimulus taken internally from the economic system benefits a few, but the economy as a whole declines by the amount of the stimulus, plus there are additional losses due to friction. This is the opposite effect of what the policy makers said they were doing. Policy makers claim they help the average worker (wage earner), but the opposite occurs. The middleclass become poorer. To make a gain from falsely accelerated transaction caused by being accelerated by the use of stored wealth as force push and by shrinking the value of the economy in general only helps an ownership entity in a position to receive the artificial money. This is not the circumstance of the average wage earner. The middleclass become poorer, the country becomes poorer, but a few who can increase their transactions and become richer.

Creating artificial currency is in complete contrast to the object of this work, which is to establish policies to increase the aggregate value of the American economy and simultaneously increase the wealth of everyone in it. The objective of this work is to increase the GDP (without financial trickery) a hundred percent in eight years, an approximate growth rate of 9%, every year for eight consecutive years.

As the economy shrinks due to some type of printed money stimulus transactions can accelerate. This happens because the force push from electricity plus fuel burned is constant while the economy becomes smaller. This is the conservation of mass effect of a flow going into a smaller area.

Physics→area₁velocity₁=area₂velocity₂

a₁v₁=a₂v₂

a₁v₁/a₂=v₂

Economic→present economy, transaction rate₁ α shrunken economy₂ transaction rate₂

E₁(T₁)=E₂(T₂)

E₁(T₁) α E₂(T₂)

This method is observed when fluid in gallons per second enter a larger pipe moving to a smaller pipe, as the pipe narrow the fluid still exists the pipe at the same gallons per second that initially entered, but the velocity is faster at the smaller end and the total fluid remains constant. This occurs because the fluid accelerates in the narrower section of the pipe to keep the flow constant because the mass is conserved. The fluid remains the same, but the velocity must change.

By shrinking the value of the economy with stimulus, the number of transactions increase for some, but not throughout society, only to those who have the capacity to take advantage make a gain. The average worker has no chance to be rewarded under policies that both print money and shrink the value of the aggregate economy. Banking receives the unearned printed money and as observed makes gains faster than the average middle class wage earner.

The conservation of mass shows up in the securities market when related in size. The big markets are like area (as in area one (a₁), the money is fluid and the velocity is the change in the transaction rate. Money accelerating from big markets to smaller markets accelerates the smaller markets more. The acceleration is visible in observation and is a common well documented observation. The big markets are area one which have a velocity as velocity one, which must equal the smaller markets (area two) and as a consequence the velocity two must increase. However, to my knowledge no one has equated this concept to the conservation of mass via the physics view of economics.

In 1950 to 1978 the United States had both strong growth and increasing consumption of oil with very little oil imports. From 1978 to present (2015) the consumption of oil has been almost flat with high oil imports. From 1978 to present the United States has declined in power yet the stock market has increased. In the view of the physics to economics model the constantly increasing kinetic energy which increased from 1950 to 1978 was a gain from the change in energy as an external input. Conversely, the gain in the dollar measured period of 1980 to present has been pushed by stored wealth allowing little progress in America. The nation stopped growing and the wealth moved into being stored in stock prices. The country stopped growing, but the stock prices increased. This of course will not last. The United States has 16% of global GDP and 50% of the world's securities. In 2000 the American GDP was 30% of the global market share.

As printed money, including government debt is not energy as is electricity generated or fuel burned than government economic stimulus (wealth taken from stored wealth) cannot possibly improve the general economic condition. Neither energy nor mass can be created or destroyed. To generate wealth, energy from outside the system must be generated first. Printed money, and government debt, are properties inside the system, and that which is inside the system cannot cross the boundary of the system without depleting the system. Printing money leaves the system through waste and inefficiency. To print money is to use stored wealth, as money printed depletes the total wealth of the United States of America.

Printing money or issuing government debt and expecting a gain is the same as saying, “I can fly because I pull upward on my belt loops”. To fly by pulling upward on belt loops is not possible because there is an equal and opposite reaction from gravity. External force is necessary to fly, such as the force from an engine or allowing an airplane to be pushed up from external force outside the individual wishing to fly.

Increasing the external summation of force will cause a change in wealth or cause the expected rate of return to increase due to externally applied force net. To make a gain the expected (predicted) rate of return is proportional to the force times distance divided by the change in time divided by the initial kinetic energy (ERR α Σf(d)/Δt/KEᵢ). It takes time to increase the economy. The ending velocity is equal to the velocity plus acceleration multiplied by time. Velocity final=velocity initial+acceleration multiplied by time (v_{f}=vᵢ+at), this means the velocity initial (vᵢ) will increase but there must be a time interval if there is distance. There is not any way to know exactly how much time it takes to effect wealth from the cause of the input because the time interval and the exact resistance to the system are unknown, and the exactness of the properties of the economic system are also unknown to a degree. Wealth will increase continuously as time increases unless something opposes it, such as bad policy. However, reasonable estimates are possible.

Compare the physics analogy of the expected rate of return to the modern finance view of an expected rate of return. The physics view, ERR α Σf(d)/Δt/KEᵢ versus the modern finance view of the expected rate of return ERR=interest on government debt+(stock gains−interest on government debt).

The modern finance version is a circular definition that says the ERR is the return. Using government debt (or any debt) as part of the gain function is impossible because debt is counter to a gain. Debt is a counterforce and its force is derived from within the system and is similar to pulling up ones belt loops to cause flight. An aggregate societal gain in wealth cannot occur by applying stored wealth as force push. If that were possible then a perpetual machine would be possible. An object cannot use its own energy to accelerate itself. If there was not any stored wealth and velocity was at zero then only external applied force could affect a change in wealth; this is the principle behind the Pilgrim Test because the Pilgrims were at zero velocity (Vo) and did not have any stored wealth. The Pilgrim's did not have any place to borrow from. Modern finance's view of using government bonds to cause a gain is impossible because government debt takes from stored wealth and is not an external net force (energy) to the system. Government debt is taken from stored wealth and is internal to the system.

To expect a gain means the effect must come from the origin, as energy external to the system applied as force, counter acted upon to become a summation of force and then interacting with the system to accelerate it.

Government debt is a counterforce to growth, and the change in stock prices can be caused by a variety of events, which include the change in the value of the currency. Unearned currency will re-price stock, which is also valued in dollars, to a new valuation because the measurement value has changed. Changes to the measurement valuation is not growth. The aggregate growth of the nation cannot be caused by printed money because printed money is a transfer from stored kinetic energy and is something, but it is inefficient in its use depletes stored wealth.

Modern finance ignores the conservation of mass, and the conservation of energy as modern finance looks at the past and projects it into the future. What happens to their theories when the base fundamentals change? The physics view of economics is constrained by the principles and truths of physical law and therefore the economy must also follow its observable truth which is following the physics analogy of economics enabling a better understanding of economic events.

The following qualified example illustrates how increasing net force changes the output.

Equilibrium is as follows:

mass=m=20 kg (kilogram)
force push=fₚ=300 N (Newtons)
force counter=f_{c}=200 N
mu=p=0.5
gravity=g=9.8 m/s² (use 10 m/s² for ease of calculation)
m/s²=meters per second squared
force of friction=μmg (which is mu·mass·gravity)
Σf=(fₚ−fₑ)−μmg
Σf=μmg=0.5 (20)(10)=100 Newtons
friction=100 N
Σf=(300−200)−100=0
force net=0
Velocity is a constant.
KE is a constant.

Next, increase force push and force counter by 10% (the force push and force counter are proportional in this example) and velocity changes in 10 seconds from 25 m/s² to 30 m/s². Time must increase for the output to occur.

mass=m=20 kg (kilogram)
force push=fₚ=330 N (Newtons)
force counter=f_{c}=220 N
mu=μ=0.5
gravity=g=10 m/s²
force of friction=f_{f}=μmg=0.5(20)00=100 N
after 10 seconds velocity increases to 30 m/s²
Kinetic energy=KE ½ mv²
Σf=(fₚ−fₑ)−μmg
Σf=(330−220)−100
Σf=10 N=net force

Wth a net force there is always a change in kinetic energy (ΔKE)

Kinetic energy initial=KEᵢ=½ 20(25²)
KEᵢ=6250 joules
Kinetic energy final=KE_{f}=½ 20(30²)
KE_{f}=9000 joules
The change in kinetic energy=ΔKE=KE_{f}−KEᵢ=9000−6250
ΔKE=2750 joules

Finding the expected rate of return:

The average velocity=\tilde{v}=velocity final plus velocity initial divided by two

\tilde{v}=(25+30)/2=27.5 m/s
\tilde{v}=27.5 m/s
acceleration=a=the change in velocity/the change in time=Δv/Δt
a=5/10=0.5 m/s²
a=0.5 m/s²

The return equals energy final minus energy initial

=E_{f}−Eᵢ

### E=KE

ΔKE==E_{f}−Eᵢ

### Return=R=ΔKE

### R=ΔKE

ΔKE=2,750 joules
Change in time=Δt=(44)=10 s (a given)
Change in velocity=v_{f}−vᵢ=30−25=5 m/s
Δv=5 m/s
Σf=(fₚ−f_{c})−umg=(330−220)−100=10
Σf=10 N
The net force is 10 Newtons
Σf=ma=20(0.5)=10 Newtons
Σf=10 N
Σf=(fₚ−f_{c})−umg=ma
Return=R=ΔKE
R=9000 joules−6250 joules=2750 joules
Rate of return=RR=return/the change in time
=ΔKE/Δt=units of energy/units of time
RR=2750/10=275=joules/second=watts
Relative return=KE initial=KEᵢ
RR/KEᵢ=Relative Return
=275/6250=0.044(100)=4.4%
Expected rate of return=ERR or predicted rate of return in the physics analogy
(Σf\tilde{v}Δt/Δt)/K Eᵢ=10 N (27.5 m/s) 10 s/10 s (100)=6250
ERR=4.4%

The output is less than the input because energy is lost due to the counterforces. In this example energy was increased 10% and the output as a change in wealth was 4.4%

The physics to economic model premise is the change in net force is the generation of electricity plus fuel burned less the counterforces of government policy less natural counterforces equals the summation force and is the cause of the output as a change in wealth. This follows that artificial stimulus cannot increase wealth because they are an opposing force that actually lessens the total wealth of the nation.

In the reasoning of physics the output or gain is caused by an input external to the system. Wealth is a result if the input of energy.

It takes energy as an input to increase the number of transactions (assumed at a profit when people are free) to result in an output of wealth.

1. The return is a change in energy R=ΔE

2. Rate of Return=ΔE/Δt

3. Relative rate of return=(ΔE/Δt)/Eᵢ=fraction

4. The predicted rate of return=(Σf\tilde{v}Δt/Δt)/K Eᵢ=fv/K Eᵢ=ΔKE

5. ΔKE α Δwealth

6. ΔKE α Δw

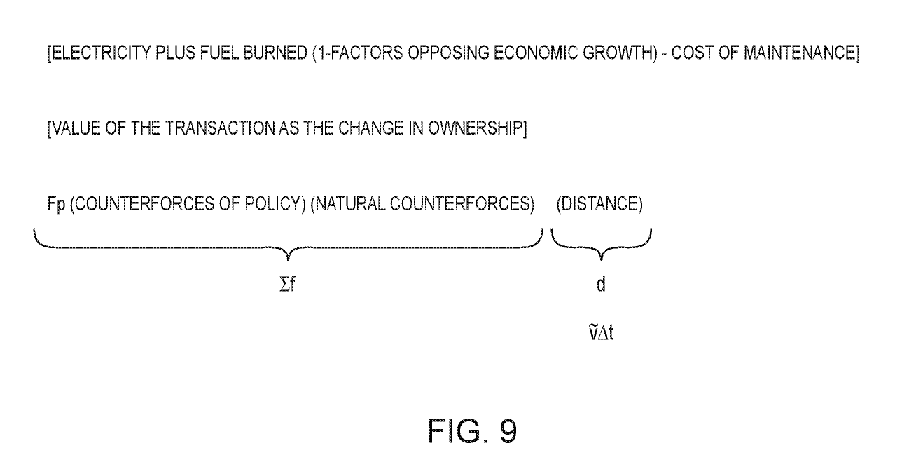

FIG. 9 illustrates how the physics to economics model determines the predicted return of an economy.

Expected rate of return=(Σf\tilde{v}Δt/Δt)/KEᵢ=Σf\tilde{v}/KEᵢ=ΔKE α Δwealth

The energy equals the object multiplied by velocity squared. A joule is E=1 Kg m²/s².

In economics to change the economy follows: Energy (E)=one half economy (e) multiplied by the (Tr)² transaction rate squared, which is (E=½e (Tr)².

For the United States to become wealthier it is necessary for the input to change. How much the input changes, is proportional to the output. Modern finance fails to understand the cause and effect. It accounts for debt as a gain without asking how the debt will be paid back.

### Chapter XVII

### Applying the Principles of Physics as an Analogy to Economics to International Trade

Adam Smith wrote the, “Wealth of Nations” in 1776, which was 90 years after Isaac Newton wrote, “The Laws of Motion” in 1668. Smith used Newton's laws to understand the activity of trade should roughly balance as goods build up to a surplus in one nation and gold would build up on the other side of the transaction nation. In time the nation with too much gold would spend it and buy goods from the other nation and this back and forth allowed for the balance of trade. Smith follows the reasoning of physics and concluded trade will increase the general wealth and not necessarily at the expense of a particular nation.

Assume the objective is the maximization of wealth for the nation state. What is wealth? Wealth is the ability to consume and is generated by the input of energy as an applied force. This means wealth is derived from energy. The net input, the net force which is derived from energy is the cause of the output which is wealth. The energy input is used to convert natural resources where the conversion of raw material to finished goods is accomplished by energy and labor. The goods are sold at a profit by a transaction of a buy and sell. The more resources processed the more jobs are generated, the more transactions occur in time assuming the economy is efficient. The acceleration of transactions is the evidence of a greater output where the input is proportional to the change in wealth. The input of energy is transferred to the output as wealth.

To increase wealth the input as a summation of force must increase first. Becoming wealthier is to increase the net force by applying electricity generated plus fuel burned, which allows the processing of more resources and causes more transactions to occur faster. As the wealth increases the gains go partially back into the domestic economy. Energy goes into the economy from an external source and the energy accumulated within the system as the change in wealth. Wealth is lost as some energy leaves the system in the form of heat, friction, taxation, government debt, the cost of unemployment, and losses due to domestic wealth also occur from trade losses. Trade losses occur in the United States from importing too many goods and allowing foreign ownership of businesses within the United States. This means the wealth of the United States declines if there are more imports than exports and if domestic businesses are foreign owned, more so than United States owned businesses in other countries based on size.

International trade breaks into the domestic transaction of a buy and sell and either the foreign buy or sell depletes the domestic economy. Is trade good or bad? It depends upon the individual nation states interest. Can trade make a country wealthier? Can trade make a competitor more powerful? All countries are not subject to the same concept of trade. The circumstances of each country are different making trade vary in importance. The purpose of this work is to explain how to make the United States wealthier. How does trade affect the wealth of America? America is extremely natural resource rich. There is an abundance of the most important resources, oil, coal, natural gas, big navigable rivers, fresh water, arable land, and essential metals such as iron and copper used in manufacturing machines. Along with a fair climate the United States has most of what is needed to operate a diverse economy.

A trade is a transaction. In the physics to economics model a transaction is the acceleration of the object of study which is the ownership entities of a free people. To increase wealth the change in the transaction rate over the change in time must occur. A trade has two sides, the buy and the sell. Domestically, both sides must profit from a transaction or it should not exist. There is an assumption free people would not transact unless there was a gain. A domestic transaction has a win win for the domestic economy because both the buy and the sell make a profit and the profit is used to go back into domestic production.

An international trade is a transaction where either the buy or sell is to a foreign entity. Selling to the foreign entity brings profit to the United States. Buying a foreign product profits the non-American entity. Germany sells far more than it buys and contributes to its GDP as a result. The United States buys more then it sells causing a subtraction from its GDP. International trade for the United States causes a loss for the nation in aggregate, but all of the individual businesses who sell products internationally make a gain. The problem is there are too few American businesses exporting relative to the volume of imports. More American's buy foreign goods than foreigners buy American goods. This means American goods are not as competitive globally as they should be. Of course this is not true with individual businesses who are the best in the world, but it is true on an aggregate basis.

Efficiency of trade is based on the efficiency of the nation state. The efficiency ratio is:

y/x=output/input=wealth/energy=ability to consume/electricity plus fuel burned.

Given the properties of the system the more wealth per net force input the greater the output of wealth.

The efficiency of trade is measured by how it changes the transaction buy and sell and how much of the result of the transaction goes back into the domestic economy. No American should demand a non-American product if the American products are better and less expensive. However, if American products are not both the highest quality and at the lowest price the domestic demand seeks a foreign product or service. Deficits in trade are evidence that domestic economic policies are not working.

Transactions of trade have been misrepresented to the American people because America loses wealth by trading (transaction at a loss). The phrase, “Buy American” emerged in the 1970's and continues to this day (2016) as a reference to the ratio of imports exceeding the relative sales of domestically produced goods as exports. The ratio of imports to American made goods is to the point where the major retailers such as Wal-Mart, Target, and Sears have almost all non-US goods for sale. These non-US goods are from countries who have far less natural resources than the United States of America and should not be able to produce goods cheaper even if their labor costs were zero.

If the phrase, “Buy American”, were actually implemented in terms of domestic consumption of domestically produced goods, would it improve the wealth of America? What does the analogy of physics to economics say?

The physics to economics model works as follows: force push goes in and is counteracted upon by various factors. Counterforce factors are mainly taxation, government debt, the cost of unemployment, and natural counterforces due to friction.

Forceₚᵤₛₕ→(1−factorₜₐₓ−factor_{gov debt}−factor_{cost of unemployment})−μmg=the net force available to accelerate the economy.

The short version is: Fp (1−fₜ−f_{gd}−fₑ)−μmg=fₙ

Then the force net or summation of force equals mass multiplied by acceleration (Σf=ma)

Σf=m a

The acceleration (a) in the analogy of physics to economics is when the transaction occurs and this occurrence increases speed when the economy is accelerated. Anything which slows the acceleration or slows the transaction rate slows the change in wealth.

How does trade fit into the physics to economics model?

The model written to include trade must add the factor of trade:

Forceₚᵤₛₕ→(1−factorₜₐₓ−factor_{gov debt}−factor_{cost of unemployment}+1−factor_{trade})−μmg=the new net force as a result of trade

Note, the factor of trade is plus or minus. When there is a trade deficit the factor is a minus because it lessens domestic wealth. If it were a positive it would be due to a trade surplus and would increase domestic wealth.

Wealth exists from the input of energy because wealth is a form of stored energy. A trade deficit results in a reduction of the net force which is the net input of external energy into the domestic economic system. Anything which reduces the net input must also reduce the net output.

Trade deficits reduce the wealth of the United States. However, there is more to the loss of wealth than only trade deficits. Foreign owned American businesses do not show up in trade data. An American business which sells its ownership to a foreign nation and remains in the United States no longer retains the profit within the United States. More wealth is being depleted from America then the deficit implies.

There is also a winner take all problem when American businesses fail because they cannot meet a foreign products price. As a result the domestic manufacturing base is gone and once gone does not show up in the deficit.

There are fundamental units of activity which are necessary for the perpetuation of the nation state, and trade is one of those necessary activities. A nation can fail for a variety of reasons. Certainly economic failure is a significant cause of distress, and often trade plays an important role in the success or failure of a country. Trade is an activity where the interpretation of the benefit to the nation state is viewed differently depending upon the process of reasoning applied. Social science, particularly a global view of social science, may see trade as world improvement. However, world improvement can be at the expense of a nation state. Natural sciences, however, can more accurately determine the value of trade relative to the specific country of interest. Regardless of the variety of interpretations of the positive and negative aspects of trade, a prolonged loss of wealth caused by a trade deficit, will lead to economic distress and possibly significant failure of a nation state. A trade deficit occurs when a country imports more than what was exported. Just like any business, constant losses due to unprofitable transactions conducted at an on-going loss inevitably cause failure.

Trade is generally viewed as a positive concept in the current social science view, and also in the modern finance view. However, the observation is, there has been 40 plus years of trade failure by the United States of America, which means every year America trades, it loses money. It is now time for a fundamental questioning of the modern concept of the desirability to trade from specifically the American point of view. Is trade good for the United States of America? Of course a gain can be made by trading, but so can losses. Currently the United States of America is losing.

Trade continues to be viewed as a positive economic in activity which the United States of America should engage, even though wealth has been depleted from America every year for forty years due to a trade deficit. Historically, the theory of American international trade was based on the period of 1776-1971 (the gold standard period), where governmental policies supported economic activity. Then things changed. From 1972 onward (the post gold standard period from 1971 and forward) government policy changed to anti-productivity in various ways. The most damaging policy change for American manufactures was ending the gold standard, which allowed unearned money to be printed. The increase in currency caused an almost equal increase in the price of American made goods. The American economy found it necessary to import lower cost foreign goods putting many domestic manufacturers out of business. When the gold standard ended, policies also changed and resulted in increased taxes on businesses and, more regulations causing time lost, which resulted in costs of doing business to increase, and money was printed driving up the cost of all American made goods. The loss of manufacturing caused more unemployment, which in turn resulted in an increase in the cost of unemployment payments. Conversely, there was rapid increase in American economic growth from 1776-1971 when the currency was backed by something tangible establishing accurate measures of the valuation of the nation's currency, which enabled a United States of America trade surplus during those years. Eventually, the founding concept of trade was altered when domestic policy allowed standardless money printing, making it impossible for either imports or exports to be priced relative to the actual input it took to make a product. This negated America's natural resource advantage. When the gold standard ended it ended globally. Non-US goods do in fact cost more, but without the ability to measure the cost difference between a U.S. goods and a foreign good the high cost foreign good sells for less in American stores as measured in dollars. It costs more energy to make a TV in Japan than it does in the United States. Why does a Japanese electronic product cost less relative to an American product? The trick is the currency is manipulated to allow the foreign TV to cost less as measured in dollars. Currency manipulation is possible because money is no longer backed by anything tangible. The United States damaged itself by printing unearned money once the gold standard ended. The foreign competition took advantage by doing the opposite. Countries like China adapted a policy to devalue their currency. Devaluation is difficult or close to impossible when global currencies are back by a tangible item such as precious metals. The devaluation is a two-step process. China internally decreases its currency to make it worth less than it should be, this hurts China's savers. However, a profit is made by China by manufacturing and exporting their products which undercut American prices. This transfers the manufacturing to China. The general Chinese population benefits due to the multiplier effect, which manufacturing causes. All the steel workers laid off in Pittsburgh are replaced by Chinese steel working citizens in China. American steel fails and China steel gains. The Chinese steel is not less expensive than American steel. It takes more energy to make the Chinese steel versus the United States, yet due to simultaneous domestic American money printing and the foreign devaluation the measure of the value of steel in a unit of currency makes the Chinese steel appear less costly in money as measured in dollars. The second step occurs when the American Steel manufacturer completely fails allowing the Chinese the ability to raise the price making further profits.

What if each home builder could adjust the distance of a foot? Than price per foot would be in chaos, just as the values of currencies are in chaos. The builder is constrained by the physics of distance, but the money printers have no constraints unless the currency is backed by something physical.

As a result trade became unprofitable due to changes in policy, making the United States of America generally inefficient (too much energy spent for too little wealth), price inefficient, not skill inefficient. An international transaction domestically is profitable for the domestic business making the trade. Domestic profit gained from foreign trade is a lesser wealth generated versus the profits which would have been gained if the goods traded (the buy and the sell) would have been made domestically. Energy was lost due to the international transaction. Upon observing America's history of trade, beginning in 1972, in conjunction with the end of the gold standard, it is obvious the country's trade began to fail simultaneously as money printing began. Failure is defined as the occurrence of a trade deficit where a loss to national wealth occurs as a result of trading activity where the United States of America would have been richer if it did not trade in a specific year when the deficit occurred.

There has been a trade deficit every year since 1972 at an average of a 3-5% loss of the GDP per year for the past forty-one years at an opportunity cost of 8%, which equals $3 trillion of lost wealth. The last best day for Cleveland Ohio, Erie Pa., Warren Ohio, Detroit Mich., Louisville Ky., almost every city in America except the lucky locations that receive printed money was 1972 when the gold standard ended. An opportunity cost is the expected gain which would have occurred if assets were retained domestically. Adjusting those losses for inflation equals approximately $9 trillion in today's money, a conservative estimate. The United States of America has lost $9 trillion of wealth, simultaneously making our competition $9 trillion richer because of the inefficient domestic management of the American currency. America has had a 3-5% trade deficit every year since the 1970's. A 3% trade deficit when the GDP is $18 trillion is $450 billion. This $450 billion could have gone into the domestic economy, but it instead went into a foreign economy. It is fair to say the present concept of trade has room for improvement. This constant big money loss year after year cannot continue if the United States of America is to remain a viable world power.

The philosophy of trade was established by the European post-Renaissance period (1400s). Europe, a set of relatively small, resource-poor countries, found it necessary to trade if their respective political authorities were to remain intact. Small countries must trade because they can't survive otherwise because they do not possess a necessary spectrum of natural resources. Their economies of scale are too small. These ideas of trade as a necessary economic activity have been engrained in economics for so long they are immune to an alternative view. Is the United States of America going broke from trade? The answer is clearly yes. However, the failure to make a gain in trade may be a combination of other fundamental failed policies which cause the inability to make a profit during an international transaction. The United States of America traded successfully during the gold standard years. America is not small; each state is roughly the size of a European country. American's total GDP is similar to the European common market, America is in a rapid financial decline at the time of this writing and relative valuations are influx. The relative position of the United States of America based on the physics view is due to its natural resources. The United States of America should be a trade winner, not a trade loser, because the United States has an energy resource advantage over all other countries except Russia and Brazil.

From 1776-1972 the United States of America made a gain from international trade. Suddenly in 1972, the gains stopped and have never reoccurred to this date. The concept of trade is not necessarily a failed concept; the domestic economic policies are causing a resource rich nation to be unable to compete internationally, as viewed in the natural science reasoning process of the principles of physics used as an analogy to economics.

The physics view is force push is lessened by (1 minus factors of counterforce) minus the natural counterforces, which are equal to summation of force, which causes the object to change behavior by being accelerated to a new velocity divided by a change in time. Clearly, America is energy or force push rich. This means the problem with making a national gain in international transaction is due to the domestic policies which act as a counterforce to force push.

The analogy of physics to economics based on the physics form of reasoning is force push is derived from electricity plus fuel burned minus the counterforces. It is the counterforces of policy which lessen the ability to export.

If trade is at a surplus, then the United States of America becomes wealthier, but not as wealthy if both sides of the transaction were done domestically. As international trade takes energy away from domestic production the trade deficit is a loss of domestic energy unless the import is an energy item such as oil. The United States of America may make a gain on importing oil because oil increases force push. Japan makes gains exporting and it does not have any oil. This is falsely represented in general media. To import oil is good because the oil enables a gain to occur. However, if the price of imported oil is too high then it may not be true. It depends on whether it is possible to make a net profit off the use if the imported oil. Being energy independent of foreign energy is a false linguistic. More than likely, the price of oil cannot lessen domestic wealth because America's competitors must also pay the same global price. If the United States of America uses imported oil to make a gain, then importing oil is a positive event because the country becomes wealthier.

For a resource rich nation, trade losses are a symptom of bad governmental policy. Government policies cause the counterforces to force push resulting in a lessening of wealth. The summation of force is the foundation of wealth. Having domestic natural resources is the big advantage, however unless policy decisions are efficient bad policy can negate the input of energy. Only the summation of force being increased can it lead to an effect of as increase in wealth, but wealth can be traded away and once traded it is gone. A decrease in the summation of force lessens the generation of wealth and importing lessens the summation of force and results in a decrease in the generation of wealth. If trade lessens wealth then why have trade? A trade surplus caused by exporting increase national wealth. It is importing which decreases American's wealth. Importing (where trade is a negative) implies not to trade or to trade only as little as possible to obtain some necessity which can't be domestically made or obtained. Exports make a gain particularly when the domestic market is saturated. However, imports purchased to meet every day needs clearly decreases the wealth of the importer.

A domestic counterforce due to policy can be counterproductive to the degree that export in general becomes impossible. The circumstances can exist where no matter how trade is engaged in the result is a loss because domestic policies are too counterproductive, making profitable trade impossible. The United States is the third largest grower of cotton, but it exports 65% of its cotton because it cannot make clothing domestically. Raw materials exported earn a very thin profit margin. Profit margins are far superior for processed goods. The seller of processed good makes more than the seller of a raw commodity. Domestic policy is the cause of the America's failure to produce an aggregate national gain from trade even though it has a resource advantage over most (if not all) competitors. American domestic policy is so counterproductive, no matter what an American company does, it cannot compete globally (of course there are exceptions). The problem with exceptional American corporations is many of these are moving to countries with lower corporate tax. Printing money domestically has caused American produced goods prices to increase which prices America out of the global markets, then add the highest corporate tax rates in the world and it is becoming do or die for American businesses to move abroad. American businesses are additionally threatened by countries with lower corporate taxation being able to pay a higher premium for a business relative to domestic buyers. To prevent from being forced to sell American businesses move, mostly to Ireland and England where the corporate taxes are less than half of the domestic tax.

The total domestic summation of force, ((Σf) domestic), available to accelerate domestic wealth is relative to the effect of how the foreign competitor's summation of force is designed through policy in the competing country. If the United States of America trades with a country where the competing country is more efficient than America, the likely result, as observed, is the United States will fail to make a gain from the transaction. When America can't compete then the American people buy imports. The inefficient country is at the disadvantage and the efficient country has the advantage in an international transaction. Add to this problem countries such as China which artificially devalue their currency making their product less expensive when sold in the United States and trade becomes more problematic. Chinese products are sold below the cost of production because their devalued currency misvalues the product. The American buyer is getting too much value for their dollar making the purchase of the import irresistible. Trade competition is a competition of whoever has the least counterforces and most resources. Poorly designed governmental policy lessens the summation of force. Trade deficits are caused by poor policy, not the cost of labor. Labor costs were never a problem when the gold standard was in effect. The cost of a good sold is the energy, technology, raw material, plant and equipment, general societal condition and labor. Labor is only a small fraction of the total, just a few percent.

The United States of America has the highest corporate tax (rate) in the world and it acts as a big counterforce to the ability to produce domestically. In the natural science view, corporate taxation is a counterforce causing a reduction in the summation of force resulting in the effect of a lessening of national wealth. The combined counterforce of over-taxation plus too much government debt (which causes US made goods to be revalued to a higher price relative to the global market), plus other social spending (unnecessary spending on unemployment, because there should not be any unemployment), results in significant counterforces that negate the resource advantage of the efficient American production process, which in turn causes a reduction in domestic production. Excessive money printing made allowable by ending the gold standard has caused prices of American made goods to increase, which is made worse by inefficient tax and debt policies. Inefficiencies make it impossible for the United States of America to engage in international trade at a likely gain. Observe forty consecutive years of trade losses, and now observe American businesses finding it necessary to move out of the country to survive. It is not rational to believe free trade benefits the United States when for the last forty plus consecutive years there has been a trade deficit.

Individual American companies have been able to trade profitably to this point, but trade becomes more difficult as the prices of American goods increase relative to the competition. Bad policy causes the domestic currency to become relatively overpriced making the importation of similar goods less expensive. American makers of products have responded to inefficient domestic policies by producing outside the country, because they can't produce internally and make a gain. The well-known phrase “businesses move American jobs overseas” is obviously meant to distract from the actual cause, which is poorly designed domestic policy. No business would move from an efficient environment. Businesses are not separate from people, business decisions are made by a free people. From 2007 to 2014 there has been a flight of $556 billion of capitalization from the United States to mostly Europe because corporate taxes in Europe at a third of US corporate taxes.

How does one trade profitably? Trade is a competition to make a profit from a transaction. To win a competition is to do better than the competitor. The reason the loser loses is not the fault of the winner. The loser loses because it's the loser's fault. The domestic reason for the failure to compete is not the fault of the foreign competitor. The solution is not to attempt to artificially require the competitor to increase their price by imposing a legal restriction such as a tariff on their goods. A tariff means a failure to compete. Cleveland football is saying the only way to win against the Pittsburgh Steelers is to require the World Bank to mandate the Steelers players wear ankle weights when they play Cleveland. The legitimate way for Cleveland to beat Pittsburgh is to be better than Pittsburgh, not by attempting to pass a law that forces Pittsburgh to be worse. The way to win the completion is to make goods better and cheaper than anyone else. To make things better and cheaper implies an advantage. The United States of America has the resource advantage versus almost every other country in the world. If US policies were efficient, it would be very difficult to compete against America as was observed from 1776 to 1971. The policies must be rewritten to enable the United States of America to have the most efficient summation of force.

America's competitors are cheating on the value of their currencies; out and out cheating. However, it is close to impossible to falsify currency valuation when money is linked to something physical.

In natural science there is evidence which leads to theories. If it occurred once, then it can reoccur, making observations important. Rome out produced the world for three hundred years, than England did so for three hundred years. The United States of America traded at a gain for one hundred-ninety six years until the gold standard ended. Japan became a world class competitor from the 1960's to 2000's until it started printing massive amounts of money.

Germany has increased its wealth through exporting, but only because it's internal capacity to consume has been saturated. They export 7% more than they import and 40-50% of their GDP is from exporting. However, Germany is in trouble because the European Union is becoming a money printer. This is a common scenario for many countries that do not have resources. The exports made by the United States only make up 13% of its GDP and there has been a 3-4% deficit every year since 1972. Having a 4% deficit is a big number because the country must grow at 4% just to have zero growth.

Currently, China has been making a net gain from global trade for the past twenty years. But Rome, England, Japan, Germany and China are relatively natural resource poor compared to America.

Only America has a clear natural resource advantage versus the rest of the world. To fail to make a gain from trade is purely a domestic policy failure; there is not any other possible explanation. Our failure is our fault.

Why trade? The purpose of international trade is to make the domestic nation wealthier. The European view of trade does not apply to the United States of America because of the size difference between the countries. Also, there is a significant resource difference between all of Europe and the United States as well. The United States has more gas, oil, coal, water, and arable land than all of Europe. The concept of trade when applied to the United States should not follow the conventional theory. America should invent its own unique theory of trade where it makes a gain every year from trade. This trade theory should be based on the ability to generate the least cost summation of force.

If demand can be met by internal production, but the demand is met by an import despite the domestic capacity to make the same item, than a loss in trade occurs because it takes energy from the United States of America to import. An import means American energy is transferred to a foreign nation. Businesses exporting cause a gain to the domestic GDP. However, if there are more imports than exports a net national loss occurs. The very act of importing is an energy loss, regardless of whether a gain occurred to the individual. An import is a loss of domestic energy. It takes domestic energy to purchase an import. When the United States loses energy it loses wealth because wealth is a direct proportion to energy. If General Electric lost money every year they would go out of business even though some decisions within GE were profitable. American owned energy generates the ability to consume. When consumption is used to buy an import then the wealth is lost to the foreign exporter. Here is the answer to the underlying truth to the phrase, “Buy locally/buy American”: in the analogy of physics to economics it is only profitable for the United States to trade if the relative summation of force of the domestic economy is superior to the competition. Production is dependent upon the cost of the net force of the domestic economy.

The United States of America is capable of producing 100% of its automobiles, and so there should not be any foreign cars imported. If the domestic economy is incapable of making a product due to lack of raw material or some other natural condition then an import is legitimately necessary. Imported coffee is fine, but imported cars, clothing, etc. is not fine. Demand should be met internally when possible. There should not be importation caused by poor policy because this will cause a decline in domestic wealth. Domestic policies must change if the United States of America is going to become wealthier.

Italy does not have iron ore, oil, gas, or coal, and therefore it must import. The same is true for Japan, which has very few natural resources. China imports raw material and energy to manufacture and export. Italy, Japan, and China are not energy independent, yet they all out trade the United States. Conversely, America has all the iron ore, metals, coal, oil, and gas it needs, and can agriculturally can feed itself, yet it has trade failures (deficits) with all of these countries. A trade failure is when a greater value is imported then exported. The reason the US loses money engaging in global competition is because domestic policies cause the price of American goods to increase to the point where imports replaced them.

The reason America imports is because its domestic summation of force is too weak or too expensive to meet domestic demand and too weak to fight off the competition. Weakening the input lessens the output. The best economic policies should maximize the input by keeping the counterforces to growth suppressed as much as possible. It is not a resource problem; it is a policy problem. The United States is too weak to produce even though it is energy rich; it is the most energy rich nation on earth. The country is not being beaten by the competition although it is losing to the competition. It is America which is causing its own failure through failed domestic policies of too much counterforce against force push.

### Kuwait Versus the Ohio.

Just south of Pittsburgh, Pa. the mighty Ohio River winds through the Ohio Valley and has ten times the mass flow rate of the Colorado River. If the energy of the Ohio River was generated into electricity it could power four states. It also passes through some of the richest clay deposits in the world, and within the area there is an abundance of oil, gas, and coal resources. Electricity can be taken out of the Ohio River without building a dam, via patent 8,890,353B2 and 9,297,354, B2 the electromagnetic hydro conveyor. I invented the power generating hydro conveyor to illustrate the natural abundance of naturally occurring energy. Energy can neither be created nor destroyed. This means there is a finite amount of energy in the universe, but in practical terms there is more energy on earth then man-kind could ever use. There is as much energy within the Ohio River as it would take to pump it backwards. All the energy in America could not pump the Ohio River north.

The hydro conveyor concept is to narrow the river to cause an increase in the velocity of the water. The narrowing could be a mile long for example. Rather than using a paddle wheel to cause a turbine to spin, instead use an elongated conveyor to capture the energy of the entire mile of a high velocity current. This can be repeated many times over the length of the river. The low cost and volume of power would allow low cost manufacturing which no one could compete with. Unless, of course, taxation, debt and unemployment were allowed to increase to the point where net force was reduced to zero or net negative force due to the counterforces of governmental policy.

This is the best region to manufacture flatware, plates, coffee cups, etc. products with ample water, rain, clay, coal, gas, and oil to extract and bake clay. There are many other similar places in the United States with similar resources. However, given all of these resources, there are only a few large makers of clay flatware products remaining in America; all the others have been put out of business by global competitors who do not have nearly the resources America does.

Kuwait sells coffee cups in Ohio for less than a cup can be produced for in the Ohio Valley. Kuwait imports clay from central Europe, imports water from outside its borders, and also imports natural gas to bake the imported clay. Then it ships the product by sea 10,000 miles, unloads it, and again ships it 500 miles over land to Ohio to sell it for a profit. Cheaper labor is not the reason this is occurring, because labor is only approximately 7% of the value of the item sold. It costs more than 7% just to ship.

The reason Kuwait can outperform the United States is because its relative summation of force is significantly greater than America's summation of force per person. The American-made coffee cup costs labor+clay+energy+shipping+government debt payments+the highest corporate tax rate in the world+the cost to pay people not to work (twenty percent of the working age population)+domestic currency (dollar) increase relative to the competitors currency. Domestic made products have price increases due to the US government printing unearned currency (which drives up the price of all American-made goods). It all adds up to the inability to compete even though the American coffee cup has the natural resource advantage. America's natural resource advantage is being wasted due to inefficient policy.

The counterforces to the generation of wealth are taxation, government debt, the cost of unemployment and printed unearned currency. In later chapters guaranteeing jobs will be discussed. To guarantee a job is a social science concept; to pay for it is a natural science solution. The fact is, a guaranteed job can be inefficient, but it is less inefficient than the welfare payment, because welfare recipients produce zero, and this causes an expense without producing anything in return for a wage. An efficient resource rich society can easily have work for all its citizens. Automation reduces counterforces, and therefore increases jobs. Observe the industrial revolution. As machines were invented more jobs were needed to produce more. The reason jobs being lost due to automation in today's market seems problematic is because the current economy is a job poor environment. Businesses cannot start because taxes are too high.

The present day counterforces to force push in the USA are too great to allow a domestic coffee cup maker the ability to compete against a resource-poor competitor 10,000 miles across the sea. Observations are the foundation of physical principles of truth. Social science cannot answer the question of how to generate wealth, improve trade, or be more efficient, because social science can easily be mispracticed as it is not deterministic. Good science produces good answers and vice versa.

Allowing America to have the highest corporate tax rate, to become over 100% in debt relative to GDP, have too much unemployment, print unearned money, and pretend it is efficient is bad science. How wealth is generated is better addressed from the natural science methods of analysis as the physics view recognizes the laws of the universe which, clearly understand the concept that to have an effect there must first be a cause. All events have a cause or else there would not be an event. The failure for a resource-rich country to compete must be caused.

The concept of trade from an American point of view is that, if the objective is to make the United States wealthier, it should not follow the same concepts that originated from the post Renaissance European period. Trade for a large, resource-rich country should be first to maximize domestic wealth by generating the lowest cost force push in the world and then pursue the minimization of counterforces. It is essential to accurately value economic activity with a currency which is fixed to a basket of elements or difficult to produce compounds. Trade is an economic life-and-death struggle of competition of the domestic summation of force against the foreign summation of force. The United States of America has the natural resource advantage and sufficient economy of scale to improve its wealth more so than all other countries in the global market place. The United States' trade deficit (loss of wealth) is a measure of mismanagement.

### Chapter XVIII

### How to Accelerate the American Economy with the Principles of Physics

The best place to begin to understand the concept of a change in wealth is to apply the methods of natural science via the laws of physics, which is the ability to do work from energy, where the change in effect equals the cause of work done plus heat. To apply physics to the economics view for the purpose of increasing the aggregate wealth of the United States is to explain an increase in wealth is caused by a change from an external input. An input from an internal source causes a net loss to the economy. Printing money or food stamps is an input from an internal source and has the net effect of an aggregate economic loss. Only an input from an external application of energy changes the net output. Unless the input changes first them there cannot be a change in the output secondly. Work done upon in physics is an output. Work done plus heat is the output of the system caused by a net external force. The output will always experience some loss of energy due to heat. This is important because any input will lose some of its usefulness. This is why printing false money of any kind results in a net loss to the economy. Energy is used to print unearned money, distribute it, account for it, and the energy used subtracts from existing wealth and the result is no gain plus there is a loss due to friction resulting in a net loss.

To become wealthier in economic terms means a change in wealth. The change in wealth is an output caused by a change in the input as a net force. To become wealthier energy is applied as a force push. Opposing forces reduce the force push to a force net. A net force is the force push minus the counterforces as a net gain where there is a change in the input caused by a change in the energy in. The net force accelerates the economy and a change in velocity occurs in a change in time. The change in velocity is the evidence the kinetic energy changed as an increase. The change in kinetic energy is proportional to the change in wealth in this model (ΔKEαΔw) where w=wealth.

The change in velocity is the change in the transaction rate. The transaction rate is the velocity and in acceleration the velocity changes in a change in time (Δ(transaction rate/Δt))=the change in velocity in the change in time. To become wealthier as a nation is to accelerate, which means more transactions. When there is a change in energy of the system the result is work done by the system plus heat.

Physics is a method of reasoning to understand observations, it can analyze how to go from a starting point and an ending point, it has disciplines, principles of truth. It uses mathematics, and is rigorously defined to solve and seek answers to difficult questions. How to accelerate (increase the velocity of transactions) of the American economy is a question very similar to the question of how to increase the acceleration of a physical object. Physics methods explain how force push is counter acted upon by opposing forces resulting in a net force. The net force accelerates the object of study, the velocity increases and the kinetic energy increases. The change in kinetic energy in the analogy of physical to economics is proportional to the change in wealth.

Wealth is generated by altering natural resources (renewable or not) from an initial condition or state to an altered condition or state. Wealth comes from iron ore changing state being altered to an automobile, a tree being transformed to a house, coal being transformed to heat, and so on, which has a cause derived from an input.

The process of economics is as follows in Table 6:

TABLE 6
Process of Economics

The origin to energy is made useful
Force is applied and energy is transferred
Applied force goes to the force push minus counterforce = net
force or the summation of force
Force net is positive
Force net = Σf (summation of force)
The Σf is the cause
There cannot be any acceleration unless caused by a summation of
force Σf
The economic system is defined as the ownership entities of a free people.
To change the speed (transaction rate) of the ownership entities requires
net force to be applied from outside the system.
Σf → owner ship entities → results as acceleration
(change in the transaction rate/change in time).
The cause, is the summation of force → [the behavior of the object
changes (economy)] by a change in velocity/a change in time
(Δv/Δt) → [the effect is the change in wealth] due to
the input of a change in energy divided by a change in time divided
by kinetic energy initial
ΔE/Δt/½ mv²ᵢ
The change in energy equals the change in kinetic energy which is
proportional to the change in wealth as an analogy of physics to
economics.
ΔE = ΔKEαΔw
There must be a cause → to have an effect
ΔE = kinetic energy αΔ wealth in the analogy of
physics to economics

Than to increase the speed of the American economy requires applying an increase in force net as a change in the cause. It requires positive net force to cause a change to the current velocity, resulting in a change in velocity in a change in time of the economy. By considering the analogy between physics and economics, it is possible to understand the principles required to improve the economy. Just as a net force must be applied to a physical object to accelerate it, so must a net force be applied to the economy to increase wealth.

The purpose of this work is to explain how to make the United States of America 100% wealthier, by increasing the current GDP of $18 trillion or its initial value to $36 trillion, in eight years by growing at approximately nine percent per year by following the principles of the physics to economics model. As of the writing of this work (2016), the gross domestic product (GDP) of the United States is approximately$18 trillion. The definition of the GDP is very problematic because it includes every artificial dollar ever printed, and the GDP also includes government debt or government spending, which is a negative event; even though this practice is incorrect the objective of this work is to double the GDP (correctly accounted for) in eight years. Government debt or government spending depletes wealth and should not be included in determining GDP unless as a subtraction. The total GDP should not include any government spending as government spending detracts from production and reduces the wealth of the people. The above comment regarding the faulty calculation methods applied by the government reported GDP total is to clarify the objective of a 100% increase in wealth of the United State in eight years is not an attempt to use trickery in accounting methods, which is currently being done. The objective is to achieve an approximate annualized growth of 9% for eight years, without printing money, or without including government debt as part of the GDP, or any form of government spending whatsoever. The objective is a real change in wealth of a 100% increase legitimately calculated, which means everyone in the United State becomes wealthier.

A principle of physics is that an effect must have cause. To increase wealth is to actually change the behavior of something physically. A physical alteration in behavior (change the velocity), to make kilograms of mass change speed follows specific rules of natural science and those rules, laws and principles are purposefully designed to reject trickery by accounting methods and other means. Of course science does not think in terms of avoiding trickery, however current methods used in government accounting are incorrect. In the physics to economics model acceleration means a change in the transaction rate with an assumption that a profit is generated in each transaction. Accelerating the US economy to make the aggregate nation wealthier should simultaneously make everyone in the nation (employed head of household) wealthier as well. The distribution of wealth occurs naturally and can also be part of the profit sharing methods. There must also be a payoff for jobs that have a naturally slower rate of transactions but not at the expense of the total economic rate of acceleration. However, supporting or sharing benefits of an accelerating economy with varying valued jobs is not a level playing field concept. Attempting to establish sameness in the micro level in the natural science way of thinking actually decreases energy and in the analogy of physics to economics a decrease in energy equally decreases wealth. To increase is an imbalance because the force push is greater than the counterforces. If force push equaled force counter than the net force would be zero and the economy would be stagnant. Natural science rejects the hypothesis where sameness is a positive. Something the same next to something the same does not have any transference of energy. Molecules in a body of mass move at different speeds, never moving toward sameness. Some things naturally move toward equilibrium and some do not. Policies forcing too much sameness would needlessly require energy to cause sameness which means the energy used would be wasted for non-production purposes. People worried about the environment must understand a poorly designed economic system uses more energy than it should. To tax climate changes will result in more energy used to overcome the tax. Not taxing corporations would cause less energy used and less pollution.

This means to become wealthier is specifically not to be the same. The only way to increase average wages is to increase the aggregate economy. An object accelerating has in increase in internal energy throughout the object. Spreading wealth must be part of an acceleration or the nation becomes poorer. The objective is to provide an increase in wealth, which people want. If wages are artificially increased without an increase in total output than the total system loses energy due to the energy expenditure of implementing the artificial decree. Any event forced upon the natural order costs energy. The decision is how to spend the energy wisely to maximize the wealth and power of the United States. Wages can go up, but more stuff must be moved in the same or less time. More transactions are necessary and must go faster relative to the original time used. The way to increase wealth is to enable gains in wealth to be broad based but without sameness.

As we say in America, it's “a deal you can't refuse”. The idea is to move the average pay of a $50,000 per year worker to $100,000 per year without inflation trickery, while generating a retirement benefit providing 100% of pay at retirement of age 60. The observation is, free people, free to become whatever it is they choose to become, generate the greatest amount of wealth. The observation is wealth is greatest among the freest. Freedom is a condition which enables the most transactions to occur at a profit. Wealth is derived from energy than not wasting generates the most energy, in turn, causing the effect of the greatest wealth. It takes energy wasted for an authority of the state to reduce freedom, than wasted energy reduces wealth. There still must be civil orderliness where social science methods are necessary, but suppressing freedoms causes the conditions of an inefficient economy. For example, social science can take the form of a harsh dictatorship, allowing oppression, and corruption, or conversely, be something positive like a constitutional system. This means the results of applying social science can be random or inconsistent, making it subservient to natural science as a problem solver. Natural science is not a morality, it is just efficient. Efficiently is important because it determines the wealth of a nation. A solution enabling process is where the betterment is the intention, to cause a longer life span, increase military power, and to secure freedom is most likely to derive from applying natural science. There are forms of social science reasoning which have historically proposed freedom claiming that state control over human activity and suppressing basic rights where ownership is forbidden is the best way to improve the human condition. Historical observations make it clear the freest people generate the highest order of social existence.

The answer to how to increase wealth is best served by the application of the natural science process of laws, truths, principles, and mathematics, to maximize wealth for the betterment of humanity, to make life better by doubling the real pay of the average worker. To double pay in physics means to actually earn twice as much because twice the work was done. Work done is caused by applying a force for a period of time. The only way to make certain the average worker receives a substantial gain is to increase national wealth. The solution offered in this work to increase wealth offers concepts on how to enable participation by every worker without causing a detriment (counterforce) to acceleration. Economic solutions are not in consideration of the political authority. Suppressing freedom prevents the conditions necessary to competitively become strong.

If there was not a political constraint what would the physics to economics conclusion be? Political parameters can be set aside when considering a theory. How to make the United States wealthier as a theory begins with the assumption there are not any rules. What does the theory conclude without compromising with existing policy. The physics to economics says the United States should be a lot richer. Fifty years ago American's global market share was at least twice the current share.

To become wealthier means to increase the summation of force to accelerate the economy. What increases wealth begins with the transferring of energy from natural resources to the economy from the push force of generating and consuming energy. Mass, or the system (the object of study) cannot be accelerated without push force being greater than the counterforce which is a positive net force. There is an assumption society will not purposefully attempt to make itself poorer therefore there is the assumption that transactions will be profitable and any increase in the transaction rate will increase wealth. The energy it takes to accelerate something bigger is greater than accelerating a smaller mass or system. To become wealthier as a nation by intent assumes a greater generation of energy by intent relative to the size of the United States. It is true a smaller economy can be accelerated more than a larger economy with the same amount of energy. The size of the economy is the number of economic entities engaged in transactions. The goal is not to increase the size of the economy, but to increase the wealth of the economy. To become wealthier relative to the global competition, then it means acceleration of the economic system, to increase production, and accelerating it occurs by increasing the change in ownership via more transactions by free people faster, as in more stuff is sold faster. To become wealthier is the effect from the cause of net force being applied via the force being in contact with ownership entities of free individuals who own both the input and output of production including the production process itself.

Only by free individuals owing production is production capable of obtaining the information of the cost of inputs making clear the required balance of inputs to output necessary to meet demand. Only individual ownership can obtain the information to be efficient. In order to beat the competition and use energy most efficiently production must be owned by free individuals and not subject to policy regulation to the point where it is impossible to be profitable which would lead to the economic entities ceasing to exist. Given the United States resources, an industry failure in aggregate can only be explained by the cause of a policy failure. The United States produced 90% of all automobiles globally in 1950, but in (2015), it only produces 5%. Policy caused the decline in market share based in the physics analogy view. America is physically the richest country but it cannot make a ship, coffee cup, t-shirts or thousands of other products either.

The steps to increase the wealth of the United State are as follows:

Begin with push force and generate more energy. More energy is a cause to increase; less energy is a cause to decrease. Burning American coal (the cheapest form of energy other than hydro power) in China does not solve global emissions. Exporting coal to America's competition makes America poorer and the competition becomes richer because the competition has cheaper energy, which provides the competition with a superior summation of force. Competition is the summation of force of the United States versus the foreign summation of force.

Hydroelectric power is the lowest cost and most environmentally friendly (carbon free) form of power. Niagara Falls powers New York City five hundred miles away and Hoover Dam powers Los Angeles five hundred miles away from the Colorado River. The Ohio River, which is untapped power has enough energy to power Ohio, West Virginia, Pennsylvania, Kentucky, Indiana, and more. Hydroelectric energy from the Ohio River outperforms the international competition unless the competition has a similar river. The Ohio River can be used to generate energy without building a damn of elevation. This is possible because of the hydro conveyor concept (U.S. Pat. No. 8,890,353B2 and U.S. Pat. No. 9,297,354B2) which captures the energy of the river over a greater distance versus a paddle wheel concept. There is enough energy in one mile of the Ohio River to dramatically change the wealth of the United States if tapped properly by the hydro conveyer. Currently the United States uses four trillion kilowatts per year. There is another trillion kilowatts in the Ohio River, which is an extremely low cost energy and is available for production.

Speed is distance travelled divided by time (d/t): to travel a distance in less time means to go faster. Regulation increases time, and to increase time is to go slower. Eliminate regulation as much as possible and place constraints on creating any new regulation. The regulation should tell coal mines it will not have new regulations for the next one hundred years; this enables the mining operators to input the capital improvement necessary to mine efficiently. Same for the ship builders (who have been put out of business by regulation), coffee cup makers, the steel mill, and so on. In physics, to increase time is to slow down. Note, it takes more energy to overcome an unnecessary counterforce. Regulations waste energy and the wasted energy causes climate change, if one believes in such. In physics as velocity increases pressure decreases. It means acceleration naturally reduces pressure. Regulations should be lessened as acceleration increases.

Taxation is a waste of time or it increases time, which is to slow. Get rid of all taxation associated with societal involvement. People should not spend any time regarding taxation. The financial system can deduct 10% of its annual flow independently of the government and give the government a set 10% of the annual flow, fixed for one hundred years. For example, if 5% was earned on bonds and the account holder only receives 4.5% and the investor would not care. A half percent can be taken from annual gains or a small percentage can be taken from banking transaction is not a concern. A thousand dollar deposit will lose a few cents before interest is added back. The point is, make the taxation small enough so no one either cares or can notice. This way the behavior is not affected and time is not wasted by businesses dealing with it. The people will spend zero time on taxation because their payments are indirect. This way the everyday citizen and business can spend time and effort pursuing the spontaneous natural direction toward increasing wealth.

The government budget should be fixed at 10% of correctly calculated GDP with 3% going to military. The tax amount must be fixed for hundreds of years to end the constant manipulation. Government debt or deficit, or spending artificially produced currency of any kind is forbidden for two hundred years. Neither federal government bonds nor state and local bonds can be issued. There is not any government borrowing because government borrowing is simply taking assets from the very people who generate the wealth. To take from the wealth generators is to reduce wealth. The United States is capable of acquiring a 30% global market share and so the 3% share of the GDP to the military will still be the world's largest military budget. Very few people need to work for government because their labor will be needed to generate a much larger global market share. There is very little welfare because there is a high employment rate. Jobs are guaranteed and to refuse to work results in no jobless benefits. Government expenses are very low relative to the business killing, high tax, high regulation, high debt, and the high cost welfare system which are occurring presently. The government is obviously incapable of managing its own budget, so this process must be moved into the hands of private banking (excluding a central bank) who must have a specific interest to keep taxation at a fixed 10% of annual growth generation. The penalty for error is embedded within the financial system and goes to competing banks. The value of the currency is backed by a basket of elements, eliminating money printing so the banking system will not have to struggle with currency valuation adjustments. Banks can competitively bid the cost of capital daily and live by their bids. Bids too high will hurt them and leverage is reduced to 30% on assets. Banks and brokers must separate again to control risk similar to the Glass Steagall Act. Foreign currency manipulation will be adjusted before entering or leaving the United States at the detriment of the manipulator.

Redesign the budget to a fixed one hundred year 10% of banking flow that cannot be increased in any way except for war and government borrowing is forbidden. Debate on increasing the budget is also forbidden. Money can borrowed to fight a declared war. When the declared war is over, and if we win, then the fixed budget goes back into effect. Flatly eliminate any possibility to increase government spending of any kind. If there is a need for more money, than the solution is for domestic wealth to increase, that is, go earn it. Increase the summation of force otherwise there is no other way to obtain more money.

The money printers, and the government bond issuers use the plight of the unemployed as justification to create a dominating, freedom depleting, over cost, and over regulatory government to justify creating debt. Money printing and government debt or any subset of any kind must be prohibited. The solution is simple; guarantee everyone a job, have the businesses pay, and make it voluntary. Remember business owners are paying zero taxes under this concept so there will be revenue to hire in exchange for no taxation (a win-win). Those who choose not to work are appropriately scorned due to the fact they are a true bum and receive no support of any kind from the government which is actually the tax payer. Tax payers are exempt from supporting those who refuse to work. This reduces the political power of those who refuse to work. The welfare budget goes to almost zero, the welfare workers get jobs making stuff, and it is far more efficient to make stuff as opposed to paying people not to work, even if they are bad workers. Making stuff makes America richer; paying people not to make stuff makes the country poorer because energy is wasted. The truly disabled are guaranteed truly disabled jobs. A dancer with a leg injury can still work at something other than dancing. Someone who can't do anything, of course, receives the help he or she needs, but there should be very few of those cases. Use the hydro conveyor to increase carbon free electricity by 25%. This will translate to an increase in economic gains as long as government policy is made efficient.

Note, to make a law upon a person is to hire a non-producing deputy whose salary further reduces production due to the loss of capital and to finance the deputy. The deputy who does nothing more than watch the one whom the new law regulates is wasted labor, wasted capital, and wasted energy. The more laws passed, the more deputies need to be hired. As the laws grow and grow, there are more deputies than ship builders. Note, the United States lost its ship building industry as well as all those who serviced and sold to the ship builders, when the inefficient laws drove the ship builders out of business, along with driving all of their suppliers out of business, killing millions of very high-paying jobs. As a result of the failed US shipping business, the Chinese, Koreans, and Europeans make ships. Although they do not have nearly any of the natural resources America has, they succeed in beating the US because America overregulated itself. The United States has iron ore, oil, gas, and coal to make ships. Korea, China, and Europe do not have iron, oil, or coal. Yet the United States can't make a ship but resourceless countries can. Every law passed requires someone to watch the law-breakers and that someone who is watching is not working at the mill making wealth, but instead wasting resources watching others. Suppressing freedom wastes energy and reduces wealth.

Saving is important to increase wealth because savings increases the aggregate system making the US wealthier. Savings adds capital to the American Economy. The capital from savers builds businesses, supports research, invents and gives the country a competitive advantage because there is more capital. In physics, saving is stored energy. Sharing wealth nationally is a profit-sharing concept not a redistribution concept. Profit Sharing generates stored ability to consume and means all American's own stock in American businesses, which gives everyone a vested interest in seeing American companies be as profitable as possible. The profit is distributed to the shareholders because they are the owners and they can take pride in their own success and wealth accumulation. Ownership provides financial security to everyone who puts forth an effort to work and work is guaranteed. Everyone who works saves at least 10% toward their own retirement, in wealth accumulation accounts, and people can save as much as they want, but 10% in mandatory. Employers must pay at least 5% into the employee's retirement, but employers are also free to pay more as they try to attract and compete for talent. All the money saved buys stock of exclusively American companies. There are not any government or corporate bonds to invest in for retirement, because bonds as a type of investment are debt which depletes wealth. Some portion of the stock is non-voting, enabling corporations to raise capital without losing ownership to some degree. Some stock can mature into finite payoffs, acting like a bond, but it is part of equity and most importantly it is not debt. This generates a flow of capital, American capital to American businesses, which everyone participates in via stock ownership. Buying non-U.S. stocks for retirement account is forbidden.

The fear for the stock investor is not a fear of a low return, but a fear of a down market for a prolonged period of time. The solution to controlling volatility and suppressing the harsh movements of the financial system (macroprudential) which is not difficult. Stop over leveraging. Over leveraging assets is the largest cause of market volatility. Most of the up and down movement of stock prices, assuming no business problem, is due to borrowing. Being able to buy two dollars' worth of stock with one dollar down causes the 50% up and down movements in stock prices, which frighten the average person. Commodities can be borrowed against twenty to one causing 95% swings in commodity prices. This damages faith in the financial system and suppresses broad based capital infusion. Too much leverage is replaced with very moderate leveraging. Stop over taxation of businesses, because taxation reduces the summation of force. Taxation is a counterforce. Businesses are leaving American, which has a 35% corporate tax rate and moving to countries who have 10-15% tax rates on businesses. Change this to where American businesses and all individuals pay zero income tax because taxation is through the flow of capital within the banking system and Congress is forbidden to alter the 10% taxation limitation. Use a commodity basket of items (not exclusively gold), that are impossible to counterfeit as the basis of the value of money, such as iron, zinc, copper, cotton, wood, corn, and beef. Then the workers are investing in the ownership of American companies who have a summation of force advantage over global competitors, which will in turn generate strong unleveraged returns. If money printing is forbidden, the result will be whoever has the highest summation of force (force net) will also have the price advantage. Any nation with an abundance of natural resources is the big winner once money printing ends. Add an insurance component to retirement savings, with competitive fees simply by placing 10% of savings, in a commodity basket to insure against loss should markets be weak at the time an individual retires. The insurance component is not leveraged; it is an asset deposit of rock solid stability because it is made up of real assets. Everyone wins. The $50,000 earner saves at least 15% from age 20 to age 59. Therefore, the 39 years of saving 15% or $7,500 per year at the long-term average return of the American stock market of 11%, the total accumulation is $4.4 million in a personally owned account that is tax free, upon retirement the assets should generate a normal debt return of 6% in the world lending system, which is $260,000 per year for life. People can pass this on to their heirs. The eleven percent annual return on assets is the long-term history of the American stock market before the government began putting unearned currency into the economy. There are no income taxes, so the individual is free to work longer if desired with no penalty, because there are not any taxes on individual behavior to penalize and no deputy watching to see whether taxes are paid. There is no IRS because taxes are pinched from the financial system without disturbing the ongoing concerns of citizens. All the government employees who were taxing the people are now working in the industries making stuff. The banking system must be restructured where 100% of all deposits are safe. This means leverage must be reduced. Safe deposit boxes can never be threatened with confiscation. Anyone who threatens to confiscate personal assets is charged with a crime which carries a mandatory nonnegotiable penalty of 20 years of hard labor without the possibility of parole. If people don't trust the system they will not put their capital into it.

Resources transformed from nature are where wealth comes from and the transformation is done by energy. What slows the economy? It is the counterforces to applied force which are due to policy or there is too little electricity plus fuel burned generated. The opposing forces to growth are dominated by taxation, government debt, and the cost of unemployment, and by the force drag of nature, due to gravity and friction. Of course, any policy which reduces assets available for production reduces production. All policies are an expense to the generation of wealth. Policies must be designed to minimize the effect on growth. Thinking in physics makes this obvious.

The economy consists of ownership entities of free people, is the object being accelerated, and so by its velocity being changed, the behavior of the economy results are a change in the transaction rate which leads to a change in wealth.

The cause of the generation of wealth is the generation and consumption of energy, which applies a push force on the economy. What slows, stops, or even reverses the force net are the counterforces of policy and the natural counterforce of force drag. Societal policy, which is the counterforce in economics, reduces wealth. Most problems are the result of too little wealth. Most policy creations are devised by the methodology process of social science, which fail to grasp the cost of the policy, which further shrinks wealth and can never increase it because a counterforce always reduces force net. Wealth is lessened by any asset taken from production regardless of the form of the subtraction. Printing money, artificially low interest rates, rent control, food stamps, and quantitative easing, are all counterforces to wealth because such policies are not energy and energy must be reduced to implement policy. Only net force derived from energy can be the cause to affect an increase in wealth. Although reducing counterforce can increase net force there first must be force push derived from energy. The proposition that false money causes a gain violates the laws of physics because something cannot be created from nothing, matter cannot be created or destroyed, which is a law of physics as a first principle.

The State of Ohio has more natural resources than the state of Delaware, and therefore Ohio has more potential to be wealthier than Delaware. Yet Delaware outperforms Ohio because Delaware legislated efficient corporate laws, and as a consequence more corporations are established there resulting in more activity at the expense of other states. In the physics analogy to economics the counterforce to establishing a corporate charter is equal among all states. Each American state establishes its own corporate rules to some degree, and so, inefficient rules cost the state wealth. Delaware is more efficient economically than Ohio because it is taking resources from the other states simply because other states are being out smarted. Delaware's corporate rules are better than Ohio's and so Delaware has greater wealth, per unit of resource.

New York State is losing business because it taxes far more than most other states. They are trying to stop the outflow by offering new businesses coming into New York a ten year, zero business tax rate as an incentive. This means New York's government knows, without a doubt, taxations is a counterforce.

Florida does not have state tax. They get it. Florida is wealthier than Ohio. Taxation is a counterforce to wealth. There are millions of different methods to design policies where the detriment to growth is minimized. By applying the methods of physics as opposed to purely social science it becomes apparent less taxation, less time spent on taxation, zero debt, and full employment plus more generation of energy results in a greater output of wealth.

Wealth is an output derived from an external input to the system or economy. Just like any business, revenue comes from some activity outside the business. If a business spends wealth painting its own building there is not any new wealth generated due to spending its own money on maintenance. There is a loss to the business in the cost of the paint, plus there is a loss of energy due to friction. The net effect is the business is less wealthy. It is an identical problem when government takes peoples assets and spends it on road repair. The aggregate wealth of the nation declines by the cost of the repair plus losses in energy due to friction. A shovel ready project, the popular phrase used to explain government spending on roads and bridges is spending which decreases the nation's total wealth. To become wealthier the economic net force must increase. The net force is derived from energy and is external to the system. Fixing a bridge is taking money from stored wealth and spending it is inside the system. A system cannot increase itself by using its own internal energy. A person cannot fly by pulling upward on their pockets. Government policies which proclaim to improve the economy by spending money on highway repair or anything else actually makes the nation less wealthy. To increase wealth the net force must increase. Resources must be managed efficiently relative to the competition for the wealth to be maximized.

### Chapter XIX

### Physics Applied to Economics as First Principles Versus Keynesianism

The objective of this work is to increase the aggregate (total) wealth of the United State of America by 100% in eight years, which is an annualized growth rate (time) of approximately 9%. Why have an objective to increase wealth? Why not keep wealth the same? The answer is in the observation of human history, where only during periods of a new real increase in wealth did actual betterment in humanity occur, such as longer life span, more leisure time, more freedom, and greater inventiveness. Plus, there also is a physics-based assumption from observation where humanity has a spontaneous, natural behavior to seek betterment, as evidenced by the current standard of living today versus one thousand years ago; betterment is nature's course. A thousand years ago the average life span was age twenty-five, the majority of the population was suffering from hunger, poor living conditions, lack of education, and there was constant conflict. Western civilizations and now most of Asia has a life span close to eighty and few are starving in America, Asia and Europe, excluding the mentally ill and addicted. I see this as the first step toward the greatness of humankind; we are learning enough to accelerate, if we choose to do so. The chapter title “Physics Applied to Economics as a First Principle versus Keynesianism” is a comparative analysis of the problem-solving methods of physics, the Physics to Economics Model (PEM), relative to the social theories of John Maynard Keynes, a 1930's socialist economist. The reasoning process used in physics and other natural sciences has been absent from the discussion of what the best solution might be for the American economy in order to achieve the goals of betterment through greater wealth. This work is introducing the reasoning process of physics by explaining how physics would solve the question of how to significantly increase domestic wealth. How does the physics view compare to the Keynesian view? Why choose to compare Keynes' theory to physics. Why not some other social science economist?

John Maynard Keynes's theories are significant because the US government has implemented Keynesian methods in the past, and they are doing so now in 2016. The theories of Keynes, an Englishman, are also being utilized in many countries around the world, even countries of differing legal structures and founding philosophies. His most famous work, The General Theory of Employment Interest and Money, was published in 1936 and since it took years to write, it is reasonable to assume he wrote during the beginning of the Depression which started in 1929. Historically, 1936 was seven years into the Great Depression, where little economic improvement was either occurring or was in sight, particularly from an English interpretation. The general well-being of Europe from 1929 to 1945 was bleak. The United States was an economy stuck in weakness, but a Depression-era America was still a rich nation with a relatively high standard of living compared to Europe. The GDP of the United State reached a high of $104 billion in 1929 and did not recover until 1941. In 1936 the GDP was only $84.9 billion annually, approximately 20% lower than the high. To make this relative to the present, the big recession of 2000, and even bigger recession on 2008 each only had a GDP decline of −2%. The 1929 high of $104.6 billion bottomed in 1933 at $57.2 billion (−45%) and there is not any modern, post-world war similar event. The Great Depression was twenty two times worse than 2008. Europe's suffering had metamorphisized into the loss of democracy in Germany, Spain, and Italy, which was the majority of the Western European's economic continent. Those nations turned into communist dictatorships. Where freedom was replaced with government brutality and Russia had succumbed to dictatorship in 1917 as a result of World War I. From an English point of view the world was failing and worse, threatening the existence of the Great Brittan and its culture.

Keynes, not an intellectual but an academic economist by his own words, said he did not like all the “math symbols” used by classical economic theory of (mathematical theories) reasoning. He said he was influenced away from classical economics, which he studied in his youth (see chapter 24) and drawn to a view of dominating government control over basic freedoms such as individual income, spending, savings, and other personal freedoms. Keynes was English, and England does not have a constitution that proclaimed individual rights as necessary neither did English law consider personal freedom paramount which is not the constitutional American view. It is typical and usual for English or European economic theories to offer solutions to economic problems by lessening individual freedom, and taking property from one group that is perceived to have too much. Robin Hood is an English story. Given most of Europe at the time of Keynes's life was still had significantly influenced by royalty, taking shots at the rich monarchs was politically easy shooting. Many of Keynes proposed solutions to economic problems are quite unconstitutional from an American perspective. There is not any disrespect implied toward Keynesian philosophy simply because of the differences from an American point of view where, Keynes is both anti American Constitution with its Bill of Rights because the English have never agreed with American freedoms. The English fought America twice (the American Revolution and the War of 1812) to control its human freedoms and they lost both times. He wrote from his English world, a royal world which collapsed during the First World War ending in 1918 and then eleven years later it started falling apart again economically. After the roaring twenties the Great Depression began in 1929. It looked like a new, even worse war was on its way by 1936, creating an environment of social failure plus military dysfunction. Europe was anything but stable, giving way to alternative theories to classical economics.

Others have criticized Keynesian theories as not fundamentally plausible such as Henry Hazlitt's, The Failure of the New Economics, An Analysis of the Keynesian Fallacies. Hazlitt picks apart almost every paragraph of Keynes's writings and notes the conflict with basic economic (from a free American's perspective) principle of reasoning, observation, and mathematics. He notes when Keynesian methods are applied, what actually occurs is in conflict with what Keynes said would occur. Hazlitt observes applied Keynesian policies actually make a nation poorer. Hazlitt does not offer a principle of natural law as to why Keynes is incorrect, but he does attack his theories item by item, and he illustrates most of Keynesianism cannot work over time. Yet the U.S. government is still applying Keynesian methods to the present day (2016), to our detriment as evidenced by the debt-to-GDP ratio. Currently, the United State is over 100% in debt with an almost impossible chance to correct the problem without wide spread suffering. It will be the middle class suffering. The suffering comes from the loss of value of saved assets. Anyone dependent upon their savings is having their wealth taken from them and the cause is government debt. National debt in the 100% plus range prevents future economic growth killing the future for the young and deriving the retired of a reasonable income. The expense of the debt suppresses business research making American products less innovative.

The following is a summary of Keynesian theories. The intent is to accurately state his theories and not alter them. There is not any attempt to alter this view to set up criticism during the counter point of view. His theories are not complicated, however he writes in a wordy style, that was typical for an English academic of his time.

Keynes last chapter (24) of his 1936 master piece, The General Theory of Employment, Interest, and Money states, “the outstanding faults of the economic society in which we live are its failures to provide for full employment and its arbitrary and inequitable distribution of wealth and income”. He further says the income tax is the best solution, along with the death tax, to suppress too much income. He notes the objective of the taxation is for “measures of redistribution of income”. Therefore from his view taxation has multiple purposes, not just to create civil sameness but additionally to suppress the income of the nation state.

Keynes rejects classical economics (a free economy by free individuals) and offers a new theory of governmental control. He says, “the weight of his criticism is against, laissez-faire” in chapter 22.

The Keynesian hypothesis of what makes a given economy operate is its source of spending from:
Individuals
Business
Government
Foreign (export)

Without this spending, there is no economic activity in his view.

The detriments of the economy (chapter 14) are as follows:
Savings
Investments
Consumption
Interest rates of borrowing

His theory is to use external government authority to alter the outcomes of economic events.

He states in chapter 4 that quantitative science is in a conundrum and cannot establish a unit comparison of many economic events, and therefore there are “no solutions”. He means there are not any solutions from the scientific (natural science) point of view because natural science is in units as a scientific form of calculation. Based on his theory, where scientific solutions are impossible, then his solution is government control.

In chapter 12 he states, “It is usually agreed that casinos should, in the public interest be inaccessible and expensive. And perhaps the same should be true of the stock exchange”, where he suggests speculation is bad for the economy because speculation is a source of instability.

In chapter 14 Keynes states the base premise of his theory, which is the rejection of an economic system that has balance, or equilibrium and he postulates natural balance is impossible. He rejects the tendency toward equilibrium as a natural phenomenon. Much of his work is stating the facts of the condition of the Great Depression (at the time of his writing) as the evidenced by how an economy is void of progress, bogged down and permanently out of balance.

Printing unearned money as a solution is introduced chapter 13 “we are tempted to assert that money is the drink which stimulates the system to activity, we must remind ourselves that there may be several sips between the cup and the lip.” Clearly he believes printing unearned money is the solution to improve an economy. The Keynesian theory postulates an economic system can never be in equilibrium, and so permanent and ongoing government money printing dumped into the economy is necessary, which is referred to as “stimulus”. He argues against the gold standard, claiming the wealthy have an advantage in accumulating gold and silver, making easy access to money difficult for the average person. Politically it is easy to attack the rich, and by ending the gold standard the door is open to printing money, referred to as “stimulus”. He calls it the “drink of stimulus”, which is very similar to what the American government calls it today. Linguistically, a theory will use words people tend to agree with as opposed to unpleasant or harsh sounding terms. Factually, printed money is unearned money, printed for no reason, not related to documented economic activity in truth it is just plain old fake printed money. It is fair to say Keynes's theory is predicated upon printing unearned money and dumping it into the economic system. No one likes a theory which says fake money is the solution, so the word “stimulus” is used by Keynes, but “stimulus”, simply means printing unearned money. However, it is important to understand Keynesian theory is based upon the premise where an economic system, which is unable to balance by itself can be made stable by printed money as the artificial counter balance, enabling full employment to occur as much as possible. His theory says the source of jobs is from printed money.

Keynesian theory is based upon the failure to establish economic balance (ongoing growth) as a principle of observation during the 1930s, giving way to the necessity to counter balance the economy by using artificial unearned money as the input which would be the cause to growth. In Keynes's mind, he can apply an input of unearned money and the artificial money causes an effect where the effect is more employment. His understanding of cause and effect is the cause is fake money and its effect is an increase in wealth.

The basis of his theory is the economy is moved by spending derived from four primary sources of individual spending, business spending, government (domestic) spending and foreign spending, (in the form of international trade). The solution is to artificially cause an internally derived increase in money and add it to the spending system, and as a result a change in something will occur, which is the outcome of more jobs, which will be caused to come into existence as a result of printed money. The artificial money is the cause in Keynes's theory, and the output of jobs and economic improvement are the effects. Therefore artificial spending equals more work; is the basis of the Keynesian theory.

The printed money (stimulus) is expected to increase demand by consumers, because consumers demand more by wanting (to spend the printed money they were given). Economic activity must increase due to the input of artificial currency being printed. The Keynesian theory is, spending drives the economy as the, “prime mover”, and if spending is stuck, (as he believed it was in the 1930s), then prices will not change, becoming rigid. In order to break the jam up, putting stimulus (fake money) into the system will cause an effect and cause a change upon the system by the “prime mover” of artificial currency.

It is important to note, at the time of Keynes's theory there was very little government debt in the 1930s, unlike now. During the Great Depression, the United States was only 16% in debt. Then Keynes's little sip of government deficit spending, means increasing spending and it is synonymous with an increase. By stimulus he intends to increase government debt (accumulated debt) and deficits (annual government debt), which is to literally print fake money by issuing government bonds or by other methods. Due to the fact there was very little government debt in the 1930s increasing debt did not seem harmful. He meant a little sip (no too much debt), perhaps giving him the benefit of the doubt because there was so little debt at the time. Also, his observations were prices were not changing because during the depression activity (transactions) were actually very slow to change, and in fact there was seemingly a truth to the rigidity he observed. It would be interesting to show Keynes today's world where most of Europe is 100% in debt to their total output, along with the United State which is also over 100% in debt and unbelievably Japan, which is 230% in debt. All have an economic growth rate of essentially zero. Too much debt suppresses the ability to grow, but he misses this fact. The zero growth is exactly what Keynes was fighting against. I wonder if Keynes would go along with his own theory if he could see the result today.

Keynes accepted on-going inflation and, the deprecation of personal assets of the people's stored savings as acceptable. He understood the value of everyone's saving accounts would decline as suffering necessary to bring a rigid economy into forward progress. The result of printing money is the loss of wealth of the people's assets to cause jobs to occur by using (confiscating) personal property as the basis for his theory. Taking assets from people is a common European concept which the founding fathers of the United States specifically targeted not to do as noted in the Bill of Rights. In addition to his theory which was supposed to be an academic theory he also criticized European's royalty of “Lords and Barons”, who he said hoarded tons of gold and silver in their coffers. “Therefore let's pry some wealth loose from their selfish possession”. This is a very European view because there are not any royalty (Lords and Barons) in America. However, cleverly, the phraseology to attack the successful in the present is the “top one percenters” is code for Lords and Barons. This point is only noted because as Keynes wrote, he also mixed in an abundance of socialist based, “worker”, phraseology to further his marketing, perhaps at the expense of some stronger facts. However, he was selling his view and so he was given his academic freedom to convince his readers, which he apparently did given the wide spread application of his ideas.

This fairly represent Keynes's theory as accurately and as briefly as possible for comparison purposes to an alternative view from the natural science analogy of the physics to economics method. Keynes's thinking is the essence of social science, and this work is diametrically opposed to the reasoning process proposed by Keynes.

### The Physics View Opposing Keynesianism

In order to increase the wealth of the United States of America as an objective there must be an initial cause, which results in and effect. This process can be explained by the methods of natural sciences such as by the field of study of physics. This work advocates using natural science, as opposed to social science, as a reasoning process to solve many of the current economic challenges America faces. These methods lead to principles that are diametrically opposed to Keynesian theory. Accurately understanding Keynesian economics can help clarify the differences between the application of social science methods and the opposing physics methods.

The natural science branch of physics is based on principles, which are derived from actual observations, repeatable experiments, and established laws and truths and formulated using mathematics to understand the interactions of the world of matter, mass, force, space, and time. Physics methods consider a process that has a starting point and an ending point, often referred to as the initial condition and the final condition, which are measured. Physics is a reasoning process introducing concepts and formulas which seek to describe how the initial position of an object which resists being moved, does in fact move to a new position; and then explain why the change occurred. In physics there must be a cause for an event. The cause must be defined and clearly explain why the event happened. Without a cause there is inactivity in natural science. There can be random behavior without a cause, but the economy cannot be operated randomly. In natural science, an event is caused and the result is the effect from the cause. There are rules, laws, observations, concepts, and formulae to explain the principles of how the cause and effect behave. A cause is always from an origin, which is the “prime mover”, and in physics this is energy measured in joules. Energy allows the operation of force that interacts with the natural world of mass, to change the behavior by accelerating it which results in an increase in kinetic energy. When the object of study accelerates the cause of the change in movement is the summation of force, meaning the cause is the summation of force, which has an origin. The origin is energy and the summation of force is a net force which can accelerate the object of study. Although the acceleration from the net force is immediate it takes time to change the kinetic energy. Importantly, the cause always comes first, and this is not reversible. The ancient Greeks (Aristotle) used the phrase of “prime mover”, to describe the cause of a change and it is still used today. The prime mover might be an easy way to understand the origin which is responsible for the cause which is the input. As the net force causes the object of study to accelerate, the object changes behavior by changing its speed and kinetic energy. Energy is the only cause of acceleration. The cause is first and the effect as an output is second when the only way the cause has the capacity to be a cause is because the cause is energy.

To change wealth is to change the output. The output is from an acceleration of the transaction rate as economic activity. Energy must be applied to accelerate the object. The object as the economy is accelerated by a change in velocity in a change in time, which is the change in a transaction rate in a change in time. More profit results from an increase in transactions. The result of more transactions is an increase in wealth as a change in wealth. The output cannot cause itself. The input causes the output.

Cause and effect are not reversible. The output cannot be used to generate the energy of the input in a practical sense. The output cannot exist unless there was an input first because the output is a result of acceleration caused by the input of energy. Only energy can cause acceleration. A cannon-ball, once shot, cannot be reshot of its own accord without the ignition of the gun power from the cannon. The cannon-ball in flight is an effect of a ball being accelerated. An attempt to shoot the cannon-ball faster, or to shoot a bigger cannon-ball, would never be applied to the ball when it is in flight because the ball in flight is an effect, and the effect comes second in the order of occurrence. To adjust the ball in flight is to first go to the cause, which happens first. In this case the cause lies within the capacity of the cannon and not the ball. The ball is a constant. The ball does not change; its behavior changes by being accelerated, where the net force applied by the cannon was the cause.

Natural science is a process and the methods of physics enabled the modern age machines. This includes the digital machine plus, aviation, electronics, computers, and medical cures, which are all a result of the application of methods of natural science. Much of economics is mining, shipping, distance, melting, forging, and changing raw material into products. All of these events involve the interrelationship of mass, distance, and time. The only way mass can be accelerated is by applying energy. The only way mass can go distance in an interval of time is from the input of energy.

Comparing the natural science reasoning process such as physics to economics to the social science thinking of Keynesianism is a comparison of the principles of truths and laws of natural science vs. a social science which is not designed to be deterministic. Even Keynes said, too large a portion of economics is merely the concoction of a maze of pretentious and unhelpful symbols (paraphrased see chapter 24). He did not like mathematically derived conclusions. So much of the modern world depends on those pretentious little symbols and so does economics.

Natural science has principles that establish a discipline which must be followed to effect an outcome within the confines of the natural world. The theory must conform to the data or else the theory may be flawed. To illustrate how Keynesian theory conflicts with the principles of natural science viewed by the physics form of reasoning, see the following short list of a few laws of physics. This list is abbreviated for ease of use, and it is a very short list as there are many laws of physics and some with lengthy descriptions. The purpose of this list is to compare some basic laws of physics to the base concept of Keynesian theory.

1. Something cannot be made from nothing (matter can neither be created nor destroyed).

2. Something cannot be turned into nothing (matter can neither be created nor destroyed).

3. Every effect has a cause (Σf=ma) (Newton's second law)

4. The cause comes first and then the effect comes second in the order of occurrence (Σf=ma).

5. The order of occurrence in the cause and effect are not reversible (Σf=ma).

6. Newton's first law: an object at rest tends to stay at rest, and an object in motion tends to stay in motion. (Σf=0→←dv/dt=0).

Newton's second law: the summation of force equals mass multiplied by acceleration

Σf=ma (the force on an object equals the product of the objects mass and its acceleration).

Newton's third law: a system cannot exert force on itself because forces in the universe are equally opposed. Every force is opposed by an equal counterforce. To expand upon this, it means to move the object to acceleration requires an external force to be applied which is greater than the counterforce of the object.

1. The change in internal energy equals work on an object done plus heat into an object.

2. The universe tends toward equilibrium.

3. Two objects cannot occupy the same space at the same time.

Nothing true is contradicted by observation and the laws of physics are observable truths.

The natural science view, is that a given theory must conform to the laws, observable principles, and the restraints of natural law to have validity. In order to adhere to these laws truths cannot be broken or else the theory cannot be true. To lift 10 kilograms straight up against the force of gravity requires a force greater than the 10 kilograms multiplied by gravity. Acceleration cannot occur unless primarily energy using force actually interacts with the object of study and the force is greater than the counterforces. In the order of occurrence, the energy is first and then the effect upon the object or system being accelerated over time occurs secondly. Therefore the process of energy first as a cause and acceleration occurring, even though immediately, as an effect from the cause and cannot be reversed. The effect cannot go back and generate an originating energy. The cannon-ball at rest in a field after being shot cannot go back to the cannon on its own and cause the cannon to do anything.

Using the laws of physics as an analogy between physics and economics concludes Keynesian theory does not conform to the laws and reasoning of physics. The natural science physics method of economic growth is derived from the input of energy which cannot be either created or destroyed. Energy is generated by converting the stored energy in some resource (oil, gas, sun, rotation of the earth) to electricity plus fuel burned. The initial cause of applied force is counter acted upon in economics by reactive forces, such as expenses caused by governmental policy and also lessened by force drag due to friction from gravity which results in a force net. It is the net force interacting with the economic system that causes acceleration. The net force increases the transaction rate between the ownership entities which is an acceleration, (change in velocity in a change in time), resulting from the transfer of energy from the input to the output. The assumption that production is owned by free people ensures transactions are profitable, because free, rational people will not enter into an unprofitable transaction voluntarily.

To grow the economy is to accelerate it. This is a law of physics and is observed in economics.

An effect cannot be altered unless there is a cause and the cause must involve energy. There cannot be an effect unless energy is applied. The net force is required to enable the effect to exist.

To become wealthier something must change. There must be a value added somewhere.

The value added is an effect where raw materials are moved from a natural state to an altered processed state. The change in value between the natural state and the processed state owned by a free people is how wealth occurs. An increase in wealth is due to a change in production of raw materials. Production uses energy. Service business or service transactions are not value events, service does not cause value, and its function is to distribute post generated value from production. Service transactions are buying and selling goods already made. Service is activity within the system. To change wealth, there must be an input external to the system. Efficiencies occur within the system as part of the effect. Efficiencies are not energy and occur secondly in the order of occurrence.

The cause in the change in wealth is the input of net force external to the system which accelerates the economy causing a change in the transaction rate. The change in the transaction rate is the evidence of a change in kinetic energy and is proportional to the change in wealth. The net force comes from energy. Spending is part of the transaction, but not the base cause. The transaction rate is the velocity of the economy. It is not possible to cause acceleration which is the change in velocity unless energy is applied first. Keynes is saying he advocates changing velocity caused by spending. Spending is a sub set of a transaction. A transaction is accelerated by energy. In time the speed of the economy increases as a change in the energy as the output. The change in the energy output as the change in kinetic energy and is proportional to the output as the change in wealth. The output is the accumulation of energy which is proportional to the accumulation of wealth. An output cannot be increased by an attempt to increase velocity ignoring the fact that velocity cannot change unless energy is input first. There can be two types of spending; spending money earned by production or spending unearned money printed by the government representing nothing.

Spending unearned money without any additional input depletes the system. To spend is to take from something which was originally generated by energy and stored. To spend is to take from stored energy or stored wealth originated from energy. To spend is the use of energy. Spending just can't be. It has to come from somewhere first. Spending is the application of internal energy from the economy. When internal energy is used the economy shrinks. Spending unearned money shrinks the value of stored wealth and shrinks the energy in the system. A change in spending if internal to the system depletes the energy of the system making the ability of the ownership within the system less able to consume. An automobile is not made to go faster by attempting to increase the velocity without stepping on the gas first. The velocity of the car is a result of the fuel burned in the engine first. The physics to economic model is electricity plus fuel burned minus counterforce equals a net force. The net force accelerates the transaction rate (velocity) in a change in time and in time the kinetic energy increases. The change in the kinetic energy is proportional to the change in wealth.

Spending unearned money and expecting it to improve the economy is like pullingup on ones belt loops and expecting to fly. Newton's third law is for every action there is an equal and opposite reaction. If printed unearned money is nothing and it pushes on the economy then nothing should happen. However, printed money does change the demand for those few who receive it. To cause a demand change the printed money must be something. As unearned printed money pushes on the economy the economy must push back. It pushes back with stored wealth. Whatever entity is pushed on the entity pushes back. To push the economy with unearned money will be pushed back with stored wealth. Spending unearned or borrowed money cannot move the economy forward to a net gain because the economy pushes back using stored wealth. To make the economy increase can only be done by a net force external to the system. The force external to the system must be derived from energy and the net force accelerates the aggregate economy to increase wealth. Wealth is an output from an external input.

Keynes's view is that spending is a cause of economic growth. The physics view is energy is the cause of economic growth because to cause economic growth is to change the rate at which of the ownership changes hands. Spending is not energy from outside the system therefore spending cannot be a cause. Printed money in itself is nothing; therefore its ability to consume comes from stored wealth.

The physics to economic view is energy generated added to the system results in the output of an increase in wealth. The energy input is transferred to the output as a change in kinetic energy which is proportional to the change in wealth. The change in artificial unearned money results in a decrease of stored wealth equal to the amount of artificial money, plus an additional decrease in stored wealth due to friction. The net effect of printing money is a net loss of national wealth.

Using unearned money to stimulate demand is a confusion of terms. When the government states they are going to either stimulate demand or stimulate the economy the people will make the assumption there will be an improvement. The method of the government applies to stimulate the economy is to print unearned currency in excess of what currency properly reflects actual wealth generated by production which occurs from energy.

Printing money can only stimulate demand for some, but not all. As a result of the printed money all national prices rise. The rise in prices due to printed unearned money results in a loss of business activity which lessens demand. Printing unearned money causes inflation, which increases domestic prices and depletes the stored wealth of savers. It also lessens the profits derived from transactions causing growth to slow. Higher domestic prices lessen America's competiveness, which lessens domestic manufacturing and increases the consumption of imports further hurting the American economy. Further loss of wealth occurs due to friction which is the cost in time of labor and energy to actually print the unearned money and disseminate it. There is a character issue. Does a national who prints unearned money have the character to lead? The lack of leadership and character have negative business consequences. The lack of character may not seem like a physics concept, but in the analogy of physics to economics view trustworthiness is a counterforce to force push because it is a condition or property of the economy. The transaction rate takes more energy to accelerate in a corrupt system.

The premise of the physics view is energy is the cause and it occurs first. The “prime mover” is energy in the physics view because there cannot be change in the natural world without the application of force net. This means the change in wealth can only occur by a change in the energy first. Keynes's prime mover is either printing unearned money, lowering interest below its natural state, or government borrowing (creating government debt) used to stimulate economic activity all of which are forms of printing unearned money. Printing money as a means to generate wealth violates the laws of physics. Keynes's theory is that demand can be stimulated by unearned money which is made from nothing and cannot be true if the objective is to increase the national wealth. This violates the laws of physics because demand is an effect from a cause, and an effect cannot be stimulated by an energyless nothing. Only a cause can change the effect, and the cause must be energy. The theory of attempting to stimulate demand is not a chicken and egg argument. If demand means aggregate domestic demand than it is impossible to stimulate because this theory believes acceleration can occur without an input of energy. Acceleration is only possible due to a change in the input as a summation of force which is a change of energy as an input. The aggregate artificial stimulation of demand cannot occur unless caused by the depletion of stored wealth of others. The net national effect of any form of stimulus whatsoever is a net loss in total national wealth. Stimulating demand also violates the occurrence order of cause and effect because the effect comes second in the order of occurrence as demand is the effect side of the equation. The effect cannot be stimulated because an effect can only occur due to energy as an input and money is not energy. The cause comes first, and only a cause can alter the condition of the effect. This means in order to change demand, an actual cause derived from an increase in the summation of force must first occur first. It cannot be argued printing unearned money comes first because energy cannot be created from nothing. Printed unearned money obtains its ability to consume by taking from stored wealth. It violates physical laws to say energy or matter was created from nothing. Note, the objective is to make the nation wealthier and everybody in it, not to make those who print money rich at the detriment of others. Money printers do become wealthy, but this can only occur by taking the value of saved assets from the people plus friction. The people lose their wealth as the money printer's gain. Printing money by the authority of a police mandate requiring the people to accept it means the money must go into the economy as the unearned money and its value is derived from the stored energy or stored wealth of the people's savings. One does not become wealthy by having the value of their assets depleted. Whose wealth is being depleted? It is mostly the average wage earner who loses wealth. The government claims the economy is better, prices are back to normal and the unemployment rate is good again, but they leave out the part where a car costs twice as much as it did before the money printing started.

In physics to affect demand requires either an increase in force push (increase energy) or a decrease in counterforces (decrease taxation, decrease government debt, and decrease the cost of unemployment in some combination) or both increase force push and simultaneously also decrease counterforces or reactive counterforces. Keynes also advocates a low-cost capital theory. This theory violates physics because the cost of capital cannot be arbitrarily assigned because its value is determined by physical factors. Capital must overcome the forces of gravity and friction by applying energy and energy has a cost. It takes energy to mine, ship, load, and unload iron ore because only energy can move the iron ore. The essence of capital is physical, and something physical cannot be altered from its natural state except by energy. Invention could lower the cost of capital. A rail road moves mass more cheaply than men with a rope. Once the railroad exists the cost of capital will reflect the cost of rail shipments and there will not be anyway to lower the cost of capital until a new invention occurs. An artificially low cost of capital is essentially printing money, which is a violation of physics if the theory is printed money is something other than a subtraction from the value of savings. Nothing cannot be something, therefore printed money cannot move mass unless it takes from stored wealth. Keynes's central objective is full employment. Employment is work done. Labor is a factor of production, which is an effect from the input of energy. Electricity plus fuel burned externally enters the economic system when the system remains constant and the output is work done. Unless energy is added to the system to cause the work done there cannot be a change in employment. Employment is derived from energy and unearned money lessens the energy within the system and does not add energy from outside the system. Keynes is taking stored wealth from the system to attempt to alter the amount of employment. It takes energy input into the system to alter resources. Jobs are the process of the alteration of resources. To increase employment or have more jobs to do more work requires more energy. Either the energy comes from outside the system as energy generated or the energy must come from stored energy within the system. If the energy comes from within then the system is depleted. In economics to deplete the system of energy is to decrease the aggregate wealth of the nation. Keynes advocates printing unearned money and artificially lowering the cost of capital by the authority of the government to cause an output. He succeeds in causing an output but he did so with stored wealth where the net effect is a decrease in national wealth. More, higher paying jobs, like ship-building require an increase in energy as an input or as an increase in the net force. Unemployment is an expense, and so giving assets to the unemployed is a counterforce, not a force push. Keynes is correct in advocating full employment, but full employment can only exist when there is sufficient force push to allow it to exist assuming the value of jobs are not lessened. Keynes is incorrect in thinking unearned money can cause employment without causing aggregate national wealth to decline. Only energy can be force push. Keynes advocates using debt from government borrowing or printing money to cause force push in order to obtain full employment, which actually results in the opposite effect. Debt is a counterforce and printing money results in a loss in the value of stored wealth greater than the value of the printed money. Unearned money put to use by the authority of a police decree lowers the value of stored wealth, taking assets from those who saved. A hundred kilogram stone cannot move from rest with zero force applied. To move the stone there must be either new energy generated to apply the force push or decrease the counterforces or use stored energy as a force push. Using stored energy is a depletion of stored energy. Just because the citizen is mandated by the laws of the state to accept unearned money as compensation for work done does not mean in physics unearned money can do work. Unearned money can't do work. How is employment increased from unemployment to full employment? A positive change from the initial employment to a new greater employment (an increase in jobs) and can only occur by an external change in the input of energy as a net force. The external input of energy is transferred to stored wealth as an accumulation. The stored wealth derived from energy is used to consume. Using unearned stimulus money will cause the initial employment position to decelerate to a negative employment occurrence. Unearned money takes energy out of the system and with less energy there is less work done. The people's wealth must be lessened when unearned money is put into the economy because the value of the unearned money must come from somewhere. That somewhere is from the depletion of the owner's stored wealth. The force to cause economic activity must be derived from generating energy and not unearned money if wealth and employment are to increase. This is Newton's third law, meaning the system cannot stimulate itself. Keynes is saying he can play pool without a cue stick. He can't. The pool ball will still sit because the pool ball cannot use its own energy to move itself. The pool ball pushes back equally against the internal energy of the ball making movement impossible. Only the external energy applied as a net force from the Q-stick can cause the ball to move. Printing unearned money will not move the ball. Only energy can move the ball. Only energy can employ.

Employment is work done by the system, and in the laws of physics work done by the system is the change in energy plus heat. It means in order to have work done in addition to what is already occurring (increase employment), the summation of force must increase assuming the objective is to accelerate employment from its previous position. A decrease in domestic energy would be highly likely to decrease work (cause un-employment), unless some super-efficiency was introduced. America exporting coal, oil, or gas is the absolute worst action the country can engage. To export energy is to bleed the patient.

Employment cannot be a central theme of economics unless it is simply as a political objective where the political sympathy outweighs the truth of the theory. Employment is an effect from a cause. Energy can have multiple forms, and any of the forms can cause an effect, where the effect itself is a form the transformation of energy. Height is a form of potential energy. Hydroelectric generation uses height to generate jobs because height is converted to energy using the force of gravity to push water to generate electricity. The force of gravity can increase employment but stimulus can't. Printed unearned money is not a form of energy. Printing unearned money takes from stored wealth.

Keynes rejects the physics observation that a system cannot move itself. To change work (cause more jobs), energy from outside the system must occur. The observation is in natural law, forces always have a counterforce, otherwise the universe would blow up, and the earth would spin into space, what goes up would keep going up and so on. The machine age is based on Newton's Laws. A net force is an imbalance which results in acceleration of the object. To make the economy accelerate which means to make a relative gain from some initial point is an imbalance. An imbalance is from the net force. If the net force is removed than the object will remain constant. A net force is when the push is greater than the counter force resulting in a net (positive) force which accelerates the object.

Keynes hypothesis is that the economic world exists in an ongoing (perhaps permanent) state of imbalance, and disequilibrium, which is unable to be affected via the normal inputs of classical economics. Keynes is observing the Great Depression and concluding there is a natural propensity of humanity to be in an ongoing predicament of stagnation, decline, and unemployment. In this view there is an inability to improve the economy making it appear stuck. What Keynes sees in fact is just a segment of time (1930s). However, he has neglected the critical question of how the Great Depression occurred, or why were economic conditions of the 1930s appearing to be stagnant. There was a rapid change beginning in 1929 of a decline of valuations of stocks and tangible goods. It was so rapid the financial systems and the associated institutions had many failures and the demand for goods quickly declined. The United States stock market declined approximately 90%. Keynes never asks why; or perhaps he does not care why because the answer conflicts with his theories. No one knows why he neglected to question the cause of the Great Depression.

In physics, a change of 90% is an effect and that effect must have an origin. Something caused stock prices to rapidly decline 90%. The 90% change can actually help determine the cause. Think of a 90% change as one side of an equation where one side is used to solve the other side. There is a tendency toward equilibrium, but not always. Since the Renaissance period economic events have moved to ward equilibrium with an up and down cycle. Something caused the up and something caused the down. In physics there can be stable (going to equilibrium) and unstable (naturally moving away from equilibrium). The history of economic cycles has behaved with a tendency toward equilibrium. However, acceleration is at the time of acceleration a disequilibrium, which allows wealth to increase. The summation of force is an imbalance between force push and those forces opposing force push. To have economic growth is an imbalance, but an imbalance of force push. This is why it takes energy to cause a net force. It is the force of the energy applied which overcomes the counter force allowing acceleration to occur is a change from net zero force to a (positive) net force. Than a cause which had an origin which resulted in an effect is only one temporary side of imbalance. The input results in an effect as an imbalance then the tendency toward equilibrium or balance occurs. When the banking system inputs stored wealth from borrowing it causes temporary gains and eventually reverses back to its original starting point less friciton. The system cannot make a gain by taking energy from itself by borrowing. Real gains must come from energy generated from outside the system.

The 1920s, the post-World War I period, experienced a force push from the energy generated to enable the war production. A newly formed federal reserve further contributed to excessive borrowing, which is a force push from internal stored wealth and allowing the asset to borrowing ratio to increase to 1:10 for stock purchases. One dollar down allowed ten dollars' worth of stock purchases. This generated a highly leveraged 1920s (roaring 20s) financial mechanism which use stored wealth as a force push to accelerate the economy beyond its ability to process natural resources and to keep pace with the rise in prices. The rise in stock prices was a reaction to the input of 1:10 leverage. It was an imbalance where too much money flowed into the economy unrelated to production. Unearned borrowed money placed into an economy accelerated the price of goods (including stock prices) while masking the decline in stored wealth as an increase in liabilities. A temporary imbalance is natural because the imbalance will likely be corrected by counterforces bringing whatever is imbalanced back into balance or equilibrium. The leveraging of one dollar down allowing ten dollars of leverage creates a change in leveraging of 90% ( 1/10−1=−90%). The result of a 90% increase of money into the system was not from an external energy and was unsustainable in time resulting in an unnatural in flow which is an imbalance on the upside. Therefore a 90% growth imbalance was created from borrowing in the 1920s which eventually lead to a correction (counterforce) as a rebalance of a −90% negative. The Great Depression was the 90% negative correction back into balance of a policy of over leveraging the economic input during the 1920s. The unsustainable asset-to-borrowing ratio was the cause of the acceleration imbalance of the 1920s, but since it was the get-rich-quick side of the imbalance no one complained or chastised the government for money printing because money was seemingly increasing. Keynes neglects the 1920s entirely. The energy from within the system (borrowed) caused the unnatural 90% upside of the 1920s which inevitably balanced to the correction of a negative −90% in the 1930s. It took time, (ten years), for the 1920s to run up markets, with particularly (World War I) as an additional force push being added to by the high leveraging. Eventually the laws of physics would suggest the outcome of ten years of over-leveraging would result in a ten year decline of 90% as the balancing out of the 1:10 asset borrowing ratio. The upside lasted ten years and the down side lasted ten years and there were little gains in twenty years. What Keynes observed in the 1930s was precisely a tendency toward equilibrium. The 1930s were an overblown negative side to then overblown positive side of the 1920s. It was a law of physics exhibition in action describing the economic environment exactly how physics should expect the result of cause and effect to occur. Keynes's interpretation of the Great Depression as an existence of a permanent imbalance is incorrect because the 1930s was a correction. Keynes misunderstanding is a net force is an imbalance. It takes an imbalance to accelerate. Only energy as force push being greater than the opposing force (a net force) can cause the object to accelerate. To grow the economy is an imbalance caused by externally applied force. Printing unearned money in any form is internal energy from the system which cannot cause the economy to grow. This is Keynes error. The imbalance is likely temporary. The physics lesson is, there is a tendency toward balance in the real world, and it is clearly illustrated by the upside debt push of the 1920s being accurately corrected, described by the down-side-take-back of: 90% up of the 1920s to the, 90% down of the 1930s, ten years up, ten years down as forces which balance. A tendency toward balance did occur over the twenty year period, and the too much leverage being input was untied by the deleveraging coming out in the 1930s. Keynes never calls into question those parties responsible for allowing the irresponsible levels of leveraging of (the borrowing ratio) debt being written into the financial laws. He blames the markets, calling them “casinos”, where the markets only accurately reflect the velocity, quantity, and volume of the input resulting in outputs. It is the government who sets a 1:10 asset to debt ratio not the stock market. Too much input from borrowed money in the 1920s was measured correctly to almost mathematical perfection by the corresponding reduction (deflation) in the 1930s. The markets are not casinos; the markets are a balancing scale. The policy makers allowing an asset-to-borrowing ratio of 1:10 caused the problem of the change in value equal to the ratio of assets to lending. This means the borrowing ratio approximates the volatility. The laws of physics would generally expect a tendency toward equilibrium on a macro scale. The universe is mostly in balance, but slightly not due to friction.

As a brief digression, a point of observation of the asset-to-borrowing ratio that the Federal Reserve will set changes over time. Learning from the mistakes of the 1920s, the stock-to-asset-borrowing ratio was reduced in the 1930s to 1 dollar can buy 2 dollars' worth of stock or 1:2-1 equals a −50% expected change. As expected in the post-World War II era, volatility in down markets mirrored closely the 50% leverage ratio. A 50% up-and-down movement is apparently not enough volatility in asset valuations (stock prices) to disturb or damage the financial system in general. The present-day commodity asset to borrowing is currently 1:20 or a −95% change typically, but it can be 1:100. Given that commodity supplies on earth are known quantities with very little expected change in the annual amounts of delivery how can commodity prices have a 95% volatility behavior? The cause of the volatility is the quantity borrowed versus the actual asset. There is a very clear cause (borrowing) and effect (volatility), where the asset-to-borrowing and market volatility are approximately similar. The 1:20 asset-to-borrowing ratio makes it impossible for the public to use commodities to replace a fiat currency. The real estate volatility of 2007 was caused by “nothing down” mortgages. There was a rapid increase in debt beginning in the 1980s followed by a rapid decrease in value of real estate prices occurring in 2008. Borrowing is a factor of market volatility. Capitalism as a measurement process does not cause markets to be volatile. Capitalism just measures. It is the policy makers which cause recession and depression, not capitalism. It is not within the nature of a free people to cause a depression upon itself.

If the source of the acceleration is from debt or printed money the long-term effect is nothing gained, even though there was an acceleration period only to be reversed in time. Long-term growth can only occur from generated energy external to the system.

When Keynes offers the solution of printing money expecting it will make an aggregate improvement (can't make something out of nothing, which is a violation of the laws of physics), it is a fallacy because to expect printed money to increase wealth is the same as expecting the system to move itself. Printing money and expecting it to be a cause is breaking the laws of physics as a natural science: nothing in must equal nothing out or stored energy out depletes the stored energy. Articfial money as an input cannot possibly cause something out without depleting the system. This is both an analogy to physics and actual physics. Zero force applied cannot be a cause and cannot result in and effect. Much of economics is actual physics. Tons of ore moved a distance in time is physics. If ore is mined with unearned money it means the real energy to mine came from somewhere and the energy was paid for by inflation. Ownership of the ore is a social contract.

Keynes believes the source of economic activity (he does not use the term motion in his theory) is spending from four main sources:

1. Individual spending

2. Business spending

3. Government spending

4. Foreign spending as a result of trade

It is a popular concept to believe spending improves an aggregate economy. However, whether popular or not, it is an untrue belief in the natural science view. The pilgrims generated energy by manual labor making their economic input by physical work. They could have borrowed against their future work, but they could not have changed the input. Their economic input would be the same regardless of borrowing. A poor society could, under the spending belief concept, simply print money and become wealthy. Money is a social contract to measure activity. To trade lumber for money is a contract, and printing money is breaking the contract. Wealth is an output from an input of energy. To change or increase wealth the input changes as a net force. The energy is transferred to altering resources to be sold as a transaction. Money spent is involved in the change in ownership of the product, which energy allowed to happen. It is not possible to increase wealth by using unearned printed money of any kind (stored wealth) to increase the number of transactions and actually increase wealth. To say spending is a cause is to say acceleration is possible absent of energy which violates the natural world. The pilgrims, at zero velocity with no stored wealth, could not print money to change their condition. Money is on the effect side of the equation and comes second in the order of events. Money cannot be a cause as it is not energy, but money can be used to take stored wealth to cause a transaction, but the total economy declines. Money is from inside the system; it cannot change the energy of the system. Only external energy put into the system can change the energy of the system.

The object cannot move by attempting to change the velocity. It is the change in energy which changes the velocity. Spending is part of the effect from an original cause. Without the origin cause, which is energy, there cannot be spending because there would be nothing to spend unless something was first earned via the application of energy. Spending cannot be first because it is an effect. The long-term results are zero growth plus energy lost due to friction which results in a net economic loss. The net effect of printing money is the economy shrinks via the depletion of stored wealth in proportion to the amount of unearned money printed plus the energy wasted to overcome friction. A theory must conform to the laws of physics or it is not likely to be correct. A poor country can't declare government spending and then expect a result. The pilgrims could not simply declare a pilgrim government start spending unearned money and expect and actual effect. Neither poor countries nor the pilgrims possess stored wealth. Artificial money simply takes from stored wealth, which is why neither the pilgrims nor poor countries can print unearned money and obtain an effect. Driving home the truth of this point are actual examples which have been tried and fail 100% of the time which supports this truth. The Roman's progressively decreased the silver content of their coins to the point the coin became worthless and they failed. The Weimar Republic printed their currency into worthlessness and the government failed. The USSR's currency was falsely valued and it could not be used in trade and the USSR failed. Greece could not print the Euro, but they printed money by allowing excessive borrowing, which caused a banking shut down. This has occurred in Africa and South America as well, all resulting in the same outcome. Printing unearned money is believing something can come from nothing. Debt is taken from stored wealth and if there is not any stored wealth then borrowing cannot occur unless the borrowing is from an outside source. This is what the International Monetary Fund (IMF) does: it acts as an outside source of stored wealth, enabling poor countries (without stored wealth), to borrow. The IMF uses the stored wealth from nations who possess stored wealth and give it to countries that do not have any stored wealth. Simply, the IMF depletes the value of the average American's bank account. American truck drivers, carpenters, police men and firemen are made poorer because of the IMF. Spending from debt or artificial money cannot be a cause, and therefore spending cannot create a change in the form of an effect in total. Changing the effect means the cause must change first, and the cause must always be some form of energy applied as a summation of force. Effecting a change in spending requires a change in the summation of force first. To effect spending in a way which allows for an increase in aggregate national wealth in the physics of economics method means either the generation of energy must increase, or the counterforces of taxation, government debt, and the cost of unemployment must decrease or both. The input of energy caused the existence of wealth, resulting in the possession of stored wealth. The energy input comes first. To spend is to take stored wealth, and it is used to consume. To borrow is to take from stored wealth. To print money and implement it into the economy is to take from stored wealth. To take from, is to deplete.

The change in value of privately owned raw materials to finished goods is where wealth, which can be measured in monetary units, comes from. Capitalism is a free people, who own, and measure what they do.

The attempt to alter the effect (spending) is treating the symptom and not the cause. The origin of wealth is energy; energy comes first. To say the economy is driven by spending violates the laws of physics because the occurrence order of the cause comes first and effect which comes second and is not reversible. Spending cannot go backward in time and create energy, because spending is an effect. Spending is a step in the process from the energy generation to the end result of wealth, but spending is not an initial cause.

An additional problem is government spending is included as one of Keynes's sources of spending. Government spending is when the government takes money from the system and uses it as force push. The force push is off set by the loss of the peoples wealth due to having the government take their money. The force push of the government is met with the counterforce of the people's loss, plus friction making the summation of force negative. Individuals can have stored wealth, which they can use to consume (spend), but the stored wealth originated from an applied force. The same is true for businesses involved in trade from a foreign source. However, the government does not possess any stored wealth. When the government spends, it is because it took stored wealth from the people, which is a subtraction from both individuals and businesses, or ownership entities. Individuals and businesses have less than what they earned because the government took from the owner in the form of taxation and inflation. Government spending cannot be a reason the economy grows because the government obtained the money by taxing the people and depleting the peoples wealth. Taxation is a counterforce and a counterforce cannot improve the economy because it lessens the economic input. Roads and schools built were not paid for by government. Money taken from the owners of the money built the roads and schools. Government is not the origin of wealth because government is not energy. Business using energy is the origin of wealth, and business built the roads and schools because production is where the money came from. Otherwise, very poor countries could just tax themselves and build millions of miles of perfectly paved roads and thousands of golden palace schools and declare themselves rich. They can't tax themselves and make a gain because the system can't take its own energy and make a gain.

Communism attempted to design a system of no ownership. Under its design the communist government did build the schools and roads. This design always fails in time because the information needed to understand the true cost of the transactions where there is not any profit in the transaction is impossible. The interrelationship of resources, energy, production, and time cannot be reasoned without the knowledge of output to input efficiency. A loss of ownership is a loss of freedom and this makes economic conditions less efficient. Without free owners a transaction is slowed down, which means velocity is lessened. Lessening freedom will always lessen wealth.

Another Keynesian view is he is anti-savings, anti-frugality. Is this view a smoke screen to hide the consequence of government intervention in the economy? When the government spends, either by money printing or by borrowing, it generates a counterforce for force push. The ability of unearned printed money to cause mass or the system to accelerate is because the value of artificial money is from using the stored wealth of the people. As a consequence, the value of personal savings and business savings owned by the people (stored wealth) are lessened, by the very act of government deficit spending (government bonds) and government printing money via stimulus, or any other form of subsidy which is a subtraction from the people's stored wealth making the national aggregate wealth decline. Deficit spending means the government caused unearned money to go into the economy by spending more than it took in by taxation. The government borrows and causes a deficit by issuing government bonds. Everyone's stored wealth is taken via government spending, the tinker, tailor, teacher, fireman, mom, and children's saving for college; all have their wealth depleted by artificial dollars. Might the people notice the value of their assets declining and wonder why? The ability of government spending to cause action is derived from someplace; the someplace is the people's bank accounts and assets, where this depletion of savings applies equally to men and woman, the rich and the poor. Perhaps this is why he belittled saving: to play down the act of saving because he knew money printing can cause potential opposition if everyone saves.

Philosophically, there are other concepts of Keynesian theory that propose lessening personal freedom. Keep in mind, this work is about becoming wealthier. Freedom is an attribute of the system. It is an economic environmental condition. The greater personal freedom the less energy it takes to accelerate transactions. Energy used to suppress freedom is energy not available for production. It is more than philosophy which purports more freedom allows for greater wealth. Wealth can be viewed as kinetic energy is motion. Velocity is the speed of something in motion as distance divided by time. In physics, as velocity increases surrounding pressure decreases allowing faster speed. As the generation of wealth increases the regulatory pressure must get out of the way, to allow the acceleration of the economy to optimize.

Keynes advocates a less free society, and ruled by an un-seen group. Keynes specifically advocates having individual income and the value of personal savings controlled by government authority, where he never mentioned exactly how this works, or who is doing the controlling. The justification for confiscating the people's wealth is to establish full employment. However, this reasoning causes the aggregate wealth of the nation to decline, which is the opposite effect that is desired by the pursuit of more jobs. Jobs come from energy not printed unearned money. To become nationally poorer is not the road to more and better paying jobs. Such reasoning is the antithesis of the objective in making society wealthier.

Keynes believes the economic policy driver of society is full employment. However, employment is an effect, and an effect is not the prime driver, energy is. Consider Newton's laws of motion. Newton's first law of motion is an object continues in a state of rest or in a state of motion at a constant velocity unless compelled to change by a net force. The reader has learned an applied force has an origin from somewhere, and that origin is energy, where the energy interacts with the object with an applied force. If this force push is greater than the counterforce (reactionary force), or independent counterforce, and force drag due to the force of friction and force of gravity, the object will change its velocity either accelerating from rest or from the objects present speed. Newton's second law describes the effect of the net force. The second law implies to alter the object's speed a net force is necessary. The second law says the acceleration of the object is in the direction of the net force, the acceleration has a magnitude proportional to the (cause) magnitude of the net force, and the magnitude of the acceleration is inversely proportional to the mass of the object, (a big objects takes more net force to move versus a smaller object). The second law can be written as the summation of force (Σf) equals mass (the object of study) multiplied by acceleration or Σf=ma.

Newton's third law states for every action there is an equal and opposite reaction. Whatever is pushed on will push back with equal force. Keynes missed this entirely when he thinks he can have a policy which pushed the economy and the economy does nothing in response. Keynes believes he can use created money to push the economy. Created money is valueless so the equal and opposite reaction of the economy is to push back with stored wealth. No net gain is possible when the input is unearned printed money.

To increase employment in natural science as viewed by physics, while following Newton's laws, would mean that changing the effect of employment would require a change in the cause happening first in occurrence. The net force generated from energy allows the processing of raw materials and jobs are part of that process. An increase in employment can only occur from an increase in net force assuming wages are constant. An increase in aggregate national wages, excluding inflation, can only occur from a net force. Increasing minimum wage depletes stored wealth and no gain is possible.

To employ is to do work which requires energy because the change in energy equals work done. Work done is an output: which means it is an effect. The output of wealth is proportional to applied net force pushing in a forward direction. The expense to live is resistance to force net. The expense to live better is more resistance to force net. To be wealthier requires an increase in force net to overcome resistance.

If the objective is to increase employment, then this can only occur by a positive net force. Employment is from energy which is of the physical world coming from a force push which in economics is due to electrical generation plus fuel burned. If the environmentalists don't like the fuel burned aspect of force push, than there are many other easy solutions. There is a trillion kilowatts in the Ohio River, which is approximately 25% of the current domestic electrical output. An increase in renewable energy equal to 25% of total production has an expected increase in wealth of approximately 10% if counterforces are kept in line. However, one solution not permissible if the objective is to increase domestic wealth is giving American coal to our international competition because they will use the coal to put America out of business. Better we burn it here first to our own advantage because it will be burned anyway.

There is an enormous amount of potential gravity-based energy available in water moving downhill, particularly in the United States. Gravity works for free. Hydro-power is the most efficient electricity possible because over time it costs the least and lasts indefinitely. To obtain the superior competitive advantage is to pay the least for generating energy and simultaneously have the least counterforces due to governmental policy. The environmentalists need to learn inefficient policy burns fuel needlessly, and not a small amount. Having the efficient (least cost, least maintenance) generator of energy (energy is not produced it is generated) and having the least costly government policy is the winner of the global competition. The low cost of energy, the least intrusive policy, plus natural resources is the combination to competiveness. Being competitive is being better. If America is properly managed no one could outperform America's resources.

If the goal is full employment than the physics to economics answer is generate more energy and minimize taxation, (eliminate income tax and use bank transaction tax), bring government debt to a permanent zero forever, also via social policy have businesses partially absorb workers to enable full employment in exchange for zero taxation and minimized regulation, thereby maximizing the summation of force. The result is the effect of increasing net force by reducing counterforces which results in greater net wealth. Increasing force push and decreasing counterforce results in an increase in the effect, because what happens on one side of the equation must happen on the other side. To increase the cause will increase the effect in the laws of the natural world as well as in the analogy of physics to economics.

Keynesian policies actually decrease net force, and therefore they cannot possibly increase the effect. In the physics to economics model increasing the effect leads to wealth. Keynesian policies result in more unemployment because the summation of force is lessened. The Keynesian equation is a decrease in the cause equals an increase in the effect and this is not possible. A decrease in cause must always decrease the effect. The correct answer is to increase the cause, which equals an increase in the effect. The effect is from the cause (energy as the cause) resulting in an increase in the output that increases the rate at which wealth increases and it leads to increased employment as employment cannot occur without wealth and wealth is analogous to energy.

Employment is a result (as an effect) of something that causes the ability to do work. If there is too much unemployment than an increase in net force is necessary to improve unemployment. To increase force net in economics requires either more energy to be generated or the applied counterforces (taxation and the cost of unemployment) and other independent counterforces such as government debt must be reduced or eliminated or both.

Keynes never once considered lowering taxes or government spending on the contrary, he proposed as a solution to use income tax which is purposefully designed to decrease the wealth as stated in his work. In the reasoning process of physical science, taxes are a counterforce and therefore reduces wealth.

Keynes writes as a citizen of constitutionless state (England), ruled for most of its history by a royal family; an environment rife with discontent. As such he uses emotional phraseology to advocate printing money, and has very little consideration for individual rights. Europeans have never had free speech, or mineral rights to their land, or the right to bear arms. European's are less wealthy than American's because they are less free. Keynes sees individual property as up for grabs in order to suit his vision of economics. Government printing of unearned money is certainly a violation of human rights as the life savings of the earners have their property confiscated in value by inflation. He also never mentions who the new ruling class will be yet the new rulers are the ones receiving the income tax money that others earn and the new rulers are the main recipients of taxation plus the printed money. He neglects to chastise the new rulers for hoarding tons of gold like he chastised the old rulers; he simply does not like the old rulers. When income is being suppressed, exactly who is doing the suppressing and exactly who is receiving the income taken from the earners. Perhaps the reason so many governments find Keynesianism desirous is it allows for the increase in government compensation to seem more legitimate. Keynesianism cannot increase the aggregate wealth of a society, but it can certainly make those who receive the taken money from the people richer.

What allows a society to change its wealth from an initial value to a greater value: is an increase in net force.

### Chapter XX

### The Physics Analogy to Economics

It has been common throughout the study of physical laws to consider an analogy to help explain a principle. The analogy draws attention to the similarities between the things we thought to be unrelated. By applying an analogy of physics to economics it becomes obvious many economic functions are based in the reasoning process of natural laws. The social science relationship of the study of the self and the interaction of the aggregate society still must follow in part natural laws. If a society attempts to become wealthier the initial wealth increases to a new greater wealth resulting in a change in wealth. The change in wealth as an event is more deterministic than a social science event and as such an analogy of physics to economics may be more useful in understanding how a change in wealth occurs.

The purpose of this work is to explain how to increase the total wealth of the United States, not by giving to one group at the expense of another, but by generating new, additional wealth, making the nation, not just for some, but everyone in it, wealthier. By applying the principles of natural science to economics and using the reasoning of physics, the answers to questions of how to increase wealth, have the fullest possible employment, and maximizing personal freedoms can become evident. For wealth to increase it is necessary for personal freedom to also increase. An increase is a change in speed. As the economy (a constant) increases speed the rate of change of transactions in time must increase because the acceleration of transactions must occur for wealth to increase. To slow the transaction occurrence is to slow the generation of wealth. Suppressing personal freedom has the effect of lessening transactions. In natural science, as speed of a fluid velocity increases the pressure must be reduced because this is a consequence of the principle of the conservation of energy. Pressure and velocity are inverse. As the economy accelerates the interference suppressing personal freedoms must also decrease because there is only a fixed amount of total energy available that must be shared between kinetic and potential manifestations. If energy is used to control and repress individual freedom then energy is not available to accelerate the economy. As speed increases regulation must decrease. If not than there cannot be acceleration.

In order to increase wealth, and to make the United States richer and stronger, the current concepts of social science must give way to the concepts of natural science. Natural science methods are based upon observations and use mathematics as a tool to solve for deterministic answers, as opposed to social science which is the study of humanity.

Than wealth requires applying energy to move something from its initial state to acceleration. The analogy to economics is the force push is electricity plus fuel burned. The opposing forces are government policies plus the counterforce of nature which equals a net force or summation of force. The object to be accelerated is the economic entity of ownership. Acceleration is the change in the ownership rate divided by the change in time. The change in velocity plus the change in time leads to the change in kinetic energy where the change in kinetic energy is proportional to the change in wealth (Σf=ma→Δv+Δt→ΔKEαΔw).

This means as more iron ore is changed into more steel, more wood is changed into more houses, more soil is worked into more row crop or if this is all done faster than previously done the result is a change of wealth.

Energy is used to apply a net force to cause the acceleration of more steel, wood, more agriculture increasing the transaction rate in the change in time. The acceleration of transactions is caused by the application of energy as an applied force which can be a net force. There can be any number of social science design constructs and concepts, but changing an output always comes back to, how much net force it takes to move so many kilograms, in a change in distance, in so much time. The external input is need to accelerate transactions resulting in a change of output enabling a change of wealth. If there is an objective for the betterment of the human condition based upon the increase of wealth than much of the answer is derived from the methods of natural science.

Economic wealth as a concept should also have a definition and a method for calculating it, just as energy as a concept has a definition and a calculation method. The analogy between physics and economics justifies applying physics methods to economic problems. Physics considers such well-defined concepts as energy, mass, distance, time, velocity, direction, temperature and the size and quantities which can be calculated in the commonly accepted SI units of kilograms, meters and seconds. Applying the concept of physics to economics is to restate economics, wealth, capital, debt, trade, taxation, and social expenses by an analogy with concepts and the definitions similar to the methods of natural science. The definition of wealth is the ability to consume and wealth is derived from energy. The analogy of physics to economics is the force applied via electricity plus fuel burned as the applied force, which is counteracted upon by opposing the use of energy with counterforces such as taxation, government debt, the cost of unemployment plus the force drag of the natural world due to gravity and friction, which together equate to the summation of force. The summation of force interacts with the system (the object of study) of ownership entities of free people to change the velocity causing the effect of the change in ownership rate in a change in time: an acceleration of transactions. The transaction change in velocity plus the change in time leads to the demonstration of the change in kinetic energy (½ mv²). The change in kinetic energy is proportional to the change in wealth ((kinetic energy=one half the economy multiplied by the transaction rate squared) (E=½eTr²)).

It is typical during a presidential election for a politician to say they are going to create more jobs. According to the Bureau of Labor Statistics the labor participation rate (the number of people working relative to total population) was 66.4% in 2007. In 2015 the participation rate declined to 62.5% or 6.24% fewer Americans have jobs now than they did eight years ago. According to the Federal Reserve the United States was approximately 63% in debt relative to GDP eight years ago (2007). In 2015 the country is 105% in debt. In 2007 the U.S. was approximately nine trillion in debt and in 2015 the debt increase to nineteen trillion. By the end of 2016 there will be 20 trillion in debt while the real GDP is 16 to 17 trillion.

The result of the politician's policy has been fewer jobs and more debt. As an observation, inputting unearned money into the economy caused the total value of the economy to decline resulting in less wealth in aggregate. Why does unearned money (money printed or borrowed by the government) being input into the economy cause a decline in wealth, jobs, and American power?

The analogy of the physics to economic model would predict unearned money as an input into the economy would decrease wealth across all economic categories. An input of unearned money is energy taken from inside the system. Unearned money uses energy already internal to the system, which is stored wealth. Printed unearned money depletes stored wealth and also loses energy due to friction and inefficiencies. A system will always experience a net loss when it uses its own energy. The government stimulus was named quantitative easing and is a phrase which has little meaning other than the government putting unearned money into the economy.

In physics when there is a push on something there is an equal and opposite push back against it. A push of unearned money is pushed back equally against by something within the system. This is why a system cannot cause its own motion. The economy pushes back against the unearned printed money with higher prices bringing the force of the artificial input to zero. However there is always friction meaning when friction is subtracted from the artificial input of unearned printed money input has a net effect of a negative. The ability of unearned printed money to consume in aggregate is a net negative. Unearned money derives its ability to consume by taking from stored wealth within the system, which means the value of the people's bank account decrease as printed money increases causing the price of goods to increase. The average price of an automobile in 2007 was $21,000 and in 2015 the price increased to $35,000. The price increase was caused by economic stimulus or printed unearned money.

The input necessary to increase the wealth of the American economy must come from outside the system and must be actual generated energy or it can come from reducing the counterforces due to government policy. To increase motion in physics can only come from a change in energy or a net force as an input. This is the view of the analogy of physics to economics.

To increase wealth the total force which is electricity generated plus fuel burned lessened by policy and natural drag must equal (assume positive) a net force. It is the net force which accelerates the system resulting in an increase in velocity, an increase in kinetic energy where the change in kinetic energy is proportional to the change in wealth.

What must a politician say if they actually intend to increase employment relative to the initial position of employment? They would say they intend to increase electrical generation, burn more fuel, lower taxation, change the method of taxation to lessen the time it takes to tax, lessen government debt and lessen the cost of unemployment. The politician would eliminate all government borrowing permanently and guarantee everyone a job bringing the welfare expense to almost nothing. Regulations would be lessened to a tiny fraction of what is currently in place. Private investors would build hydroelectric power generating and exporting American energy would end. Importing should be as little as possible and exports should be compromised of finished goods and raw materials should not be exported. To win in global competition the value of currency must be linked to something real and never inflated. If the objective is to increase wealth and have more jobs and higher paying jobs than changes are necessary based on the above items. Of course there are a million details, but this is the general view.

The Physics of Newton's Second Law
Fp(1 − factors of counterforce) − μmg = ma (the change in acceleration
of the mass and the increase in velocity in a change in time)
↓
Analogy of Physics to Economics
↓
Economics
Fp(1 − factors of counterforce) − μmg = ma
The object is the economy of individual owners
Physics → Fp(1 − f₁ − f2 − f₃) − μmg = ma
Economics → Fp(1 − f_{tax,} − f_{gov debt,} − f_{unemployment}) − μmg α ma
Fp = the generation of electricity + fuel burned
Counterforces are taxation, government debt and the cost of unemployment.

| | |
|---|---|
| Wealth | α kinetic energy |
| Change in wealth | α in the change in kinetic energy |
| Cost of Capital | α μg (friction multiplied by gravity) |
| Capital | the resistance to force push of the commodity |
| Government Debt | = counterforce (independent) |
| Taxation | = counterforce (reactive) |
| Acceleration | $= \frac{the change in the change of ownership}{{time}^{2}}$ |
| | $\frac{change ( transaction rate )}{change in time}$ |
| Distance | = change in ownership |
| Cost of Unemployment | = counterforce (independent) |

To expect is to anticipate an effect. In order to have an effect, there must be a cause, according to the physics to economics view. Thus the physics view rejects the capital asset pricing model concept that the expected rate of return (ERR) is based upon markets and government debt because these are not forces that can cause an effect.

The physics view predicts rate of return as an effect from a cause due to the summation of force where the expected rate of return is proportional to the summation of force where the constant of proportionality is the average velocity multiplied by the change in time divided by the initial kinetic energy or (k=(ũΔt)/KEᵢ

The change in energy (ΔE) divided by the initial energy (KEᵢ) is proportional to growth as a percentage ΔE/Eᵢ=growth (a change). Than force multiplied by distance divided by a change in time and divided by the initial kinetic energy of the economy (Σf(ũΔt)/Δt)/(KEᵢ) which is proportional to the change in growth=expected rate of return, which is (Σf(ũΔt)/Δt)/(½ mv²)ᵢ=ΔE/Δt/KEᵢ which is the percentage change in growth.

An effect such as the expected rate of return (ERR) necessitates a cause must come from energy and subject to counterforces. The change in kinetic energy is proportional to the change in wealth. The kinetic energy changed due to the input of net force.

The analogy to the change in economic growth is the input of the summation of force multiplied by the average transaction rate multiplied by the change in time (distance) divided by change in time divided by the initial kinetic energy of the economy is proportional to the change in growth as a percentage, (Σf(ũΔt)/Δt)/KEᵢ α ERR.

Employment is part of the process of production and occurs from energy being externally input into the system. Increasing employment requires externally applied force to the system where the output is work done. Employment cannot increase if energy is taken from inside the system. When energy is taken from inside the system the system shrinks. The output from the economy is the change in wealth but there is always energy lost due to heat. Taking from one group and giving to another is using energy within the system or stored wealth to transfer wealth. The net effect is a loss of aggregate wealth. This means taking from one and giving to another will always reduce aggregate wealth. Reduction of energy occurs due to loss due to friction. As a practical observation, attempts to transfer wealth within the American economy have resulted in causing Americans to become less wealthy and it actually transferred the American wealth to foreign countries. The suppression of American efficiency results in a failure to compete. American money, jobs, and businesses have migrated out of America since the political philosophy (social science) of printing money began. As an ongoing system, wealth cannot be transferred continuously. That which was transferred never would have occurred in the first place if there was more knowledge regarding how the system operates. The Soviet Union generated very little wealth as an observation. Russia used its wealth to force equality resulting in a society where most were poor by Western standards. Transfers of wealth internal to the system deplete the energy of the system therefore shrinking the aggregate system.

The ending of the gold standard and the beginning of money printing is the same as letting the stored wealth out of the economy. The unearned money uses stored wealth to consume, depleting the United States of its value which, lessens the relative power of America globally. This has been observed.

To increase the wealth of the United States requires the increase in the applied force derived from energy as the prime mover. Spending is not energy and therefore it cannot be the prime mover. The pilgrims could not have become richer by spending because spending without earning first is simply a use of stored energy or stored wealth and the pilgrims did not have any stored wealth and were at a velocity of zero. To become wealthier as a nation is to increase the summation of force by either increasing electricity generated plus fuel burned, or by lessening the counterforces to force push which are predominately taxation, government debt, and the cost of unemployment. There is not any reason to collect taxes directly from the people because it increases time needed to pursue a gain. Tax banking transaction and eliminate income tax. Government borrowing lessens wealth because it subtracts assets from production. Unemployment expenses can be nearly eliminated by replacing the expense with guaranteed jobs. The less counterforce to the force push of electricity plus fuel burned the greater the net force which eventually leads to the increase in wealth. The climate change believer's political view should embrace the reduction of counter forces because counter forces needlessly waste energy. To hug a tree is eliminate income taxes. Wasting the people's time causes the people to burn more fuel to replace the value of the wasted time.

### Chapter XXI

### PEM

### The Physics to Economics Model

### The First Principle of Economics Process of Input to Output

Electricity plus fuel burned minus the counterforce of government policy of taxation, government debt, and the cost of unemployment plus the counterforce of natural drag equals the force net of the economic input. The output is the change in the transaction rate divided by the change in time as an increase in velocity, which leads to the change in kinetic energy where the change in kinetic energy is proportional to the change in wealth.

TABLE 7
Physics to Economics Model
The process to increase the wealth of the United States
Increasing the Wealth of the American Economy
How to Cause an Expected Rate of Return of an Economy to Increase
Expected Rate of Return (ERR)
↓
ERR = Must be caused by something
↓
The change in wealth = Must occur as a result of an input
↓
Determine the change in wealth by applying principles as a tool using the process of physics
↓
To cause a change, there must be a change in the input to alter the output, resulting in a change
assuming an increase, and assuming that which is being accelerated is fairly constant.
↓
To change requires a cause which results in an effect
↓
The effect is an alteration to the object of study where the behavior of the object changed velocity
↓
This means the cause is first in the logic sequence
↓
The result occurs secondly in the sequence of the order of events
↓
The input of energy transfers the energy to the economy in time and is demonstrated by the change in
transactions.
↓
Cause and effect follow a natural science order of occurrence where the cause always precedes and the
effects which will occur in logic at a sequence after the input occurs even if the effect is instantaneous.
↓
This process follows the natural science principles and concepts of physics analogous to economics.

| | |
|---|---|
| | Economics |
| Physics | Economies as an analogy to Physics |
| The only way to accelerate an object is by the input of | The only way to accelerate the economy is by the |
| a net force | input of a net force |
| The input of net force interacts with the object and | The input of net force interacts with the economy |
| changes its behavior by accelerating it which leads to | and changes its behavior by accelerating it which |
| a change in velocity in a change in time as the | leads to a change in the transaction rate divided |
| evidence is demonstrated by the kinetic energy | by the change in time which is the evidence of |
| increasing as the output. | the change in kinetic energy which is proportional |
| | to the change in wealth but not on a one to one |
| | basis. The percentage change in energy as an |
| | input generates a lesser percentage in wealth. |
| There must be a cause, first in the order of occurrence | There must be a cause, first in the order of |
| to result in a (positive) change, to make a change | occurrence, to result in a predicted change where |
| where the change is second in the occurrence of time. | the change is second in the order of occurrence. |
| The cause precedes the effect. | The cause precedes the effect. |
| The result logically is from the cause. | The result logically is from the cause. |
| Physics | Economics |
| Newton's second law of motion | Newton's second law of motion |
| Summation of force equals mass multiplied by | as an analogy to economics is the |
| acceleration | summation of force is equal to the economy of |
| Σf = ma | ownership entities multiplied by the change in the |
| | transaction rate divided by the change in time |
| | Σf = ma |
| Summation of force includes multiple forces. | Summation of force includes multiple forces. |
| Energy applied as force push is counteracted upon by | Energy applied as force push is counteracted |
| multiple counterforces to | upon by multiple counterforces to |
| equal a net force. | equal a net force. |
| Energy applied as force push is | Energy applied in economics is |
| counteracted upon by | electricity + fuel burned counteracted up on by |
| [(1 − factors_{1,2,3. . .})] − counterforces of nature as friction | counterforces as factors of taxation, government |
| multiplied by the object (mass) | debt and the cost of unemployment and also |
| multiplied by gravity (μmg) + independent factors. | counter acted upon by forces of nature and |
| | possible other factors. |
| Forceₚᵤₛₕ(1 − f_{1,2,3}) − friction(mass)(gravity) = | Electricity plus fuel burned multiplied by one |
| (mass)(acceleration) | minus the factors of taxation, government debt, |
| | and the cost of unemployment also minus the |
| Fₚ(1 − f_{1,2,3}) − μmg = ma | cost of maintenance is proportional to the |
| | ownership entities of a free people multiplied by |
| Σf = ma | the transaction rate divided by the change in |
| | time. |
| | Fₚ(1 − fₜₐₓ − f_{gov debt} − f_{cost of unemployment}) − |
| | cost of maintenance α |
| | (ownership entities)(transaction rate / Δt) |
| | ↓ |
| | Σf α ma |

Physics
Net Force = (mass)(acceleration)
written as . . .
Fₚ(1 − f_{1,2,3}) − μmg = ma

| | |
|---|---|
| Force Push | = Fₚ |
| Factors of counterforce | = f |
| Coefficient of friction | = μ |
| Mass | = m |
| Acceleration due to gravity | = g |
| Acceleration | = a = Δ(Δx) / (Δt)² = Δ²(x) / (Δt)² |
| Fp(1 − F_{1,2,3}) − μmg | = Σf |
| x | = position |
| Δx | = change in place of x is distance |

The physics to economics analysis
Force push = Fₚ = electricity + fuel burned
Factors = factors of taxation, factors of government debt, factors of the cost of unemployment (0 ≧ f ≦ 1)
Mass = m = ownership entities of a free people (the object of the study)
μmg = environmental constraints to be overcome
Acceleration = a = the change in the change of the ownership divided by the change in time squared as
the change in the transaction rate divided by the change in time.

| | |
|---|---|
| Physics | Economics |
| What changes | What changes |
| 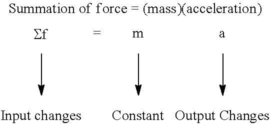 | 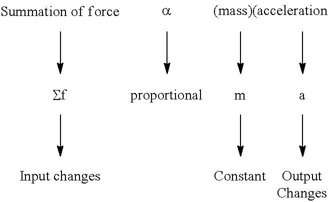 |
| 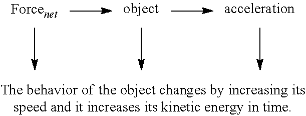 | 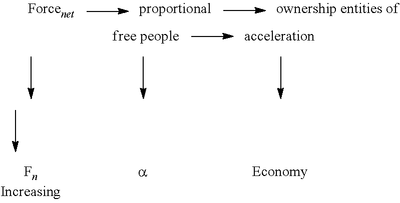 |
| | The behavior of the economy changes by |
| | increasing its speed which leads to the change in |
| | velocity plus the change in time demonstrating |
| | the changes in kinetic energy which is |
| | proportional to the change in wealth. |
| In order to change the velocity of an object either at | In order to change the velocity of the economy |
| rest or already in motion, the input (the net force | (assuming the US economy already has motion |
| applied) must change, assuming a positive forward | but with little or no growth the input of force net |
| motion. The increase is the effect | must be applied to increase the speed assuming |
| | a positive change is the objective |
| Energy must change to generate an output as work | Energy must change (as an increase) to result in |
| done plus heat. | an economic change in the total economy |
| A change in energy = ΔE | A change in energy = ΔE |
| A change in energy is noted as: | A change in energy is noted as: |
| A change in energy equals E_{final} − Eᵢₙᵢₜᵢₐₗ | A change in energy equals E_{final} − Eᵢₙᵢₜᵢₐₗ |
| ΔE = E_{f} − Eᵢ | ΔE = E_{f} − Eᵢ |
| In physics, for energy to be an output without | In economics (which is largely of the physical |
| depleting the system than the energy must to go into | world), to follow scientific reasoning means, to |
| the system externally. | become wealthier as a nation requires an |
| | external input of a net force derived from energy |
| | and reduced by counterforces where the net |
| | positive input results in a change in the output |
| | where the change in the output is a change in |
| Energy in = Energy out plus friction | wealth. Wealth cannot increase unless the input |
| ΔEᵢₙ = Eₒᵤₜ + heat | is external to the system and the input increases |
| | relative to the current initial input. |
| | Energy in = Energy out plus friction |
| | ΔEᵢₙ = Eₒᵤₜ + heat |
| Physics | Economics |
| Energy is a concept and is defined by what it does. | Wealth is a concept and is defined by what it can |
| Energy is the ability to do work. It is measured in units | do, which is the ability to consume. Wealth is |
| of joules which is a Newton multiplied by a meter. | derived from energy. The property of wealth |
| Energy in motion is kinetic energy and is calculated by | enable it to do work, the property of energy |
| 1/2mv² | enables it to do work. |
| | The change in kinetic energy is proportional to |
| | the change in wealth in the analogy of physics to |
| | economics. |
| | Kinetic energy in economics is energy equals one |
| | half the economy of ownership entities multiplied |
| | by the transaction rate squared |
| | E = 1/2eTr² |
| Distance in physics is a dimension in space | Distance in the analogy of physics to economics |
| x = dimension in space | is the change in ownership is a transaction. |
| Change in x = Δx = x_{f} − xᵢ | x = ownership |
| Distance = velocity multiplied by the change in time | For the economy to change wealth when wealth |
| d = vΔt | is an output then the summation of force |
| Then Σfd = ΣfvΔt | multiplied by the distance must occur. Distance |
| The output as a change in energy is equal to the | is necessary for the transfer of energy from the |
| summation of force multiplied by distance | input to the output. The input of energy is |
| Σf = force | transferred to the output as wealth. |
| ΔE = change in energy | |
| vΔt = distance | Distance is also the average velocity multiplied |
| The change in energy equals the summation of force | by the change in time in the analogy of physics to |
| multiplied by average velocity multiplied by the change | economics. |
| in time | |
| ΔE = Σf\tilde{v}Δt | ΔE = Σf\tilde{v}Δt |
| The change in energy (ΔE) is equal to the summation | In economics the change in energy is the |
| of force multiplied by average velocity multiplied by | summation of force multiplied by the average |
| the change in time. | velocity multiplied by the change in time. |
| ΔE = Σf(\tilde{v})(Δt) | |
| ΔE = fd | Forceₚᵤₛₕ = Fₚ = electricity plus fuel burned |
| | The counterforce to Fₚ = (1 − factor of taxation − |
| Forcepush = Fₚ = the applied force | factor of government debt, minus the factor of the |
| The counterforce to Fₚ = (1 − factor of counterforce) | cost of unemployment minus the cost of |
| minus the coefficient of friction mu (μ) multiplied by | maintenance as friction). |
| mass (m) multiplied by gravity (g) as μmg | Distance is ownership. The change in ownership |
| | is a transaction. Velocity is a transaction rate. |
| The change in energy is the summation of force Fₚ | Acceleration is a transaction rate in a change in |
| (counterforce) − μmg | time. |
| 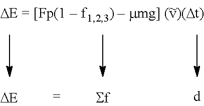 | Σf = (1 − fₜₐₓ − f_{gov debt} − f_{cost of unemployment}) − cost of maintenance ↓ distance = (average transaction rate)(Δt) ↓ Distance ↓ \tilde{v}Δt |
| | The change in energy equals force multiplied by |
| | distance |
| | ΔE = fd |
| | ΔE = Σf\tilde{v}Δt |
| | 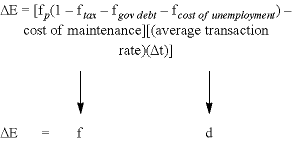 |

A change as an output is from a change in input.
A change in energy causes the change of the output.
Energy is transferred from the input to the output by the interaction of forces causing the object to, in time,
go distance.
ΔE = Σf(\tilde{v})(Δt)
The gain in economics is the expected (projected) return (ER) = change in energy

| Physics | | | Economics | | |
|---|---|---|---|---|---|
| ↓ | | | ↓ | | |
| 1. | ΔE | = A change in energy | 1. | ΔE | = A return (R) |
| 2. | ΔE / Δt | = Rate of change in energy | 2. | ΔE / Δt | = Rate of return (ER) |
| 3. | (ΔE / Δt) / Eᵢ | = Relative rate of change of | 3. | (ΔE / Δt) / Eᵢ | = Relative rate of return |
| | | energy | | | (RRR) |

| | | | | |
|---|---|---|---|---|
| 4. | Force distance/change in time/kinetic | 4. | ΔE / KEᵢ | = The relative return |
| | energy initial is the relative change | 5. | Σf\tilde{v}Δt / Δt / KEᵢ | = Relative rate of return |

| | |
|---|---|
| 6. | Return/in time/relative to the starting point = |
| | ΔE / Δt) / KEᵢ = Σf · d / Δt / KEᵢ = Σf\tilde{v}Δt / Δt / KEᵢ = |
| | growth = |
| | ΔKE α Δwealth in seconds |
| | Energy is applied to the economy as a |
| | constant force which travels distance and |
| | is the amount of energy needed to |
| | change wealth. |

For a positive return to occur the velocity of the object of study must change its speed.
The object of study in the economy is the individual owners as a free people.
↓
In economics to increase the aggregate wealth of the United States requires acceleration

| | |
|---|---|
| ↓ | ↓ |
| Physics | Economics |
| The change in the value of (x) | The change in the value of ownership |
| x = position | x = ownership |
| To have a change (positive) as a gain the value of the | To have an economic gain the transaction rate |
| x must change from xᵢₙᵢₜᵢₐₗ to x_{final} | must change. To accelerate the object, the |
| The change in x = | individual owner is a change in the transaction |
| Position final − position initial | rate in a change in time. Acceleration happens |
| Δx = x_{f} − xᵢ | instantaneously and in time the object is in |
| That is the object of study has motion. | motion and has a change in kinetic energy. The |
| | change in wealth occurs as a result of the object |
| | in motion. |
| Velocity = | A rate of return is a change in return in a change |
| A change in x / in a change in time | in time |
| v = Δx / Δt | Velocity = |
| v = x_{f} − xᵢ / t_{f} − tᵢ | A change in ownership / in a change in time. |
| | v = Δx / Δt |
| | v = ownership_{f} − ownerhsipᵢ / t_{f} − tᵢ |
| v =distance / time | v = transaction rate |
| v = d / t | Tr = transaction rate = v = ownership_{f} − |
| d = v(Δt) | ownerhsipᵢ / time_{f} − timeᵢ = |
| | transaction rate is a change in transaction in a |
| | change in time |
| | v = transaction / Δt = transaction rate |
| | d = vΔt |
| | Tr = (transaction rate)Δt |
| Acceleration (a) is the change in the time rate of | Acceleration (a) of the economy is the change in |
| change of the position of x | the time rate of change of ownership |
| a = Δ(Δx) / (Δt)² | a = Δ(Δownership) / Δt² |
| a = (x_{f} − xᵢ)₂ − (x_{f} − xᵢ)₁ / (Δt₂ − Δt₁) / (Δt_{f} − Δtᵢ) | a = (ownership_{f} − ownershipᵢ)₂ − (ownership_{f} − |
| | ownershipᵢ)₁ / (Δt₂ − Δt₁) / (Δt_{f} −Δtᵢ) |
| a = Δ²(x) / (Δt)² | |
| a = (Δvelocity / Δtime) = Δv/Δt | a = Δ²(ownership) / (Δt)² |
| | a = (Δvelocity / Δtime) = Δv / Δt |
| | a = Δ(transaction rate) / Δt |
| Acceleration of the object of study is an occurrence, | Acceleration of the economy is an occurrence, |
| which logically comes after the input of force even | after the input of electricity plus fuel burned. |
| though acceleration is instantaneous. | |

Economics
The expected rate of return (ERR) is a relative time rate of the change of energy.
The change in energy / change in time / energy Initial = (ΔE / Δt) / Eᵢ = (ΔE/Δt) / KEᵢ
KE = kinetic energy
↓
The economy is already in motion and therefore it has kinetic energy and is generating wealth. To
increase wealth is a change in wealth as an output. First the input must change before the output
changes.
↓
The unit of the time rate change of energy is a joule/second, which is a watt.
↓
The change of energy in time is relative to the initial energy
ΔE / Δt / KEᵢ = j / s / KEᵢ = watt / KEᵢ
↓
Expected Rate of Return (ERR)
[(Δ[Fp(1 − fₜₐₓ − f_{gov. debt} − fᵤₙₑₘₚ) − friction from the environment]
[(\tilde{v})(Δt) / Δt)] / [Fp(1 − fₜₐₓ − f_{gov. debt} − fᵤₙₑₘₚ) − friction from environment](\tilde{v})(Δt)ᵢ
↓
Expressed as a percentage change as
$\frac{\begin{matrix}[ Fp ( 1 - {f}_{tax} - {f}_{gov . debt} - {f}_{unemp} ) - μ mg ] ( \tilde{v} ) ( Δt ) \\ α ( ownership entities of a free people ) ( acceleration ) ( distance )\end{matrix}}{{E}_{i}}$
(100) = % Δ in growth
External energy → force net → mass multiplied by acceleration → leads to the change in velocity plus the
change in time which leads to the change in kinetic energy which is proportional to the change in wealth.
The energy as an input is transferred to the generation of wealth as the output. The change in kinetic
energy is proportional to the change in wealth (ΔKE αΔW).
Wealth = the ability to consume and is derived from energy.
Wealth = W
Wealth is proportional to kinetic energy (KE).
ΔKE αΔW
Cost of capital αμg (friction multiplied by gravity)
Capital is its mass plus its cost in energy.
Government debt = an independent counterforce to force push.
Taxation in the form of income tax uses the people's time to be collected. Taxation is a counterforce to
force push and the waste of time is an additional counter force. Taxation should occur without the use of
people's time.
The cost of unemployment is a counterforce to force push.
Unemployment is unnecessary and the cause of unemployment assuming a free people is due to
government policy.
↓
To increase the wealth of the aggregate US economy means in the order of occurrence either energy
must increase or the counterforces against force push must decrease or both energy increases and
counterforces decrease simultaneously.

| | |
|---|---|
| Momentum in Physics | Momentum of the Economy |
| Momentum = p | Momentum = p |
| Mass = m | Economy = e |
| Velocity = v | Velocity is the transaction rate = Tr |
| Momentum = mass · velocity | Momentum = mass · velocity |
| P = mv | P = eTr |

### Chapter XXII

### Answers to Questions of Economics Based on the Physics to Economics Model

1. At the initial arrival, during the first 12 months in the new world, could the pilgrims have simply declared themselves employed teachers (school) with good pay and a pension?

No. The asset, resource, or wealth used to pay teachers or any civil servant must be earned first. In order to generate wealth, energy is used, to apply force to transform natural resources into an altered state. This results in a product that has greater value than the natural resource.

2. Could the pilgrims have printed money and used the printed money to buy a house, food, or clothing?

No. The initial pilgrim society had no wealth other than their bodily internal chemical energy and intelligence. To simply print money and declare by the civil authority the money had value would not change the total value of society. The unearned pilgrim money could not take from stored wealth because there was not any stored wealth. The unearned money is not energy external to the system therefore it can't change the system. If zero force goes in then zero force comes out, plus friction. Matter cannot be created from zero; an object at rest cannot move unless by external force. Printed money is without force and a forceless input will result in no output and there is also an additional subtraction of wealth due to friction. Printing money would result in a net loss.

The pilgrims did not have stored wealth. They could not borrow because there was not any stored wealth to take from to give the debt force. They initially worked collectively and shared the output. Collectivism is like a debt as many will owe to the shared outcome. Sharing in the aggregate output causes unearned income to some. The unearned income causes a drag against the initial force push and results in a lesser output. There was not any stored wealth to use to give the unearned income value resulting in an immediate harsh decrease in output.

3. Could the pilgrims have borrowed money to buy a house, or food, or clothing?

No. The pilgrim's possessed zero wealth, other than their potential labor, and so there was no way to take from stored wealth to enable borrowed money to have any value. Borrowing must take its energy from somewhere. In modern society (America for example) there is stored wealth in existence. Borrowing subtracts from stored wealth, plus borrowing also takes additional stored wealth to pay interest, plus overcome friction due to the force of gravity, plus pay for the cost of government. Government borrowing can never generate a gain, but it always causes a reduction in societal wealth.

4. Could the pilgrims have started a government and had the government pay the pilgrims so they could buy their necessities?

No. The initial government would not possess wealth. The American government possesses wealth in 2016 because it took wealth from the people. Government can only take from this existing wealth which was first generated by the input of net force derived from energy. In the order of occurrence of cause and effect in the logic of physics, the cause must precede the effect. The dispersion of tax (assets taken from the people) and government debt (stored wealth taken from the people) are assets which first must be generated by the people by use of the summation of force originating from energy. The people must generate the wealth first before the government can take it.

Government cannot engage in business because business obtains the information necessary to operate with the efficiency equal to the efficiency necessary to overcome the counterforces of policy and nature. When government takes money from free private production to attempt to engage in a government business it is unlikely to succeed. There is a loss of wealth in the act of taking from the people, plus the people have less money because it was their money which government took. The result is society in general is made poorer by having its money taken. The immediate effect of the attempt of a government business is the initial start of the business used taken money from the people and caused a decline in society. The government would have to apply the money it subtracted from the economy and make a business decision as to where to invest the money. Keep in mind, the money being invested was subtracted from existing, efficient, profitable businesses which depleted their capacity to produce. If profitable business opportunities exist the ownership entity of capital would have already invested in the opportunity making government input unnecessary. Successful business means the energy applied equals the use of resources plus a gain necessary to perpetuate the activity. Energy=resources+gain. Private businesses have developed sophisticated abilities to match the cost of the input to the value of the output. Private business must balance their expenses to make a gain from the output. This is the most efficient use of energy. A government business violates this equation. The government equation is energy in minus the energy taken from the people equals resources needed plus the gain necessary to self-perpetuate. Energy−energy taken=resources+gain.

Typically when a government attempts to operate a business it cannot balance its works, so it resorts to printing unearned money and giving it to the failed government business. Printing unearned money further reduces the wealth of the people and the nation. There must be constant transactions by a free people to determine the cost of inputs and the profits from outputs. Without the knowledge of true costs, energy becomes misallocated and societal wealth declines. This is observed.

5. When an economic system is in an initial position, at rest (velocity zero), or with zero stored wealth how does the initial position change to a future position (position final)?

To move an object from rest, to accelerate it, requires the application of net force. The force is the cause and the effect is the acceleration. In economics, the object to be accelerated, is the collection of property owners. Wealth is an effect caused by the summation of force where the summation occurs is first in occurrence and the wealth is an output which occurs as an effect as a result of the input of net force. The input in an economy is electricity plus fuel burned minus the counterforce which is the net force.

6. What eventually enabled the pilgrim economic system to begin accelerating or gaining wealth?

The pilgrims generated wealth by the force of their labor once they established they were a free people who owned their individual labor. They maximized their applied force by using caloric energy, which was transformed to applied force, accelerating their transactions and supported by their tools and via a free market. A free market was necessary because it enabled the clarity of how much input results in so much output. The pilgrim did not have an income tax or government debt or the cost of unemployment (everyone worked).

7. Can spending unearned money build a pilgrim house or feed a pilgrim family?

No. Money is a measure of the consequence of using energy as the input into the economy. Once wealth is generated, then the result can be measured. Currency must be commensurate to the activity to account for the generation of wealth. The falsification of the unit of measure (money as a measure) does not alter the value of a unit of measure. Falsely printed money results in a remeasure of the unit causing a universal price change. However, a falsification of measurement cannot alter an outcome. The only way to alter an outcome is to first alter the input as a change in the net force.

8. Could the pilgrim society establish a minimum wage to increase their aggregate wealth?

No. Wages, or compensation, must be relative to the amount of kilograms moved so much distance in time eventually going someplace. A wage can only increase when the value of the job increases. If the job moves more weight, at the same speed, or the same weight faster or less weight very fast, the value of the job increases. To pay more for no change in output is altering the value of the currency. In time, a large scale minimum wage increase will universally decrease the value of the currency more so then then the actual wage increase. A minimum wage falsely accounts for actual work done. The wage must be relative to energy used. This alters the measurement of money. The real reason for a need to increase the minimum wage is because the value of the dollar has been inflated due to printing unearned money by the government.

9. Could the pilgrims have started a hedge fund to increase their aggregate wealth?

No. A hedge fund would not increase aggregate wealth. It acts as a transfer of wealth between the winners and losers making bets. Betting does not alter the aggregate wealth of a society because the betting is internal to the society. The input of energy into the system must be external to the system to have a net increase. Using energy internal to the system depletes the energy in the system and there is a further depletion due to friction. There is a net loss when energy internal to the system is used. To bet more or less lumber will be cut at some time interval does not cause more wood to be cut. In order to become wealthier, the pilgrims needed to cut more wood faster, and move it farther in less time assuming energy and efficiency were constant. Europeans in the fifteenth and sixteenth century had both wind and water mills which did work. These are an example of an external input of energy into a system. Windmills and watermills would cause the pilgrims to become wealthier

10. Could the pilgrims have implemented quantitative easing, QE 1, 2, or 3 to stimulate their economy? QE means quantitative easing which the American government currently uses to stimulate its economy by simply printing unearned (fake) money.

No. Quantitative easing is simply falsification of the value of money which causes everything measured in money to be re-measured resulting in universal price increases (inflation). Quantitative easing is implemented by the government by issuing bonds at very low interest and then buying them back using unearned printed money. The additional money printed reduces the value of stored wealth by the amount of printed money plus friction. The net result is there is less wealth in the economy. Neither energy nor matter can be created from nothing. Printing unearned money from nothing cannot cause a change in wealth. Only a change in the input of energy can cause a change in wealth. The United States GDP growth rate during quantitative easing has been essentially zero and the national debt has doubled. The net effect has been a loss of wealth.

11. Why didn't the pilgrims issue food stamps to feed the poor pilgrims?

Food stamps are the same as printing unearned money. To produce food, physical mass measured in kilograms must be moved, it takes time, and distance must be transversed. A food stamp cannot accelerate mass which went a distance in a time interval unless it took from the stored wealth of the people. It is a false currency, that is unearned which causes prices to rise because the value of the currency is cheapened. A food stamp is not energy and cannot transform energy as applied force resulting in a transfer its energy to generate wealth. Only applied force derived from energy resulting in a forward acceleration caused by the summation of force can result in an effect. Food stamps cannot cause and effect because they are a not a net force. Food stamps like unearned printed money result in a net loss of wealth to the nation. The currency is lessened by the amount of the food stamp and there is always friction in the activity to produce the food stamp.

12. Does printing money cause the United States of America to become wealthier or better off?

No. To print money corresponding to work done when a gain occurred is the correct reason to print money to document wealth, and the printing must be justified by the business gained. Money printed in excess of actual gains has a less than zero (negative) value because printed money causes price increases equal to the amount of printed money and prices increase additionally due to friction. Unearned printed money pushes on the economy and therefore the economy must push back. What pushes back against the unearned printed money? It is the stored wealth of the people that pushes back which results in a depletion of stored wealth. Unearned printed money is not energy therefore it does not have the capacity to generate wealth. Yet unearned money is used by some to consume. This consumption is at the expense of the peoples stored wealth (the individual savings accounts of the people) because the purchasing power of savings declines due to putting unearned money into the system. There is an additional loss of savings due to the friction during the activity of printing and distribution. It takes energy to print unearned money and that energy is lost from the system.

13. An object cannot stimulate itself to acceleration. Only by adding energy from an external source can the object be accelerated. The economy cannot be stimulated into a change in wealth by taking energy internal to the system to use it as force push. Unearned printed money from a stimulus or any other form of stimulus is using the internal energy which depletes stored wealth. Money printing stimulus does not cause aggregate transactions to increase, and it simultaneously decreases stored wealth by the same amount printed and additional wealth is lost due to friction. Also the profit from the transaction caused by stimulus is minus the depletion of stored wealth resulting in no gain. Further, the activity of the stimulus is an additional loss of stored wealth resulting in the effect of an aggregate loss of national wealth caused by the stimulus or applying unearned printed money into the economy. A government stimulus applying unearned printed money into the economy is an unconstitutional seizure of personal property via the intended depletion of the values of individual savings accounts. It continues because at this time the people are being fooled. The lost purchasing power should be refunded.

14. Does printing unearned money cause the individual average wage earner to become wealthier or better off?

There is a question of perspective in who gains and who loses due to unearned money being input into the economy. Anyone who has a job loses the purchasing power of their earnings. Workers are constantly working for less or are constantly having their pay cut due to any form of stimulus. Stimulus also reduces production as the depletion of stored wealth lessens assets available for production. The business owners lose the opportunity to increase gains and the wage earner lose the opportunity to find a job. The wage earner is the victim and loses wealth due to price increases and lack of opportunity. The actual money printer gains, but society in aggregate experiences a net loss. Those who receive the unearned money can consume with it, but it is at the expense of anyone who works or has stored wealth. Many workers have stored wealth in their bank accounts and money printers take from those workers. Many Moms have money in their bank accounts and their wealth is depleted by the money printers.

15. Does the government printing money and using the printed money to buy goods from people increase, decrease, or keep the same level of wealth within the United States.

When the government buys goods from the people, the people lose the goods and likely when the people buy the goods back from the government it is at a higher price. The government obtained the money to buy the good by either printing it or taking it via taxes. Either way the government is using what was taken from the people to buy the peoples opportunity. The people lose the opportunity to buy when the prices are low and are forced to pay higher prices due to their own money being taken from them. It is almost certain the government policy of allowing significant leverage into markets causes the extreme highs and lows in the first place. They pretend they are helping when an extreme low occurs, but they caused the low. They take the stored wealth of the people and force prices up, which hurts the people in the aggregate. Of course there are individual winners, but the nation loses.

16. Does inflation cause the United States to be wealthier, less wealthy, or have a neutral effect on existing wealth?

The answer is inflation makes the nation less wealthy. Inflation means the value of stored wealth is depleted. However much unearned money was printed in any form is how much of the peoples savings lost the ability to consume. An additional loss of wealth occurs due to friction. Wealth is depleted by the quantity of unearned printed money plus the energy it took to actually implement the form of printed money. The housewife or single mom had $10,000 saved, but after eight years of inflation (2007-2015) the money is only worth about $6,000. Thus $4,000 was taken from the mom by the money printers.

17. Does government debt in the form of treasury bonds make the United States wealthier, poorer, or have a neutral effect on wealth?

The answer is government debt is very destructive to any nation state for many reasons. Government debt is the failure of government to manage the balance of taxation to cost of government. The ability of the debt to be used to consume comes from stored wealth of the people. Government debt should not exist; its only purpose is to pay for the failure of government to balance taxation to governmental costs. Government debt reduces the available capital in the economy. As a result there is less capital to produce wealth. There is less capital for research. Almost all inventions come from non-governmental entities. The cost of borrowing for businesses increases because there is competition for the lenders. The entire distribution process for government debt is an unnecessary expense. If the interest rate were three percent it would equal an expense to the people of $570 billion annually. The people lose $570 billion for no reason other than the government failed to balance their budget. Adding $570 billion to the economy every year would significantly add a positive change the wealth of the United States. It would approximately equal the military budget, or it could build thirty new full size automobile plants per year. The nation losses because debt reduces capital available and there are additional costs due to interest and friction. The friction is the process to print, account, and distribute the government bonds. The total loss to the United States due to government debt is approximately four percent of the GDP per year and the US is only growing at 2% per year currently. As the government does not have any money other than what it takes from the people who produce it, the interest paid on the government debt is a 100% burden of the people. Governments have added a new technique in issuing government bonds which is to bill the bond holder directly. Whoever buys a government bond is not paid interest and billed for the bond purchase. This method is called negative interest bonds. The nation loses equally regardless of who pays for the bond because the money all comes from the same place: the people who earned it.

18. Does taxation make the United States wealthier, less wealthy, or is it a neutral effect?

There must be taxes to operate the police, fire, military, post office, and to maintain civil orderliness. However, taxes are an expense or counterforce to the generation and accumulation of wealth. Therefore taxation should be limited to and fixed at 10% of total domestic revenue and collected from the money system with civilian oversight. Collecting taxes via income tax reduces domestic wealth by 2-3% of the GDP per year because it costs time and discourages economic activity. Taxes collected directly from the people cause a loss of aggregate wealth due to the inefficiency of a system which wastes time. When time is wasted by the order of the government it results in wasted energy. Ten percent of all the coal burned in the United States is wasted due to the income tax method of collection to put it in terms of relative energy usage.

The main counterforces to force push of electricity plus fuel burned are taxation, government debt and the cost of unemployment (all those not working who are capable).

The income tax method costs an unnecessary three percent of the GDP, government debt is an unnecessary four percent of the GDP and the total welfare expense is another four percent of the GDP. The total is an eleven percent loss per year due to bad policy. The total government budget is in the 21% range of GDP based on historical data and if 11% is unnecessary than there is an approximate 10% needed to operate the government. In addition, the economic growth would be in the 10% range for many years as long as the counterforce to growth remains low.

19. Does the money spent on unemployment make the United States wealthier, less wealth, or the same?

There should be full employment on a voluntary basis. To pay someone not to work is a multiple loss of domestic wealth. The money to pay the unemployed is money taken from the production, which compounds the problem of lack of opportunity. The unemployed do not produce and all that they would have produced is lost. There is not any limit of the number of jobs available as long as there is an input of net force. The greater the net force, the greater the opportunity and the greater number of jobs. Well paying jobs is a ratio of the input of net force to the labor force in consideration to the properties of the nation state.

20. Does moving assets from A to B make the United States wealthier, poorer, or the same?

To move or change position within a gravitational field within an atmosphere will always cause a use of energy to overcome the resistance due to the force of gravity. There is always a use of energy (cost) to move. Redistribution uses energy within the system, which depletes the total energy available. It would take externally added energy to pay for the expense of redistribution. In aggregate, to redistribute is an expense because it moves something from its initial position to acceleration. The nation is richer if it never were to redistribute wealth. If the economic system is designed efficiently redistribution would not be necessary. Risk should be insured, but insurance is always an expense. Wth guaranteed employment transferring earned money from one person to another is not necessary.

21. Does the International Monetary Fund (IMF) make the make the United States wealthier, poorer, or the same?

No. Relative to the interest of every American citizen's financial interest, the IMF is an expense causing a loss of domestic wealth. The IMF lends to countries that are likely to never pay the debt or interest on the loan. The value of the IMF loan is a subtraction form the stored wealth of America.

22. What exactly is a job?

A job is part of the process of production and secondly it is part of the process to support service or production.

External energy in the form of electricity plus fuel burned is input less counterforces into the economy to accelerate it. Only a net force can accelerate it. The application of energy allows the force to accelerate the object which occurs instantaneously. This is the summation of force equals mass multiplied by acceleration. To transfer the energy of the input into the economy there must be distance in the change in time. The distance is demonstrated by the change in the transaction rate in a change in time. The energy from the input is transferred to the economy which is demonstrated by the change in velocity of activity.

A job is part of the process of accelerating the economy and more jobs are the demonstration of the energy transfer from the energy input to the economy. A job adds value to the raw material being altered to the product. A job comes from the energy input. Jobs are not created. Only God can create. Matter and energy are a fixed amount in the universe. Energy is generated and transferred measured in force which must go distance for the transfer of energy to occur. A society which allows personal freedom has the best condition to receive the energy as an input because the change in the transaction rate in the change in time leads to the change in velocity plus the change in time, which shows the change in kinetic energy and the change in kinetic energy is proportional to the change in wealth.

23. What causes commodity prices to move up and down to the degree which occurs at present?

There is very little change in supply and demand year to year of global commodities. Most of the change in price of goods, commodities or securities is driven by debt; debt in the form of lending to buy the item. Debt is the driver of volatility not free people transacting to generate a profit. Debt is the primary cause of markets crashing and wide swings in the price of commodities. Debt caused the up markets of the 1920's and the Depression of the 1930's. Real estate debt caused by no money down mortgages resulted in the 2008 real estate failures. Stocks could be purchased at a ten to one ratio (a change of 90%) during the 1920's. Over buying resulted and reversed to a negative −90% in the 1930's causing the great depression. The problem was not capitalism it was the government set lending rate. Very little or no gain is generated by commodity lending. Government or securities debt is a counterforce to long-term growth. Over short time intervals securities debt causes up spikes followed by the reverse. The reason commodity prices have 95% up and down swings in price is due to the typically high leverage lending of a twenty to one debt ratio.

24. What causes the stock market prices to change 50% from highs to lows?

There is very little business change year to year; however stocks can be leverage 2:1 causing 50% swings. Without the borrowing the swings in stock prices would only the 5%-ish year to year.

25. Can any government subsidy, in any form, for any reason make the United States wealthier, poorer, or the same?

Any government application of printing unearned money is a subtraction of wealth from America. To become wealthier as a nation, is to minimize government usage of the people's wealth. Wealth is an output from the input of energy which is transferred throughout the system as the process which results in wealth. Government subsidies reduce the input therefore reduce the output.

26. Does recalibrating an inch alter the actual distance?

No. Measurement methods cannot alter the laws of the universe. Changing the value of a dollar does not increase wealth.

27. Does increasing minimum wage increase or decrease the wealth of the individual being paid the minimum wage? Does it increase or decrease the aggregate wealth of the nation?

Minimum wage is currently popular. However, in fact the value of work done is the mass moved distance in time, eventually going distance. The physical view of work is in an economy something must be moved. Iron ore must be dug up, shipped and melted. There cannot be an economy without motion. A small island nation could have an economy of only insurance companies. However, in the larger view the island is a sub set of a global economy, which does mine, ship, melt, and build. An insurance company lives off the wealth generated by electricity plus fuel burned which is the force used to melt steel and make cars. It is the force used to alter to alter resources from a natural state to an altered state of enhanced value which allows wealth to occur. The current economy with zero growth generates wealth. To increase wealth relative to the current wealth requires a change in energy. There cannot be a change in the output unless the input changes first. The input is energy as applied force lessened by counterforces. A wage is a measured amount of work done and the measure is in dollars. However the actual work is mass moved distance in time. It is the applied force less counterforce which enables work done. The wage is only a measure of work done in units of currency. Work has a value that can't be artificially legislated because the work is physical. The value of work is in proportion to the value added to the transaction. To alter the measure does not alter the work done. The end result of increasing minimum wage is to cause more poor people because prices of goods increase equally or more than the minimum wage increases. The result is the cheapening of the currency. As the currency is cheapened the value of money shrinks taking money from women's and men's bank accounts. However, it is not the fault of the worker who is demanding a higher minimum wage. The worker is a victim of the decline in purchasing power of the dollar. It was the government policy of printing unearned money which caused the dollar to decline. The politicians know why the dollar is losing purchasing power because it is their policies which print the unearned money. Then they act like friends of the people when they increase minimum wage. But, it was the policies of the politicians which caused the increase in prices resulting in the need for the change in wages allowing workers living standard to keep up with the price increases. This is why the gold standard is needed.

28. Can the economy be stimulated by artificially low interest rates? Can it be artificially stimulated by any financial method?

Financial stimulus cannot increase the aggregate wealth of an economy. It is a hard fact law of physics that only a net force can accelerate an object. A net force is the result of a force pushed derived from energy being greater than the counterforces. A force push can exist without a counterforce, but a counterforce cannot exist without a force push. Force push derived from energy is the prime driver of economic change.

Financial stimulus in all of its forms are counterforces. Efficient financial design is less of a counterforce than inefficient financial design, but financial stimulus of any kind is still a counterforce. Too much taxation, poorly designed methods of taxation, government debt, printing unearned money, paying people not to work, no gold standard, and artificial interest rates are all counterforces to economic growth. Finance is not energy. Inefficient finance can be made more efficient, still finance is not a force push. Finance is limited to the role of a counterforce. Good financial policy can only be less of a counterforce than inefficient finance.

It is a hard fact law of physics that only force push minus counterforces, where the force push is greater than the counterforce, can the resulting net force accelerates an object. Finance tricks can never be a force push. Financial stimulation is often thought of as printing unearned money in some form such as lower than market interest rates, food stamps, lower than market rent, or outright printing unearned money. All of those shrink stored wealth and with friction have the net effect of decreasing national wealth. Good policies would increase the force net of the economy; go on a gold standard, stop printing unearned money, eliminate income tax and replace it with a banking system tax, forbid government bonds, and guarantee everyone a job ending the unemployment expense. These lessen the counterforces to force push and increase net force. The economy is stimulated by increasing the net force which accelerates the number of transactions (assumed at a profit). The change in velocity of a transaction is the demonstration of an increase of the kinetic energy which is proportional to the change in wealth. It is the increasing of the profitable transaction which leads to a change in wealth. Profitable transactions lead to wealth. But, a transaction can only be stimulated by the input of external force net.

29. What exactly does an increase in the economy mean?

To increase is an acceleration which is equal to change in velocity divided by a change in time. In the physics to economics model it means to increase transactions more so then what is already occurring in a change in time. More profitable transactions lead to an increase in wealth. What is accelerated? The ownership entity of a free people increase speed where the ownership entity is a constant in this example. It is the behavior of the economy which changes and the change is a change in speed. The input cause which forces the economy to accelerate is electricity plus fuel burned minus the counterforce of policy and nature which equal the summation of force. The force push used to accelerate is derived from energy. The energy in is transferred to the economy, accelerating it, the velocity is increased in time as a demonstration of the change in kinetic energy (energy from motion) and the change in kinetic energy is proportional to the change in wealth. The input of energy increases an economy and is unique to the specific properties of the economy of study.

In physics, the summation of force equals mass of an object multiplied by acceleration (Σf=ma). In economics it is the same. The summation of force is electricity plus fuel burned minus the counterforces which equals the ownership entities multiplied by the change in the transaction rate divided by the change in time as the acceleration (Σf=ma) or is the summation of force equals the economy multiplied by the transaction rate divided by the change in time (Σf=e ΔTr/Δ). The acceleration is demonstrated as a change in velocity in a change in time which is the change in kinetic energy which is proportional to the change in wealth as the change in the economy.

30. Can government spending change wealth?

No, government spending is taking energy internally from the economy. To increase wealth means the economy must be accelerated. The only way to accelerate the economy is by applying an external net force. An object cannot use its own energy to move itself. An economy cannot use its own internal energy to increase wealth in aggregate.

31. What is the cost of government?

The government's existence is a cost. All of government is a 100% expense against wealth. This is why it is so important to control the subtraction of wealth taken from the people by government wealth reduction methods. Government budgeting must be fixed where it cannot be increased for any reason (with a war/disaster exclusion) at 10% of the value of the economy at the federal level and 5% at the state level. No other taxation is permitted. The current budget has approximately 11% of the GDP (half of the budget) as an unnecessary expense due to inefficiencies. Also, there cannot be any financial trickery which alters the value of the currency. Altering the value of the currency in anyway is a counterforce to economic growth. The post war American budget has been in the 20% of GDP range and approximately half of it is unnecessary.

After reading this work, the reader should be able to differentiate between the physics view of economics vs. the present view of economics as interpreted by the currently applied social science method of reasoning.

Of course, social science methods are scientific but the weakness is there is a lack of measurement. The lack of measurement can disguise the agenda of social science theories. As such, political power can be obtained using the name of social science as a clever method to fool the people and reduce personal freedom. The tricks in social science cannot be measured so any claim can be made as to its benefits. Properly applied social science might be a benefit if the political agenda can be sifted out. Social science is necessary to design social order. Despots have used social science to out and out murder millions throughout history. While making the claim they were trying to improve the human condition.

Much of the foundation of economic policy should be founded in natural science which is more precise and highly measurable. If the object is to become wealthier, than such an objective can be clearly realized by the natural science view, or by using a physics based design to make economic policies.

### Chapter XXIII

### The Physics Definition of Economics

Economics is a natural science process of a physical cause and effect governed by the laws of physics. Physics explains the interaction between the abundance of the energy from the sun, plus the stored energy within the earth, and other resources which are applied to the economy to meet the demand of human evolution.

Evolution is the effect as an economic output which is caused by the external input of energy. The external energy applied as an input changes the velocity of the economy by accelerating it, and in time the output is demonstrated as a relative increase

The cause of the acceleration of the economic entity is from the external input of applied force derived from energy minus the opposing forces derived from policy and natural counterforces resulting in a net force. The net force to the economy is the input as the cause and the cause always precedes the effect. The effect in economies is the acceleration of the economic entity plus the change in time.

The input of the net force transfers energy from the input to the economic entity changing its behavior by increasing its speed and in a time interval demonstrates the change in kinetic energy of the economy. The change in kinetic energy is proportional to the change in wealth, which is the output in the analogy of physics to economics. The change in wealth is the ability to improve human condition.

The principles of the physics analogy to economics are as follows:
Economics must obey natural laws.
The input to an economy is the force push of electricity plus fuel burned minus the opposing forces (counterforces).
The counterforces to economic growth are multiple and are dominated by policies on taxation, the cost of government debt, and the cost of unemployment plus natural counterforces.
The economy is the ownership entities of a free people.
Acceleration of the economic entity is demonstrated by the change in the transaction rate in a change in time, assumed at a profit. The change in velocity demonstrates the change in kinetic energy of the economic entity. The change in kinetic energy leads to a proportional change in wealth.
The economic output is caused by the input of energy resulting in a change in wealth.
Wealth is the ability to do something; it can also be stored and can only exist from an input of energy.
Economic growth is the change in value of the economic entity in time relative to the initial economic kinetic energy.
Wealth cannot be increased by altering the value of the currency.
To increase wealth requires an increase of the force net derived from energy.

### GLOSSARY

Mass

Time

Distance

Mue

m

t

μ

Kg

Kilogram

Seconds

s

Gravity

g

Net force

Summation of force

Factor

Factor of taxation

Factor of government debt

Factor of the cost of unemployment

Cost of capital

Acceleration

Newton

Joule

Watt

Velocity

Speed

d

Wealth

Social Science

Natural Science

The subject matter described herein may be embodied in systems, apparatus, methods, and/or articles depending on the desired configuration. In particular, various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, calculators, and the like (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs; optical disks; memory components such as in the form of memory chips, memory devices, and semiconductor memory devices; and Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. Nonlimiting examples of semiconductor memory devices include volatile memory devices such as SRAM or DRAM devices, and nonvolatile memory devices such as ROM devices, flash memory devices, FeRAM devices, CBRAM devices, PRAM devices, SONOS devices, RRAM devices, Racetrack memory devices, NRAM devices, and Millipede devices.

Specifically, in certain embodiments, the present subject matter provides an article comprising a machine-readable medium embodying instructions that when performed by one or more machines result in operations which include the following. The instructions of the article include identifying at least one economic variable of an economic phenomena to be analyzed. The instructions also include assigning one or more physics variables to each of the identified economic variables, wherein the assigned physics variables correspond to the respective identified economic variable. And, the instructions include evaluating the assigned physics variables using physical laws to thereby analyze the economic phenomena.

In other embodiments, the present subject matter provides an article comprising a machine-readable medium embodying instructions that when performed by one or more machines result in operations which include the following. The instructions of the article include identifying and defining an economic system having a plurality of wealth values. Each wealth value is associated with a particular time. The instructions also include identifying a first number of transactions occurring in the economic system at a first time, and identifying a second number of transactions occurring in the economic system at a second time, the second time being after the first time. The instructions additionally include determining a change in transactions over time by comparing the first and second numbers of transactions in the economic system to thereby obtain a transaction rate, Tr. The instructions also include identifying a value of economy of ownership entities in the economic system, e. And, the instructions include applying a formula (I) using the transaction rate Tr and the value of economy of ownership entities e to determine the change in wealth ΔW of the economic system, wherein the formula (I) is:

ΔW=½e(Tr)² (I)

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Specifically, in certain embodiments, the present subject matter provides a system that includes a processor and a memory. The processor and memory are configured to perform operations that include identifying at least one economic variable of an economic phenomena to be analyzed. The operations also include assigning one or more physics variables to each of the identified economic variables, wherein the assigned physics variables correspond to the respective identified economic variable. And, the operations additionally include evaluating the assigned physics variables using physical laws to thereby analyze the economic phenomena.

In other embodiments, the present subject matter provides a system comprising a processor and a memory. The processor and memory are configured to perform operations that include identifying and defining an economic system having a plurality of wealth values, each wealth value associated with a particular time. The operations also include identifying a first number of transactions occurring in the economic system at a first time, and identifying a second number of transactions occurring in the economic system at a second time, the second time being after the first time. The operations also include determining a change in transactions over time by comparing the first and second numbers of transactions in the economic system to thereby obtain a transaction rate, Tr. The operations further include identifying a value of economy of ownership entities in the economic system, e. And, the operations include applying a formula (I) using the transaction rate Tr and the value of economy of ownership entities e to determine the change in wealth ΔW of the economic system, wherein the formula (I) is:

ΔW=½e(Tr)² (I)

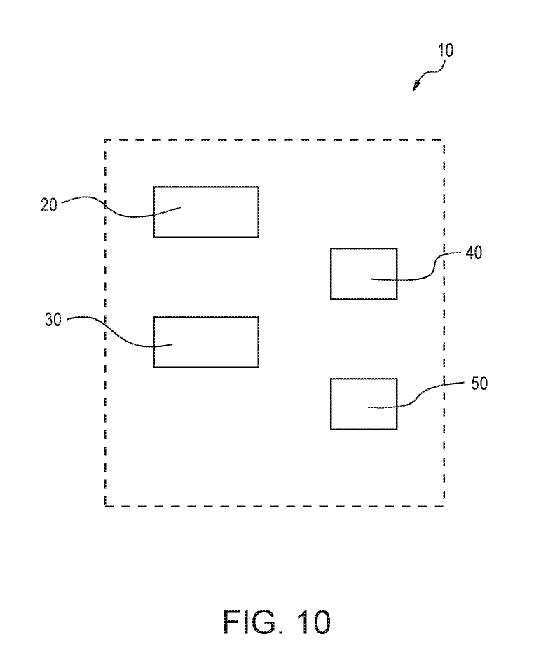

FIG. 10 schematically depicts a system 10 in accordance with an embodiment of the present subject matter. The system 10 comprises a processor 20 and a memory 30 in communication with one another. The system may additionally comprise one or more user interface(s) 40. The system 10 may also comprise means 50 for receiving data and/or information. An example of the means 50 is a mechanism or component that reads or otherwise accesses information coded and/or stored on a machine-readable medium. Another example of the means 50 is a wired or wireless connection configured to receive a machine-readable signal from a database or other source of information or data.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A method for determining a change in wealth of an economic system, the method comprising:
identifying and defining an economic system having a plurality of wealth values, each wealth value associated with a particular time;
identifying a first number of transactions occurring in the economic system at a first time;
identifying a second number of transactions occurring in the economic system at a second time, the second time being after the first time;
determining a change in transactions over time by comparing the first and second numbers of transactions in the economic system to thereby obtain a transaction rate, Tr;
identifying a value of economy of ownership entities in the economic system, e;
applying a formula (I) using the transaction rate Tr and the value of economy of ownership entities e to determine the change in wealth ΔW of the economic system, wherein the formula (I) is:
ΔW=½e(Tr)² (I).

2. The method of claim 1 wherein the determining the change in transactions is performed by mathematically obtaining a difference between (i) the second number of transactions at the second time, and (ii) the first number of transactions at the first time.

3. An article comprising a machine-readable medium embodying instructions that when performed by one or more machines result in operations comprising:
identifying and defining an economic system having a plurality of wealth values, each wealth value associated with a particular time;
identifying a first number of transactions occurring in the economic system at a first time;
identifying a second number of transactions occurring in the economic system at a second time, the second time being after the first time;
determining a change in transactions over time by comparing the first and second numbers of transactions in the economic system to thereby obtain a transaction rate, Tr;
identifying a value of economy of ownership entities in the economic system, e;
applying a formula (I) using the transaction rate Tr and the value of economy of ownership entities e to determine the change in wealth ΔW of the economic system, wherein the formula (I) is:
ΔW=½e(Tr)² (I).

4. The article of claim 3 wherein the article is selected from the group consisting of magnetic discs, optical disks, memory components, and programmable logic devices.

5. The article of claim 4 wherein the article is a semiconductor memory device.

6. A system comprising:
a processor and a memory, wherein the processor and the memory are configured to perform operations comprising:
identifying and defining an economic system having a plurality of wealth values, each wealth value associated with a particular time;
identifying a first number of transactions occurring in the economic system at a first time;
identifying a second number of transactions occurring in the economic system at a second time, the second time being after the first time;
determining a change in transactions over time by comparing the first and second numbers of transactions in the economic system to thereby obtain a transaction rate, Tr;
identifying a value of economy of ownership entities in the economic system, e;
applying a formula (I) using the transaction rate Tr and the value of economy of ownership entities e to determine the change in wealth ΔW of the economic system, wherein the formula (I) is:
ΔW=½e(Tr)² (I).

7. The system as in claim 6, further comprising a user interface via which a user can select a variable for analysis.

8. The system as in claim 6, further comprising a user interface via which results of the analysis are presented to a user.

9. The system as in claim 6, further comprising means for receiving data related to at least one variable.

10. The system as in claim 9, wherein the means for receiving the data comprises a mechanism that reads information coded on a machine-readable medium.

11. The system as in claim 9, wherein the means for receiving the data comprises a wired or wireless connection configured to receive a machine-readable signal from a database comprising the data related to the at least one variable.
